(19) United States
(12) Patent Application Publication
(10) Pub. No.: US 2022/0058355 A1
(43) Pub. Date: Feb. 24, 2022

(54) CODE GENERATION DEVICE

(71) Applicant: I.P SOLUTIONS, LTD, Tokyo (JP)

(72) Inventor: Kenji YOSHIDA, Tokyo (JP)

(21) Appl. No.: 17/257,624

(22) PCT Filed: Jul. 2, 2019
(86) PCT No.: PCT/JP2019/026392

§ 371 Date: Nov. 7, 2021

(30) Foreign Application Priority Data
Jul. 2, 2018 (JP) 2018-126428
Jul. 2, 2018 (JP) PCT/JP2018/025120
Jan. 4, 2019 (JP) 2019-000364

(51) Int. Cl. G06K 7/14

(52) U.S. Cl. CPC G06K 7/1408; G06F 3/041

(57) ABSTRACT

The challenge of the present invention is to be able to use a large number of code generation apparatuses and to be able to identify each one.

In the apparatus, a plurality of electrodes detected by a change in a physical quantity detected by a touch panel by bringing it into contact with or by substantially into contact with the touch panel connected to a first information processing apparatus is arranged on a bottom surface of a housing, and the apparatus comprises a communication processing unit that is equipped with a housing formed of a conductive member connected to the plurality of electrodes and that enters a connected state based on at least a part of an electrode code with the first information processing apparatus that recognizes the electrode code formed based on electrodes detected by the touch panel among the plurality of electrodes.

### FIELD OF THE INVENTION

The present invention relates to a code generation apparatus used with an electronic device equipped with a touch panel.

### BACKGROUND OF THE INVENTION

In recent years, code generation apparatuses such as electronic stamps, touch cards, and the like in which electrodes are formed that can be detected with a capacitive touch panel have become widespread. By holding these code generation apparatuses over or placing these code generation apparatuses on an electronic device (for example, a smartphone) equipped with a capacitive touch panel, the electrodes are detected, and the capacitance code defined by the arrangement of the electrodes are recognized (see Patent Literature 1 to 4).

### PRIOR ART DOCUMENTS

### Patent Literature

Patent Literature 1: Japanese Unexamined Patent Application Publication No. 2015-5275.

Patent Literature 2: Japanese Translation of PCT International Application Publication No. JP-T-2016-505922.

Patent Literature 3: Japanese Unexamined Patent Application Publication No. 2011-134298.

Patent Literature 4: Japanese Patent No. 5709284

### SUMMARY OF THE INVENTION

### Problems that the Invention is to Solve

However, with the electronic stamps of Patent Documents 1 and 2 and the touch cards of Patent Documents 3 and 4, only one fixed electrode pattern can be used. Touch panels that are come into contact with code generation apparatuses such as electronic stamps and touch cards include commercial devices such as gaming devices and tablets, but the overwhelming majority are smartphones. Therefore, for electronic stamps and touch cards, the area where the electrode pattern is formed is dependent on the screen size of a smartphone display. The size, shape, and geometry of the electrodes are naturally limited when smaller smartphones are also targeted. Furthermore, there are cases in which two electrodes are detected as one electrode when a predetermined distance is not provided between two adjacent electrodes, and considering these factors, the number of electrode codes definable from electrode patterns is limited to around 100. However, to perform stamp rallies at many facilities, payments at stores, point awarding, erasing, and the like, it is necessary to discriminate each facility and store, and thus a large number of electrode patterns (electrode codes) are required. However, current electronic stamps and touch cards cannot be used to handle this. Furthermore, if electronic stamps and touch cards were to be used for personal seals, authentication cards, and the like, much more electrode code generation apparatuses having codes different from each other are required.

The present invention has been made in view of such a situation, and an object of the present invention is to use a large number of code generation apparatuses and to identify each one as a different apparatus.

### Solution to the Problems

(1) To solve the above-described problems, featured is an apparatus according to the present invention, wherein a plurality of electrodes detected by a change in a physical quantity detected by a touch panel by bringing it into contact with or by substantially into contact with the touch panel connected to a first information processing apparatus is arranged on a bottom surface of a housing comprising: a communication processing unit that is equipped with a housing formed of a conductive material connected to the said plurality of electrodes and that enters a connected state based on at least a part of an electrode code with the said first information processing apparatus that recognizes the electrode code formed based on electrodes detected by the said touch panel among the said plurality of electrodes.

(2) Furthermore, the said communication processing unit may include a storage means, and at least a unique device ID or a unique ID formed by combining a device ID with an electrode code may be stored.

(3) Furthermore, the said electrode code may be formed based on at least one of shapes, sizes, and geometric arrangements of the detected electrodes, magnitudes of detected physical quantities, and combinations thereof.

(4) Furthermore, the said touch panel may be a capacitive touch panel.

(5) Furthermore, the said first information processing apparatus may enter a connected state with the said communication processing unit by recognizing a communication address including at least a part of the said electrode code or a communication address corresponding to at least a part of the said electrode code.

(6) Furthermore, the apparatus may comprise a first operation unit configured to control the said communication processing unit, wherein the said first information processing apparatus may enter a connected state with the said communication processing unit by recognizing a communication address including at least a part of the said electrode code or a communication address corresponding to at least a part of the said electrode code and by operating the said first operation unit.

(7) Furthermore, the apparatus may comprise a sensing unit for sensing a state wherein the said first information processing apparatus is in contact with or substantially in contact with the said touch panel, wherein the said first information processing apparatus may enter a connected state with the said communication processing unit by recognizing a communication address including at least a part of the said electrode code or a communication address corresponding to at least a part of the said electrode code and by having the said sensing unit sensing a state wherein the said first information processing apparatus is in contact with or substantially in contact with the said touch panel.

(8) Furthermore, the said sensing unit may detect a change in a physical quantity detected from the said touch panel.

(9) Furthermore, the said sensing unit may comprise one or more light detection sensors on a surface that is in contact with or substantially in contact with the said touch panel, and may detect light displayed on the touch panel.

(10) Furthermore, the said one or more light detection sensors may be recognized by at least one of shapes, sizes, and geometric arrangements of the electrodes, magnitudes of detected physical quantities, and combinations thereof serving as a basis for forming the said electrode code and an optical code formed upon a history thereof may be acquired by changing at least one of light colors, light intensities, and blinking times in time series in a region of the said touch panel corresponding to the said position.

(11) Furthermore, the said first information processing apparatus may enter a connected state with the said communication processing unit located at a distance closest from the said first information processing apparatus when a plurality of communication addresses including at least a part of the said electrode codes or a plurality of communication addresses corresponding to at least a part of the said electrode codes may be recognized.

(12) Furthermore, the said communication processing unit may comprise a GPS and may cause the first information processing apparatus to recognize a position acquired by the said GPS.

(13) Furthermore, the said communication processing unit may have a clock function and may transmit time information or information that changes with time.

(14) Furthermore, the said housing may have either a plate shape or a three-dimensional shape, and a film formed of a non-conductive material may be provided on the surface of the bottom surface section of the housing.

(15) Furthermore, the said conductive material may be connected to a contact region formed in a region of a surface of the said housing, and an electrode code formed based on electrodes detected by the said touch panel is recognized by conduction of the conductive material to the said electrodes caused upon making contact with or holding the said contact region.

(16) Furthermore, the said conductive material may be connected to a contact region formed in a region on the surface of the said housing, the contact region may be formed in a plurality of regions on the surface of the housing, and by causing conduction between each conductive material in the said regions and the said electrodes connected to respective conductive material by making contact with or holding at least one of the said plurality of areas, a switchable electrode code formed based on electrodes detected by the said touch panel may be recognized.

(17) Furthermore, a film formed of a non-conductive material may be provided on a surface of the contact region.

(18) Furthermore, the apparatus may further comprise one or more second operation units capable of switching electrode codes formed based on electrodes detected by the said touch panel by conduction or disconnection of at least a part of conduction paths between the said electrodes and the said conductive material when a predetermined operation is received.

(19) Furthermore, the apparatus may further comprise a conduction control unit capable of switching electrode codes formed based on electrodes detected by the said touch panel by electrically connecting or disconnecting at least a part of conduction paths between the said electrodes and the said conductive material.

(20) Furthermore, an electrode code may be formed based on a history of electrodes detected by the said touch panel by electrically changing the said connection or disconnection in time series.

(21) Furthermore, at least a part of the said electrode code may include a code for instructing the said first information processing apparatus to perform a predetermined information processing.

(22) Featured is an information communication method according to the present invention, wherein a communication processing unit provided in a housing of the apparatus with a plurality of electrodes arranged on the housing bottom surface, and a first information processing apparatus connected to a touch panel that detects one or more positions by detecting changes in physical quantities are caused to enter a connected state based on at least a part of the said electrode codes by causing the said first information processing apparatus to recognize an electrode code formed based on a plurality of electrodes detected by changes in physical quantities detected by the said touch panel by bringing the housing bottom surface into contact with or substantially into contact with the touch panel.

(23) Furthermore, featured is an information communication method, wherein in regards to a connection based on at least a part of the said electrode code, the said first information processing apparatus is caused to recognize a communication address including at least a part of the said electrode code or a communication address corresponding to at least a part of the said electrode code, and the said first information processing apparatus and the said communication processing unit is caused to enter a connected state.

(24) Furthermore, featured is the information communication method, wherein a connection based on at least a part of the said electrode code causes the first information processing apparatus to recognize a communication address including at least a part of the said electrode code or a communication address corresponding to at least a part of the said electrode code and causes the said communication processing unit and the said first information processing apparatus to enter a connected state by causing the said communication processing unit to detect a state in which the touch panel is in contact with the said apparatus or substantially in contact with the said apparatus.

(25) Furthermore, featured is the information communication method according to claim 24, wherein the said communication processing unit causes the said communication processing unit and the said first information processing apparatus to enter a connected state by detecting light from the touch panel.

(26) Furthermore, featured is the information communication method, wherein performed is at least one of (A) in the said connected state, a first predetermined information is transmitted from the said communication processing unit to the first information processing apparatus or a second predetermined information is transmitted from the said first information processing apparatus to the said communication processing unit, (B) the said communication processing unit and the said second information processing apparatus are caused to enter a connected state by a predetermined method, and a third predetermined information is transmitted from the said communication processing unit to the said second information processing apparatus or a fourth predetermined information is transmitted from the said second information processing apparatus to the said communication processing unit, (C) the said first information processing apparatus and the said third information processing apparatus are caused to enter a connected state by a predetermined method, and a fifth predetermined information is transmitted from the said first information processing apparatus to the said third information processing apparatus or a sixth predetermined information is transmitted from the said third information processing apparatus to the said first information processing apparatus, and (D) the said second information processing apparatus and the said third information processing apparatus are caused to enter a connected state by a predetermined method, and a seventh predetermined information is transmitted from the said second information processing apparatus to the said third information processing apparatus or a eighth predetermined information is transmitted from the said third information processing apparatus to the said second information processing apparatus.

(27) Furthermore, featured is the information communication method according to claim 26, wherein a unique device ID or a device ID that is unique in combination with the said electrode code is stored in the said communication processing unit, and at least one of the said first or third predetermined information includes the said device ID.

(28) Furthermore, featured is the information communication method according to claim 27, wherein the said first information processing apparatus judges that an electrode code is a misidentified code when a combination with an electrode code different from a device ID that is unique in combination with the said electrode code is recognized.

(29) Furthermore, featured is the information communication method, wherein at least one of the said first to third information processing apparatuses has a first specific code for specifying the said information processing apparatus and/or a second specific code set in an activated software, and at least one of the said second, fourth, fifth, sixth, seventh, and eighth predetermined information transmitted from the said information processing apparatus includes any one of the said first and second specific codes.

(30) Furthermore, featured is the information communication method, wherein the said first information processing apparatus recognizes a communication address including at least a part of the said electrode code or a communication address corresponding to at least a part of the said electrode code and causes the said first information processing apparatus to enter a connected state with one or more of the said third information processing apparatuses.

(31) Furthermore, featured is the information communication method, wherein the said third information processing apparatus includes the said second information processing apparatus.

(32) Furthermore, featured is the information communication method, wherein the said apparatus and the said first to third information processing apparatuses determine whether at least one of the said first to eighth predetermined information received is correct or incorrect by a predetermined method.

(33) Furthermore, featured is the information communication method according to claim 32, wherein the judgment result by the said predetermined method is transmitted to a transmission source of the received said predetermined information.

(34) Furthermore, featured is the information communication method, wherein at least one of the said first to eighth predetermined information includes predetermined data and encrypted information obtained by encrypting the predetermined data.

(35) Furthermore, featured is the information communication method according to claim 34, wherein the said encrypted information is information obtained by encrypting by an encryption means encoded information obtained by encoding the said predetermined data by an encoding means.

(36) Furthermore, featured is the information communication method, wherein the information processing apparatus receiving the said predetermined information authenticates whether or not the said predetermined data is correct by collating encoded information obtained by decrypting the said encrypted information by a decrypting means with encoded information obtained by encoding the said predetermined data by the said encoding means.

(37) Furthermore, featured is the information communication method, wherein when at least any one of the said first to eighth predetermined information is transmitted or received, a corresponding predetermined processing is performed.

(38) Furthermore, featured is the information communication method, wherein the said predetermined process includes a process of disconnecting at least one of a connected state between the said third information processing apparatus and the said first or second information processing apparatus and a connected state between the said communication processing unit and the said first and/or second information processing apparatus.

(39) Furthermore, featured is the information communication, wherein the communication processing unit is equipped with a clock function and time information or information that changes with time is included in the first and/or third predetermined information.

(40) Featured is an information communication system comprising the apparatus according to the present invention and a first information processing apparatus connected to a touch panel that detects one or more positions by detecting changes in physical quantities, and wherein a plurality of electrodes arranged at the bottom surface of the housing of the apparatus is brought into contact with or substantially into contact with the said touch panel, the said first information processing apparatus recognizes an electrode code formed based on electrodes detected by the said touch panel among the said plurality of electrodes, and the communication processing unit provided in a housing of the said apparatus and the said first information processing apparatus enter a connected state based on at least a part of the said electrode code.

(41) Featured is the information communication system according to the present invention, wherein the said communication processing unit and the said first information processing apparatus enter a connected state by the information communication.

(42) Furthermore, featured is the information communication system, further comprising a second and/or third information processing apparatus, wherein information processing is performed by the information communication method according to any one of claims 26 to 38.

(43) Furthermore, featured is the information communication system, wherein the said first information processing apparatus is a smartphone.

(44) Furthermore, featured is a program wherein a plurality of electrodes arranged on a bottom surface of a housing of the apparatus is brought into contact with or substantially into contact with a touch panel that detects one or more positions by detecting changes in physical quantities and is connected to the first information processing apparatus, the said first information processing apparatus recognizes an electrode code formed based on electrodes detected by the said touch panel among the said plurality of electrodes, and by using the information communication method, the said first information processing apparatus and a communication processing unit provided in the housing of the said apparatus are caused to enter a connected state based on at least a part of the said electrode code.

(45) Furthermore, featured is the program, wherein information processing is performed by the information communication method in a system further comprising a second and/or third information processing apparatus,

### Advantageous Effect of the Invention

According to the present invention, it is possible to provide a large number of code generation apparatuses that make contact with or substantially make contact with the touch panel of the information processing apparatus, and the code generation apparatuses can be specified by the information processing apparatus.

### BRIEF DESCRIPTION OF THE DRAWINGS

FIG. 1 shows diagrams of an example of an external configuration of an information processing system according to one embodiment of the present invention.

FIG. 2 shows schematic diagrams of an external shape of a code generation apparatus according to the first embodiment.

FIG. 3 shows diagrams of an example of a code generation apparatus according to the first embodiment.

FIG. 4(A) is a diagram showing a conductive pattern diagram printed on a conductive pattern printed sheet, and FIG. 48(B) is a diagram showing the shape when a conductive pattern printed sheet is attached to the bottom part of the housing.

FIG. 5 is a schematic diagram of a circuit of a code generation apparatus according to the first embodiment.

FIG. 6(A) is a schematic representation of a first conductive pattern detected by a touch panel in a state with a code generation apparatus making contact with the touch panel with touching of human body contact electrodes, and FIG. 6(B) is a schematic representation of a second conductive pattern detected by a touch panel in a state with a push button of a code generation apparatus being pressed.

FIG. 7 shows schematic diagrams of an external shape of a code generation apparatus according to the second embodiment.

FIG. 8 is a diagram showing an example of a configuration of a code generation apparatus according to the second embodiment.

FIG. 9 shows diagrams of an example of a configuration of a code generation apparatus according to the second embodiment.

FIG. 10 shows diagrams of overviews of electrode detection operations of a general electrostatic capacitance type touch panel.

FIG. 11 shows schematic diagrams of an external shape of a code generation apparatus according to the third embodiment.

FIG. 12 shows schematic diagrams of a circuit of a code generation apparatus according to the fourth embodiment.

FIG. 13 shows schematic diagrams of an external shape of a code generation apparatus according to the fourth embodiment.

FIG. 14 shows diagrams of a judgment method for (STEP 1) and (STEP 2) of electrode detection coordinates for pattern coding according to the fifth embodiment.

FIG. 15 shows diagrams of a coordinate transformation method for pattern coding.

FIG. 16 shows flowchart diagrams of an example of pattern coding processing according to the fifth embodiment.

FIG. 17 shows schematic diagrams of an external shape of a code generation apparatus according to the sixth embodiment.

FIG. 18 is a schematic diagram showing a configuration of a code generating apparatus according to the sixth embodiment.

FIG. 19 is a schematic sectional view showing a configuration of a code generation apparatus according to the sixth embodiment.

FIG. 20 shows schematic diagrams of a form of a code generation apparatus of a modification example according to the sixth embodiment.

FIG. 21 shows schematic diagrams of a form of a code generation apparatus of a modification example according to the sixth embodiment.

FIG. 22 shows diagrams of a code specification of a multi-code stamp of which several stamp codes can be set with a slide switch.

FIG. 23 is a flowchart diagram showing an authentication system using an electronic stamp.

FIG. 24 shows an embodiment of a code generation apparatus equipped with a dot code reader.

FIG. 25 shows an embodiment of a code generation apparatus equipped with an optical code reader.

FIG. 26 shows an embodiment of a code generation apparatus equipped with an optical code reader.

FIG. 27 is an example showing synchronization by an optical code reader.

FIG. 28 is an example showing the time-series change of synchronization by an optical code reader.

FIG. 29 shows a diagram exemplifying a connection between a code generation apparatus and an information processing apparatus.

FIG. 30 shows a diagram exemplifying a connection between a code generation apparatus and an information processing apparatus.

FIG. 31 shows a diagram exemplifying placeable positions of electrodes when electrodes are placed at diagonal edges of a square region.

FIG. 32 is a diagram exemplifying an electrode pattern arranged with five circular electrodes.

FIG. 33 is a diagram exemplifying an electrode pattern arranged with five circular or elliptical electrodes.

FIG. 34(A) is a schematic side view showing an example of an external view of a stamp-type code generation apparatus 120, FIG. 34(B) shows a schematic top surface view, and FIG. 34(C) is a schematic bottom surface view.

FIG. 35 is a schematic sectional view of a side of a code generation apparatus 120 dissected in a vertical direction.

FIG. 36(A) is a schematic side view showing an example of an external view of a stamp-type code generation apparatus 120, FIG. 36(B) shows a schematic top surface view, and FIG. 36(C) is a schematic bottom surface view.

FIG. 37(A) shows a schematic configuration diagram of a code generation apparatus 121, and FIG. 37(B) is a diagram showing an example of a switch circuit of a conduction control unit thereof.

FIG. 38 is a schematic sectional view of the side surface of a code generation apparatus 121 dissected in a vertical direction.

FIG. 39 shows a shape of a stamp applicable as a code generation apparatus equipped with a communication processing unit.

FIG. 40 shows a shape of a stamp applicable as a code generation apparatus equipped with a communication processing unit.

FIG. 41 shows a shape of a stamp applicable as a code generation apparatus equipped with a communication processing unit.

FIG. 42 shows a shape of a stamp applicable as a code generation apparatus equipped with a communication processing unit.

FIG. 43 shows a shape of a stamp applicable as a code generation apparatus equipped with a communication processing unit.

FIG. 44 shows a shape of a stamp applicable as a code generation apparatus equipped with a communication processing unit.

FIG. 45 shows a table exemplifying a relationship between an electrode code, a communication address, and a device ID.

FIG. 46 shows a table exemplifying a relationship between an electrode code, a communication address, and a device ID.

FIG. 47 shows a table exemplifying a relationship between an electrode code, a communication address, and a device ID.

FIG. 48 shows a table exemplifying a relationship between an electrode code, a communication address, and a device ID.

FIG. 49 shows a table exemplifying a relationship between an electrode code, a communication address, and a device ID.

FIG. 50 shows a table exemplifying a relationship between an electrode code, a communication address, and a device ID.

FIG. 51 shows a table exemplifying a relationship between an electrode code, a communication address, and a device ID.

FIG. 52 is an example in which an electrode pattern including five electrodes is formed in five stages.

FIG. 53 is an example in which an electrode pattern including five electrodes is formed in four stages.

FIG. 54 is an example in which an electrode pattern including five electrodes is formed in three stages.

FIG. 55 is an example in which an electrode pattern including five electrodes is formed in two stages.

FIG. 56 is an example in which an electrode pattern including five electrodes is formed in five stages.

FIG. 57 shows a diagram exemplifying an output of a smartphone touch event.

FIG. 58 shows a flowchart exemplifying a transmission and reception of information between a code generation apparatus and an information processing apparatus.

FIG. 59 shows a flowchart exemplifying a transmission and reception of information between a code generation apparatus and an information processing apparatus.

FIG. 60 shows a flowchart exemplifying a transmission of encrypted information by a code generation apparatus.

FIG. 61 shows a flowchart exemplifying a transmission of encrypted information by a code generation apparatus.

FIG. 62 shows a flowchart exemplifying a transmission of encrypted information by a code generation apparatus.

FIG. 63 is a diagram exemplifying transmission and reception of information between a code generation apparatus and an information processing apparatus.

FIG. 64 is a flowchart exemplifying transmission and reception of information between a code generation apparatus and an information processing apparatus.

FIG. 65 is a diagram exemplifying transmission and reception of information between a code generation apparatus and information processing apparatuses.

FIG. 66 is a flowchart exemplifying transmission and reception of information between a code generation apparatus and information processing apparatuses.

FIG. 67 is a flowchart exemplifying transmission and reception of information between a code generation apparatus and information processing apparatuses.

FIG. 68 is a diagram exemplifying transmission and reception of information between a code generation apparatus and information processing apparatuses.

FIG. 69 is a flowchart exemplifying transmission and reception of information between a code generation apparatus and information processing apparatuses.

FIG. 70 is a diagram exemplifying transmission and reception of information between a code generation apparatus and information processing apparatuses.

FIG. 71 is a flowchart exemplifying transmission and reception of information between a code generation apparatus and information processing apparatuses.

FIG. 72 is a diagram exemplifying transmission and reception of information between a code generation apparatus and information processing apparatuses.

FIG. 73 is a flowchart exemplifying transmission and reception of information between a code generation apparatus and information processing apparatuses.

FIG. 74 is a diagram exemplifying transmission and reception of information between code generation apparatuses and an information processing apparatus.

FIG. 75 is a flowchart exemplifying transmission and reception of information between code generation apparatuses and an information processing apparatus.

FIG. 76(A) shows an example of a schematic top surface view of a card-type code generation apparatus 120a, FIG. 76(B) shows a schematic side view, FIG. 76(C) shows a schematic sectional view, and FIG. 76(D) shows a schematic bottom surface view, and FIG. (E) shows a schematic configuration diagram.

FIG. 77 is a diagram showing an embodiment of a personal authentication service using the present invention.

FIG. 78 is a diagram showing an embodiment of a ticket purchase/coupon acquisition service using the present invention.

FIG. 79 is a diagram showing a ticket purchase and coupon acquisition service (dot display) using the present invention.

FIG. 80 is a diagram showing a ticket and coupon printout service using the present invention.

FIG. 81 is a diagram showing a customer attracting coupon and point service using the present invention.

FIG. 82 is a diagram showing an electronic point card service using the present invention.

FIG. 83 is a diagram showing an information service by a print medium using the present invention.

FIG. 84 is a diagram showing a mail-order service by a print medium using the present invention.

FIG. 85 is a diagram showing an entertainment service using the present invention.

FIG. 86 is a diagram showing an information transfer service using the present invention.

FIG. 87 is a diagram showing an information link for a dot code forming medium using the present invention.

FIG. 88 shows schematic diagrams of a code generation apparatus of the thirteenth embodiment.

FIG. 89 shows a circuit board pattern example of a first circuit board of the thirteenth embodiment.

FIG. 90 shows descriptive diagrams of a method of connecting wiring of electrodes of a first circuit board of the thirteenth embodiment.

FIG. 91 shows circuit board pattern diagrams of a second circuit board of the thirteenth embodiment.

FIG. 92 shows a descriptive diagram of a method of connecting wiring between a first circuit board and a second circuit board of the thirteenth embodiment.

FIG. 93 shows a sectional view and a descriptive diagram of a connected state of a code generation apparatus of the thirteenth embodiment.

FIG. 94 shows a descriptive diagram of modification example 1 of a code generation apparatus of the thirteenth embodiment.

FIG. 95 shows descriptive diagrams of modification example 2 of a code generation apparatus of the thirteenth embodiment.

FIG. 96 shows descriptive diagrams of modification example 3 of a code generation apparatus of the thirteenth embodiment.

FIG. 97 shows a descriptive diagram of modification example 4 of a code generation apparatus of the thirteenth embodiment.

FIG. 98 shows schematic diagrams and a sectional view of a code generation apparatus of the fourteenth embodiment.

FIG. 99 shows a descriptive diagram of a switch operation of a code generation apparatus of the fourteenth embodiment.

FIG. 100 shows schematic diagrams of a drive mechanism of a code generation apparatus 125 of the sixteenth embodiment.

FIG. 101 shows schematic diagrams of a drive mechanism of a code generation apparatus 126 of the sixteenth embodiment.

FIG. 102 shows schematic diagrams of a configuration of a code generation apparatus of the seventeenth embodiment.

FIG. 103 shows schematic diagrams of a configuration of a code generation apparatus of the seventeenth embodiment.

FIG. 104 shows a flowchart exemplifying an overall picture of an information processing.

FIG. 105 is a flowchart showing a process of connecting a code generation apparatus and an information processing apparatus.

FIG. 106 is a flowchart showing a process of connecting a code generation apparatus and an information processing apparatus.

FIG. 107 shows a table exemplifying a mapping of electrode codes and BD addresses.

FIG. 108 shows a diagram showing an application example for a POS system.

FIG. 109 shows a flowchart showing an application example for a POS system.

FIG. 110 is a diagram showing an application example for admission and exit authentication.

FIG. 111 is a flowchart showing an application example for admission and exit authentication.

FIG. 112 is a diagram showing an application example for e-commerce.

FIG. 113 is a flowchart showing an application example for e-commerce.

### DESCRIPTIONS OF THE EMBODIMENTS

Hereinafter, the embodiments of the present invention will be described with reference to the figures.

[Overview of the Information Processing System]

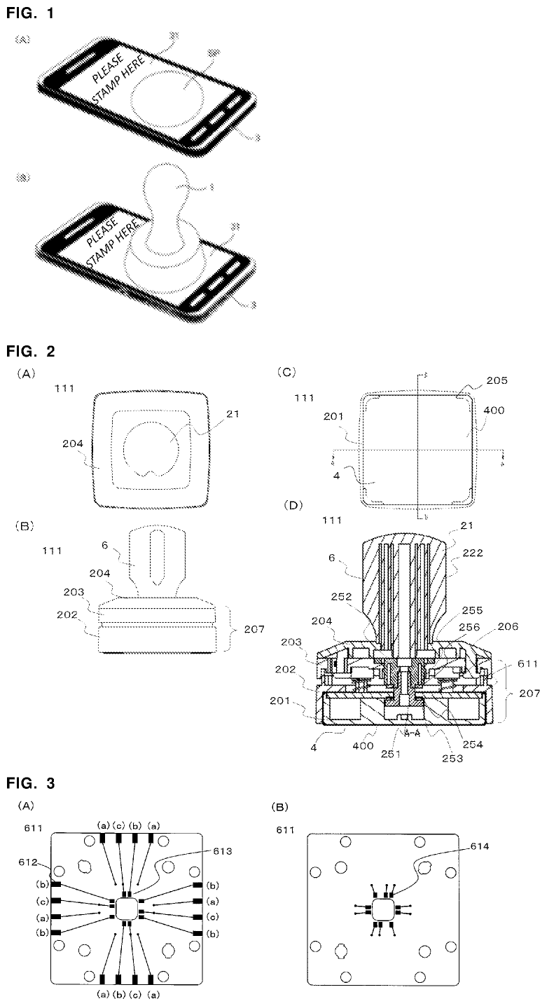

FIG. 1 is a diagram showing an example of an external configuration of an information processing system according to an embodiment of the present invention.

The information processing system shown in FIG. 1 includes a code generation apparatus 1 that generates codes, a code recognition apparatus 3 that recognizes the codes, and a server 4 that executes predetermined processings corresponding to the codes.

The code recognition apparatus 3 and the server 4 are connected via a predetermined network N such as the Internet.

As shown in FIG. 1, a code recognition apparatus 3 is configured with an information processing apparatus such as a smartphone or a tablet having a touch panel 31. The touch panel 31 includes a display unit and a capacitance type position input sensor stacked on the display surface of the display unit. On the touch panel 31, an area SP (hereinafter referred to as “code detection area SP”) for detecting a group of electrodes indicating a pattern code output by the code generation apparatus 1 is displayed.

The code recognition apparatus 3 includes a detection unit and a recognition unit as functional blocks not shown.

Note that although a functional block may be configured with hardware alone, in this embodiment, it is configured with software and hardware. That is, the detection unit and the recognition unit exhibit the following functions by the cooperation of software and hardware.

When one or more electrodes 5 of a code generation apparatus 1 connected to the human body with a low impedance make contact with or comes into close proximity to the code detection region SP of the touch panel 31, the detection unit detects conductive patterns which are arrangement information of the one or more electrodes 5 based on the detection results of the position input sensor.

The recognition unit recognizes pattern codes generated by the code generation unit of the code generation apparatus 1 based on conductive patterns of one or more detected electrodes.

This pattern code is transmitted to the server as necessary.

The server executes various processings based on the pattern code.

### First Embodiment

FIG. 2 is a schematic view showing the external form of the code generation apparatus 111 of the eleventh embodiment. FIG. 2(A) shows a top view, FIG. 2(B) shows a side view, and FIG. 2(C) shows a bottom view. FIG. 2(D) is a sectional view with scission in the vertical direction. As shown in FIG. 2(A) to FIG. 2(C), the code generation apparatus 111 has a shape similar to that of a square stamp, and since the upper part of the housing 2 is a push button of a push button switch of the operation unit 6, by holding the housing 2 by the hand and having the apparatus make contact with the touch panel 31 and then pressing it, the two kinds of pattern codes, the first conductive pattern 81 and the second conductive pattern 82 can be sequentially generated. The handle unit 222 is formed of a conductor for use as a human body contact conductive material 21 so that it can be touched naturally when the code generation apparatus is held in the hand,

As shown in FIG. 2(D), conductive pattern printed sheet 400 of PET resin having a thickness of 0.188 mm on which electrodes 5 are printed with conductive ink is bonded to the bottom surface 4 and the side surface of the housing bottom 201 of the code generation apparatus 111 with a double-sided adhesive tape having a thickness of 50 μm so that the positions of the electrodes 5 do not deviate but the sheet 400 can still be easily peeled off.

The thickness and the material of the conductive pattern printing sheet 400 are such that when the electrodes 5 make contact with the touch panel 31, the electrodes 5 are detected by the touch panel through the base material of the sheet. The thickness and material are not limited to the above-mentioned thickness and material, and any thickness and material may be used as long as durability that can withstand the stamp operation of repeatedly pressing a touch panel can be secured. For example, a polypropylene resin sheet or high-quality paper for photographic printing with PP coating is sufficient. Furthermore, the method of bonding is not limited to a method of using double-sided tape, and as long as there is no positional deviation of the bonding surface and the bonding can easily be removed when it is to be removed, a method of applying adhesive glue or the like is sufficient.

The conductive ink used for printing a conductive pattern printed sheet 400 may be any ink as long as it has conductivity, such as silver paste ink, silver salt ink, silver nano ink, carbon ink, or the like, The minimum wiring width for wiring in a conductive pattern is preferably 0.8 mm to 1.0 mm for carbon ink in view of the percentage of defective products due to parasitic capacitance of the conductive pattern, wiring time constants, necessity of ink layer flattening, wiring pattern disconnection, increase in resistance or the like, and when the percentage of defective products due to wiring pattern disconnection, increase in resistance, or the like is within an allowable range, a width of 0.6 mm to 1.0 mm is more preferable. In the case of silver paste ink or the like containing metal, it is preferably to have a width of 0.2 mm to 0.3 mm, and if the percentage of defective products due to wiring pattern disconnection, increase in resistance, or the like is within an allowable range, a width of 0.1 mm to 0.2 mm is more preferable.

In the case of a conductive pattern printed sheet 400 made of PET resin having a thickness of 0.188 mm, from the viewpoint of parasitic wiring capacity, it is sufficient that the minimum wiring width is 0.8 mm or less by adopting a wiring method described later. The wiring resistance is preferably about 100 Ω/mm and may be 1 KΩ/mm or less. Furthermore, The thickness of the electrodes 5 formed by printing and the ink layer of the wiring is preferably to be as thin as possible, and is preferably 10 μm or less, and 20 μm or less which does not require planarization is sufficient.

Guiding grooves 205 that are shallower than the thickness of a conductive pattern printed sheet 400 including the double-sided adhesive tape are provided on the bottom surface 4 and the side surface of the lower housing 201. By attaching the conductive pattern printed sheet 400 to the lower housing 201 using the guide groove 205, it is possible to improve work efficiency for attaching while ensuring the attachment position accuracy. Furthermore, by making the depth of the guide groove 205 shallower than the thickness of a conductive pattern printed sheet 400, the conductive pattern printed sheet 400 can be brought into tight contact with the touch panel 31 when being brought into contact with the touch panel 31.

The design can also be improved by printing a graphic such as a product logo on the outer surface of a conductive pattern printed sheet 400 that makes contact with a touch panel 31. Furthermore, since the conductive pattern printed sheet 400 is exposed, it is possible to attach a protective sheet such as a thin silicon sheet of about 50 μm that does not interfere with detection of electrodes by a touch panel 31 to protect the sheet and the outer printed surface, and preventing slippage (displacement) when making contact with a touch panel 31. When attaching a protective sheet, it is preferable to reduce the sheet thickness of the conductive pattern printed sheet 400 to about 0.125 mm in consideration of the thickness of the protective sheet.

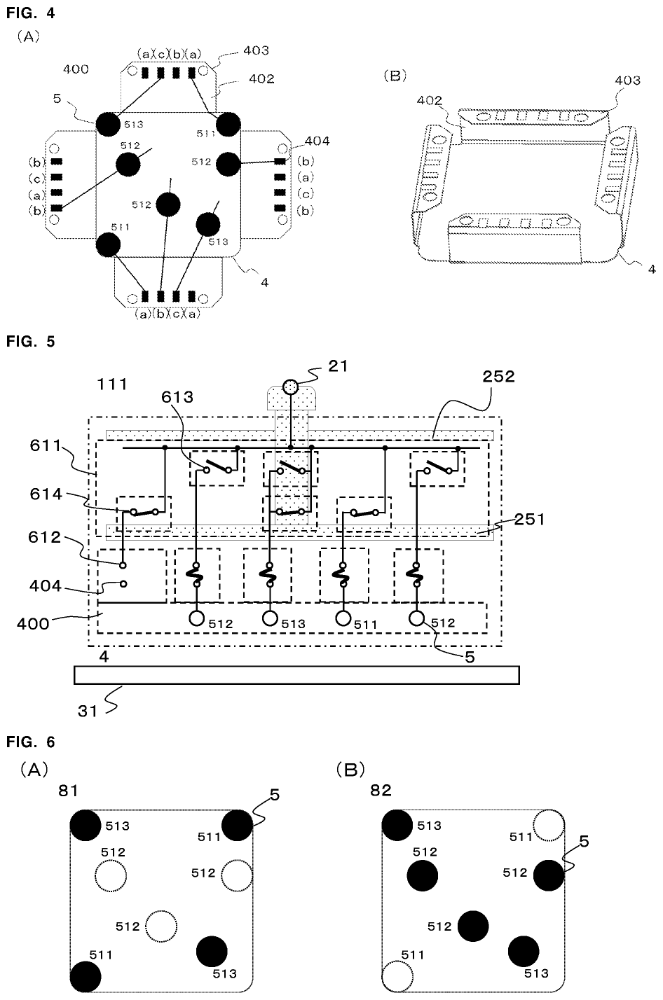

A circuit board 611 is fitted on the upper surface portion of the lower housing 201. As shown in FIG. 3(A), circuit board connection terminals 612 are arranged at equal intervals on the outer periphery of the front surface side of the circuit board 611. Also, as shown in FIG. 4(A), sheet connection terminals 404 are provided at positions corresponding to the folding portion 403 provided at the edge of a side surface attaching unit 402 of a conductive pattern printed sheet 400. The circuit board connection terminals 612 on the surface of the circuit board 611 can be crimped and electrically connected to conductive pattern connection terminals 404 provided in the folding portion 403 of the conductive pattern printed sheet 400 by folding the folding portion 403 of the conductive pattern printed sheet 400 attached to the lower housing 201 over the circuit board 611 and screwing down a circuit board sheet presser 202 from above. Also, if the strength of crimping between the terminals differs due to variations in the circuit board thickness or in the height of the circuit board sheet presser 202 and conductivity becomes insufficient, it is possible to secure conduction between the connection terminals by applying conductive adhesive glue or placing conductive double-sided tape between the connection terminals. It is sufficient if the connection resistance between the connection terminals is lower than about several tens of KΩ.

Also, a circuit board sheet presser 202 is provided with a planar fixing unit that can simultaneously fix a circuit board 611 and a conductive pattern printed sheet 400 on the outer periphery of the surface of the lower housing 201, and an outer frame portion that covers the side surface of the lower housing 201. By providing an outer frame portion, the side surface portion of the conductive pattern printed sheet 400 is protected, and since almost the entire side surface of the code generation apparatus 111 is covered, the design of the code generation apparatus 111 can be improved, by applying colors or patterns to the outer surface of the outer frame portion.

Furthermore, by extending the side surface of the upper housing 203 to the vicinity of the bottom surface 4 to cover the side surface of a code generation apparatus 111, the circuit board sheet presser 202 can be a simple flat plate without the outer frame portion.

A circuit board 611 has openings at four locations on the inner side corresponding to the corners of the rectangle, and by inserting substantially column-shaped supporting columns 206 protruding from the lower housing 201, positioning with the lower housing 201 is determined. Also, the circuit board 611 has an opening at the center of the circuit board, and a lower side movable contact unit 251 is inserted from the back surface to the front surface retaining slidably and fixed by sandwiching the circuit board 611 with an upper side movable contact unit 252.

A thin wiring pattern is used to connect board connection terminals 612 provided on the outer periphery of the surface of a circuit board 611 to the upper side fixed contacts 613 provided around the surface of the central opening with the shortest distance. Also, as shown in FIG. 3(B), lower side fixed contacts 614 are provided around the back surface of the central opening of the circuit board 611, and are wired to circuit board connection terminals 612 on the outer periphery of the surface via a thin wiring pattern and through holes with the shortest distance.

There are three types of connection specifications from the circuit board connection terminals 612 to the fixed contacts 613 and 614 near the central opening. (a) One in which lower side fixed contacts 614 are provided only on the back surface, (b) one in which upper side fixed contacts 613 are provided only on the front surface of a circuit board 611, and (c) one in which fixed contacts 613 and 614 are provided on both the front and back surfaces.

As for the three types of connection specifications, at least one set is provided on each side of the circuit board 611, the sufficient total for each side is 5 sets or more of (a) and (b), and 4 sets of (c). This is because there is a limit in the number of multi-touches that can be detected simultaneously by a touch panel 31 of a smartphone such as an iPhone (registered trademark), and to ensure ease of wiring between electrodes 5 of a conductive pattern printed sheet 400 and circuit board connection terminals 612. For use with tablets of the like where the number of allowed multi-touch is large or there is no limit, the total number of necessary sets of terminals of the connection specifications for each side of the circuit board is the same number as the multi-touch number for (a) and (b), and multi-touch number minus one for (c).

The three types of connection specifications are used according to electrode detection specifications for the conductive pattern to be created. (a) is used for electrodes detected by the touch panel 31 only for the second conductive pattern, (b) is used for electrodes detected by the touch panel 31 only for the first conductive pattern, and (c) is used for electrodes detected for both the first and second conductive patterns.

As shown in FIG. 2(D), the lower side movable contact unit 251 has a structure in which a ring-shaped portion 253 is provided at a lower portion of a columnar body having a substantially rectangular shape in a plan view, and the whole unit has conductivity. At positions facing the lower side fixed contacts 614 provided near the central opening of the back surface of the circuit board 611 of the ring-shaped portion 253, a movable contact 254 made of conductive rubber having elasticity is provided to absorb the contact interval variations of the portion where the lower side fixed contacts 614 on the circuit board 611 and the lower side movable contact unit 251 make contact and enables all of the contacts to have contact conduction. Furthermore, the movable contact 254 is not limited to conductive rubber, and may be a plate spring contact or the like or anything as long as it has elasticity, absorbs contact interval variations, and enables all of the contacts to have contact conduction.

The upper side movable contact unit 252 has a structure in which a step portion 255 is provided at the top of a columnar body with a substantially rectangular shape in a plan view, a concave is provided in the center of the columnar body, and the lower side movable contact unit 251 is fitted in, and the whole unit has conductivity. At positions facing the upper side fixed contacts 613 provided near the central opening of the front surface of the circuit board 611 of the step portion 255, a movable contact 256 made of conductive rubber having elasticity is provided to absorb the contact interval variations of the portion where the upper side fixed contacts 613 on the circuit board 611 and the upper side movable contact unit 252 make contact and enables all of the contacts to have contact conduction.

Furthermore, the movable contact 256 is not limited to conductive rubber, as with the lower side movable contact unit 251.

The upper side movable contact unit 252 is provided with a latch structure at the upper portion and is fitted and fixed to the upper housing 203. The upper housing 203 is provided with a cylindrical opening through which a supporting column 206 is inserted with the maintenance of slidability at a position corresponding to the supporting column 206 protruding from the lower housing 201. At the bottom of the cylindrical opening, there is a step where the opening diameter is reduced, and a spring is inserted into the supporting column 206, and in a state sandwiched between the lower housing 201 and the upper housing 203, a screw with a ring is fixed to the supporting column 206 which is inserted in the opening from above the upper housing 203. Thus, the upper housing 203 and the lower housing 201 are fixed maintaining slidably, and a contact driving mechanism for a conductive pattern switchover push button switch of a code recognition apparatus 111 is formed. The pairs of a lower side fixed contact 614 and a movable contact 254, and the pairs of an upper side fixed contact 613 and a movable contact 256 are set with spacing so that both of the contacts of the pairs are not in contact simultaneously at the time of a switching operation, and thus is of a non-shorting type switching method. This is to avoid being subject to limits on the number of multi-touches that can be simultaneously detected set in a touch panel 31 of a smartphone such as an iPhone (registered trademark). The structure of the lower housing 201 to the upper housing 203 corresponds to the main body 207.

A holding unit 204 is attached to the upper housing 203 with a detachable structure. The holding unit 204 includes a non-conductive lid portion that covers the upper housing 203 and enhances designability, and a conductive handle unit 222 that corresponds to a handle of a stamp. The handle unit 222 comes into contact with the upper side movable contact unit 252 and is electrically connected.

FIG. 4(A) shows a conductive pattern printed on a conductive pattern printed sheet 400, and FIG. 4(B) shows the shape when the conductive pattern printed sheet 400 is attached to the lower housing 201. The conductive pattern is printed with conductive ink on the inner surface of the conductive pattern printed sheet 400 attached to the lower housing 201. In the conductive pattern, the circular electrodes 5 having a diameter of 8 mm provided on the bottom surface 4 portion and the sheet connection terminals 404 provided on the folding portion 403 are connected by a printing pattern so that the wiring is of the shortest distance and the wiring has minimum printable line width for each electrode. Electrodes 511 detected by the touch panel 31 for a first conductive pattern 81 are connected to sheet connection terminals 404 with a symbol (a), electrodes 512 detected by the touch panel 31 for a second conductive pattern 82 are connected to sheet connection terminals 404 with a symbol (b), and electrodes 513 detected by the touch panel 31 for both a first conductive pattern 81 and a second conductive pattern 82 with a symbol (c).

Of the electrodes 5 shown in FIG. 4(A), electrodes 5 arranged near the center of the bottom surface 4 are provided with wiring with a length about that of the radius of an electrode 5 and passing through the center point of the electrode 5 and extending in the opposite direction by 180° with respect to the original wiring connected to a sheet connection terminal 404.

When the wiring width is wide, due to the parasitic capacitance generated between the wiring and a touch panel when the wiring is making contact with the touch panel 31, the touch panel 31 detects the wiring part besides the electrodes, and a phenomenon of the detected coordinates of the electrodes being deviated in the direction of the wiring occurs. For this reason, in the case of electrodes with long wiring printed in the region of the bottom surface 4, wiring is extended in the opposite direction to the original wiring as shown in FIG. 4(A), thereby generating parasitic capacitance by wiring also on the opposite side, and thus reducing the amount of deviation of the detected coordinates of the electrodes. When the wiring for electrodes in the area of the bottom surface 4 is short, no extension wiring is necessary.

If the wiring can be printed with a width of less than 0.2 mm, the extension wiring is not necessary because the parasitic capacitance of the wiring is small.

Table 1 shows results of the evaluation of deviation of the detected coordinates compared with and without extension wiring when the evaluation sample was detected 20 times by the touch panel of a smartphone (iPhone 6) with the sample having a conductive pattern formed by arranging five 8 mm diameter electrodes made of carbon ink on a 7×7 grid lattice with a grid spacing of 7 mm on the inner surface of a 0.188 mm thick PET resin sheet and connecting with wiring with a width of 0.8 mm The sample having the extension wiring is provided with a 4 mm extension wiring having a wiring width of 0.8 mm in a direction 180° opposite to the original wiring.

Following the method shown in the [Pattern code decoding method] section of the fifth embodiment to be described hereinafter, the two electrodes 511 in the lower left and the upper right in the figure of the conductive pattern of FIG. 48(A) were used as reference electrodes so that the coordinates detected by the touch panel could be converted into coordinates of a grid arrangement with grid intervals of 7 mm, and as a result of the evaluation of the deviation of the other three electrodes (electrodes 2 to 4 in Table 4) with respect to the arranged grid in percentage of a grid spacing, it was confirmed that the average amount of deviation could be reduced by 10% with the extension wiring.

TABLE 1

| | | Without wiring extension | | | With wiring extension | | |
|---|---|---|---|---|---|---|---|
| Term | | Electrode 2 | Electrode 3 | Electrode 4 | Electrode 2 | Electrode 3 | Electrode 4 |
| Deviation | avg | 35 | 25 | 28 | 25 | 18 | 18 |
| in the | min | 17 | 10 | 20 | 16 | 2 | 7 |
| detected | max | 56 | 39 | 36 | 35 | 58 | 27 |
| coordinates | | | | | | | |

In the above evaluation, in regards to the wiring between electrodes 5 for forming a conductive pattern, it was confirmed that when the wiring width is 0.8 mm, the touch panel 31 detects both the electrodes 5 and the wiring due to parasitic capacitance between the touch panel and the wiring, and thus, the detected arrangement coordinates of the electrodes 5 are deviated in the direction of the wiring, and it was confirmed that the deviation could be corrected with the extension wiring. Thus, the width of the wiring between the electrodes 5 is preferably 0.8 mm or less, and more preferably 0.2 mm or less, within a range of allowable wiring width for conductive ink printing (wiring resistance does not increase).

FIG. 5 is a schematic diagram of a circuit of a code generation apparatus 111. FIG. 6(A) schematically shows a first conductive pattern 81 detected by a touch panel 31 when a code generation apparatus 111 is making contact with a touch panel 31 while touching a human body contact electrode 21 (STEP 1). FIG. 6(B) schematically shows a second conductive pattern 82 detected by a touch panel 31 when the push button of a code generation apparatus 111 is pressed (STEP 2) from the state of (STEP 1).

As shown in FIG. 2 to FIG. 6, according to the specifications, the code generation apparatus 111 can be set so that the first conductive patterns 81 and the second conductive patterns 82 be changed simply by changing the printing pattern of the conductive pattern printed sheet 400 by connecting selectively the conductive pattern printed sheet 400 having electrodes 5 and wiring printed thereon with conductive ink, with sheet connecting terminals 404 and circuit board connecting terminals 612(a), 612(b), and 612(c) of the circuit board 611.

The first conductive pattern 81 is formed by connecting sheet connection terminals 404 connected from electrodes 5 (511, 513) of the conductive pattern printed sheet 400 and circuit board connection terminals 612(a) and 612(c) of the circuit board 611. The second conductive pattern 82 is formed by connecting sheet connection terminals 404 connected from electrodes 5 (512, 513) of the conductive pattern printed sheet 400 and circuit board connection terminals 612(b) and 612(c) of the circuit board 611.

For the first conductive pattern 81, it is preferable to have at least three electrodes 5 so that the orientation of a code generation apparatus 111 placed on a touch panel 31 can be specified, to have the arrangement of the electrodes 5 not be rotationally symmetric, and also to have the number of electrodes 5 be five or less due to restrictions on multi-touches of smartphones.

As a result, the orientation of the code generation apparatus 111 making contact on the touch panel 31 can be specified from the results of code decoding processing of the first conductive pattern 81. Thus, since the second conductive pattern 82 can be subjected to code decoding processing using this orientation information, a pattern in which the arrangement of the electrodes 5 is rotationally symmetric can also be used as a conductive pattern. Therefore, the number of codes for the second conductive pattern 82 can be dramatically increased.

Furthermore, since according to this specification transition from (STEP 1) to (STEP 2) can be done by pressing the push button switch and two types of codes can be generated in a time series, and thus the number of codes becomes the multiplication of the number of first conductive patterns 81 and the number of second conductive patterns 82.

As a result, the number of codes that can be set by the code generation apparatus 111 increases dramatically.

### Second Embodiment

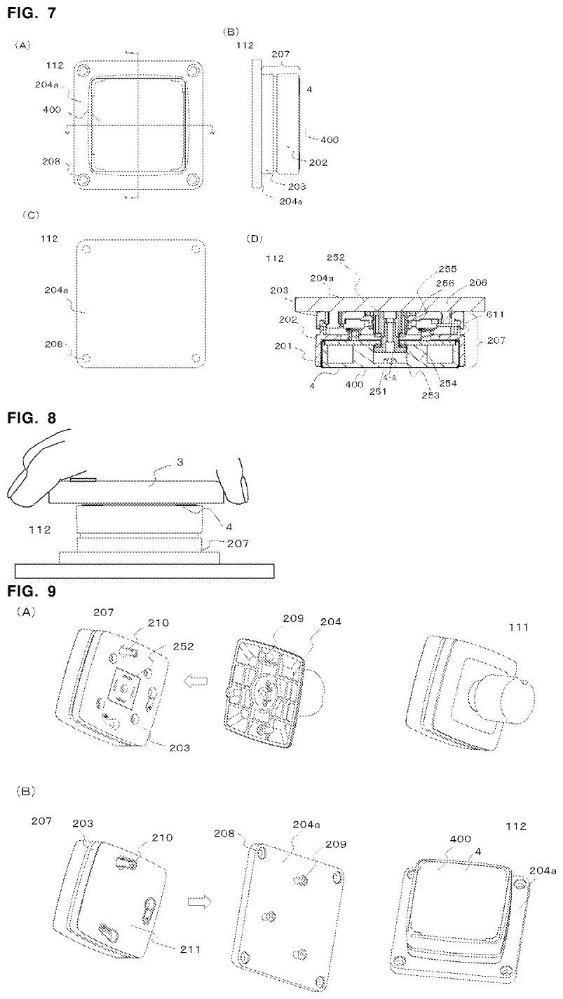

FIG. 7 shows schematic diagrams of the external form of a code generation apparatus 112 of the twelfth embodiment. FIG. 7(A) shows a top view, FIG. 7(B) shows a side view, and FIG. 7(C) shows a bottom view. FIG. 7(D) shows a sectional view with scission in the vertical direction. As shown in FIG. 7(A) to FIG. 7(D), the code generation apparatus 112 has a structure different from that of the first embodiment only in the holding section 204a, and the main body 207 is composed of the same parts as those of the code generation apparatus 111 of the first embodiment.

The code generation apparatus 111 is of a stamp type, and is used to generate pattern codes in time series by holding the handle unit 222 by the hand, touching a human body contact electrode 21, bringing into contact with and pressing down on a touch panel 31 of a smartphone or the like which is a code recognition apparatus 3, the touch panel 31 detecting a conductive pattern formed on a pattern printed sheet 400 and further switching conductive patterns with a push button switch.

### (Human Body Conductivity Detection)

On the other hand, the code generation apparatus 112 is used in a state where the main body 207 is attached to a flat holding unit 204a and the bottom surface 4 faces the front. As shown in FIG. 7(A), holes for attachment 208 are provided at the four corners of the flat holding unit 204a, and it is possible to fix it to a wall or the like with the holes for attachment 208 and screws. As shown in FIG. 8, the touch panel 31 is brought into contact with and pressed onto the bottom surface 4 of a code generation apparatus 112 while holding the smartphone which is a code recognition apparatus 3 or the like by the hand. A code generation apparatus 112 is effective, for example, by setting one on a wall or desk near an exhibition display in a museum, when a visitor brings a touch panel 31 such as that of a smartphone into contact with the code generation apparatus 112, the visitor can obtain information on the exhibits, or by setting a code generation apparatus 112 on a desk in a railway station, when a passenger brings a touch panel 31 such as that of a smartphone into contact with the code generation apparatus 112, the passenger can obtain a stamp rally point.

In this case, with a code generation apparatus 112, it is necessary to have a touch panel 31 detect a conductive pattern formed on a conductive pattern printed sheet 400 without having a human body contact electrode 21 being touched with a finger or by the hand and without conduction to the human body. (Human body non-conduction detection)

Also, as with a code generation apparatus 111, conductive patterns can be switched by a push button switch of the main body 207 and the pattern codes can be generated in time series.

Assembly structures of the holding unit 204 and the main body 207 of the code generation apparatus 111 are shown in FIG. 9(A), and assembly structures of the holding unit 204a and the main body 207 of the code generation apparatus 112 are shown in FIG. 9(B) for comparison. The upper surface of the upper housing 203 of the main body 207 is provided with a fitting groove 210 with a part of the opening on the upper surface side being narrowed, and a thick cylindrical fitting protrusion 209 is provided on the attachment surface of the holding units 204 and 204a. By inserting a fitting protrusion 209 into a fitting groove 210 and rotating the holding unit 204 or the main body 207, the holding units 204 and 204a and the main body 207 are fixed, and code generation apparatuses 111 and 112 are formed.

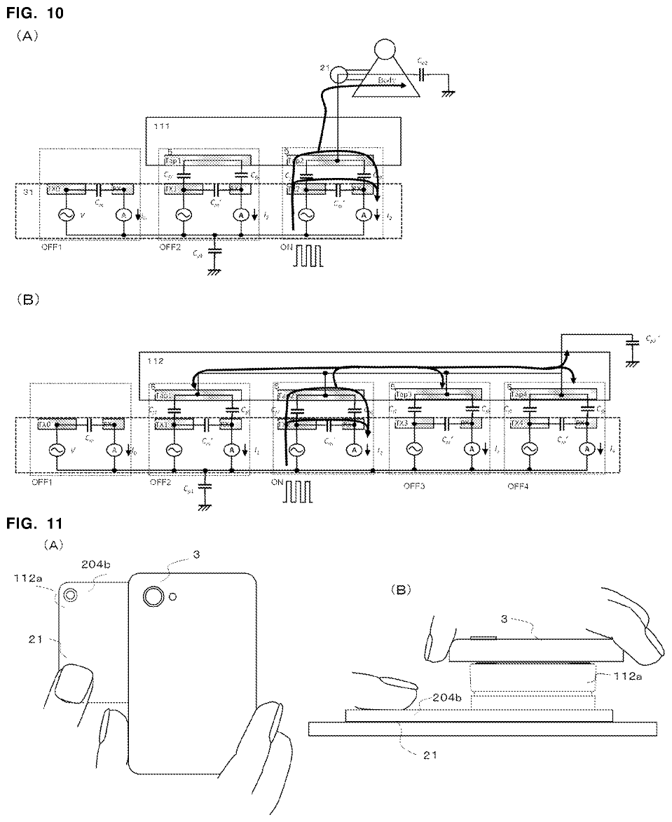

FIGS. 10(A) and 10(B) show overviews of electrode 5 detection operations of a general capacitive touch panel 31. FIG. 10(A) shows a detection operation of a state where a code generation apparatus 111 is placed on a touch panel 31 with human body contact (human body conduction detection method), and FIG. 10(B) shows a detection operation of a state where a code generation apparatus 111 is placed on a touch panel 31 with no human body contact (human body non-conduction detection method).

As shown in FIG. 10(A), in general, a capacitive touch panel 31 has a large number of TXn and RXn are arranged in a mesh shape so that they intersect perpendicularly with intervals of about 4 mm to 6 mm inside the touch panel 31 to detect the presence/absence of a touch with a finger on the surface of the touch panel and the touch position, and a capacitance Cm for detecting a touch is provided at the intersections of TXn and RXn.

When there is a Tap due to a finger or electrodes 5 on the surface of a touch panel 31, electrostatic capacitance is formed between Tap-TXn and between Tap-RXn, and the combined capacitance Cm′ between TXn-RXn becomes smaller than Cm. Voltage amplitudes (alternating current signals) of about several hundred KHz are sequentially applied to a large number of TXn and current In flowing on the RXn side is measured for the large number of RXn. The capacitance change of Cm′ is measured by the change in the current value In at the intersections of TXn and RXn being Tapped and the positions (coordinates) of the Taps on the touch panel 31 are specified.

In the human body conduction detection of FIG. 10(A), a code generation apparatus 111 is placed on a touch panel 31, and when electrodes 5 having a diameter of about 8 mm printed on the conductive pattern printed sheet 400 are Tapped on any position on the touch panel 31, the capacitance Cm′ is changed by the electrodes 5. However, the determination threshold value for coordinate detection by the touch panel 31 is not reached, since the change in the amount of Cm′ is small and thus the change in the amount of current I1 is also small with only a single electrode 5 separated from the human body by a push button switch (not shown) built in the code generation apparatus 111, like Tap1 in FIG. 10(A).

As for the Tap2 electrode 5 connected to the human body via a push button switch (not shown) of the code generation apparatus 111, the human body contact electrode 21 has a coupling capacitance Cp2 with the human body, and the voltage amplitude (alternate current signal) of TX2 makes a small current flow also to the human body side via coupling capacitance Cp2. For this reason, the amount of change in current I2 of RX2 increases, and the determination threshold value for coordinate detection by the touch panel 31 is exceeded, and thus the positions of electrodes 5 can be detected.

On the other hand, in the human body non-conduction detection as shown in FIG. 10(B), for the electrodes 5 printed on a conductive pattern printed sheet 400 used in the code generation apparatus 112, a plurality of electrodes 5 are always connected to each other via a circuit board 611 and a push button switch (not shown). In the case of FIG. 10(B), the electrodes 5 from Tap 1 to Tap 4 are connected to form a conductive pattern. Furthermore, an additional capacitance Cp2′ is added to a conductive sheet 211 or a circuit board 611 described later provided at a common node to which the electrodes 5 are connected.

Considering a case where a touch panel 31 applies a voltage amplitude (alternate current signal) to TX2 at the position of Tap2 where an electrode 5 is located, with human body non-conduction detection, each electrode 5 of the other Tap1, Tap3, and Tap4 has a coupling capacitance with TXn and RXn via a common node, and the voltage amplitude (alternate current signal) of TX2 makes a small current In flow to RXn via each coupling capacitance. Furthermore, the additional capacitance Cp2′ also becomes coupling capacitance, and a small current flows to the ground.

For this reason, the amount of change in the current I2 of RX2 increases, and the determination threshold value for coordinate detection by the touch panel 31 is exceeded, and thus the positions of electrodes 5 can be detected.

In addition, it is possible to have the touch panel 31 detect the positions of all of the electrodes 5 connected to the common node, since a small current can be flowed similarly to the coupling capacitance of an electrode 5 located at a place other than the intended TXn and RXn, even if TXn and RXn are sequentially switched over on a touch panel 31 to a location of another electrode 5.

In FIG. 10(B), the electrodes 5 are all arranged on different TXn and RXn, but the actual conductive patterns of a touch panel 31 and a code generation apparatus 112 are two-dimensional (planar), and thus in some cases, a plurality of electrodes 5 are arranged on a common TXn or a common RXn.

In this case, the total effective capacitance may decrease compared to cases where all of the electrodes 5 are arranged on different TXn and RXn. For example, if the wiring resistances between TXn, RXn, and the electrodes are ignored, when two electrodes 5 are arranged on the same RXn, the electrode-RXn capacitances CfR of the two electrodes 5 have a configuration similar to that when terminals on both sides of the combined capacitance are connected in a series to the same RXn node, and the capacitance becomes effectively invisible to RXn.
Thus, in human body non-conduction detection, on a touch panel 31, a dependency between the electrode arrangement positions of a conductive pattern and electrode detection performance occurs. Normally, since TXn and RXn on the touch panel 31 are arranged in the vertical and horizontal directions on a square touch panel surface, when a plurality of conductive pattern electrodes 5 are arranged in the vertical or horizontal direction on the touch panel surface, electrode detection becomes difficult.

For this reason, with a code generation apparatus 112 of human body non-conduction detection, both the conductive pattern 81 and the conductive pattern 82 need to be conductive patterns using a plurality of electrodes 5, and more stable detection is possible by using more electrodes 5 within the number limit of multi-touches of the code recognition apparatus 3.

As shown in FIG. 9(B), on the upper surface of the upper housing 203 of the main body 207 of a code recognition apparatus 112, a conductive sheet 211 for additional capacitance is affixed so that the upper movable electrode component 252 and the conductive area of the conductive sheet are connected (electrically connected). Furthermore, the conductive sheet 211 for additional capacitance may be affixed on the upper surface of the flat plate-shaped holding region 204a instead of the upper surface of the upper housing 203. The conductive sheet 211 for additional capacitance may be of a copper film or the like which is entirely conductive, or may be a sheet on which a conductive pattern is formed by printing with conductive ink in the same manner as the conductive pattern printed sheet 400. When forming a conductive pattern, it is possible to assist electrode detection by touch panel 31 by providing wiring in a loop shape of approximately 12.5 cm and resonating with a radio wave having a WiFi frequency of 2.5 GHz. Furthermore, the conductive sheet 211 may not be necessary.

Furthermore, instead of a conductive sheet 211 for additional capacitance, a conductive pattern connected with a movable electrode unit may be formed in a pattern free area without any wiring or contacts on the front and back surfaces of the circuit board 611 shown in FIGS. 3(A) and 3(B), and may be used as additional capacitance.

Still further, in an area of a conductive pattern printed sheet 400 as shown in FIG. 4(A) where there are no electrodes or wiring, conductive patterns may be formed as wiring and be connected to the movable electrode unit via the circuit board 611, and may be used as additional capacitance.

### Third Embodiment

FIG. 11 is a schematic diagram showing an external form of a code generation apparatus 112a of the third embodiment. FIG. 11(A) shows a top view of when in use, and FIG. 11(B) shows a side view of when in use.

The code generation apparatus 112a is obtained by changing the holding unit 204a of the code generation apparatus 112 with human body non-conduction detection to human body conduction detection. There is no change from the code generation apparatus 112 except for the holding unit 204a and the method of use.

As shown in FIG. 11(A), the holding unit 204b of a code generation apparatus 112a has a size in which one direction is larger with respect to the plane dimensions of the main body 207 so that the holding unit 204b can be easily touched when the bottom surface 4a of a code generation apparatus 112a is making contact with a smartphone which is a code recognition apparatus 3. The holding unit 204b is of a conductive resin, a resin with the surface plated with metal, or a metal, and has conductivity.

Although not shown, as in the case of the holding unit 204a, by fitting the fitting groove 210 provided in the upper housing 203 of the main body portion 207 and the fitting protrusion 209 on the attachment surface of the holding unit 204b together and rotating, the holding unit 204b and main body 207 are fixed together, and the holding unit 204b is crimped and electrically connected to the upper movable contact unit 252 exposed in the upper housing 203 when it is fixed to the main body 207.

Thus, the holding unit 204b becomes a human body contact electrode 21, and the code generation apparatus can be regarded as a code generation apparatus of a human body conduction detection system.

Furthermore, FIG. 11 shows a smartphone which is a code recognition apparatus 3 held by the right hand and 204b sticking out on the left side under the assumption that the holding unit 204b is touched with the left hand. However, 204b may be widened as a whole.

### Fourth Embodiment

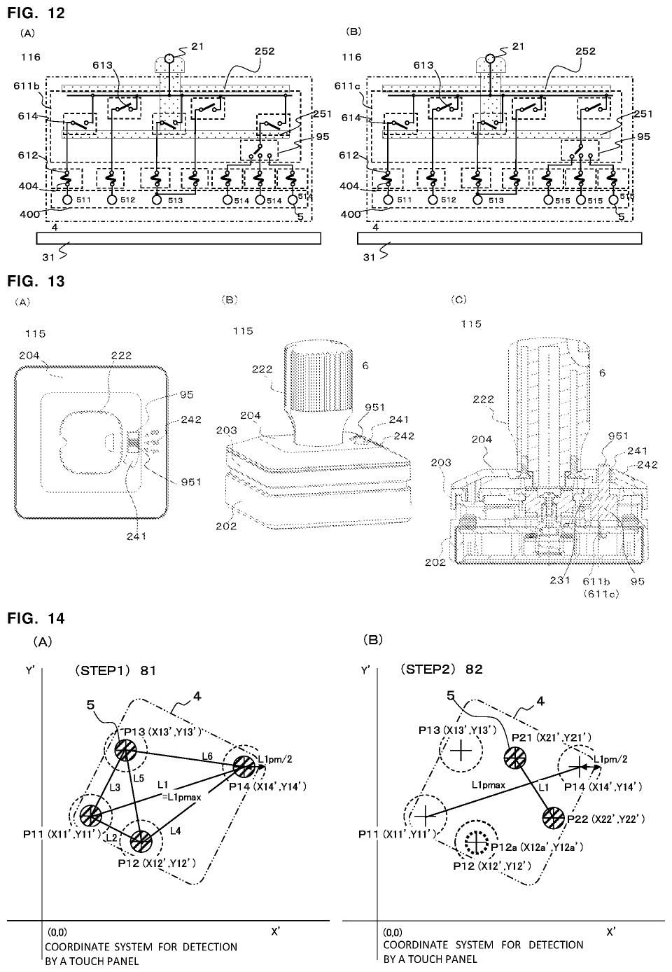

FIG. 12 shows schematic diagrams of circuits of a code generation apparatus 115 according to the fourth embodiment. FIG. 12(A) shows a schematic diagram of a circuit where the ID switching electrodes 514 are provided in a first conductive pattern 81, and FIG. 12(B) shows a schematic diagram of a circuit where the ID switching electrodes 514 are provided in a second conductive pattern 82. The specifications of the code generation apparatus 115 differ from the specification of the code generation apparatus 111 in that an ID switchover switch 95 which is an operation unit is added, and a plurality of conductive patterns can be provided for either one of the first conductive pattern 81 or second conductive pattern 82.

In addition, descriptions of parts other than the ID switchover switch 95 and the conductive pattern switching method that are not significantly different from those of the code generation apparatuses of the first embodiment and other embodiments are omitted.

In the circuit specifications of FIG. 12(A), an SP3T type (one circuit and three contacts) slide switch 95 is provided between the fixed contacts 614 on the back surface of the circuit board 611b and the electrodes 5, and electrodes 514 are connected to each contact terminal of the switch, respectively. As a result, it is possible to switch among electrodes 514 for conduction to the human body contact electrode 21 for the first conductive pattern 81 according to the position of the slide switch 95, and three different first conductive patterns 81 can be generated.

In the circuit specifications of FIG. 12(B), an SP3T type (one circuit and three contacts) slide switch 95 is provided between the fixed contacts 613 on the front surface of the circuit board 611c and the electrodes 5, and electrodes 515 are connected to each contact terminal of the switch, respectively. As a result, it is possible to switch among electrodes 515 for conduction to the human body contact electrode 21 by the second conductive pattern 82 according to the position of the slide switch 95, and three different second conductive patterns 82 can be generated.

FIG. 13 is a schematic view showing an external form of a code generation apparatus 115. FIG. 13(A) is a top view, and FIG. 13(B) is a side view. FIG. 13(C) is a sectional view with scission in the vertical direction. As shown in FIGS. 13(A) to 13(C), a code generation apparatus 115 has specifications in which the shape is similar to that of a square stamp as in the case of a code generation apparatus 111 shown in the first embodiment, and since the upper part of the housing 2 is a push button of a push button switch of an operation unit 6, it is possible to sequentially generate two types of patterns codes, a first conductive pattern 81 and a second conductive pattern 82, by bringing the code generation apparatus into contact with the touch panel 31 while holding the housing 2 by the hand and pressing down. In addition, a code generation apparatus 115 has specifications in which it is possible to provide a plurality of conductive patterns for either one of the first conductive pattern 81 or the second conductive pattern 82, since an ID switchover switch 95 is provided.

As shown in FIGS. 13(A) to 13(C), openings 231 and 241 are provided in the upper housing 203 and the holding unit 204, respectively, and the switch operation unit 951 for switching codes is protruded from the opening 241 enough to enable switchover operations. On the side of the opening 241 on the upper surface of the housing 2 along the direction in which the switch operation unit 951 for switching codes slides, a mark 242 corresponding to a code of a conductive pattern is provided in a part corresponding to each switching position of the slide switch. In FIG. 13(A), the marks 242 are provided as numerals and A marks to indicate positions and are shallowly engraved on the upper surface of the holding unit 204. Furthermore, the marks 242 are not limited to these, and may be provided in convex shapes or may be formed by printing or by stickers. Still further, the marks 242 need not be numbers, and may be graphics or the like according to how the apparatus is used.

In addition to having a rectangular opening along the direction in which the switch operation unit 951 for switching codes slides, the opening 241 provided in the holding unit 204 extends in a substantial arc shape in the counterclockwise direction in regards to the center of the holding unit 204. This is because the code generation apparatus 115 is provided with a mechanism of rotating and fixing together the holding unit 204 and the upper housing 203 as shown in FIG. 9, as with the code generation apparatus 111 of the first embodiment.

Furthermore, the opening 231 provided in the upper housing 203 is large enough so that the body portion of the slide switch 95 and the upper housing 203 do not come into contact with each other when the handle 222 is pressed to switch the push button switch of the operation unit 6.

Furthermore, the two types of circuit specifications corresponding to FIGS. 12(A) and 12(B) can be exchanged just by exchanging the circuit boards 611b and 611c which differ only in the wiring pattern, and all of the parts other than the circuit boards are can be

### Fifth Embodiment

### [Switchable Conductive Patterns and Pattern Code Decoding Method]

With a code generation apparatus 1 capable of switching a conductive pattern, to increase the number of codes that can be issued with all of the code generation apparatuses 1 and to facilitate decoding into pattern codes, it is necessary to provide conditions for methods of electrode arrangement each for the first conductive patterns 81 of (STEP 1) and the second conductive patterns 82 of (STEP 2), and to perform a pattern coding process with considerations of the electrode arrangement conditions. An example of switchable conductive patterns and a pattern code decoding method is shown below.

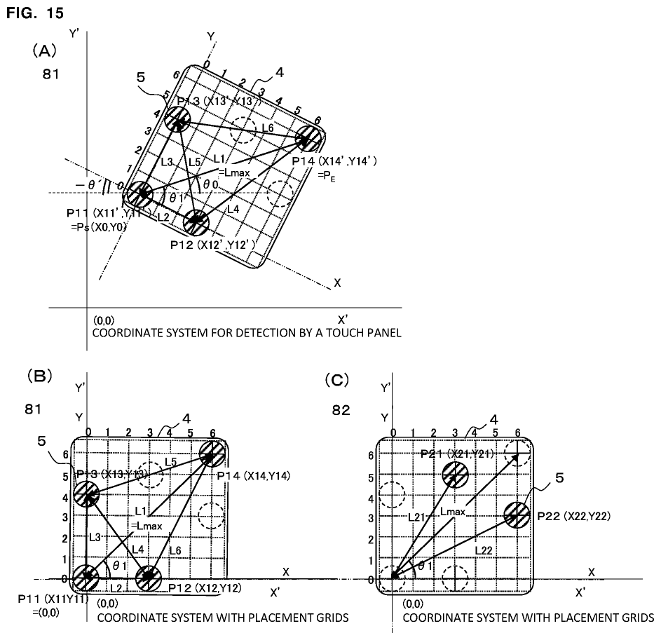

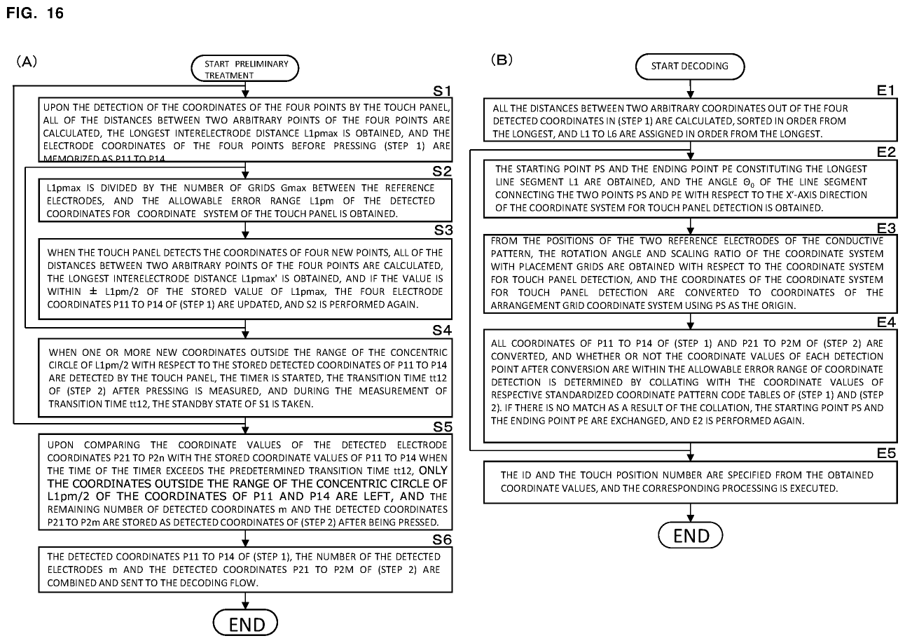

FIG. 14 shows explanatory diagrams of the determination method of (STEP1) and (STEP2) of the detected electrode coordinates for pattern coding, where FIG. 14(A) shows the state of (STEP1) and FIG. 14 (B) shows the state of (STEP2). FIG. 15 shows diagrams of a method of coordinate conversion for pattern coding, in which FIG. 15(A) shows the detection state of a touch panel 31 of a coordinate detection system, FIG. 15(B) shows the conversion of the detected state of (STEP 1) to the electrode arrangement grid coordinate system of code generation apparatus 1, and FIG. 15(C) shows the conversion of the detected state of (STEP 2) to the electrode arrangement grid coordinate system of code generation apparatus 1. FIG. 16 is a flowchart showing an example of pattern coding processing of the code generation apparatus 1 which has an operation unit 6 and can switch between the first conductive pattern 81 and the second conductive pattern 82.

With the code generation apparatus 1, according to specifications, by pressing for example a push button switch 60 of the operation unit 6, with (STEP 1) corresponding to the state before pressing and (STEP 2) corresponding to the state after pressing, by switching the connections between the plurality of electrodes 5 provided respectively for the first conductive pattern 81 and the second conductive pattern 82, and the human body contact conductive material 21 ON or OFF, two types of codes can be generated.

[Specifications for Electrode Arrangement for Conductor Patterns]

FIG. 15(B) shows an electrode arrangement example of the first conductive pattern 81, and FIG. 15(C) shows an electrode arrangement example of the second conductive pattern 82. An X and Y electrode arrangement grid coordinate system is provided in the bottom surface 4 area of the code generation apparatus 1 which comes into contact with the touch panel 31, and the electrodes 5 are arranged at their integer coordinate points. Thus, the arrangement distances of each electrode 5 can be easily calculated from the unit grid distance of the grid coordinate system. The unit grid distance is set based on the size of the touch panel 31 assumed to be used, the coordinate position detection accuracy of the touch panel, the size of the bottom surface 4 of the code generation apparatus 1, the size of the electrodes 5, and the like. In the case of the present embodiment, a coordinate system in which the area of the bottom surface 4 is divided from 0 to 6 for both X and Y is used.

In addition, the electrodes 5 of each conductive pattern cannot be arranged at all integer coordinate points, and for the determination of restrictions on the distance between the electrodes 5 and arrangement positions, the size of the electrodes 5 and the influence on coordinate detection by touch panel 31 of the placement of a plurality of electrodes at close coordinate positions in a conductive pattern and the like are to be considered.

For example, the minimum value for the electrode to electrode distance needs to be greater than or equal to the distance at which two electrodes 5 are not detected as one electrode by the touch panel 31.

Furthermore, in particular for projected capacitive touch panels often used in smartphones, when a plurality of electrodes are arranged in parallel to the outer frame of the touch panel, since a plurality of code generation apparatus electrodes 5 are aligned on one line of transparent electrodes for coordinate detection in the touch panel, there are cases where detection by the touch panel 31 is affected. For this reason, the number of the electrodes 5 arranged on the same line in a conductive pattern may be given a limit.

For the first conductive pattern 81, it is necessary to detect at least three electrodes 5 so that the orientation in which the code generation apparatus 1 is placed on the touch panel 31 can be specified, and in consideration of the assumed limitation in the number of multi-touches for a smartphone, a maximum number of five electrodes is preferable. Therefore, in this embodiment, the four electrodes 5 are provided for the first conductive pattern 81.

However, when the method of use has the orientation of the surface making contact with the touch panel 31 of the code generation apparatus 1 fixed, or when there is no limit on the number of multi-touches, or when tablets which detect five or more, or dedicated business apparatuses are used as the code recognition apparatus 3, the minimum number and the maximum number of electrodes are not limited to the above-described numbers.

As for the first conductive pattern 81, it is preferably to provide a reference electrode to facilitate code decoding. In this embodiment, all of the first conductive patterns 81 are provided with the two electrodes at the positions (0, 0) and (6, 6) of the grid coordinate system as reference electrodes, which have the longest distance in between. As a result, the length Lmax between the reference electrodes, the angle θ1 formed by the line segment connecting the reference electrodes and the X axis of the grid coordinate system can be used for code decoding. Furthermore, the reference electrode positions are not limited to the coordinates of this embodiment, as long as the distance between the reference electrodes, and the angle formed by the line segment connecting the reference electrodes and the X axis of the grid coordinate system can be specified.

For example, in this embodiment, reference electrodes can also be provided at the two points (0, 0) and (5, 6). By making the code decoding processing algorithm correspond to other reference electrode positions, a large number of conductive patterns having different code systems can be set. If conductive patterns and code decoding processing algorithms corresponding to each of a plurality of code systems are prepared, for example, a code system using the two points (0, 0) and (6, 6) of this embodiment as reference electrodes, a code system using the two points (0, 0) and (5, 6) as reference points, and a code system using two other points as reference points and so forth, even more codes can be issued for the whole system without having to change the main body of a code generation apparatus 1.

As for the second conductive pattern 82, due to the switchable feature of a code generation apparatus 1, information on the electrode arrangement coordinates of both the first conductive pattern 81 in (STEP 1) and the second conductive pattern 82 in (STEP 2) can be used for decoding, and thus reference electrodes are unnecessary. Therefore, for the second conductive pattern 82, electrodes 5 can be freely arranged at the arrangement coordinates as long as restrictions on the spacing between electrodes 5 and arrangements are followed.

Also, the number of arranged electrodes can be freely arranged within the range of 1 or more to the restricted number of multi-touches. Therefore, more conductive patterns can be set for the second conductive pattern 82. According to the present embodiment, code generation apparatus 1 is configured to have one to four electrodes arranged in the second conductive pattern 82.

Furthermore, for the second conductive pattern 82, due to the switchable feature of a code generation apparatus 1, it is possible to arrange electrodes 5 of the second conductive pattern 82 at the same coordinates as those of electrodes 5 arranged in the first conductive pattern 81. For example, for a code generation apparatus 1 having a configuration in which a conductive pattern printed sheet 400 is used and the code generation apparatus 1 is capable of switching conductive patterns, if the electrodes 5 of the first and second conductive patterns 81 and 82 are arranged at the same coordinates, the number of electrodes printed on the conductive pattern printed sheet 400 is smaller than the sum of the number of electrodes used in (STEP 1) and (STEP 2), and thus the arrangement of electrodes 5 of the two types of conductive patterns is facilitated, and a large number of conductive patterns can be set.

Also, although according to the present embodiment, the code generation apparatus 1 is configured so that reference electrodes are provided in the first conductive pattern 81, and the number of the electrodes 5 is three or more, so that the orientation of the code generation apparatus 1 placed on the touch panel 31 can be specified with the first conductive pattern 81, and reference electrodes are not provided in the second conductive pattern 82, it is also possible to provide reference electrodes in the second conductive pattern 82, and have the number of the electrodes 5 be three or more, so that the orientation of the code generation apparatus 1 placed on the touch panel 31 can be specified with the second conductive pattern 82, and reference electrodes are not provided in the first conductive pattern 81. If specifications of the latter configuration are also provided separately, even more codes can be issued for the whole system without having to change the main body of a code generation apparatus 1.

Still further, it is also possible to set a group of reference electrodes by combining patterns of both the first conductive pattern 81 and the second conductive pattern 82. For example, the reference electrode at the position (0, 0) can be provided in the first conductive pattern 81, and the reference electrode at the position (6, 6) can be provided in the second conductive pattern 82, and the longest distance between electrodes can be set with electrodes 5 of both the first conductive pattern 81 and the second conductive pattern 82, and by using an electrode 5 other than those used as reference electrodes for the first and second conductive patterns 81 and 82, the orientation of the code generation apparatus 1 placed on the touch panel 31 can also be specified. As a result, since the number of electrodes that can be freely arranged in both the first and second conductive patterns 81 and 82 increases, even more conductive patterns can be provided, and even more codes can be issued for the whole system.

A normalized coordinate pattern code table is created by organizing coordinate values of first conductive patterns 81 and second conductive patterns 82 created upon these specifications as normalized coordinate pattern codes for (STEP1) and (STEP2).

[Pattern Code Decoding Method]

With the code generation apparatus 1 capable of switching conductive patterns, according to specifications, a first conductive pattern 81 of (STEP 1) and a second conductive pattern 82 of (STEP 2) are provided, and by pressing a push button switch 60 which is the operation unit 6, the connections between the plurality of electrodes 5 provided respectively and the human body contact conductive material 21 are switched ON or OFF, and thus two types of codes can be generated.

For this reason, it is necessary to determine whether the electrode coordinate information detected by the touch panel 31 is that of the first conductive pattern 81 of (STEP 1) or the second conductive pattern 82 of (STEP 2) as a pre-stage of general code decoding processing.

Since two types of conductive patterns are provided, electrodes 5 that are not necessary for the electrode arrangements of either the conductive patterns 81 and 82 are provided on the bottom surface 4 of the code generation apparatus 1 disconnected with human body contact conductive material 21 are present on the touch panel 31 of a smartphone which is an example of a code recognition apparatus 3.

Moreover, in the touch position detection algorithm of a touch panel 31 of a smartphone 3, to continuously recognize a finger touch as the same touch, there are some smartphones in which there is a control system for reducing the detection sensitivity threshold value at a touch position once detected (detection threshold hysteresis control), and for some of these smartphones in which the extent of detection threshold decrease due to hysteresis control of the threshold is set to be large, in some cases, electrodes 5 of the first conductive pattern 81 of (STEP 1) connected to the human body contact conductive material 21 may continue to be detected by the touch panel 31 despite being disconnected from the human body contact conductive material 21 for the second conductive pattern 82 of (STEP 2), thus causing the problem of misrecognition of the correct code of the second conductive pattern code 82.

An example of a pattern code decoding method dealing with these two problems will be described.

The electrode arrangement specification of the conductive patterns of the present embodiment complies with the following four conditions. (1) Four electrodes 5 including two reference electrodes are used for the first conductive pattern 81. (2) One to four electrodes 5 are used for the second conductive pattern 82. (3) In the electrode arrangement of the second conductive pattern 82, electrodes are not arranged at electrode arrangement positions of the first conductive pattern 81. (4) The values of distance between the electrodes of the second conductive pattern 82 are set to be smaller than the distance of Lmax between the reference electrodes.

FIG. 16(A) shows a pre-processing flow for detected coordinate determination, and FIGS. 14(A) and 14(B) show examples of electrode detection states in (STEP 1) and (STEP 2) in regards to the touch panel coordinate system. As shown in FIG. 16(A), when the code generation apparatus is placed on the touch panel 31, (STEP 1) is attained, and the touch panel 31 detects the coordinates of four points in the state of S1. Based on the detected coordinates, all of the distances between two of the four points are calculated by the code recognition apparatus, and not only is the longest interelectrode distance L1pmax obtained but also the electrode coordinates of the four points before pressing (STEP1), P11 to P14, are stored.

Next, in the state of S2, L1pmax is divided by the number of electrode arrangement grids between the reference electrodes (6 in this embodiment) to obtain the detected coordinate allowable error range length L1pm of the coordinate system on the touch panel. FIG. 14(A) shows an example in which the touch panel detects the four points P11 to P14 in (STEP1), the distance between the detected coordinates of P11 and P14 is L1pmax, the longest, and the inside of the concentric circles indicated by broken lines having the radius of L1pm/2 at each detected position indicates the allowable error range of the detected coordinate.

In addition, when the touch panel further detects four new coordinates in the state of S2, the state becomes S3, and all of the distances between two of the four points are calculated and the longest interelectrode distance of L1pmax′ is obtained, and if the value is in the range of ±L1pm/2 with respect to the stored L1pmax, the electrode coordinates of P11 to P14 of the four points of (STEP1) are updated, and S2 is performed again.

Next, as shown in FIG. 16(A), when one or more coordinates outside of the range of the concentric circle L1pm/2 of the coordinates are newly confirmed and detected by the touch panel with respect to the stored detected coordinates of P11 to P14, the state becomes S4, a timer is started, and the transition time tt12 after the code generation apparatus is pressed (STEP2) is measured. During the transition time tt12 measurement, the system is in waiting in the state of S1.

When the predetermined transition time tt12 has passed, the state becomes S5, the coordinate values of the detected electrode coordinates of P21 to P2n at that time are compared with the stored coordinate information of P11 to P14, and leaving out only the coordinates outside the range of the concentric circle L1pm/2 of the coordinates, the number of remaining detected electrodes m and detected coordinates P21 to P2m are stored as detected coordinates after pressing (STEP2).

FIG. 14(B) shows an example in which detected electrode coordinates of P21, P22, and P12a are obtained (STEP2) after the elapsed time of tt12 from the starting of the timer, and since P21 and P22 are outside the range of the concentric circles of L1pm/2 of the stored detected coordinates of P11 to P14, they are stored as the detected electrode coordinates of the second conductive pattern 82 of (STEP2). Since P12a is determined to be within the range of the concentric circle of L1pm/2 of the stored detected coordinates of P12, it is determined to be a remaining detected electrode 5 of the first conductive pattern 81 due to the influence of the hysteresis control of the detection threshold and is deleted from the detected electrode coordinates of the second conductive pattern 82.

When the detected electrode coordinates of the second conductive pattern 82 are obtained, the state becomes S6, and the detected coordinates P11 to P14 of (STEP 1) and the number of detected electrodes m and the detected coordinates P21 to P2m of (STEP 2) are combined, sent to the decryption flow, and the pre-processing ends.

Next, when the detected coordinate information of (STEP 1) and (STEP 2) are ready, the code decoding flow is executed. FIG. 16(B) shows a code decoding flow for detected coordinate determination, and FIG. 15(A) shows an electrode detection state of (STEP 1) in the touch panel coordinate system, and FIGS. 15(B) and 15(C) show examples of the electrode detection states of (STEP 1) and (STEP 2) after conversion to the arrangement grid coordinate systems.

As shown in FIG. 16(B), first, all of the distances between two of the four detected coordinates detected in (STEP 1) are calculated, sorted from the longest order, and assigned L1 to L6 in order from the longest. Next, the starting point PS and the end point PE constituting the longest line segment L1 are obtained, and the angle θ0 of the line segment connecting the two points PS and PE with respect to the X′-axis direction of the coordinate detection system of the touch panel is obtained. (States E1 and E2).

FIG. 15(A) shows an example where, the electrode coordinates of the four points from P11 to P14 are detected in (STEP1), the distances between each of two electrodes are obtained, the longest line segment L1 corresponds to P11-P14, and with PS as P11 and PE as P14, the angle with respect with the X′ axis is θ0.

Here, since the angle θ1 of the line segment connecting with the reference electrodes P11 and P14 with respect to the X axis of the arrangement grid coordinates is known, the rotation angle θ′ of the arrangement grid coordinate system with respect to the touch panel coordinate detection system can be obtained by subtracting θ1 from θ0. Also, similarly, since the length of the line segment connecting the reference electrodes P11 and P14 is also known, by taking the ratio with the longest line segment L1, the enlargement/reduction ratio of the arrangement grid coordinate system with respect to the touch panel coordinate detection system can be determined.

From these pieces of information, the coordinates are converted into those of the arrangement grid coordinate system for electrode arrangement by rotating the coordinate values on the touch panel by −θ′ and applying enlargement/reduction ratios with PS as the origin. FIG. 15(B) shows an example in a case where the touch panel detected coordinate P11 is converted to PS from the arrangement grid coordinates of the P11 reference electrode of the conductive pattern 81, and converting P11 to P14 of (STEP 1) into corresponding points of the arrangement grid coordinate system. FIG. 15(C) shows an example where P21 to P22 of (STEP2) are converted to corresponding points of the arrangement grid coordinate system.

All of the detected coordinates of (STEP 1) and (STEP 2) are coordinate-converted, and whether or not the coordinate values of the respective detection points after conversion are within the range of the detected coordinate allowable error is determined by collation with coordinate values of each normalized coordinate pattern code table. If there is no match as a result of the collation, the starting point PS and the end point PE are exchanged, and the process is executed again from the state E2. (States E3 and E4 in FIG. 16(B))

By specifying each ID code of (STEP1) and (STEP2) from the obtained coordinate values, specifying ID codes as those of a code generation apparatus by combining them, and executing corresponding processings, code decoding processing is completed. (States E3 and E4 in FIG. 16(B))

Also, according to specifications of this embodiment, although the code generation apparatus 1 is configured so that the code can be recognized regardless of the angle of placement when the code generation apparatus 1 is brought into contact with the touch panel 31, it is possible to execute processings according to the rotation angle upon code generation apparatus 1 making contact with the touch panel 31 by using the rotation angles of the coordinate detection system of the touch panel 31 obtained in the process of the code decoding processing and the arrangement grid coordinate system.

With a single code generation apparatus 1, for example, it is also possible to execute four different processings corresponding to the four states of rotation angles of 0, 90, 180, 270 degrees of the code decoding process, corresponding to each of the four sides of the substantially square bottom surface shape of the code generation apparatus 1 with respect to one side of the touch panel 31.

Furthermore, the pre-processing flow part as shown in FIG. 16(A) of the pattern code decoding processing can be provided as an application program or a web browser program for a smartphone which is a code recognition apparatus 3, and the code decoding flow part shown in FIG. 16(B) can be executed on a server, the pre-processed electrode coordinate detection information can be transmitted to the server by telecommunication from the smartphone, and the ID code decoded on the server can be sent back to the smartphone. As a result, it is possible to improve the confidentiality of the code decoding processing method and the normalized coordinate pattern code table.

The conductive pattern specifications and the pattern code decoding methods of the present embodiment are not limited to those described, and it is needless to say that as long as it is possible to determine whether or not pattern codes created based on the conductive pattern specifications and subjected to decoding processing match with those of the pattern code table, the code decoding processing may be performed in any manner.

### Sixth Embodiment

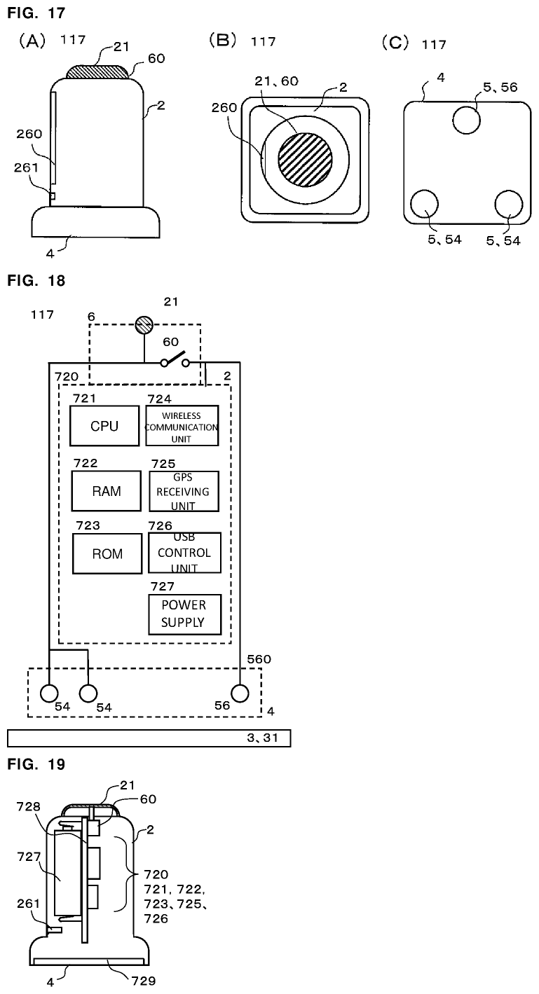

FIG. 17(A) is a schematic diagram of a side view showing an example of an external form of a code generation apparatus 117, FIG. 17(B) is a schematic diagram of a top view, and FIG. 17(C) is a schematic diagram of a bottom view. FIG. 18 is a schematic diagram of a configuration of a code generation apparatus 117. FIG. 19 is a schematic diagram of a sectional view of a side of a code generation apparatus 117 with scission in the vertical direction. The code generation apparatus 117 transmits and receives pattern codes and many other kinds of information by one-to-one communication with a smartphone triggered by having the touch panel 31 of a smartphone which is a code recognition apparatus 3 detect electrodes 5 upon the use of a push button switch.

As shown in FIGS. 17(A) and 17(B), the code generation apparatus 117 has a shape similar to that of a square stamp, the upper part of the housing 2 is a push button switch 60, the push button has conductivity, and it is used as a human body contact conductive material 21. In addition, a battery case door 260 which is opened and closed when a battery is replaced, and a USB connector 261 are provided on the side surface.

Moreover, as shown in FIG. 75(C), a plurality of adjacent electrodes 5 are arranged on the bottom surface 4 with enough spacing to disable detection of adjacent electrodes 5 as a single electrode even if the adjacent electrodes 5 are making contact with the touch panel 31 at the same time. In the figure, electrodes 5 are shown, but actually the bottom surface 4 is covered with a sheet of colored resin or a thin plate 410 thin enough so that the capacitance of the electrodes 5 is not significantly reduced.

The three-electrode arrangement of the electrodes 54 and 56 is an arrangement that can be distinguished as a code pattern from others. Furthermore, for example, when human fingers in a form such as a right triangle touch a touch panel 31, it is preferable to have an arrangement where easy touching of the same form is difficult to accomplish. Furthermore, by increasing the number of electrodes provided in the electrode area 560 to 4 or 5, it may be made difficult for human fingers to easily touch the touch panel 31 with the reproduction of the same shape.

As shown in FIGS. 18 and 19, the code generation apparatus 117 includes an electrode area 560 having electrodes 5 on the bottom surface 4, a control unit 720 installed on a PCB circuit board 728 in the housing 2, and an operation unit 6 of the push button switch 60.

The electrode area 560 is provided with two electrodes 54 that are directly connected to the human body contact conductive material 21, and is further provided with one trigger electrode 56 which is connected to a human body contact conductive material 21 via the push button switch 60.

In the housing 2, there is a control unit 720 installed on a PCB circuit board 728. As an information processing apparatus, the control unit 720 includes a CPU (Central Processing Unit) 721, internal memories RAM (Random Access Memory) 722 and ROM (Read Only Memory) 723, a wireless communication unit 724, a GPS (Global Positioning System) receiving unit 725, a USB (Universal Serial Bus) control unit 726, and a power supply unit 727. Furthermore, the operation unit 6 is provided with a push button switch 60 as one with a human body contact conductive material 21. The components other than the power supply unit 727 and the operation unit 6 may be configured with one semiconductor device or with a combination of a plurality of semiconductor devices.

The CPU 721, RAM 722, and ROM 722 constitute an information processing apparatus, and when the push button switch 60 is turned ON by pressing, the power is turned ON, necessary data is read from the ROM 722, and corresponding processing is performed. The ROM 723 stores an ID number corresponding to each of the code generation apparatuses 117, information to be transmitted to a smartphone when the push button switch 60 is pressed, and the like. The wireless communication unit 724 uses a wireless device such as WiFi or Bluetooth (registered trademark) which can serve to construct a wireless LAN (local area network). The GPS receiving unit 725 obtains positional information of the place where the code generation apparatus 117 is located. The USB control unit 726 controls USB connections with another apparatuses (not shown) when program update, data input/output, charging, or the like of the code generation apparatus 117 is performed. Furthermore, the USB control unit 726 may not be necessary. The power supply unit 727 supplies power to the control unit 720, and may be either a dry battery or a rechargeable battery as long as it can supply power that meets the specifications of the circuits and devices installed on the control unit 720. If a rechargeable battery is used, it may be chargeable via the USB connector 261.

A code recognition apparatus 3 is installed with an application program for recognizing a code generation apparatus 117 from detected coordinates when a touch panel 31 detects electrodes 5 of the code generation apparatus 117, and also for constructing a wireless LAN.

The operations and processings of a code generation apparatus based on this embodiment will be described. (1) When the code generation apparatus 117 is brought into contact with a touch panel 31 of a code recognition apparatus 3 and a human finger touches a human body contact conductive material 21, two reference electrodes 54 are detected by the touch panel 31. (2) Furthermore, when a push button switch 60 is pressed, a human body contact conductive material 21 and trigger electrodes 56 are electrically connected, and detected by the touch panel 31. (3) The code generation apparatus 117 further activates the control unit 720 and sends a connection request for establishing a wireless LAN by the information processing apparatus to the code recognition apparatus 3 within a predetermined amount of time. (4) When three detected coordinates are obtained, the code recognition apparatus 3 analyzes the detected coordinates and determines whether or not they are the three information trigger points with an application program. If they are the information trigger points, a wireless LAN is activated and a connection is accepted, and the apparatus that requested connection within the predetermined amount of time is determined to be the relevant code generation apparatus 117 and is connected. (5) When the code generation apparatus 117 and the code recognition apparatus 3 are connected by the wireless LAN, the code generation apparatus 117 sends the ID number written in the ROM 723 by the information processing apparatus to the code recognition apparatus 3. The code recognition apparatus 3 checks the received ID number to determine whether the connection is correct. If the connection is correct, other necessary information is exchanged.

The detected electrode coordinates of the touch panel 31 are used as a communication activation trigger, and ID numbers and other kinds of information can be exchanged in large numbers by performing communication. Since the ID number is written in the ROM, the required number can be easily created.

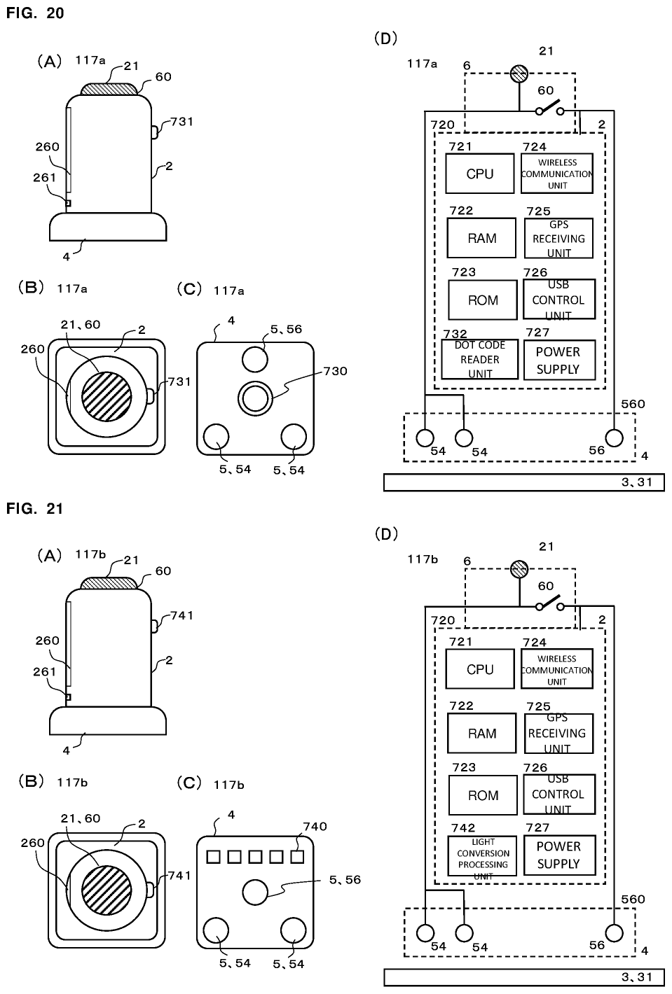

FIG. 20(A) is a schematic diagram of a side view showing an example of an external form of a code generation apparatus 117a, which is a modification example of a code generation apparatus 117 of the sixth embodiment. FIG. 20(B) is a schematic diagram of a top view, and FIG. 20(C) is a schematic diagram of a bottom view, and FIG. 20(D) is a schematic diagram of a configuration.

As shown in FIGS. 20(C) and 20(D), the code generation apparatus 117a is a code generation apparatus 117 provided with a dot code reader 730 on the bottom surface 4 and a dot code reader 732 on the controller 720. There is an opening on the sheet or thin plate 410 provided on the bottom surface 4 at the part where the dot code reading apparatus 730 is.

As shown in FIG. 20(A), when a dot code reading switch 731 is provided on a side surface of the housing 2 and the dot code reading switch 731 is turned ON, a dot code displayed on a touch panel 31 or some other medium is read and is stored in a RAM 722 or a ROM 723 of a control unit 720.

By providing a dot code reading apparatus 730, not only is information input to the ROM 723 in advance but also other kinds of information embedded in a dot code, separately, can be transmitted using a code generation apparatus 117a to a smartphone which is a code recognition apparatus 3.

FIG. 21(A) is a schematic diagram of a side view showing an example of an external form of a code generation apparatus 117b, which is a modification example of a code generation apparatus 117 of the sixth embodiment, FIG. 21(B) is a schematic diagram of a top view, FIG. 79(C) is a schematic diagram of a bottom view, and FIG. 21(D) is a schematic diagram of a configuration.

As shown in FIGS. 21(C) and 21(D), a code generation apparatus 117b is a code generation apparatus 117 provided with a photodiode 740 on the bottom surface 4 and a light conversion processor 742 on the controller 720. There is an opening on the sheet or thin plate 410 provided on the bottom surface 4 where the photodiode 740 is. Furthermore, instead of a wireless communication unit 724, an optical conversion processing unit 742 may be provided.

As shown in FIG. 21(A), by providing a receiving switch 741 on the side surface of the housing 2, and the receiving switch 741 is turned ON, an optical code displayed on the touch panel 31 is read, and the light conversion processing unit 742 of the control unit 720 performs code conversion processing and the data is stored in the RAM 722 or the ROM 723.

Furthermore, when a light conversion processing unit 742 is provided instead of a wireless communication unit 724, by bringing the code generation apparatus 117b into contact with a touch panel 31 and pressing the push button switch 60, the electrode coordinate information is recognized and checked by the code recognition apparatus 3. If the ID is correct, the light intensity of the touch panel 31 in the area corresponding to the photodiode 740 of the code generation apparatus 117b can be changed for issuing optical data patterns for ID confirmation, the photodiode 740 of the code generation apparatus 117b can receive light, and the light conversion processing unit 742 can confirm that the ID has been confirmed.

By providing a photodiode 740, a code generation apparatus 117b can receive information from the smartphone which is a code recognition apparatus 3 without using wireless communication.

The functions of the control unit 720 provided in the code generation apparatuses 117, 117a, and 117b can be used in combination, and furthermore, unnecessary functions can be omitted. Needless to say, the method of providing a control unit 720 provided in the code generation apparatuses 117, 117a, and 117b can also be applied to code generation apparatuses of other embodiments.

### Seventh Embodiment

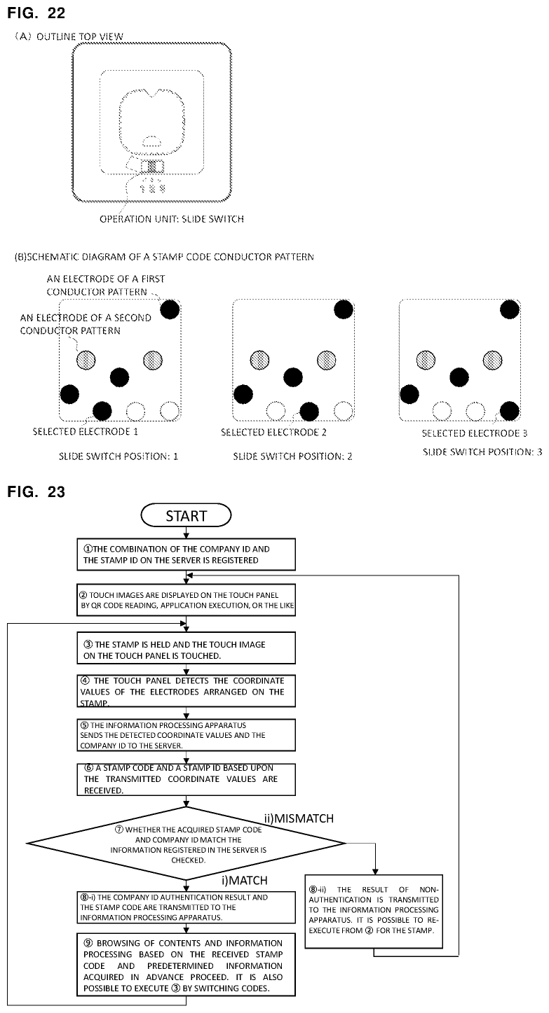

Next, various systems using the code generation apparatus will be described with reference to FIGS. 22 to 28.

(Company ID/Stamp Code Authentication System)

FIG. 22 shows an embodiment of a setting of an operation unit of an electronic stamp which is one type of a code generation apparatus. A code specification of a multi-code stamp in which a plurality of stamp codes can set by a slide switch is shown. In the present embodiment, although the electronic stamp issues stamp codes by a slide switch, it may have any shape and form regardless of the type of the stamp or the slide switch.

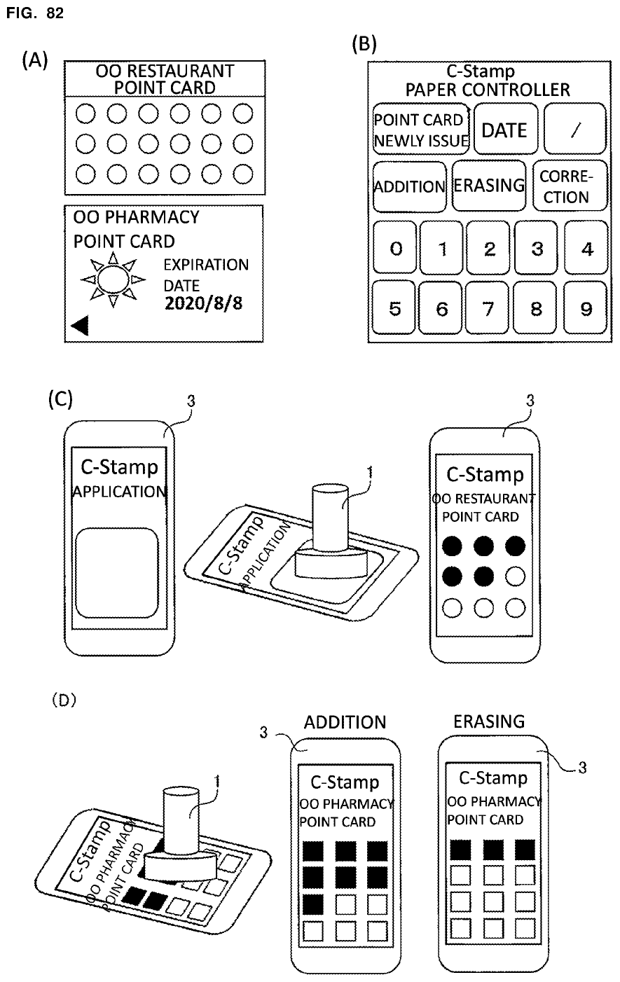

The slide switch which is the operation unit in FIG. 22(A) can be switched to slide switch positions “1,” “2,” and “3.” As shown in FIG. 22(B), with the slide switch position “1” the selective electrode 1 is electrically connected, with the slide switch position “2” the selective electrode 2 is electrically connected, with the slide switch position “3” the selective electrode 3 is electrically connected, and thus a first conductive pattern is formed. As shown in this practical example, among the first conductive patterns, a stamp ID: 150 is shown for a conductive pattern that does not include any selective electrodes. Here, when any one of the selective electrodes is electrically connected, for the selective electrode 1 stamp code: 1501, for the selective electrode 2 stamp code: 1502, and for the selective electrode 3 stamp code: 1503 is assigned. As shown in FIG. 82, stamp codes each including selective electrodes 1, 2, and 3 correspond to A, B, and C, respectively.

When a user uses an electronic stamp, it is desirable to construct a stamp ID authentication system to maintain confidentiality in performing charging, obtaining usage logs, and analyzing stamp codes issued by the electronic stamp. The flow of an authentication system is shown in FIG. 23.

(1) First, the company ID of the company under contract and one or more stamp IDs used by the company are registered in the authentication server. A company ID-stamp ID table may be created. Although not shown, the plurality of stamp codes that can be issued with a multi-code stamp may be registered in the authentication server instead of a stamp ID. Of course, both the stamp IDs and the stamp codes may be registered.

(2) Next, when a predetermined processing such as reading a QR code or executing an application is performed by an information processing apparatus, a touch image that guides the stamping of the electronic stamp is displayed on the touch panel.

(3) Next, the user holds and stamps an electronic stamp on the touch image displayed on the touch panel.

(4) Next, the touch panel on which the electronic stamp is pressed detects the coordinate positions (coordinate values) of a predetermined number of electrodes from the detected capacitance.

(5) Next, the information processing apparatus (including software) connected to the touch panel transmits at least the coordinate values and the company ID to the authentication server. Here, although not shown, the information processing apparatus may have a function of recognizing a stamp code from the coordinate values by pattern analysis and acquiring a stamp ID from the stamp code. Note that the information processing apparatus may have a function of only recognizing the stamp code and the function of acquiring a stamp ID from the stamp code may be in the authentication server. As a result, it is possible to keep confidential which stamp code corresponds to which stamp ID.

(6) Next, the authentication server recognizes the stamp code by pattern analysis from the received coordinate values of the electrodes, and acquires a stamp ID corresponding to the stamp code. Note that if the electronic stamp does not have a multi-code issuing function, there is one stamp code for each stamp, and the stamp code and the stamp ID correspond. When the stamp code is recognized from the coordinate values by pattern analysis and the stamp ID is acquired from the stamp code in procedure (5), the authentication server may receive both the stamp code and the stamp ID, or may acquire only the stamp code and the authentication server may transmit the stamp ID corresponding to the stamp code.

(7) Next, the authentication server collates the acquired stamp ID or stamp code along with the company ID with the registered codes.

(8) When the acquired stamp code agrees with the pre-registered stamp code, the authentication server transmits the stamp code to the information processing apparatus (including software) to complete the authentication. If not verified, the authentication server transmits a code indicating error to the information processing apparatus (including software) and there is no authentication. In the case of non-authentication, since an electronic stamp with an unregistered stamp code is used, it is necessary to re-execute from process (2) for the electronic stamp.

(9) Based upon the authenticated stamp code, the information processing apparatus (including software) executes access to contents such as WEB sites and various information processings.

Note that in process (1), a predetermined number of stamp codes corresponding to the stamp ID may be registered in the place of the stamp ID. In that case, the predetermined number of stamp codes registered together with the company ID are collated in process (5). The stamp ID authentication system can record the history of authenticated company IDs and stamp codes with time, and this can be utilized for measuring the effects of electronic stamps and for marketing research.

If linked with a GPS device built into an information processing apparatus such as a smartphone, the history can be recorded together with the areas of use. In a stamp rally that uses an electronic stamp, if the location information of the electronic stamp is registered on the authentication server and the location information is included in the transmission information from the smartphone, even if the number of stamp IDs is limited, the stamp can be reliably identified by the stamp ID and the position information. In addition, a similar system can be provided for stamps, coupons, and point granting/erasing at stores.

Furthermore, if it is found that a stamp is used with improbable position information, it can be acknowledged that the stamp is a counterfeit or a stolen item. Also, when an electronic stamp is given to each user, a stamp ID is recorded on each user's smartphone, and the smartphone ID and the stamp ID are registered on the authentication server. If an electronic stamp is stamped on a touch panel (including those of a smartphone or a tablet) installed at a predetermined location registered in the authentication server in advance, from the authentication server connected to the touch panel, it is also possible to send a history of stamp stamping on the authenticated user's smartphone and provide corresponding services.

For performing various charging by using electronic stamps, high security can be ensured by using PIN code input and passwords together with stamp code authentication. For PIN code and password input, if the application has a function to detect the rotation angle of the stamp, by placing a mark such as ▴ in the positive direction of the stamp, the order of the placement directions for stamp placements can be set as a password.

A code generation apparatus of the present invention has a touch panel detect physical quantities and acquire multiple pieces of coordinate information, and an information processing apparatus built-in or connected to the touch panel analyzes a pattern from the multiple pieces of coordinate information, and not only does it acknowledge the code generated from the code generation apparatus, but it also calculates the orientation of the pattern, that is, the orientation of the code generation apparatus at the same time. Therefore, the stamp code and the orientation of the stamp can be recognized regardless of the orientation the stamp is placed on the touch panel. The accuracy is within ±several degrees, and even in consideration of human operability, up to a total of 8 directions (vertical, horizontal, and diagonal directions) can be reliably recognized. Thus, using the number of combinations including the order of the angles set with the eight directions θ₁ to θ₈ with the following rotation angle ranges, PIN codes or passwords can be set. The upward direction (0 degrees): range of 337.5 degrees<θ₁≤22.5 degrees, oblique upper right direction (45 degrees): range of 22.5 degrees<θ₂≤67.5 degrees, right direction (90 degrees): range of 67.5 degrees<θ₃≤112.5 degrees, oblique lower right direction (135 degrees): range of 112.5 degrees<θ₄≤157.5 degrees, downward direction (180 degrees): range of range of 157.5 degrees<θ₅≤202.5 degrees, diagonally lower left direction (225 degrees): range of 202.5 degrees<θ₆≤247.5 degrees, left direction (270 degrees): range of 247.5 degrees<θ₇≤292.5 degrees, diagonally upper left direction (315 degrees): range of 292.5 degrees<θ₈≤8 of 331 degrees. When inputting a PIN code or password, the stamp orientation may be changed in a predetermined order while maintaining touching or replacing each time. To make the operation smooth, first, the stamp may be placed in the upward direction, and then the direction may be changed for inputting the password.

(Content Download with a Browser)

The user photographs a QR code (registered with a URL including at least the company ID) printed on a poster, a flyer, or the like of stores and facilities that provide services using electronic stamps with a QR code reader (including the camera) provided in (or connected to) an information processing apparatus such as a smartphone, a tablet, or a PC. Then, the user reads the URL analyzed by a means of the analysis of a smartphone or the like, accesses the URL with a browser, and downloads content data including HTML, JavaScript (JS), and predetermined data (including company ID). When content display or the like is executed, an electronic stamp touching screen is displayed on a display (touch panel) such as that of a smartphone. When the store side or the facility side sets a multi-stamp code for the electronic stamp (an electronic stamp that does not have a multi-stamp code function does not require special settings), and the electronic stamp is stamped, the touch panel detects the coordinate values of a predetermined number of electrodes, JS transmits at least the coordinate values and the company ID to the stamp ID authentication system of the authentication server, and receives the results of the stamp code analyzed from the coordinate values and the company ID authentication results by the authentication server. The information processing apparatus may have a function of recognizing a stamp code from the coordinate values by pattern analysis and acquiring a stamp ID from the stamp code. In that case, the authentication server may be set to receive the stamp code and the stamp ID.

Thereafter, processing based on the stamp code is executed. Note that if the HTML or JS is acquired by downloading with a general-purpose browser, since the HTML or JS temporarily stored in the information processing apparatus can be analyzed and the URL or the like corresponding to images, video data, and contents can be acquired, these contents can spread to third parties. To provide contents only to those who can enjoy the service, it is necessary to develop a dedicated browser (app) with a QR code reading function, download, install, and use the dedicated browser according to the following procedure, and create a mechanism in which the URL of the connection site is concealed and content data cannot be stored. Note that by downloading and installing the application, a smartphone ID can be acquired, and push communication (email or information distribution to a smartphone user) is possible.

(1) Use a general-purpose browser to read the QR code for electronic stamps and download and install a dedicated browser.

(2) A dedicated browser is used to read the QR code for the electronic stamp, to acquire the corresponding URL, to download confidential HTML, JS, and predetermined data (including company ID and the like), and to acquire or stream contents.

(Application Development Using SDK (Software Development Kit))

If priority is given to real-time performances such as games, or if you do not want to go through an authentication server, an authentication system may be provided as an SDK and may be incorporated into an application or JS, to perform stamp code analysis of the coordinate values detected by the touch panel, and acquire and authenticate the stamp ID. In that case, an SDK in which a stamp ID (or stamp code) under contract along with a company ID is registered may be provided. As a result, an electronic stamp having a stamp code of a company not under contract cannot be used and security can be ensured.

(Setting of Subcodes (Dedicated Arguments))

Even with a single stamp code, it is possible to download different contents by adding a subcode (dedicated argument) to the URL registered in a QR code and changing the URL according to the combination of the company ID and each subcode. As a result, it is possible to realize multiple types of electronic stamps having the same stamp ID (an electronic stamp having a multi-stamp code function possesses a predetermined number of stamp codes, and in this embodiment, there are three types, A, B, and C). QR codes corresponding to these multiple types of electronic stamps registered with URLs including at least company IDs and subcodes are provided to users. Note that the company ID and subcodes may be included in the data area of the QR code.

(Electronic Stamp Own by an Individual and Security by PIN Code Entering)

To strengthen the security of prepaid payments on the Internet by users with electronic stamps, it is desirable to have PIN code entry in addition to stamp ID (including stamp codes) authentication using a dedicated browser (application). PIN code input can be implemented by changing the placement orientation of a stamp as described above, and a PIN code cannot be input unless a PIN code inputter possesses a stamp. Currently, PIN codes are employed for electronic prepaid cards such as POSA cards used on the Internet with smartphones and PCs. The user purchases a prepaid card or the like at a convenience store or the like, obtains a PIN code by scratching off a concealed PIN code or by removing a concealment sticker, enters the PIN code at the time of prepaid payment, and settles a charge payment. However, “imposter fraud,” where fraud groups telephone elderly people, make them purchase prepaid electronic stamps for e-commerce at convenience stores, elicit the PIN codes, and illegally use the prepaid electronic stamps, is becoming a social problem. The problem is that even if the fraud group does not obtain the prepaid card, fraud can be easily executed by making an elderly purchase a prepaid electronic stamp over the telephone and eliciting the PIN code. A mechanism is available in which the PIN code cannot be input unless a dedicated browser (application) is downloaded and installed, and the electronic stamp is stamped, when an electronic stamp is used for prepaid payment, for the user to input the PIN code. Furthermore, as described above, it is possible to make PIN code input only with an electronic stamp. As a result, “imposter fraud” is impossible with only the telephone, and the delivery of the electronic stamp is required. With “imposter fraud”, it is extremely difficult to implement delivery, and since evidence is likely to remain, extremely high security can be provided.

On the other hand, PIN code input is also desirable when providing contents (including items with charges) such as videos, images, game items, or the like, and benefits such as coupons, points, or the like only to specific people. This is because if the content or coupon is copied and spread to a third party, the meaning of service for a specific person is lost. In addition, if economic services such as discounts and cash vouchers for specific people spread, companies will suffer serious damage. Therefore, when a user uses an electronic stamp, it can be made so that the service provider can provide various services only when a dedicated browser (application) is downloaded and installed, and the electronic stamp holder is authenticated. If the application is downloaded and installed, the ID of an information processing apparatus such as a smartphone can be acquired by the provider, and thus push communication can be performed from the provider side, and new services can be provided to the user promptly. When push communication or content concealment is not required, a general-purpose browser may be used with an emphasis on convenience. Note that a stamp equipped with a communication function and/or an information reading function, which will be described later, can secure a high level of security without having to enter a PIN code.

(Code Generation Apparatus with an Information Reading Function)

FIG. 24 shows an embodiment of a code generation apparatus equipped with a dot code reader. A dot code reader is an apparatus built in a code generation apparatus that reads a dot code by placing the code generation apparatus on a printed matter in which a dot code has been printed in advance, or on a touch panel such as that of a smartphone or tablet on which a dot code is displayed.

When a code generation apparatus is pressed in two stages onto a touch panel such as that of a smartphone or tablet, a stamp code is recognized by the smartphone or tablet from a conductive pattern formed with the detected plurality of electrodes. Regardless of where the code generation apparatus is placed or the orientation on the touch panel, since the conductive pattern of the first stage and/or second stage is formed with a geometrically unique arrangement, the position of the dot code reader of the code generation apparatus can be specified. For example, as shown in FIG. 24(A), when the pattern forms triangle ABC and the reading apparatus is at the position D, if the middle point M of the longest side AB is assigned as the origin, the side AB as the X axis, and the line perpendicular to the side AB passing through the origin as the Y axis, the coordinate position of the reading apparatus at a distance can be defined in advance. Furthermore, if a straight line connecting the origin and the coordinate position of the reader is drawn, and the inclination angle of the reader with respect to the line is assigned angle θ, the orientation of the reader can also be defined. Therefore, if the unique geometric arrangement of a conductive pattern of a code generation apparatus can be recognized by a smartphone or tablet, as shown in FIG. 24(B), even if the code generation apparatus is placed on the touch panel with an angle, the position and orientation of the reading apparatus can be calculated, and the dot codes may be displayed so as to match them. The method for defining the coordinate position and orientation of a reader is not limited to this method, and any method may be used as long as they can be defined in the same manner Since it is only necessary to display a dot code instantaneously when the dot code is read, it can be said that this is a highly secure method in which a dot code that is originally difficult to see cannot be visually recognized by another person or by an imaging apparatus. By using a dot code, one block unit that can store one dot code can store 27 bits to 108 bits of information in an area of 1.5×1.5 mm to 3×3 mm, and by increasing the size of a block, even more information can be stored in a dot code. Here, if a time-series dot code whose dot code changes with time is displayed on a display and read, an even larger amount of data can be transmitted and received. Furthermore, the amount of information can be further increased by colorizing the dots. Since the reading apparatus reads dot colors in RGB, regardless of the display that may display different colors depending on each model type, at least red (R), green (G), blue (B), yellow (RG color mixture), cyan (GB color mixture), magenta (RB color mixture), black, white (no dots) can be distinguished, and just with that itself, there can be an increased to 3 bits per dot. That is, the amount of information per cell is tripled. Furthermore, if a color tone modulation technique is used, there is a high possibility that the amount of information can be furthermore increased by two times, that is, by about six times in total. As a result, the system can transmit a photograph or a short-scale animation with a high compression ratio by changing the color of the dot code with time in combination with the use of the time series dot code with time changes. If a code generation apparatus is provided with a communication function, even if imposturous use is attempted by some other code generation apparatus, if an authentication server is provided, by comparing the unique IDs of the code generation apparatuses sent to it, it is possible perform authenticity determination. Therefore, further improvement of security can be achieved. In addition, a one-time ID is sent to a smartphone from an authentication server (which may be the cloud), the one-time ID is converted by the smartphone into a dot code, it is displayed on the code generation apparatus so that it is hidden from the human eye by the outer appearance of the code generation apparatus, the code generation apparatus obtains the dot code (one-time ID), a one-time password is calculated from the dot-code with the concealed ID and a concealed equation recorded in the code generation apparatus, the result is transmitted to the authentication server, and the server collates the relationship of it with the priorly transmitted one-time password, and thus a code generation apparatus can be identified with extremely high security. In addition, since the authentication server also identifies and collates smartphone IDs, utilization in various fields requiring security such as financial settlements, settlements of important matters, provision of information, and browsing between smartphone users and code generation apparatus owners can be done. Note that since the dot code can define a large amount of information, contents such as photographs, illustrations, and simple animations may be transmitted as authentication is complete.

Note that although a dot code reader installed in a code generation apparatus reads a dot code from an image photographed with visible light including colored dots that are visible, as a dot code displayed on a display of a smartphone or the like that is a light-emitting medium, to photograph and read a dot code formed on a non-light emitting medium such as printed matter, since there is no interspace between the bottom of the code generator and the paper surface and light does not enter, it is necessary to irradiate light and have the dots be read from the reflected light. Therefore, in order to read only a dot code that is printed superimposed on a graphic, the dots may be printed with infrared absorbing ink (carbon black ink, infrared absorbing stealth ink, or the like), and the other colors may be printed with ink that does not absorb infrared light. When infrared light is irradiated and the reflected light is photographed, since only the dot portion absorbs the infrared light and is imaged black, the dot code can be read. In this case, since visible light does not enter, it is not necessary to provide a filter that transmits only infrared light. Note that the CMOS sensor used in the dot code reader can image both visible light and infrared light.

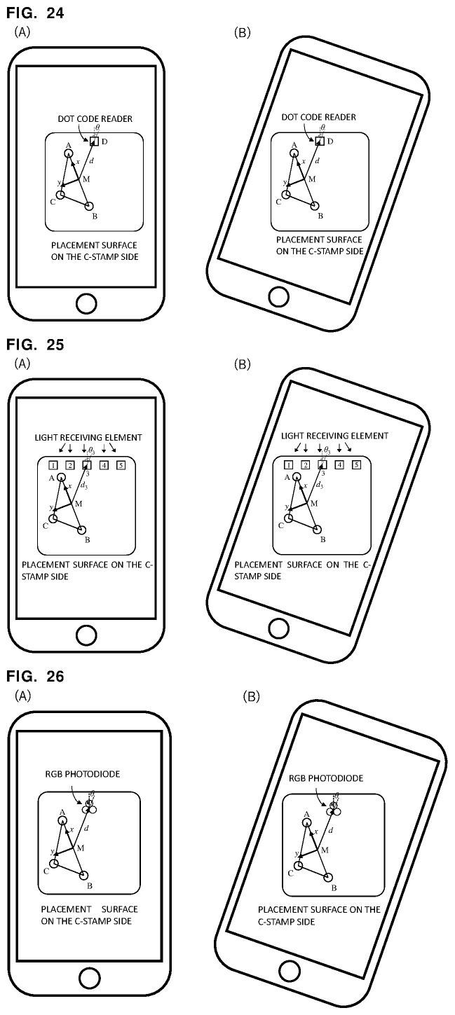

FIG. 25 shows an embodiment of a code generation apparatus equipped with an optical code reader. An optical code reader is an apparatus that can read an optical code emitted from a display of a smartphone or tablet with a module having a light-receiving function such as a plurality of diodes upon placing a code generation apparatus on the touch panel of the smartphone or tablet. As shown in FIG. 25, regardless of where the code generation apparatus is placed or the orientation on the touch panel, the position and arrangement of each light-receiving element (diodes or the like) of the optical code reader of the code generation apparatus can be specified from the unique pattern code of the code generation apparatus in the same way that a reading apparatus can be specified by a code generation apparatus equipped with a dot code reading apparatus. Here, light-receiving elements 1 to 5 are exemplified, and the method of defining the position and orientation of the light-receiving element 3 is exemplified as in the example of the dot code. The same applies to the method of defining the positions and orientations of the other light-receiving elements. The method of defining coordinate positions and orientations of the light-receiving elements is not limited to this method, and any method may be used as long as it can similarly define them. When using elements such as diodes, since the number of elements that can be mounted is limited, the amount of data that can be transmitted and received at one time is small compared to dot codes. However, the amount of data can be greatly increased by sending 1-bit information with each element turned ON/OFF at a very short predetermined time interval of 1/60 seconds at the fastest. Also, instead of dichroic diodes, by using RGB diodes capable of emitting the eight colors based on RGB and their mixtures, red (R), green (G), blue (B), yellow (RG color mixture), cyan (GB color mixture), magenta (RB color mixture), black, white (no dots) which are said to be detectable without problems on general smartphones and tablets, the amount of information of each element increases to 3 bits. Furthermore, if a color modulation technology is used, the amount of information can be increased further to at least 4 bits. As shown in FIG. 26, regardless of where the code generation apparatus is placed or the orientation on the touch panel, the position and arrangement of the RGB diodes of the optical code reader of the code generation apparatus can be specified from the unique pattern code of the code generation apparatus in the same way that a reading apparatus can be specified by a code generation apparatus equipped with a dot code reading apparatus. Since it is only necessary to display an optical code for an instance for having an optical code read, as with the method using a dot code, it can be said that the method using an optical code is highly secure since an optical code is not visible to others or imaging devices. In addition, when a communication function is added to a code generation apparatus, the code generation apparatus and smartphone can be specified by an authentication server, and it can be used in various fields as with the code generation apparatus equipped with the dot code reader as described above, and thus a great advantageous effect can be expected. Although an optical code can hold a less amount of information, since there is the advantage that manufacturing can be performed at a low cost, the optical code has an advantage when there is no need to transmit a large amount of data. Note that with a code generation apparatus equipped with a dot code reader, a code can be formed on a medium that is not a light emitter, and by printing dot codes on print media such as newspapers, magazines, catalogs, circulars, flyers, tickets, and the like, cards with which an individual can be identified, trading cards, and the like, application to various fields is possible. Note that if an information reading apparatus for optical codes, dot codes, or the like is installed but a communication function is not installed, upon making collations with or judgments on the information received by the code generation apparatus, collation or judgment results may be output by providing audio output, optical output with LEDs, and also a code generation apparatus may be provided on a display. Furthermore, related history may be output later via a USB or the like.

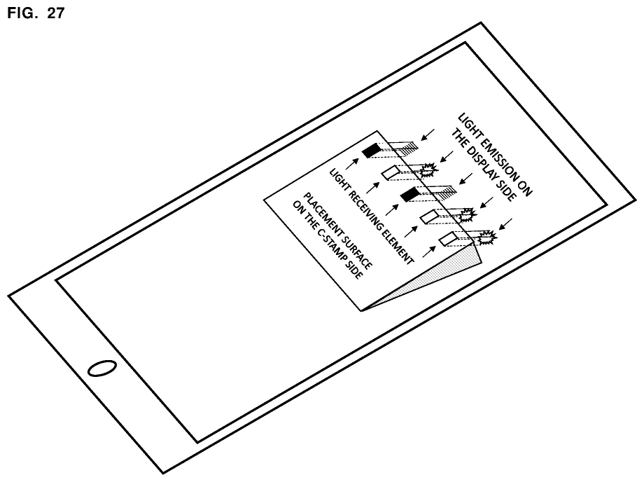

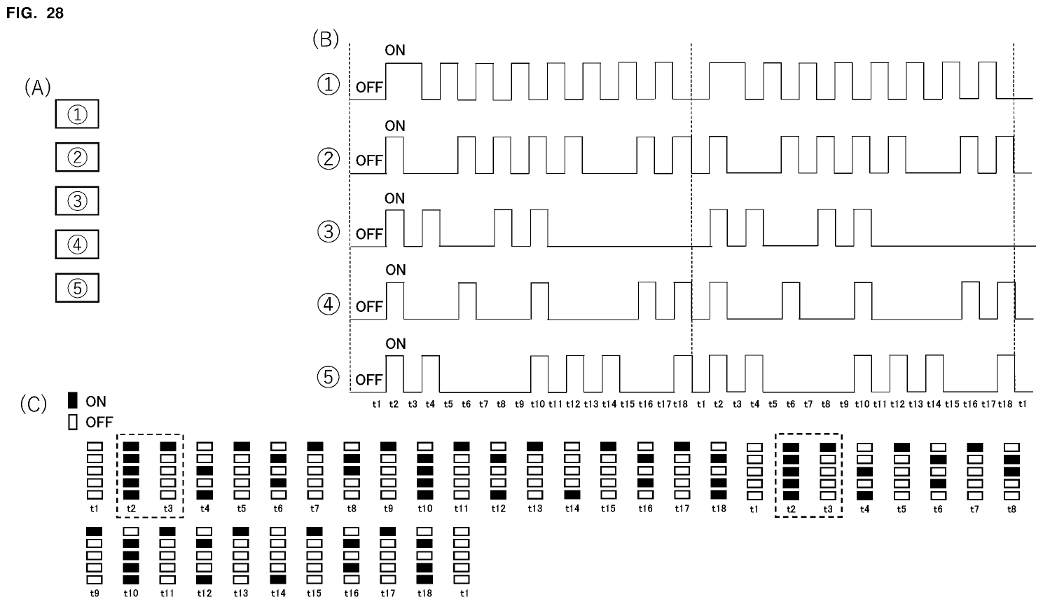

FIG. 27 shows an example of synchronization by a code generation apparatus equipped with an optical code reader, accompanying light emission from a light-emitting area of a smartphone display. This is an example in which the second, fourth, and fifth light receiving elements (diodes or the like) from the left each receive light emitted from the corresponding display side. A simple example of such an optical code exchange process is shown in FIG. 28. FIG. 28(A) shows five light receiving elements, FIG. 28(B) shows the relationship between each element and time-series changes, and FIG. 28(C) shows the state of synchronization of the elements at each timing. Reading is started triggered by a change to a state where all elements are ON at t2, from a state where all of the elements are OFF at t1, with element 1 continuously ON at t3, element 1 is determined to take the role of the time axis in the time series changes. In other words, the group surrounded with broken lines is the header, and thereafter, ON and OFF are repeated for each predetermined time interval by synchronization of the element 1. The remaining four elements allow the code generation apparatus to receive information such as an optical code. A state where element 1 is OFF in consecutive steps (t18 and t1), corresponds to a delimiter signal. This series of processes is repeated. Intermediary t1's are not necessarily required.

Thus, it is possible to directly acquire a user's personal information without using the NET simply by placing a code generation apparatus on a touch screen of a user's smartphone. The above mentioned personal information may include as necessary information such as membership numbers, name, address, various Internet addresses, smartphone IDs, financial settlement information of credit cards and the like, certification information, health insurance information, and biometric information such as face photos. Upon registering information associated with My Numbers, it may be made so that only information approved by the user can be read by a code generation apparatus.

(A Code Generation Apparatus Equipped with a Communication Function.)

An embodiment in which a communication function is installed in an electronic stamp which is a type of code generation apparatus will be described. If WiFi is installed as a communication function, the stamp address for each stamp is stored, and the stamp ID and the stamp address are registered with a linkage between them on the authentication server. Furthermore, a smartphone ID may be registered on the authentication server, and collation with the smartphone being used may be possible. When a stamp is stamped on the touch screen of a stamp-compatible application on a smartphone at a store or facility, an authentication server obtains a stamp ID, and concurrently, a stamp address is sent from the stamp to the authentication server by a stamping operation (switch is ON), and upon collating the stamp ID and stamp address registered on the server in advance with the acquired stamp ID and stamp address, authentication may be granted if they match, and thus forgery and theft can be prevented. If a theft is detected, the stolen stamp may be made not to be approved if the theft is registered on the server, or it may be made so that the thief is tracked and found. Note that to have the stamp usable in different places wherever it may be, it is only necessary to have the names of the SSIDs the same. By registering information on the location of a stamp on the authentication server, it is possible to recognize where the stamp was stamped. The stamp stamping service may provide users with various contents via a server through WiFi communication.

Since it is not impossible to forge a capacitance code and generate the same stamp ID, as exemplified in this embodiment, by assigning a unique concealed stamp address to the stamp and performing authentication, extremely high security can be ensured. Furthermore, a one-time password may be transmitted from a stamp to an authentication server for authentication if a real-time clock is installed in the stamp and it is stamped on a smartphone. Based upon the authentication result, the processing of payments or the like intended to be implemented with a smartphone may be implemented. Also, when stamping on the smartphone, stamp authentication may be performed by having the smartphone send a request to the authentication server, having the authentication server send a one-time pass ID to the stamp, having a one-time password be generated based upon a concealed ID and concealed equation stored in the stamp, and having it be sent to the authentication server.

Note that it is needless to say that any network means including LAN or the like other than with WiFi may be used. On the other hand, if a stamp equipped with a dot code reader or optical code reader as described above is used, a one-time password can be sent from an authentication server to the stamp simply by placing the stamp on the touch screen of a user's smartphone, and the one-time password may be sent to the authentication server for authentication. Alternatively, upon checking the one-time password with the stamp, authentication may be confirmed by sound output, confirmation light with LED or the such, or vibration by the stamp. If the stamp is equipped with a display, the result may be displayed on the stamp.

Note that it is possible to confirm whether or not a stamp has executed correctly if the stamp ID or stamp code acquired by the smartphone by stamp stamping on the touch screen to the stamp is sent to the stamp, and if the data received by the stamp, and the stamp ID and stamp code issued when the stamp was stamped are collated. Confirmation of misrecognition may be performed as a stand-alone, or by transmitting the information to the authentication server after collation confirmation, reliability of the system lowered by misrecognition of the stamp can be restored. Needless to say that the confirmation of misrecognition as described above can be used together with any practical example.

When BLE (including classic Bluetooth) is installed as a communication function, the stamp address is stored as the BLE device name for each stamp as in the above example, and the stamp ID and the stamp address are registered with a linkage between them on the authentication server. Furthermore, the smartphone ID may also be registered on the authentication server, and collation with the smartphone being used may be enabled. When a smartphone is stamped on a touch screen of a stamp-compatible application at a store or facility, a BLE installed in the stamp in a sleep state undergoes an advertising process as a peripheral to the central by a stamping operation (switch is ON). At the same time, the authentication server obtains a stamp ID, sends a stamp address corresponding to the stamp ID to the smartphone, and the central pairs with a BLE device having the stamp address. Upon completion of pairing, authentication and services similar to those with WiFi communication by stamp stamping can be implemented. Furthermore, when using BLE as a beacon, if a stamp address is stored as data for an advertising process and it is distributed unilaterally, even if the central and peripheral are not connected, the application displaying a stamp touch screen can obtain a stamp address instantaneously. Thus, the smartphone side (including the authentication server) can authenticate the stamp. In this case, since the central and the peripheral are not connected, data cannot be exchanged because the central is limited to acquiring one-time addresses. Here, to eliminate the possibility of a central operating on another smartphone acquiring and using the stamp address, it is desirable to advertise a one-time address by making the stamp address variable. In addition, the stamp ID or stamp code may be included in the peripheral data at the time of stamping. As a result, it is possible to authenticate by collating the stamp ID or stamp code acquired by a stamp being stamped on a smartphone. Note that it is needless to say that communication means with smartphones other than BLE may be used. The communication functions such as WiFi and BLE and the information reading functions such as the dot code reader and the optical code reader as described above may be used in any combination in all of the embodiments.

By placing a stamp in the segmented area, registering the stamp address and the like in a peripheral, the smartphone central acquires the data from entering/exiting of the area, and the user can obtain vibrational or sound output, or a display on the smartphone, that can perceptually urge the user to promptly perform stamping. Note that there may be a plurality of the above-mentioned areas, and different stamps may be set for each area, and the stamp address may be registered in the peripheral so that a new service can be provided every time the area is moved. Good. Note that the stamp installer may move the stamp and provide the same service.

If the stamp is affixed to a wall or poster, since there is no need for manpower, service can be provided more easily. Furthermore, if the smartphone transmits the data acquired from the peripheral to the authentication server, the smartphone can acquire a touch screen that can access new services and the contents thereof, and a strong motivation for stamp stamping can be obtained. Needless to say that it is also possible to provide different services depending on the position upon movement. Here, if the installation position of a stamp (including the installation position of a moved stamp) is also registered on the authentication server, a smartphone can track and search for a stamp with its GPS function. Furthermore, if the stamp is equipped with a GPS, the position may be transmitted to the smartphone as data from a peripheral.

(Personal Authentication of an Electronic Stamp Owner)

In the storage apparatus built-in a stamp, a person's name, date of birth, address, and biometric information such as photographs, and other basic personal information may be registered. Other information such as credit card information, bank accounts, licenses, health insurance cards, and other certificates may be registered. Such information may be registered on the server. After a person selects information that can be disclosed on the person's smartphone, by stamping a stamp on another party's touch panel, the other party obtains the information by a means of communication and by having the stamp holder state the date of birth, address, and the like, identity verification may be performed. By disclosing a photo, identity verification can be done easily. Such identity information may be deleted immediately to prevent leakage of identity information. In addition, when personal authentication is performed with a device, if the person makes an approval on the touch panel of the device upon request of the provision of information from the device, by stamping the stamp on the touch panel of the device, biometric information of the user is transmitted from the stamp or server to the device and unmanned identity verification can be performed by matching it with biometric information acquired from the person on the spot (acquisition of face, fingerprint, iris, vein information, or the like by a camera or sensor set at a facility or in a device), and financial settlements, entry to important facilities, and operations of important equipment can be performed with high security. To facilitate biometric information authentication, although not shown, a fingerprint authentication apparatus or a camera may be attached to a stamp for personal authentication when the person uses the stamp. Note that the biometric information of a person can be easily registered by photographing the face, fingerprints, and iris with a camera installed on the person's smartphone, and the biometric information communicated from the smartphone may be stored in a storage apparatus built-in the stamp or registered on a server. Note that if a stamp is stolen, it may be set to refuse authentication of the stamp and information communication from the stamp or server may be stopped. Note that if a stamp equipped with a dot code reader or optical code reader is used, the user's personal information can be obtained directly by simply stamping the stamp on the touch screen of the user's smartphone without having to use the Internet. The above-mentioned personal information may include as necessary information such as membership numbers, name, address, various Internet addresses, smartphone IDs, and biometric information such as face photos. The method of personal authentication is as described above. In this case, it is desirable to enable the user to choose which personal information to disclose. Note that the user's personal information may be transmitted by an information reading apparatus by stamping a stamp set at a facility or in a device against a smartphone owned by the user. A stamp may have any shape or form, and instead of pressing a stamp on a smartphone, a smartphone may be placed on or over a stamp.

Furthermore, when using a BLE as a beacon, if a stamp holder carries a stamp and roams to various stores, facilities, or regions, the stamp address is stored as data for an advertising process, and it is unilaterally distributed, a stamp application can constantly transmit data such as a stamp address as a peripheral, an information processing apparatus equipped with a touch panel that plays a central role can acknowledge the existence of the stamp, and the information processing apparatus can catch the attention of the user by giving out signals to the stamp or a stamp holder's smartphone by outputting vibrations or sounds or by displaying to prompt the user to stamp the stamp on the information processing apparatus. With this stamping, various services can be provided to smartphone users. In such a system, information processing apparatuses may be searched to perform stamping like in treasure hunting at an event, in a museum, at an amusement facility, in a mall, or the like having many stores. Furthermore, by using a time stamp and position information at the time of stamp authentication as keys, events branched for individual users or guidance for new routes can be displayed, and thus various routings and experiences can be provided in the same venue. Furthermore, new route guidance may be provided by reading a dot code or an optical code displayed on a paper medium or a display with an information reading apparatus installed in a stamp. In addition, a game-like element in which the location information of where the user stamped a stamp while moving and the location information of where a stamp placed at a fixed location such as a store was stamped is displayed “on a map only at the time of the stamping (for example, for 10 seconds to 3 minutes) and someone else tries to track the trace” may be added.

(Financial Settlements with an Electronic Stamp)

In an example of a financial settlement, when the store side applies a stamp on a touch screen of a purchaser's smartphone and the stamp is authenticated, the item names, the unit prices, the total payment amount, and the like of purchasing items sent from the store side system to a settlement server are received by and displayed on the smartphone, and after the purchaser confirms and approves the display contents, the purchaser selects a payment method, and information on a pre-registered bank account for withdrawal payments for financial settlements, credit cards, prepaid cards, or the like are transmitted to a settlement server, and when the payment server makes an approvement and a settlement, the store side system is immediately notified, and the purchase/payment procedure of the items is completed. Furthermore, icons such as “settlement,” “cancellation,” “single payment,” and “split payment,” and the like may be displayed on the purchaser's smartphone for selection and settlement. Note that if a payment cannot be completed, if there is an overuse of a credit card, if there is a shortage in remaining balance for a prepaid card, or a bank account, such information may be displayed on a smartphone and recorded. In this way, payments can be made without having to issue receipts with purchased items, unit prices, payment totals, and the like, and the store side can eliminate the use of a printer, and the purchaser can record and manage purchased product information as data.

In addition, by issuing different stamp codes, by using a switchover switch on an operation unit of a stamp, any combination of processings such as “confirm purchasing items,” “settlement,” and “cancellation,” or “settlement,” “stamp granting,” and “stamp erasing,” or the like may be performed.

If you want to send money between individuals or corporations, if the sender enters the amount of money and the destination on the smartphone, applies a stamp and the stamp is authenticated, remittance information such as the destination and amount will be displayed again for confirmation, and upon approval, the remittance is notified to the receiving side and the remittance is carried out. In that case, to increase security so that a third party other than the principal cannot send or receive money, it made be set so that a password is inputted when the “settlement” icon is tapped. For this password input, if the application has a function for detecting the rotation angle of a stamp, a mark such as A can be provided for indicating the positive direction of the stamp, and the order of orientation of each placement upon placing the stamp can be set as the password. For the orientation of the touch screen (password input screen), for example, for a password set as “right (90 degrees), diagonally lower left (225 degrees), down (180 degrees), diagonally upper right (45 degrees),” it is sufficient to change the orientation of the stamp in this order while keeping the surface in contact, or to remove and place the stamp every time. To make the operation smooth, first, the stamp may be placed in the upward direction, and then the orientation may be changed for password input. Furthermore, if the sender's personal information (including biometric information) is registered on a stamp or server, the sender can be identified by a personal authentication as described above. For these financial transactions, in addition to the amount and date, classifications such as ‘Loan,’ ‘Gift,’ ‘Consideration,’ and the like may be set by issuing different stamp codes or according to the orientation of stamp placement using the stamp operation unit switchover switch. Also, the transmission side may confirm the sender and approve the transfer. Furthermore, when a stamp equipped with a dot code reader or optical code reader as described above is used, the user's personal information can be obtained from the user's smartphone via the dot code or optical code simply by placing the stamp on the touch screen of the user's smartphone. Such information may be acquired to determine whether a financial settlement can be allowed. The personal information may include information such as a settlement number, name, address, various Internet addresses, smartphone ID, and biometric information such as a face photo as necessary.

While the smartphone receives and displays the items, unit price, total payment amount, and the like for items for purchased sent from the store-side system to the payment server, bar codes, QR codes, or the like affixed or printed on the items purchased by the user may be photographed with the user's smartphone, the items, unit price, total payment amount, and the like for items for purchasing may be tabulated, displayed, and confirmed, and then the store-side may apply a stamp to obtain the information by an information obtaining apparatus, may display and confirm the information on a store-side system, and may perform a settlement. A display may be installed on the stamp, and the information may be displayed, confirmed, and settled.

(Granting/Erasing of Points, Coupons, and Stamps Using an Electronic Stamp)

In the use with points, coupons, and stamps, for a user to acquire a benefit, the user can acquire the benefit if a stamp is stamped on a touch screen displayed on a user's smartphone and authenticated by an approval server. In this case, a different stamp code may be issued by a switchover switch of the stamp operation unit and the provided service may be changed for each stamp code, for example, such as for “point granting,” “point erasing,” “cancellation of operation,” “point granting/erasing,” “stamp granting/erasing,” and “coupon granting/erasing.” Here, if two types of processings such as “granting/erasing” are performed with one stamp code, a mark indicating orientation may be provided on the stamp, and the processing of “granting” may be performed when the stamp is placed in the vertical direction on the touch image, and the processing of “erasing” may be performed when the stamp is placed in the horizontal direction. Even by taking into consideration human operability, since up to a total of eight directions, that is, vertical and horizontal directions and diagonal directions, can be reliably recognized, even more functions may be assigned. Needless to say that the corresponding processings may be selected by a touching operation on a smartphone with a stamp with removal and placement. Furthermore, a variety of services may be provided easily by updating and communicating the contents of services stored in a stamp. Since the acquisition status and usage status of user points, coupons, and stamps can be stored on the server, services can be provided via the server. However, by installing a stamp authentication function in an application, and by having only direct communication between a stamp and smartphone via a BLE or the like, it is possible to provide authentication and services in an environment that does not use the Internet. As a result, information leakage from the server can be prevented. A method that does not use a server can also be used for personal authentication, and the like, and leakage of personal information can be prevented. The information stored in a stamp can be updated from any information processing apparatus such as a smartphone having a communication function, either wired or wireless. Note that authority to update the information may be granted only to specific persons, and the authority may be exercised upon authentication of personal information including the human body information.

Furthermore, when using a stamp equipped with an above-mentioned dot code reader or optical code reader, the user's personal information can be obtained directly without going through the Internet simply by placing the stamp on the touch screen of the user's smartphone. The personal information may include information such as membership numbers, name, address, various Internet addresses, smartphone ID, and biometric information such as a face photo as necessary. The method of personal authentication is as described above.

(Use in Ticketing)

A stamp ID or stamp code that approves an acquired ticket is registered on an authentication server in advance, and by stamping the corresponding stamp on a touch screen at the time of entry, allowance of entry is approved, and the user's smartphone displays the result. Furthermore, to strengthen security, by enabling a stamp to read the ticket number or the like via an optical code or dot code from the user's smartphone, collation with the ticket number or the like stored in the stamp may be performed and permission of admission may be indicated with a sound, confirmation light with LED or the like, or vibration. Furthermore, for a stamp equipped with a communication function, an acquired ticket number, or the like may be transmitted to the authentication server for verification. The result may be transmitted to the user's smartphone, or may be confirmed by sounds, light, vibration, or the like from a stamp. If a display is installed on the stamp, the result may be displayed on the stamp. An optical code or dot code displayed on the user's smartphone may include a one-time password by transmission from the cloud. As a result, security can be furthermore improved.

In addition, when a purchaser moves an item in the store from a shelf to a basket using barcode scanning, RFID, sensors, or the like, by reading a dot code printed on an item or on an affixed sticker with a stamp equipped with a dot code reading apparatus and making a payment after authentication using an electronic stamp, it is possible to complete a payment in the state where the purchaser is in the store with certainty.

(Installation of GPS and Communication Function in a Code Generation Apparatus)

An embodiment in which a GPS and a communication function are installed in an electronic stamp which is a kind of code generation apparatus will be described. It is assumed that the user carries the electronic stamp and uses it in various places. When a user possesses an electronic stamp, the corresponding stamp ID of the electronic stamp and user information is registered on the authentication server. By tracking the GPS installed in an electronic stamp, when an electronic stamp is stamped on a touch panel (including those of smartphones and tablets), an authentication server obtains the location information of the electronic stamp based on the stamp ID of the authenticated electronic stamp, and thus can specify where the electronic stamp was used. Even if the number of stamp IDs of the electronic stamp is limited, if position information from a GPS can always be tracked, it can be determined whether or not the electronic stamp is that possessed by a specific user. However, it is difficult for a GPS to recognize positions indoors. Note that if an electronic stamp and the smartphone ID of a smartphone owned by a user are registered together on an authentication server, even if location information from the GPS installed in the electronic stamp cannot be continuously tracked, the usage status of the electronic stamp is transmitted to the user's smartphone and it is possible to disable the use of the electronic stamp unless the user makes an approval. This also allows the user to approve the use of the electronic stamp by a third party.

By installing a communication function in an electronic stamp, it is possible to realize the following wide usage.
By using communication functions (including wireless networks of carriers and the like, independent private networks such as those with beacons, and local networks provided by shopping malls and the like) upon the authorization of an electronic stamp, it is possible to prevent improper stamp stamping by unauthorized modification of browsers and applications outside of the primary participation area, and by specifying the electronic stamp to be used at the ID coordinate position of an electronic stamp, it is possible to have the set usage period and usage content be reflected.
   Initial participation by
If an electronic stamp has communication functions (including wireless networks of carriers and the like, independent private networks such as those with beacons, and local networks provided by shopping malls and the like), performs position authentication in installed areas (stores, event venues, and the like), and detects movement to the outside of the area registered through communication, it becomes possible to prevent unauthorized use and send new action instructions to devices such as a smartphone for the use of the electronic stamp in the destination area.
By recognizing and recording a time stamp on a communication server connected to a network (including wireless networks of carriers and the like, independent private networks such as those with beacons, and local networks provided by shopping malls and the like) when using an electronic stamp, and by having a smartphone browser application or dedicated application that detected the coordinate position of the stamp records the time stamp, it is possible to determine illegal use when a stamp is newly used at an improbable destination based on the recorded position and time.
If an electronic stamp itself has a communication function (including wireless networks of carriers and the like, independent private networks such as those with beacons, and local networks provided by shopping malls and the like), by combining location information and a time stamp indicating where the stamp was used, it is possible to perform a unique authentication. In addition, by installing a notification function such as an issuing unit or a vibration unit in an electronic stamp, it is possible to notify the user that the electronic stamp is in a usable area or an event has occurred.
By authenticating with an electronic stamp and a smartphone as a set, it is possible to assume an environment that “a smartphone holder is definitely at the place where the stamp is placed,” there is double merit of providing merits allowed to those that “continuously stay in a specific place,” and “actions that only the stamp carriers are allowed” by having an electronic stamp move “with the user.”

In addition, according to the present invention, it has become possible to realize the following functions that have been difficult with conventional electronic stamps.
Since an operation unit is provided on the stamp and a plurality of conductive patterns can be switched in stages during the execution of a predetermined operation, and a large number of codes can be issued according to the combinations, and thus it is possible to provide a large number of stamps with different codes.
It is possible to issue a plurality of codes with a single stamp by switching a plurality of different conductive patterns by providing an operation unit on the stamp and carrying out predetermined settings.
Multiple codes can be issued with a single stamp by providing multiple areas where the human body can touch the stamp and by changing the conduction path.
A large number of conductive patterns can be set by providing a setting unit on the stamp and setting whether or not conduction is to be made for each of the plurality of electrodes, thus making it possible to manufacture a large number of stamps with different conductive patterns with one type of housing.

Furthermore, although in the above embodiment, the dot code (dot pattern) is exemplified as information that can be read by the code generation apparatus, in the present invention, any type of information that can lead to the generation of a code in the code generation apparatus is sufficient, and the form or the like is not necessarily limited. For example, QR codes (registered trademark), barcodes, color codes, or the like can be adopted as the predetermined information C.

While various embodiments using the code generation apparatus have been described above, the present invention is not limited to these embodiments, and the code generation apparatus can be used for various other purposes.

In addition, the embodiments in this specification and the drawings can be combined in various ways.

Furthermore, although in the present specification and the embodiments in the drawings, the code generation apparatus is described as being in contact with the touch panel 31, the condition of the electrodes of the code generation apparatus is not limited to being in contact with the touch panel, and as long as the capacitance used for contact detection determination by the touch panel can be changed, the code generation apparatus can be above the code detection area of the touch panel, and the functions of the present invention can be realized even with a touch panel having a hovering function.

As long as the touch panel 31 of the code recognition apparatus 3 has a multi-touch function, in addition to a projection capacitive type, a surface capacitive type, a resistive film type, an ultrasonic surface acoustic wave (SAW) type, an optical type, an electromagnetic induction type, or a combination type touch panel thereof may be used.

### Eighth Embodiment

### (Overview of an Information Processing System)

In the present invention, first, the code generation apparatus 120 (including the code generation apparatuses 1, 111, 112, 112a, 115, 117, 117a, 117b) having one or more electrodes 5 on the bottom surface (or on the inside) of the housing is brought into face contact or substantially brought into face contact with a touch panel 31 of a first information processing apparatus 310 (including code recognition apparatus 3) having or connected to a touch panel 31 that detects one or more positions by detecting changes in physical quantities. Then, the touch panel 31 detects a physical quantity or a change thereof of one or more electrodes 5 arranged on the bottom surface of the housing 2 on which a conductive member connected to the electrodes 5 is incorporated, and a first information processing apparatus 310 recognizes an electrode code corresponding to the electrode pattern (including the pattern codes described in the range from the description of FIG. 1 to up to the descriptions of the seventh embodiment) based on the detected size, shape, geometrical arrangement of the one or more electrodes 5 arranged on the bottom surface of the housing, the amount of the detected physical quantity, or the detected time change thereof. An electrode 5 may be formed in a convex shape with a metal or a conductive molding or member, and may be of any structure as long as the touch panel 31 can detect a physical quantity thereof. Furthermore, the line-shaped conductive member connected to an electrode 5 may be formed in a plane together with an electrode 5 by printing or plating, or may be provided attached directly above or attached substantially directly above an electrode 5.

The geometrical arrangement here referred to is an arrangement pattern formed by a plurality of detected electrodes 5. Arrangement patterns that are similar to each other are regarded as identical, and unique arrangement patterns are converted into numerical values to define electrode codes. Of course, a notation of an electrode code is not limited to a numerical value and may include letters. A line-shaped conductive member connected to a detectable electrode 5 may be electronically connected/disconnected to make the physical quantity of the electrode 5 be detected/not detected in a time series, and the time intervals between each of these may be changed like a Morse code and the code may be converted into a numerical value, or time-series data may be formed by changing the magnitude of a physical quantity over time. For example, the conduction or disconnection of a plurality of arranged electrodes 5 may be changed in a time series and a time series electrode pattern may be formed based on the history of the electrode patterns detected by the touch panel 31. In this way, a large number of unique electrode codes can be generated by the combination of geometric arrangements and time series. In such a case, an apparatus can be identified even if it does not have a unique device ID. Furthermore, time-series data formed by changing the size, shape, and geometrical arrangement of the detected electrodes 5 may be used as an electrode code. Needless to say, any combination of the above time-series data can be used to generate time-series data for electrode codes. On the other hand, in a case where only one electrode 5 is to be detected, an electrode code may be defined by the size of a detected physical quantity, the shape of a detected electrode 5, and a time series thereof. Furthermore, an electrode code may be defined by any combination of the detected size, shape, geometric arrangement, and detected physical quantity of electrodes 5. Based on at least a part of this electrode code, a first information processing apparatus 310 recognizes a code generation apparatus 120 equipped with a communication processing unit 32 (including the wireless communication unit of the code generation apparatuses 117, 117a, and 117b), the communication processing unit 32 and the first information processing apparatus 310 enter a connected state, and information is transmitted and received. Furthermore, information processing based on the information transmitted and received may be performed. Note that the above-mentioned “in (into) surface contact or substantially in (into) surface contact” for a code generation apparatus corresponds to a case where a plurality of electrodes 5 are provided at the bottom of the code generation apparatus, and in the case of a single electrode 5, a code generation apparatus may be brought into contact or substantially brought into contact. In the following practical examples, the code generation apparatus will be described as “in (into) contact or substantially in (into) contact” and “in surface contact or substantially in surface contact” situations are included. Here, the touch panel method may be any method such as a resistive film method, a surface acoustic wave method, an infrared method, an electromagnetic induction method, a capacitance method, and the like. Hereinafter, practical examples are described for cases where the capacitance method is used, which is widely used in smartphones and tablet terminals (the first information processing apparatus 310, and the code recognition apparatus 3 is included). However, any touch panel 31 may be used as long as the described features can be realized with the touch panel 31.

As a method of connecting a first information processing apparatus 310 with a communication processing unit 32 of a code generation apparatus 120 upon the recognition of an electrode code, a device ID that identifies a code generation apparatus 120 may be transmitted to the first information processing apparatus 310, the first information processing apparatus 310 or a third information processing apparatus 330 (which may be an authentication server or the cloud) connected to the first information processing apparatus 310 may authenticate the device ID, and the code generation apparatus 120 may be identified. For example, assuming that the electrode code is “1051,” a communication processing unit 32 having “C-Stamp1051” including “1051” as a communication address is connected to a first information processing apparatus. Note that a communication address may be a part of the electrode code ‘1051’, for example, ‘C-Stamp51’ which includes the lower two digits, or electrode code-communication address tables as exemplified in FIGS. 45 to 51 below may be set in advance, and a first information processing apparatus 310 may be connected to a code generation apparatus 120 having a communication address corresponding to an electrode code recognized by the first information processing apparatus 310. Furthermore, a function F(N) capable of acquiring a communication address may be set and when an electrode code N is inputted as a parameter, a first information processing apparatus 310 may be connected to a code generation apparatus 120 having the communication address. In this case, the first information processing apparatus 310 is a host, and the code generation apparatus 120 is a guest. To perform such processing, a capacitance type touch panel 31 of a first information processing apparatus 310 is to make contact or substantially make contact with the electrodes 5 arranged on the bottom surface of the housing of a code generation apparatus 120, to read the electrode 5 arrangement pattern from the change in capacitance, and the first information processing apparatus 310 to recognize the corresponding electrode code and communication address, and to identify the code generation apparatus 120 in contact or substantially in contact with the first information processing apparatus 310. A program suitable for controlling the process of connecting the code generation apparatus 120 may be installed in the first information processing apparatus 310, the host. Note that by applying a predetermined method, the code generation apparatus 120 may become a host, and the first information processing apparatus 310 may become a guest.

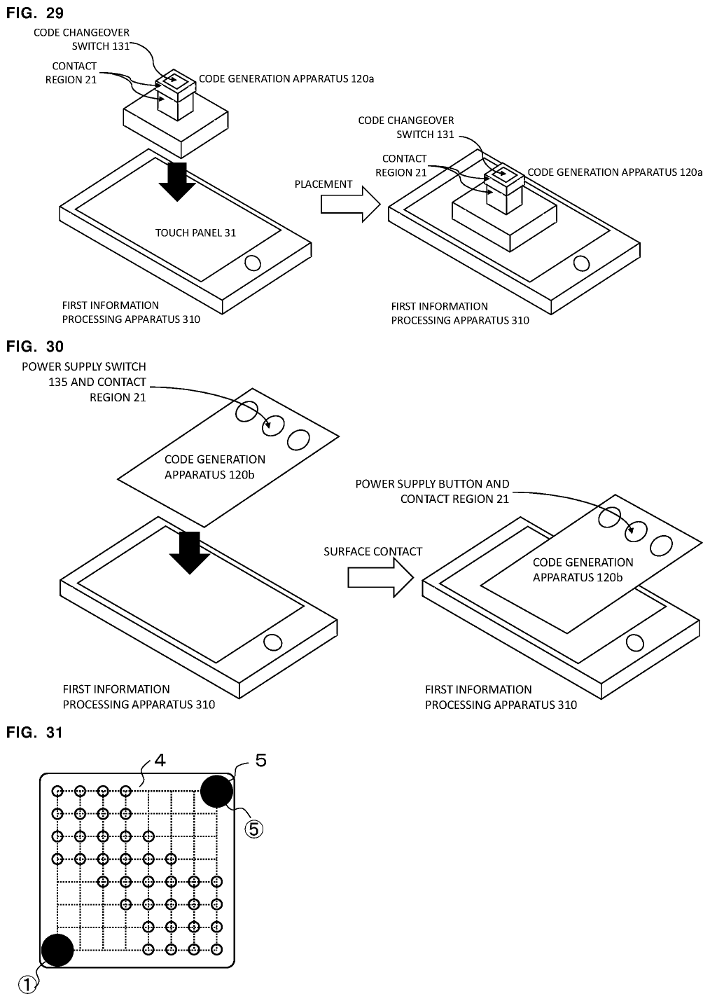

FIGS. 29 and 30 are diagrams showing examples of external configurations of information processing systems comprising a code generation apparatus 120 and a first information processing apparatus 310 according to an embodiment of the present invention. The shape of a code generation apparatus 120 may be any of a three-dimensional shape such as a stamp or a seal, a plate shape (board shape) such as a card or a coin, or any other shape that can be realized. Here, in FIGS. 29 and 30, practical examples are shown in which a first information processing apparatus 310 is a smartphone and a code generation apparatus 120 with a communication processing unit 32 is a stamp 120a and a card 120b. A first information processing apparatus 310 may be an information processing apparatus such as a tablet, a wearable computer, or the like having a touch panel 31.

The information processing system shown in FIG. 29 is comprised of a code generation apparatus 120a that generates a stamp-type electrode code and a first information processing apparatus 310 that recognizes the code, and by pressing the code generation apparatus 120a onto the touch panel 31 of the first information processing apparatus 310, a communication processing unit 32 of the code generation apparatus 120a is connected to the first information processing apparatus 310 to transmit and receive information, and perform information processing. Note that pressing is an operation of pressing the code generation apparatus 120a onto the touch panel 31, and a switch for detecting the pressing may be provided in the code generation apparatus 120a, and the communication processing unit 32 may be in a standby state when there is a pressing. In addition, instead of pressing down, the code generation apparatus 120 may be brought into contact or substantially brought into contact with the touch panel 31, and by operating a code changeover switch 131 (including a push button switch, a code switch, a slide switch, a dial switch, a toggle switch, a rotation switch, a changeover switch and a DIP switch) provided in the housing 2 according to the method described in the section of the present description [Overview of a pattern code switching method] or by having a human body touch the one or more contact points on the housing 2 (including human body contact conductive members and human body contact electrodes), the code generation apparatus 120a may be caused to generate a physical quantity so that the arranged electrodes 5 can be detected and pressing can be performed. It is desirable to have the electrodes 5 be detected by a touch panel 31, by having the electrodes 5 be electrically connected through a connected conductive member when a human body touches the housing 2 on which a conductive member connected to the electrodes 5 is incorporated.

Here, a circuit switch linked to a changeover switch may be provided somewhere along the above conductive member, so that when it is turned ON by a switch operation, there is conduction and an electrode 5 is detected, and when it is turned OFF by a switch operation, conduction is disconnection and an electrode 5 cannot be detected. Note that a conductor capable of storing sufficient electricity for detecting an electrode 5 may be provided so that an electrode 5 can be made conductive without having to be touched by the human body. In that case, such electrodes 5 and electrodes 5 detected by touching by a person may be combined. In FIG. 29, the code changeover switch 131 and the human body contact conductive member 21 are drawn in the upper part of the handle. However, it may be provided on the side of the handle or on the pedestal to which the handle is attached. Furthermore, by forming contact regions in a plurality of regions on the surface of the housing 2 and by having at least one of these regions make contact with the human body or by holding at least one of these regions by hand, respective contact regions may be made conductive with connected electrodes 5 via line-shaped conductive members. The codes may be made switchable by changing the fashion of making contact with or holding any one of the contact regions 21. A film or sheet made of a non-conductive material may be provided on the surface of the bottom region of the housing to protect and conceal the electrodes 5. Furthermore, the protective member may be printed with non-conductive ink or may be coated with non-conductive material. Alternatively, the electrodes 5 may be exposed. Note that if a film is provided, AC conduction is operative, and when the electrodes 5 are exposed, DC conduction is operative. Components of a code generation apparatus 120b described below may be included.

The information processing system shown in FIG. 30 is comprised of a code generation apparatus 120b that generates a card-type electrode code and a first information processing apparatus 310 that recognizes the code, and by causing the code generation apparatus 120b to make contact or substantially make contact with the first information processing apparatus 310, a communication processing unit 32 of the code generation apparatus 120a is connected to the first information processing apparatus 310 to transmit and receive information, and perform information processing. In the case of a card, it is desirable to implement power saving because the cost and thickness of the card may increase to provide a mechanism for charging or replacing the battery. Therefore, a solar power generation apparatus may be installed on the surface of the card or power may be supplied via a USB. Of course, it is also possible to set an expiration date and have a battery that can secure power for that period be built in. Other components described for the code generation apparatus 120a may also be included.

(Basic Configuration of a Code Generation Apparatus Equipped with a Communication Processing Unit)

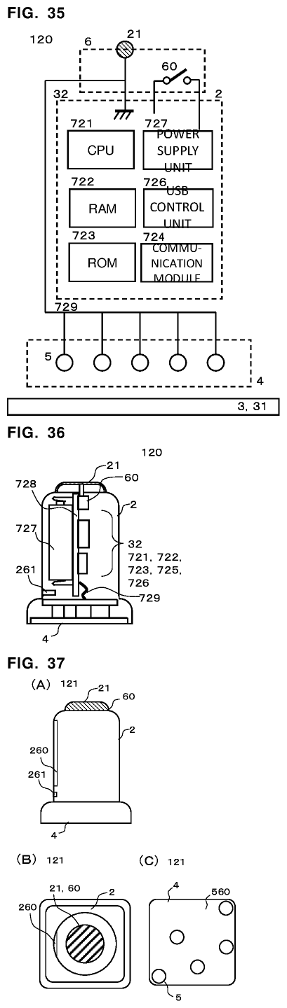

FIG. 34(A) is an example of an external view showing a schematic side view of a stamp-type code generation apparatus 120, FIG. 34(B) shows a schematic top view, and FIG. 34(C) shows a schematic bottom view. FIG. 35 shows a schematic configuration diagram of a code generation apparatus 120. FIG. 36 shows a schematic sectional view of a side of the code generation apparatus 120 dissected in the vertical direction.

The basic configuration of a code generation apparatus when the physical quantity is capacitance is, for example, as follows. As shown in FIG. 34(C), the code generation apparatus is comprised of a plurality of electrodes 5 placed in a geometrically characteristic arrangement and one or more conductive contact regions 21, and a contact region 21 is electronically connected to a predetermined electrode 5 by making contact with the human body, and is also electronically connected to the other electrodes 5, and the arrangement of the geometrically unique electrodes 5 detected by a touch panel 31 is detected. In other words, a unique electrode pattern is formed under a unique conducting state formed by the electrodes 5 and line-shaped conductive members 729.

Note that an electrode pattern may be formed in which at least one of the electrodes 5 is not connected to a contact region 21. The electrodes 5 that are not connected to contact regions 21 may be provided with a storage unit with energy sufficient for detection by a touch panel 31. By having the code generation apparatus 120 come into contact with or substantially come into contact with the touch panel 31, the electrode pattern is detected and an electrode code converted into a numerical value is recognized by a first information processor 310. When the code generation apparatus 120 has one electrode 5, it may recognize the electrode code that quantifies the size and shape of the detected electrode 5, the size of the detected physical quantity, and their temporal changes. Note that if the code generation apparatus 120 has only one electrode 5, an electrode code derived from a numerical value based on the size or shape of the detected electrode 5, the size of a detected physical quantity, or a time series thereof may be recognized.

As shown in FIG. 35, in a basic configuration, a communication processing unit 32 comprises a CPU 721, a storage means, a communication module 724, and a power supply unit 727. As the storage means, included are both a non-volatile memory 723 such as a ROM, a flash memory, and the like, and a volatile memory 722 such as a RAM. A ROM 723 may store at least a program for implementing communication processing by the communication processing unit 32 and a device ID of the code generation apparatus 120. A RAM 722 may store various information transmitted to and received from the first to third information processing apparatuses and other devices. The areas of ROM 723 and RAM 722 may be controlled by a program. The communication module 724 includes those of wireless and wired connections such as those of wireless LAN, WiFi, Bluetooth, BLE (Bluetooth Low Energy), RF (Radio Frequency) connection (high-frequency connection), infrared communication, and the like. Here, a communication address of a communication processing unit 32 corresponds to an ID of the communication processing unit 32 necessary for the first information processing unit 310 to connect with other devices, and a MAC address (Media Access Control address), a BD address (Bluetooth Device address), an SSID (Service Set Identifier, a wireless LAN access point ID number), an ICCID (Integrated Circuit Card Identifier, an ID number for an IC card such as a SIM card), an IP address (Internet Protocol address), and the like, which are IDs for the communication processing unit 32 may be used. The power supply unit 727 is a rechargeable battery or dry cell battery, and as methods of charging, included are a method of supplying external power through a USB connection, a method of converting light energy into electrical energy using a photoelectric conversion element, a method of using an electromotive force generated by electromagnetic waves from an external wireless device, and the like. However, the method is not limited to these methods. Also, combinations of multiple methods may be used.

(Applied Configuration of a Code Generation Apparatus Equipped with a Communication Processing Unit)

In addition to the basic configuration described above, the communication processing unit 32 may comprise a code generation recognition switch 132 that recognizes an operation or pressing by a code changeover switch 131, LED lights that indicate a communication status, an error, an energization status, a charging status, and the like. Furthermore, it may comprise an apparatus with a display, an apparatus with a vibrator, an audio output apparatus, and the like as alerting means that are easy to grasp sensuously and are appealing to the senses of sight, touch, and hearing for conveying various information such as a communication status, an error, an energization status, a charging status, and the like. And it may also be configured with at least one of a clock function (including a timekeeping function, and the like), a Bluetooth (including a BLE), beacon, GPS receiver, USB control unit, optical conversion processing unit, electromagnetic conversion processing unit, dot code reader, display, and the like. Furthermore, the system may be configured with a code generation apparatus 120 having a touch panel recognition sensor 134 that itself detects whether or not a code generation apparatus 120 has

The code generation recognition switch 132 is used to ensure that the communication processing unit 32 is properly connected to the first information processing unit 310. For example, when there is a plurality of code generation apparatuses 120 with the same communication address for the communication processing unit 32 in the vicinity of the first information processing unit 310, it is not obvious which communication processing unit 32 should be connected. Such a situation may not occur when code generation apparatuses 120 are used by a business operator, since a business operator can manage the code generation apparatuses 120 so that code generation apparatuses 120 having the same communication address do not co-exist in the same area. A card-type code generation apparatus 120 can be used as a point card, a financial settlement card, a trading card (including game cards), various membership cards, an authentication card, an advertisement card, and the like, and a stamp-type code generation apparatus 120 can be used personal electronic seal and the like. However, due to the configuration and mechanism of a code generation apparatus 120 (as shown in examples from the description of FIG. 2 to the descriptions of the seventh embodiment), the number of electrode patterns is limited to several dozens to several thousands. Therefore, there is a high possibility that a large number of users possessing code generation apparatuses 120 having the same electrode code gather in the vicinity of a certain first information processing apparatus 310 at the same instant. Therefore, the first information processing apparatus 310 may be set to enter a connection standby state when a code generation recognition switch 132 is turned ON by an operation of a code changeover switch 131 or by pressing of a code generation apparatus 120. In other words, a first information processing apparatus 310 is in a state where a communication address of a communication processing unit 32 can be searched, and if the communication address corresponds to the electrode code recognized by the first information processing apparatus 310, the first information processing apparatus 310 may be enabled to connect to the communication processing unit 32. In most cases, this would be sufficient. However, if another user who has a code generation apparatus 120 with the same communication address operates or presses the code changeover switch 131 at the same time, even though the other user does not bring his/her code generation apparatus 120 into contact with or substantially bring it into contact with a touch panel 31 of the first information processing unit 310, the communication processing unit 32 of the code generation apparatus 120 of the other user may also become a connection target. Therefore, if a code generation apparatus 120 is equipped with a touch panel recognition sensor 134, only the communication processing unit 32 of the code generation apparatus 120 that makes contact or substantially makes contact with the first information processing unit 310 becomes the connection target, and thus no connection based on misidentification occurs. As another method, a communication processing unit 32 of a code generation apparatus 120 may be equipped with a clock function 133 and a communication address that includes time information of a pressing operation may be generated, and upon selecting a communication address that includes the time information within a predetermined time range based on the time information of when the first information processing unit 310 has made contact or substantially has made contact with the code generation apparatus 120, a connection may be established. In this case, the communication processing unit 32 that can set the communication address in a variable manner is used. Furthermore, when a plurality of code generation apparatuses 120 having the same communication address are present, the plurality of code generation apparatuses 120 may be sequentially connected to the first information processing apparatus 310, time information of when a code generation recognition switch 132 is turned ON may be transmitted from the clock function 133 of the code generation apparatus 120, and a connection with the target code generation apparatus 120 may be established if the time information of the generation apparatus 120 is within a predetermined time range from the time when the first information processing unit 310 has made contact or substantially has made contact with the code generation apparatus 120.

Note that as a clock function 133 provided in the communication processing unit 32, a real-time clock may be provided to enable the issuance of one-time passwords and to output absolute and relative times. Furthermore, it may serve as a counter that marks predetermined time intervals. A communication processing unit 32 transmits such time information or information that changes with time to an information processing unit.

A beacon is a transmitter of BLE radio waves. Since a radio wave intensity is attenuated in inverse proportion to the square of the distance from the beacon, if the first information processing apparatus 310 receives a signal (radio wave) transmitted from a beacon of a code generation apparatus 120, the first information processing apparatus 310 can calculate the relative distance of the code generation apparatus 120 equipped with the beacon using a dedicated application. Note that in recent years, smartphones that can receive beacon signals without having to run a beacon signal receiving application have also appeared. Therefore, as shown in FIG. 29 or FIG. 30, when the code generation apparatus 120 makes contact or substantially makes contact with a first information processing apparatus 310, if a plurality of code generation apparatuses 120 having the same communication address that includes at least a part of an electrode code or the same communication address that corresponds to at least a part of an electrode code exist in the vicinity of the first information processing apparatus 310, a connection may be established with the nearest code generation apparatus 120. Note that information recorded in a storage medium of the code generation apparatus 120 may be transmitted by a beacon signal to a first information processing apparatus 310 that is ready to receive a beacon signal when an electrode code is recognized with a dedicated application. On the other hand, the first information processing apparatus 310 may send out a beacon signal when an electrode code is recognized with a dedicated application, and a code generation apparatus 120 equipped with a BLE may identify the first information processing apparatus 310 and establish a connection based on radio wave intensity. In this case, the beacon signal should include the communication address of the first information processing apparatus 310. In the above practical example, since the reception or transmission of a beacon signal is executed when the first information processing apparatus 310 recognizes an electrode code, the BLE of the information processing apparatus 310 may be caused to turn ON only at that time and thus significant power saving can be realized. Note that it is needless to say that this method may be used in combination with the previously described methods of identifying a code generation apparatus 120.

If a code generation apparatus 120 has a GPS receiver, the code generation apparatus 120 can acquire its own positional information, so that if the information is transmitted and a first information processing apparatus 310 receives the information, the distance between the apparatuses can be calculated based on the own positional information of the first information processing unit 310 that can be acquired from its own GPS receiver, and based on this information, a code generation apparatus 120 at the same position or at the nearest position may be identified.

A USB control unit controls the exchange of information through a USB connection and the uptake of external electric power.

In a light conversion processing unit, photoelectric conversion elements (so-called solar cells) are arranged, and the light energy captured by a light receiving panel is converted into electric energy, which is used to charge a rechargeable battery.

The electromagnetic wave conversion processing unit converts electromagnetic induction energy generated from electromagnetic waves into electrical energy, which is used to charge a battery charger.

By installing a dot code reading unit, an information reading system can be constructed, expanding the range of applications. The dot code reading unit reads a dot code displayed on a display of a touch panel 31 of a first information processing apparatus 310, and information is extracted from the dot code using a dedicated application. The dot code reading unit includes those exemplified in FIG. 20 and its description. Note that the dot code may include the dot patterns described in FIGS. 90 to 97 of International Publication WO2019/004486 and those that adapt to the descriptions.

The display may show an ongoing processing and stored information as text or graphics.

The touch panel recognition sensor 134 is installed in a code generation apparatus 120 and it is a sensor for causing the code generation apparatus 120 to detect a state of being in contact or substantially being in contact with a touch panel 31.

(Applied Configuration of a Code Generation Apparatus with Electrical Electrode Pattern Switching)

When the human body touches a contact region 21 provided on the surface of the housing of a code generation apparatus 120, the human body and the electrode 5 are electrically connected to each other via line-shaped conductive members connecting the contact region 21 with respective electrodes 5, by adopting a structure in which the electrodes 5 are detected by a touch panel 31, and providing a switch of a diode or a transistor along the line-shaped conductive member, the detection/non-detection of the electrodes 5 by the touch panel 31 can be controlled by causing conduction/disconnection. Regarding the number of electrodes 5 to be energized, 5 multi-touches are possible on an iPhone, and for most Android smartphones, 5 to 10 multi-touches are possible. For some older models of smartphones, only a single-touch or multi-touches of 4 or less are possible. However, there are only a few of them, and considering market share, it is sufficient to target smartphones of 5 multi-touches.

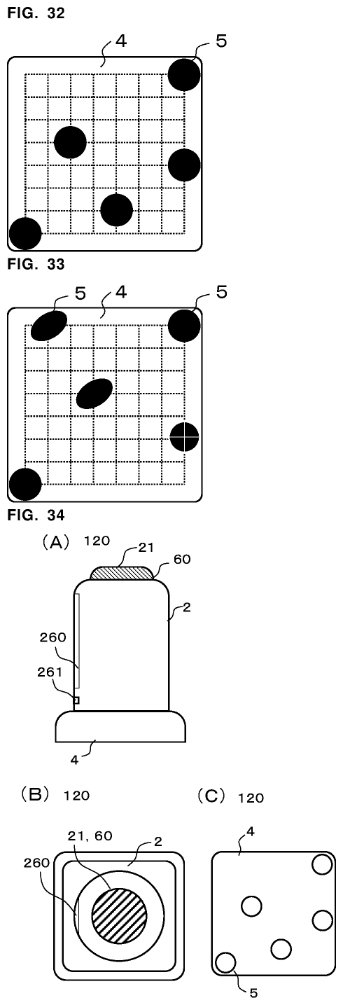

To have the electrodes 5 be detected, a capacitance of about 3 pF or more is usually required for enabling detection between a smartphone (touch panel 31) GND and an electrode, and taking into account a condition where the smartphone is covered with a thick protective sheet and placed on a wooden desk, for circular electrodes 5, it is desirable to provide electrodes 5 having a diameter of about 7.5 to 8.5 mm Note that the shape may be elliptical or rectangular, and an area of 44 to 57 mm² is preferable. Also note that the ratio of the short side to the long side is preferably 1/2 or more, which is the ratio of the tip of a human finger in vertical contact with a touch panel 31. FIG. 32 shows a schematic view of an electrode arrangement as seen through the bottom surface 4 of a code generation apparatus 120. The grids shown by the broken lines are auxiliary lines indicating the placement intervals of the electrodes 5, and the white circles placed at the grid points in FIG. 31 indicate possible placement positions for the electrodes. In FIG. 33, circular electrodes and elliptical electrodes are placed in a mixed manner, and the circular electrodes have a diameter of 8 mm and an area of 50.265 mm², and the elliptical electrode is set to have a major axis of 10 mm, a minor axis of 6 mm, and area of 47.124 mm²′ which is substantially equal to the area of a circular electrode. Since there are smartphones that detect two electrodes 5 as one electrode 5 centered either between the two electrode edges or between the electrode centers when the distance between the edges of adjacent electrodes 5 is shorter than a predetermined distance, an ellipse or a rectangle can be used to suppress such phenomenon by increasing the predetermined distance between adjacent electrode edges without changing the distance between the electrode centers. Specifically, based on the results of experiments with such smartphones, it is desirable to have the distance between the electrode edges be 13 mm or more, in principle. Except for some smartphones, the distance may be 12 mm or more. This makes it possible to set a large number of placement positions for the electrodes 5, and it is possible to increase arrangement patterns for the electrodes 5, and thus electrode codes.

The size of the bottom surface region of a code generation apparatus 120 is dependent on the size of the display of a smartphone. Since the majority of small-sized smartphones in distribution have a display with a short side width of about 50 mm, it is desirable to have the width of the bottom surface region of the code generation apparatus 120 to be within 50 mm. Note that it is possible to increase the number of electrode codes by making the bottom surface region rectangular and increasing the number of electrode placement positions. However, the housing 2 of the code generation apparatus 120 becomes large, while it is necessary to press the code generation apparatus 120 according to the predetermined area of the display, thus leading to a lack of convenience and design quality. It is desirable to have the effective area for placing the electrodes 5 on the bottom region of 50×50 mm be within 49×49 mm taking into account the overlap of the thickness of the sides of 1 mm.

Regarding a detection of electrodes 5 of a touch panel 31, the touch panel 31 normally used in a smartphone is of a projection type capacitance method, and transparent electrodes are provided in a grid pattern on the inner layer of the touch panel 31 at intervals of 4 to 5 mm, and when the touch panel surface is touched with a finger or an electrode 5, the capacitance of a transparent electrode in the vicinity changes, and by converting the capacitance change into electric current or voltage and reading the value, the position of the touching on the touch panel is detected. In other words, since physical quantities are detected at intervals of 4 to 5 mm, the center coordinate values of the finger or electrode 5 that is in contact or substantially in contact are calculated by an algorithm unique to the controller of each touch panel 31, and thus the coordinate values of the electrode 5 detected by touch panels 31 (including information processing apparatuses) are deviated. With a simple algorithm in which interpolation curve interpolations are not performed, the detection of physical quantities at 5 mm intervals will cause a maximum coordinate value deviation of 5 mm/2=2.5 mm Therefore, for the detection of electrodes 5, a coordinate value deviation of 2.5 mm should be taken into account, and to recognize the arrangement of electrodes 5, it is desirable to place electrode 5 on the intersections (grid points) of grid lines with an interval of 5.5 mm or more, which is based on a margin of 10% with respect to 2.5 mm×2=5 mm. As a result, the first information processing apparatus 310 can accurately recognize whether or not the electrodes 5 are arranged at the grid points. In a practical example, assuming that the diameter of a circular electrode 5 is 8 mm, then in a 49×49 mm area where the electrodes 5 can be placed, 49-8=41 mm, and if the placement interval of the electrodes 5 is 5.85 mm as shown in FIG. 31, then 5.85×7=40.95 mm, which is within 41 mm. As a result, the electrodes 5 can be placed at any of the 8×8 grid points. When the first information processing apparatus 310 is a smartphone and the code generation apparatus 120 is a stamp or a card, it is desirable to place the electrodes 5 in a square or rectangular area to fit the rectangular-shaped display of the smallest smartphone among adaptable models, to form as many electrode codes as possible. In the practical example shown in FIG. 31, if reference electrodes 5 are placed at (1) (circled number) and (5) (circled number) at the diagonal edges of this square area, that is, at the corners of the bottom region of the housing, so that the distance between the placed electrodes is at a maximum, placeable positions for the other three information electrodes 5 are 38 points. The remaining information electrodes 5 may be placed at one or two of the remaining corner points. However, they must be placed in such a way so that the formed pattern is not identical with any other pattern no matter how a pattern is rotated. Here, if a circular electrode 5 with a diameter of 8 mm is used, and the adjacent electrodes 5 are separated by three grid points in the horizontal or vertical direction and two grid points respectively opposite in the vertical or horizontal direction, the distance D between the electrode centers is D=√{(3×5.85)×(3×5.85)+(2×5.85)×(2×5.85)}=21.09, and the distance H between the edges of the electrodes is H=D−8 mm=21.09−8=13.09 mm, which satisfies the aforementioned condition of “it is desirable to have the distance between the electrode edges be 13 mm or more.” Therefore, when placing adjacent electrodes 5 at the 38 possible placement locations, they should be placed with three grid spacings in the horizontal or vertical direction and two grid spacings in the respective opposite vertical or horizontal direction as shown in FIG. 32. As a result, in this practical example, 300 patterns of unique electrode arrangement pattern can be generated by the arrangement of 5 electrodes 5, and in the case of 4 electrodes 5, 170 patterns can be generated. The method of numerating an electrode pattern into an electrode code is described in the [Pattern code decoding method] section of the fifth embodiment of the present specification. Note that a conduction control unit 79 may be provided to electrically connect or disconnect at least a part of a conduction path between electrodes 5 and conductive members with which an electrode pattern is formed, so that the electrode code formed based on the electrodes 5 detected by the touch panel 31 can be made to be switchable. Furthermore, a large number of electrode codes based on a history of electrodes 5 detected by the touch panel 31 may be formed by changing the electrically switchable electrically connected and disconnected states in a time-series.

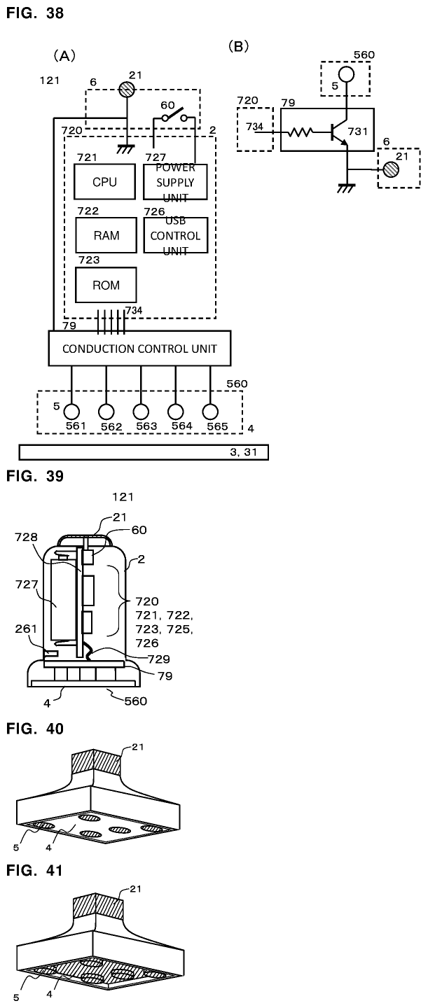

FIG. 37(A) is an example of an external view showing a schematic side view of a stamp-type code generation apparatus 121, FIG. 37(B) shows a schematic top view, and FIG. 37(C) shows a schematic bottom view. FIG. 38(A) shows a schematic configuration diagram of a code generation apparatus 121 and FIG. 38(B) is an example showing a switch circuit of a conduction control unit 79 thereof. FIG. 36 shows a schematic sectional view of a side of the code generation apparatus 121 dissected in the vertical direction. When a code generation apparatus 121 is pressed onto a touch panel 31 of the smartphone, which is a first information processing apparatus 310, a control circuit installed inside becomes operative by a push button switch 60, and by changing the conduction and disconnection to the electrodes 5 detected by the touch panel 31 in a time-series, electrode patterns are formed in a time-series, and a large number of time-series electrode codes are generated, which can be input to smartphones which are first information processing apparatuses via touch panels 31.

As shown in FIGS. 37(A) and 37(B), the code generation apparatus 121 has a square stamp shape, and the upper portion of the housing 2 or the entire housing is a push button switch 60, and furthermore, the push button is made conductive and is a human body contact area 21. Note that although the push button may be made of non-conductive material, a contact region 21 for holding the code generation apparatus 121 must be made of conductive material. Also, on the side, a battery case door 260 for opening and closing when exchanging batteries, and a USB connector 261 are provided. Furthermore, as shown in FIG. 37(C), a plurality of electrodes is arranged on the bottom surface 4 with spacing (13 mm or more is desirable) so that adjacent electrodes 5 are not detected as one electrode 5 even if they make contact with a touch panel 31 simultaneously, and with a size that enables detection upon having a human touch it via a human body contact area 21 under standard operating conditions for the touch panel 31. Note that if adjacent electrodes 5 do not become conductive simultaneously, the distance between adjacent electrode edges may be set to about 7 to 8 mm (about the same size as an electrode 5), as long as the center coordinate value of electrodes 5 can be recognized essentially accurately when each is made conductive. The number of electrodes 5 placed on the bottom surface 4 for detection should be equal to or less than the number specified by the multi-touch constraint of a touch panel 31, and if the first information processing apparatus 310 is a smartphone, the number of electrodes 5 is preferably equal to or less than 5. Furthermore, although the electrodes 5 are visible in FIG. 37(C), the bottom surface 4 is covered with a thin colored resin sheet or thin plate 410 so as not to significantly reduce the capacitance of the electrodes 5 and so that the electrodes 5 cannot be visually recognized from the outside.

An electrode pattern formed by an arrangement of electrodes 5 is an electrode pattern distinguishable with others upon detecting all of the arrangement positions of the electrodes 5 arranged on the bottom surface 4 and recognizing the orientation of the pattern, and is an electrode pattern that can be decoded to an electrode code as in the case of the configuration shown in the fifth embodiment. Note that in a case where the conduction of the electrodes 5 is carried out in a time-series with a number of steps less than the number of electrodes 5, the electrode pattern may be set so that the arrangement positions of the electrodes 5 that are made conductive and the orientation of the pattern may be recognized, and thus can be distinguished from other electrode patterns.

As shown in FIGS. 38(A), (B) and 39, a code generation apparatus 121 includes an electrode section 560 with electrodes 5 in the bottom 4, a control unit 720 installed on a PCB board 728 inside the housing 2, a conduction control unit 79 for switching between conduction and non-conduction between an electrode 5 and a contact region 21, and an operation unit 6 for a push button switch 60. Note that the push button switch 60 may be realized with a structure in which the holding region is pushed into the housing when pressed, such as a simplified seal (self ink-supplying seal Shachihata and the like).

The electrode section 560 is provided with a total of five electrodes 561, 562, 563, 564, and 565 that are connected to a contact region 21 via the control switch 731 of the conduction control unit 79. The electrodes 5 are formed by patterning, by etching a conductive layer of a PCB board on the surface of the side that is the bottom side 4 of the PCB board at positions corresponding to the electrode arrangement of the electrode pattern so that the electrodes have predetermined diameters. Also, the electrode section 560 may be created by printing on a sheet with conductive ink in the same manner as the electrode pattern printing sheet 400 of the first embodiment.

Inside the housing 2, there is a control unit 720 installed on a PCB board 728, and as an information processing apparatus, the control unit 720 is comprised of a CPU (Central Processing Unit) 721, internal memories of a RAM (Random Access Memory) 722 and a ROM (Read Only Memory) 723, a USB (Universal Serial Bus) control unit 726, and a power supply unit 727. In addition, a push button switch 60 is provided in the operation section 6, with the push button integrated with the contact section 21. Parts other than the power supply unit 727 and the operation unit 6 may be configured with a single semiconductor device, or may be configured by combining a plurality of semiconductor devices.

The control unit 720 generates and outputs control signals 734 for controlling ON/OFF (conduction to the electrodes/disconnection) of the control switch 731 of the conduction control unit 79 in accordance with the number of electrodes 5 that form an electrode pattern. Each of the control units of the control signals 734 is connected to a respective control switch 731 of the conduction control unit 79. In FIG. 37(B), the control switch 731 is configured in one stage with a bipolar transistor. However, the circuit configuration is merely an example, and any configuration is adoptable provided that an element or a circuit is capable of ON/OFF control, and for example, a MOS FET or a diode may be used. Furthermore, to reduce the parasitic capacitance when electrode 5 is turned OFF, the configuration may have bipolar transistors connected in series.

An information processing apparatus is comprised of a CPU 721, a RAM 722, and a ROM 722, and when the push button switch 60 is turned ON by pressing, the power is turned ON, necessary data is read from the ROM 722, and the corresponding processing is performed. The ROM 723 stores ID numbers corresponding to respective code generation apparatuses 121, and information to be sent to a smartphone when the push button switch 60 is pressed and the like are stored. The apparatus may be configured so that the power can be turned ON beforehand by long pressing or the like of the push-button switch 60, and with the CPU in a sleep mode, the CPU may be activated by pressing the button switch 60. In addition, the USB control unit 726 controls USB connections with other apparatuses not shown in the figure when program updating, data input/output, battery charging, and the like of the code generation apparatus 121 are performed. Also, the USB control unit 726 may be omitted. The power supply unit 727 is for supplying electric power to the control unit 720, and may be either a dry battery or a rechargeable battery provided that it can supply electric power that meets the specifications of the circuits and devices installed in the control unit 720. If it is a rechargeable battery, it is possible to make it chargeable via the USB connector 261. In addition, although not shown in the figure, a plurality of changeover switches may be provided and different time-series electrode patterns assigned to each switch may be formed. As a result, one code generation apparatus 121 can generate multiple electrode codes, and for example, each electrode code may be made to correspond to any function in addition to the functions of “add,” “erase,” “transmit device ID,” and “ON/OFF of wireless connection” of the stamp.

Furthermore, the first information processing apparatus 310 is implemented with an application program that serves to recognize a code generation apparatus 121 from detected coordinates when a touch panel 31 detects electrodes 5 of the code generation apparatus 121.

The behavior and processings of a code generation apparatus 121 will be described based on this practical example. (1) When a code generation apparatus 121 is brought into contact with a touch panel 31 of a first information processing apparatus 310 and a human finger touches a contact region 21, (2) if the push button switch 60 is pressed down, in addition, the control switch 731 of the conduction control unit 79 is turned ON or OFF by control signals 734 in accordance with the ON/OFF sequence of the electrodes 561 to 565 programmed in the information processing apparatus comprising a CPU 721, a RAM 722, and a ROM 722.

(3) When a control switch is turned ON, contact region 21 and corresponding electrodes 561 to 565 are electrically connected and detected by a touch panel 31, and when the control switch is turned OFF, the electrodes are not detected by the touch panel 31.

Note that with some smartphones, although detection is normal when there is conduction to an electrode 5, the electrode 5 may remain detected even if the conduction has been disconnected. When such smartphones are to be covered, an electrode pattern in which electrodes 5 that have been electrically connected once are not connected again in a time-series may be formed.

(4) The first information processor 310 decodes an electrode pattern from the detected coordinate values by the touch panel 31 of up to five electrodes 5 into a code, and also decodes the detected coordinate values into a sequence code corresponding to an electrode-ON sequence based on information of the order of detection of the detected coordinate values as a function of time. By combining these two pieces of information and collating with an ID number received as a time-series code, the code of a code generation apparatus 121 is recognized. Since the number of possible time-series electrode codes is derived by the multiplication of the number of electrode patterns and the number of electrode-ON sequences, the code generation apparatus 121 can generate a very large number of electrode codes (which may include device IDs).

In addition, when a code generation apparatus 121 can surely turn OFF an electrode 5 once detected by the touch panel 31 with the control switch 731 of the conduction control section 79, it is possible to repeat ON/OFF with no restrictions in an electrode-ON sequence and output more different sequences, thus making it possible to input in a first information processing device 310 information other than a device ID in an electrode code.

Furthermore, although the external shape is shown as a three-dimensional stamp-type in FIG. 37, the shape is not limited to this, and can also be of a thin card shape.

On the other hand, when the first information processing apparatus 310 is a smartphone, after the detection of an electrode 5 by the detection of a capacitance that exceeds a predetermined threshold value (for example 4 pF or more), depending on the model, if the predetermined threshold value for detection is set low, the electrode 5 may be found not to be undetected due to residual capacitance (for example about 2 pF) possessed by the electrode 5 and some conductive members of which the conduction path is disconnected. In other words, once an electrode 5 is made conductive and detected by a touch panel 31, the detected state will be maintained if they remain in contact or substantially in contact. When such a model is also to be covered, if a plurality of electrodes 5 forming an electrode pattern is provided, the number of electrodes 5 to be detected may be increased in succession in a time-series as shown in FIGS. 52-56. For example, if the number of the plurality of electrodes 5 is N, and if all of the electrodes 5 are set to be initially non-conductive when in contact or substantially in contact with a smartphone, it is possible to form an electrode pattern detected in a time-series by conducting to at least one electrode 5 different from priorly detected electrodes in the same time-series over two to a maximum of N steps by a predetermined operation. A method of calculating the number of such time-series detection patterns is shown in the following paragraph. Note that most multi-touch smartphones are capable of detecting 5 to 10 locations, and so it is desirable to set N=5 for compatible models. In that case, there are 540 possible time-series detection patterns. When N=4, there are 74 time-series detection patterns. By combining with the aforementioned 300 and 170 electrode arrangement patterns for respective arrangements of 5 and 4 electrodes, 300×540=162,000 and 170×74=12,580 electrode codes can be generated, respectively. Note that even for electrodes 5 that maintain the above-mentioned detected state, when a predetermined electrode 5 is made conductive in a time-series, and then the electrode 5 is disconnected and an adjacent electrode 5 is made conductive, since the disconnected electrode 5 is no longer detected, the distance between adjacent electrode edges can be reduced, and thus electrode codes can be significantly increased.

(Calculation Method for Time-Series Detection Patterns when the Number of Electrodes is N and the Number of Conductions to the Electrodes is M Times)

When the number of electrodes is N and the number of conductions to the electrodes 5 is M times, let T(N, M) be the number of time-series detection patterns,

$$T ( N , M ) = M ! \{ \begin{matrix}N \\ M\end{matrix} \} \qquad [ Formula 1 ]$$

Here,

$$\{ \begin{matrix}N \\ M\end{matrix} \} \qquad [ Formula 2 ]$$

is a Type 2 Stirling number, which can be calculated by the following recurrence formula.

$$\begin{matrix}\{ \begin{matrix}N \\ M\end{matrix} \} = \{ \begin{matrix}N - 1 \\ M - 1\end{matrix} \} + M {\{ N - 1 \}}_{M} \\ where & [ Formula 3 ] \\ \{ \begin{matrix}0 \\ 0\end{matrix} \} = 1 & [ Formula 4 ]\end{matrix}$$

is defined and further when N<M,

$$\{ \begin{matrix}N \\ M\end{matrix} \} = 0 \qquad [ Formula 5 ]$$

is defined.
T(N, M) can also be expressed more intuitively as follows: Let D(N, M) be a set of all methods to represent N as the sum of M integers (assuming that the order can is distinguished), and the source of D(N, M) be

{aₙ} [Formula 6]

{aₙ} [Formula 7]

corresponds to a number sequence of the length of M consisting of positive integers.
For example, for N=4 and M=2, the number sequence with a₁=3 and a₂=1 would be a source of D (4, 2). Based on this definition, T(N, M) can also be expressed by the following equation.

$$T ( N , M ) = {\sum }_{\{ {a}_{n} \} ∈ D ( N , M )} \frac{N !}{{{\prod }^{n}}_{i = 1}^{ } {a}_{i} !} \qquad [ Formula 8 ]$$

The values of T(N, M) for various N and M are shown in the following table. A blank cell corresponds to a case where M>N and T(N, M) is not defined. The total number of time-series detection patterns for a given N is given by the sum of the numerical values written in each row. When the number of electrodes is N and the number of conductions to the electrodes 5 is M times, let T(N, M) be the number of time-series detection patterns,

$$T ( N , M ) = M ! \{ \begin{matrix}N \\ M\end{matrix} \} \qquad [ Formula 1 ]$$

Here,

$$\{ \begin{matrix}N \\ M\end{matrix} \} \qquad [ Formula 2 ]$$

is a Type 2 Stirling number, which can be calculated by the following recurrence formula.

$$\begin{matrix}\{ \begin{matrix}N \\ M\end{matrix} \} = \{ \begin{matrix}N - 1 \\ M - 1\end{matrix} \} + M { \{ N - 1 \}}_{M} \\ where & [ Formula 3 \} \\ \{ \begin{matrix}0 \\ 0\end{matrix} \} = 1 & [ Formula 4 ]\end{matrix}$$

is defined and further when N<M,

$$\{ \begin{matrix}N \\ M\end{matrix} \} = 0 \qquad [ Formula 5 ]$$

is defined.
T(N, M) can also be expressed more intuitively as follows: Let D(N, M) be a set of all methods to represent N as the sum of M integers (assuming that the order can is distinguished), and the source of D(N, M) be

{aₙ} [Formula 6]

{aₙ} [Formula 7]

corresponds to a number sequence of the length of M consisting of positive integers.
For example, for N=4 and M=2, the number sequence with a₁=3 and a₂=1 would be a the source of D (4, 2). Based on this definition, T(N, M) can also be expressed by the following equation.

$$T ( N , M ) = {\sum }_{\{ {a}_{n} \} ∈ D ( N , M )} \frac{N !}{{{\prod }^{n}}_{i = 1}^{ } {a}_{i} !} \qquad [ Formula 8 ]$$

TABLE 2

| | M = 2 | M = 3 | M = 4 | M = 5 | M = 6 | M = 7 |
|---|---|---|---|---|---|---|
| N = 2 | 2 | | | | | |
| N = 3 | 6 | 6 | | | | |
| N = 4 | 14 | 36 | 24 | | | |
| N = 5 | 30 | 150 | 240 | 120 | | |
| N = 6 | 62 | 540 | 1,560 | 1,800 | 720 | |
| N = 7 | 126 | 1,806 | 8,400 | 16,800 | 15,120 | 5,040 |

(Shape of a Stamp Applicable as a Code Generation Apparatus Equipped with a Communication Processing Unit)

Although examples of stamps having other shapes are shown in FIGS. 40 to 44, it is possible to install a communication processing unit 32 of the present embodiment in these stamps as well.

FIG. 40 shows a stamp with a three-dimensional shape in which a plurality of electrodes 5 are embedded in the bottom surface area 4 exposed so that the plurality of electrodes 5 maintain flatness, and by making contact or substantially making contact with a touch panel 31 of an information processing apparatus, the electrodes 5 connected with a conductive member 21 of a contact region by conductive material held by the fingers are detected and an electrode code corresponding to an electrode pattern is recognized.

FIG. 41 shows a stamp with a three-dimensional shape in which the electrodes 5 are provided on the bottom surface region 4 exposed and in the shape of protrusions, and by making contact or substantially making contact with a touch panel 31 of an information processing apparatus, the electrodes 5 connected with a conductive member 21 of a contact region by conductive material held by the fingers are detected and an electrode code corresponding to an electrode pattern is recognized.

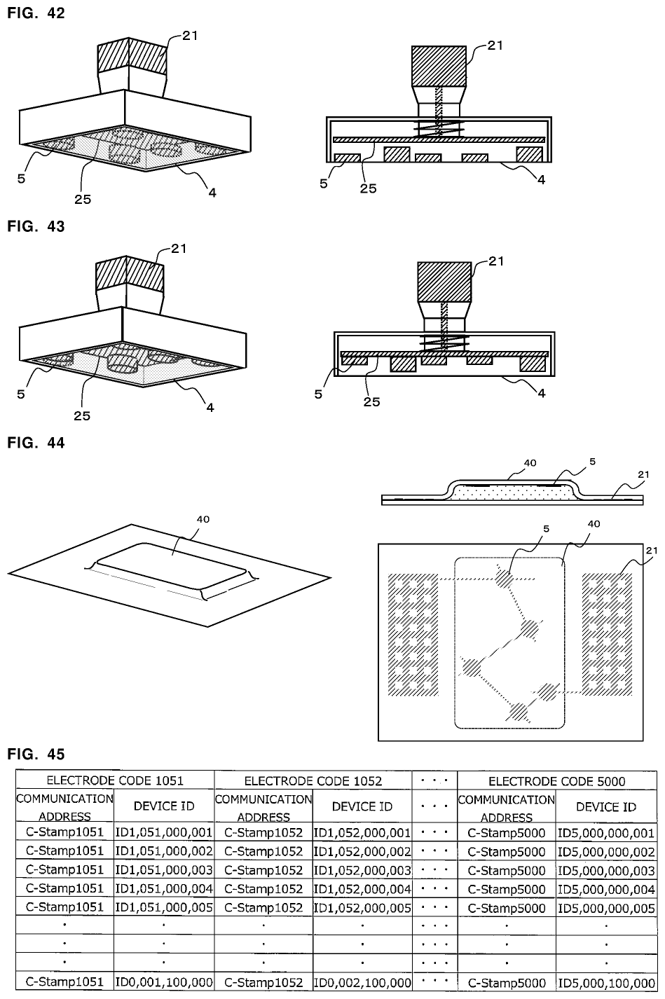

FIG. 42 shows a stamp in which the electrodes 5 are provided on the bottom surface region 4 with columnar shapes and are elastic in the vertical direction arranged on a base member (plate or sheet) of non-conductive material, and by pressing the stamp down, the electrodes 5 come into contact with a movable electrode 25 of a conductive base member (plate) connected by conductive material to a conductive member 21 of a contact region held by the fingers. By varying the height of the columnar electrodes 5, the electrodes 5 may shrink in the vertical direction when pressed, and the number of electrodes 5 that are electrically connected may increase stepwise. Combinations of electrode patterns detected by the touch panel 31 in a stepwise manner may be numerated and thus many electrode codes can be defined.

FIG. 43 shows a stamp in which by pressing the stamp down, columnar electrodes 5 elastic in the vertical direction provided downward from a movable electrode 25 of a conductive base member (plate) connected to a conductive member 21 of a contact region held by the fingers by conductive material come into contact with a member of non-conductive material of the bottom surface region, and the electrodes are detected by a touch panel 31. By varying the height of the columnar electrodes 5, the electrodes 5 may shrink in the vertical direction when pressed, and the number of electrodes 5 that are electrically connected may increase stepwise. Combinations of electrode patterns detected by the touch panel 31 in a stepwise manner may be numerated and thus many electrode codes can be defined.

FIG. 44 is a stamp made of a thin plate-like medium for use on a wall or a poster and has a convex contact surface region 40 on which a plurality of electrodes 5 connected by a conductive member are placed on the back side of the contact surface region 40. By having a smartphone make contact or substantially make contact with the convex contact surface region 40, the smartphone detects the electrodes 5, and an electrode code corresponding to an electrode pattern is recognized. At the end of a conductive member connecting an electrode 5, a conductive member 21 is provided as a contact region with an ensured sufficient area, and electrodes 5 are detected by causing parasitic AC coupling between the fingers, the human body, or the housing of the smartphone and the conductive member 21, and having conductive members connecting the electrodes 5 and the housing of the smartphone be AC conductive. Furthermore, the conductive member 21 may be incorporated in the form of a line with a predetermined length so it can resonate with radio waves in the surrounding environment, such as those of WiFi, to supplement the AC amplitude and assist in the conduction with the housing of a smartphone, thereby facilitating the detection of electrodes 5. Still further, the conductive member 21 of the contact region may be exposed on the surface of the thin plate, so that the human body and the housing of the smartphone may be brought into conduction by a touch with the fingers.

### Ninth Embodiment

### (Reading of an Electrode Pattern)

When the human body comes into contact with a contact section 21 or a contact section 21 is held, in which the contact section 21 is of a conductive member (DC conduction) formed on the housing surface of the code generation apparatus 120 (stamp or card) or a conductive member (AC conduction) coated with a non-conductive member, there is conduction by direct current or alternating current between the contact section 21 and the electrode 5 connected to the conductive member. By pressing or holding the apparatus against the display of a first information processing apparatus 310 (smartphone) having a touch panel 31, while having the apparatus make contact or holding the apparatus, the first information processing apparatus 310 reads the geometric arrangement of the electrodes 5 attached to the bottom of the code generation apparatus 120 and recognizes the arrangement associated with the electrode code based on the geometric arrangement. Unlike methods based on common NFC (Near Field Communication) technology, since the present technology involves a change in capacitance, the two involved devices need to be in contact or substantially in contact. A common protective sheet for a smartphone may or may not be affixed, since it does not interfere with the detection of capacitance. Other modifications may be applied as well provided that they do not interfere with the detection of a geometric arrangement of the electrodes 5 based on capacitance. The conduction state may be controlled by a switch of a non-conductive material or other physical quantity changes may be applied in place of capacitance.

In a basic electrode pattern configuration, only all of the electrodes 5 that are incorporated into a conduction path with a conductive member and are detected by capacitance are arranged on the bottom section of the housing. However, electrodes 5 may also be placed at some or all of the other placeable positions, and by making at least part of the conduction paths conductive or not conductive to form other electrode arrangement patterns, a plurality of electrode patterns may become usable. In such a case, there may be electrodes 5 that are not used in any of the electrode patterns. Furthermore, even when only a single electrode pattern is used, there may be unused electrodes 5. A code generation apparatus 120 may be equipped with a pressing mechanism or a switch as a second control unit 6, and the switching may be performed as a physical process by operating the control unit 6. In addition, a conduction control unit 79 may be provided so that switching can be performed by electronic control. In addition to the bottom section, the placement area for the electrodes 5 may be in another section. In other words, the surfaces that come into contact or substantially come in contact with a touch panel 31 may be in a plurality of regions on the surface of the housing 2. In such a case, the electrode pattern connected to a conductive member may be made different depending on the region that is in contact with a touch panel 31 or held against a touch panel 31, and thus the first information processing apparatus 310 may be made to recognize a plurality of different electrode codes. Other adoptable switching methods include a method with the installation of a changeover switch, a method using a mechanism in which multi-step pressing leads to multi-step connection, a method using a mechanism of achieving control by rotating or moving a code generation apparatus 120 or combining the two, and a method using a mechanism of achieving control by changing the method of holding a conductive member or the position of holding a conductive member.

An electrode pattern generated by a code generation apparatus 120 is preferably enumerated for convenience, and the numeric value may be an electrode code assigned to the code generation apparatus 120, or the numeric value may be divided and a part may be assigned to, for example, a code that instructs a first information processing apparatus 310 to perform a predetermined information processing. and the remainder may be assigned to an identification code for the code generation apparatus 120. As a practical example thereof, a part of the arranged electrodes 5 may be assigned to a code that instructs the first information processing apparatus 310 to perform a predetermined information processing, and the remaining arrangement pattern may be assigned to a device identification code, beforehand. The information processing may be, for example, “add” or “erase” for reward points, or “pay,” “cancel,” or the like. When electrode codes are switchable, the code generation apparatus can be connected to a first information processor 310 if a communication address is made common for the plurality of electrode codes is made common. If an electrode code is in a switchable form, even more information processing instructions are possible, and connections and disconnections between code generation apparatuses and information processing apparatuses can be facilitated. Furthermore, a third information processing apparatus 330, which recognizes a communication address corresponding to an electrode code may be connected to a first information processing apparatus 310, or a second information processing apparatus 320, which recognizes a communication address corresponding to an electrode code may be connected to a code generation apparatus 120.

(Code Generation Apparatus ID and Communication Address)

The number of electrode codes (number of IDs) that can be assigned to electrode patterns range from a few hundred to several thousand at most, depending on the configuration and mechanism of the electrode patterns of a code generation apparatus 120 (examples shown in the range from the description of FIG. 2 to the descriptions of the seventh embodiment). However, provided that the maximum allowable number of IDs is not exceeded, there is no problem in distinguishing stamps even if the number of IDs is small, because one code generation apparatus 120 per store is usually sufficient for stamps, and even in stores where multiple IDs are required, several stamps with different electrode codes are sufficient. However, there are cases where there are multiple code generation apparatuses 120 having the same electrode code in the same Bluetooth (including BLE) range of communication. For example, in the case of cards, since they are easy to carry, they are expected to be distributed to individuals. However, there are cases where the same electrode code would have to be assigned to different cards, since several thousand codes would not be enough to go around. In such a case, participants of games or events that use cards or users who have gathered to receive a predetermined service intended for cardholders, may gather at a specific location, creating the possibility of a plurality of cards having the same electrode code co-existing in the same area. After making contact with a specific code generation apparatus 120, the first information processing apparatus 310 tries to recognize the code generation apparatus 120 that made contact as the communication partner. However, if there are a plurality of code generation apparatuses 120 in the vicinity of the first information processing apparatus 310 that are assigned the same electrode code (communication address), there is a possibility that the first information processing apparatus 310 cannot identify the code generation apparatus 120 that has made contact or has substantially made contact with the touch panel 31 of the first information processing apparatus. If this results in a connection based on misidentification, there would be a serious security issue.

Therefore, in addition to an electrode code, if a unique (one and only) code generation apparatus 120 ID (hereinafter referred to as device ID) is set for a code generation apparatus 120, it is stored in a non-volatile memory of the code generation apparatus 120, and the device ID is transmitted to an information processing apparatus, the code generation apparatus 120 can be identified. Furthermore, for a first information processing apparatus 310 to enter a state of connection with a communication processing unit 32 of the code generation apparatus 120, the recognition of a communication address is necessary. Note that when a connected state is established, the connection may be made automatically, or a connected state may be made by once entering a standby state and then entering a connected state by the operation of an operation unit 78 by providing a pressing mechanism or a switch as the first operation unit 78. Since the correspondence between an electrode code, a device ID and a communication address is important, a table exemplifying the correspondence relationship between a unique device ID or a device ID unique in combination with an electrode code stored in a storage means of a communication processing unit 32, an electrode code, and a communication address is shown below.

In the table of FIG. 45, a relationship between an electrode code, a device ID, and a communication address is exemplified using specific numerical values. As shown here, since different device IDs are assigned to all code generation apparatuses 120, all the code generation apparatuses 120 can be identified just with the device IDs, but electrode codes and communication addresses may be made to correspond. That is, even if device IDs are different such as ID1,051,000,001 and ID1,051,000,002, the same communication address of C-Stamp1051 may be made to correspond to the same electrode code 1051.

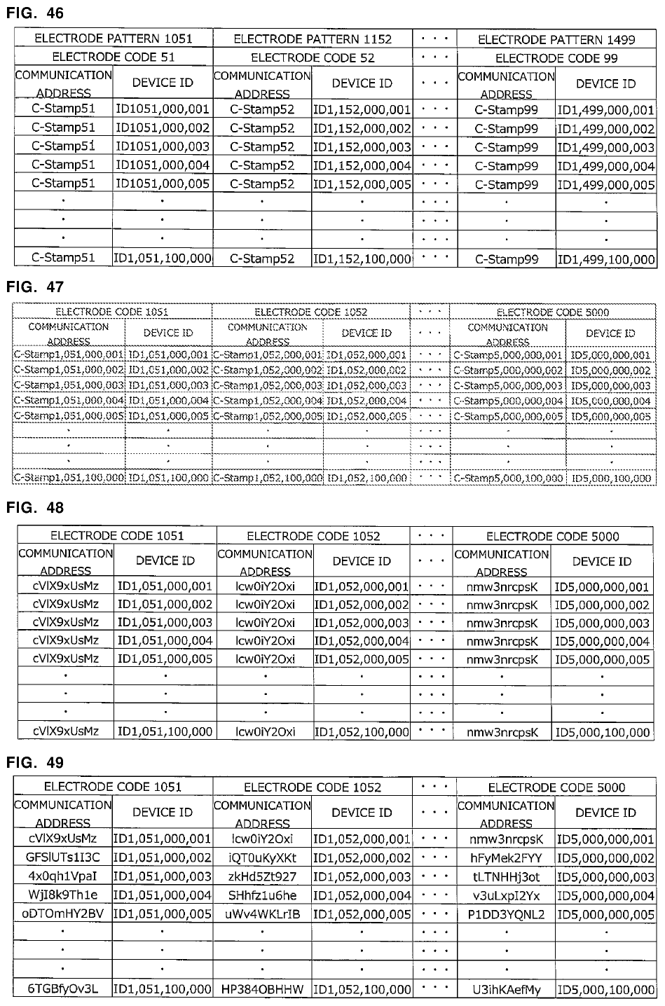

And, in the table of FIG. 46, the case where a part of an electrode pattern is assigned a function and a part is assigned to an electrode code is exemplified. Here, the upper two digits of the electrode code recognized from the electrode pattern are assigned to a code for function and the lower two digits are assigned to an identification code of a code generation apparatus 120. Furthermore, as in the table of FIG. 45, an electrode code and a communication address may be made to correspond and be the same. For example, the upper two digits of 10 of an electrode pattern 1051 may correspond to some function, and the lower two digits of 51 may correspond to an identification code of a code generation apparatus 120. And a communication address corresponds to a code corresponding to the lower two digits of 51.

Furthermore, in the table of FIG. 47, unique device IDs are assigned as in the case of FIG. 45, but a different communication address may be assigned to each apparatus in correspondence with the device ID. That is, even for apparatuses having the same electrode code 1051, if the device IDs are different such as ID1,051,000,001 and ID1,051,000,002, different communication addresses C Stamp1,051,000,001 and C-Stamp1,051,000,002 may be assigned, respectively.

Furthermore, in the tables of FIGS. 48 and 49, unique device IDs are assigned as in the case of FIG. 45, but to a communication address, a code generated by applying some function f(N) to N of the electrode code or device ID may be made to correspond. As for the communication address, as in the case of FIG. 48, the communication address may be the same for apparatuses with the same electrode code. Or as in the case of FIG. 49, different communication addresses may be assigned to apparatuses with different device IDs.

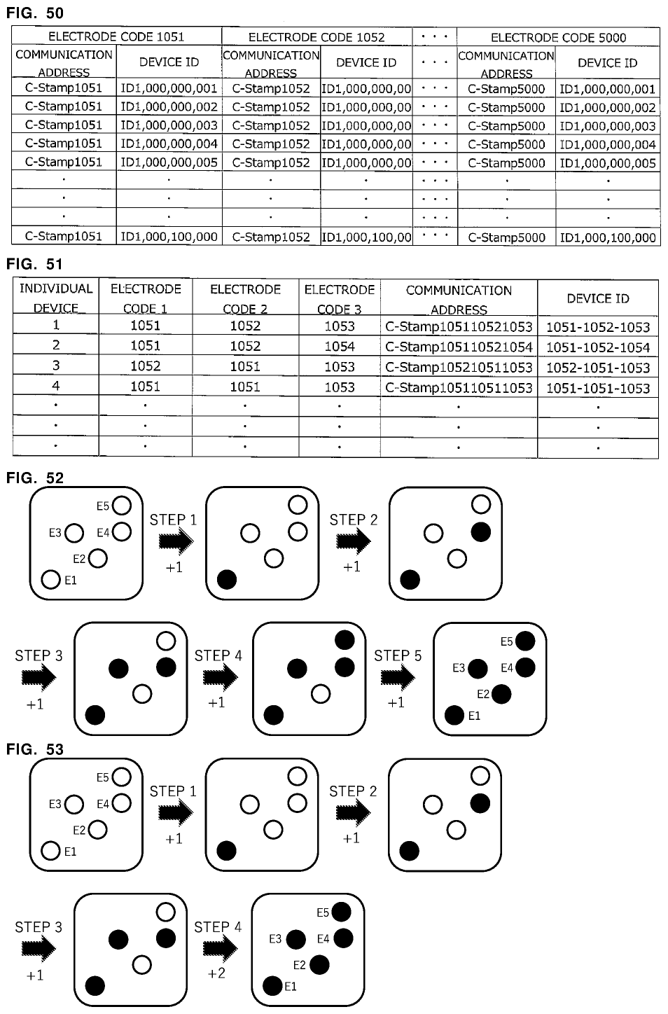

As long as the code generation apparatuses 120 can each be identified, an apparatus may be unique if a combination of a device ID and an electrode code is unique. That is, if the electrode codes are different, they may have the same device ID. For example, as shown in FIG. 50, the device ID may be ID 1,000,000,001, respectively, for apparatuses having electrode codes 1051 and 1052.

Note that when all the device IDs are unique (one and only) as shown in the tables of FIGS. 45 to 49, the electrode code can be identified by the device ID. This is an advantage since error checking can be performed during electrode code recognition. There is. For example, code generation apparatuses 120 having device IDs of ID1,051,000,001 to ID1,051,100,000 will all have the electrode code of 1051.

Although not shown, when a beacon is installed in a communication processing unit 32 of each code generation apparatus 120, a unique communication ID is assigned to the beacon, and the unique communication ID may be transmitted as a device ID from the beacon to an information processing apparatus that can recognize the beacon. Also, any other method other than the above may be used provided that identification can be ensured in situations where the identification of different code generation apparatuses 120 is required. Furthermore, a plurality of methods may be combined.

Furthermore, in the case of a code generation apparatus 120 that can switch electrode patterns, if a simple switching mechanism is used, a different electrode pattern is detected for each switching, and thus a single code generation apparatus 120 will have device IDs corresponding to the number of times (a plurality) of the switchings. However, it is also possible to increase the number of device IDs by combining a plurality of electrode codes and specifying the reading order, devising the method of reading electrode codes, or the like. Here, examples of two patterns are described.

The table in FIG. 51 shows an example of the former case, where three independent electrode codes can be switched. For example, if individual apparatus 1 has three electrode codes, 1051, 1052, and 1053, that can be read by a first information processing apparatus 310 in this order by switching, then the code generation apparatus is recognized to have a device ID of 1051-1052-1053. Based on this designation, it is possible to make the following assignments. For a switchable individual apparatus 2 of a code generation apparatus 120, a device ID of 1051-1052-1054, for a switchable individual apparatus 3 of a code generation apparatus 120, a device ID of 1052-1051-1053, and for a switchable individual apparatus 4 of a code generation apparatus 120, a device ID of 1051-1051-1053. The code generation apparatus 120 with the ID can be assigned as the code generation apparatus 120. Thus, it is possible to increase the number of unique IDs based on the number of code switchings for the electrode codes as a degree number, and thus it is possible to significantly increase the number of identifiable apparatuses. For example, if the number of electrode codes is 1,000 and switching can be done three times, theoretically, 10 million (1,000³) apparatuses can be identified. However, in such a case, since all of the electrode codes (a plurality) included in the device ID must be recognized, it is necessary to have a first information processor 310 read the electrode codes while switching them sequentially. The communication addresses may be common-or independent.

Using FIGS. 52 to 55, an example of adding electrodes 5 to be connected at each stage in the time series is described, assuming a case in which a smartphone normally detects electrodes 5 that are connected, but detection is not discontinued even if the connection is disconnected. Note that in this case, the number of electrodes 5 is 5, which is common for multi-touch patterns. Note that the white circles indicate non-conducting (OFF) electrodes 5, and the black circles indicate conducting (ON) electrodes 5. For electrode patterns of five electrodes 5, only a small number of electrode codes can be generated if detection is done in a single step, because only electrode arrangement patterns based on the arrangement of a predetermined number of electrodes 5 can be generated. However, if the number of detected electrodes 5 can be increased in stages, the number of codes can be increased to many with a single electrode arrangement pattern.

As shown in FIG. 52, when conducting electrodes are increased in five steps, for the electrode pattern that is formed lastly in the state of STEPS, since the arrangement positions of electrodes numbered E1 to E5 can be identified in the decoding process, a time-series electrode code can be obtained by the conduction sequence of the electrodes 5 from STEP1 to STEPS and the electrode arrangement pattern by assigning a temporary electrode number to the electrodes 5 according to the order they are detected in each STEP and storing the coordinate values of the detected electrodes 5 as data. As shown in FIG. 52, when five electrodes 5 are turned ON one by one over five steps, the number of time-series electrode patterns is 5!=120.

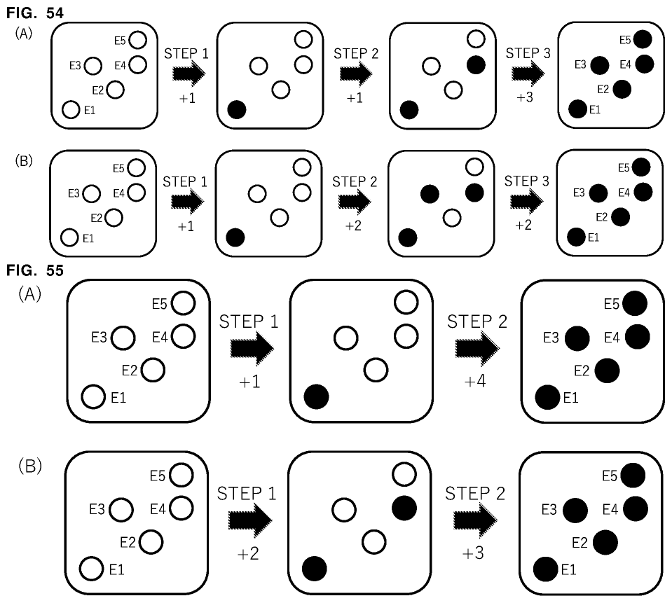

As shown in FIG. 53, when conducting electrodes are increased in four steps, in one of the steps, an increase is by two, and since the increase of two can be set in any of the four steps, the number of time-series electrode patterns is ₅C₂×3!×4=240. As shown in FIG. 54, when conducting electrodes are increased in three steps, two ways are possible to divide the five electrodes, one in which three increase in one step and one increases in two steps (FIG. 54(A)), and one in which two increase in one step and one increases in one step (FIG. 54(B)). Thus, the number of time-series electrode patterns are respectively, ₅C₃×2!×3=60, and ₅C₂×₃C₂×1!×3=90. Furthermore, as shown in FIG. 55, when conducting electrodes are increased in two steps, two ways are possible to divide the five electrodes, one in which four increase in one step and one increases in one steps (FIG. 55(A)), and one in which three increase in one step and two increase in one step (FIG. 55(B)). Thus, the number of time-series electrode patterns are respectively, ₅C₄×1!×2=10, and ₅C₃×2C₂×2=20. In total, there are 540 ways. Note that these are time-series electrode patterns, the one case of one step is not included. In this way, the number of electrode codes can be increased 540-fold by conducting (turning ON) the electrodes 5 that form an electrode arrangement pattern comprised of five electrodes 5 stepwise. Note that to ensure that the time-series electrode patterns are recognized by a smartphone panel, the time for having the electrodes 5 ON in each STEP needs to be at least 51 msec, and 100 msec is even more preferable. The description here is for a pattern with five electrodes 5, but the same applies for cases where the number of conducting electrodes 5 is four or less. Although not shown, if four electrodes 5 are used to form an electrode arrangement pattern, the same calculate gives 74 ways. In other words, up to 74 times as many electrode codes can be generated for a single electrode arrangement pattern. If multi-touch with six or more points can be realized, the number of steps can be increased to match the number of points, and the number of device IDs can be increased accordingly.

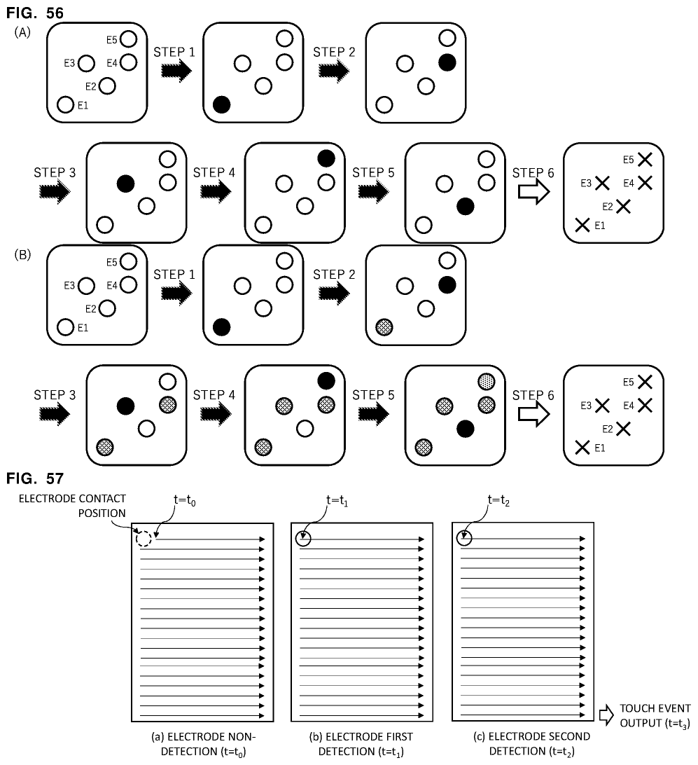

Next, if the shortest distance between the electrode edges is set to about 7-8 mm to increase the number of electrode 5 arrangement patterns, it is desirable to disconnect the electrodes 5 in the next stage once they are made conductive so that two or more electrodes 5 in close proximity are not detected fused together as one when the distance between the edges of the electrodes 5 is short. In such a case, the electrodes may be virtually added in the data processing stage. As exemplified in FIG. 56(A), only one electrode 5 each is to be detected in each of the five steps (STEP 1 to 5), and in STEP 6, the five different detected coordinate values stored up to STEP 5 and indicated by the X marks are to be added virtually to form an electrode arrangement pattern.

In this way, even if the electrodes 5 to be conducted in each STEP is one and switching is sequential, by assigning a temporary electrode number to the electrodes 5 according to the order they are detected in each STEP and storing the coordinate values of the detected electrodes 5 as data, as in the case of descriptions of FIG. 52, time-series electrode codes can be obtained by the conduction sequence of the electrodes 5 from STEP1 to STEPS and the electrode arrangement pattern, and the number of time-series electrode patterns is 5!=120. Here, five electrodes 5 are made conductive one after another, and the conduction of other electrodes 5 is disconnected, but provided that adjacent electrodes 5 are not made conductive simultaneously, time series of two to four steps can be formed, and a larger number of electrode codes can be generated.

Furthermore, by keeping an electrode 5 adjacent to an electrode 5 that is kept ON in an OFF state, it is possible to suppress the phenomenon in which a touch panel 31 detects two adjacent electrodes as one electrode 5 when the above-mentioned distance between the two adjacent electrodes is short. This is because, since the physical quantity of one of the adjacent electrodes 5 that is not conducting is about 2 pF, while the conducting electrode 5 has 4 pF or more, the intensity for detection becomes relatively dominant for the conducting electrode 5, and generally, the coordinate position of the electrode 5 can be detected accurately. This makes it possible to alleviate the restrictions on the spacing between adjacent electrode edges when forming electrode arrangement patterns, and to significantly increase the number of electrode arrangement patterns.

FIG. 56(B) shows an example in which specifications are the same as those described for FIG. 56(A), except that electrodes 5 detected in a previous STEP continue to be detected by the touch panel 31 even though the electrodes 5 that were turned ON in each step were turned OFF in the next step. Here again, white circles indicate electrodes 5 that are OFF, and the black circles indicate conducting electrodes 5, and the circles with the shaded pattern indicate electrodes 5 that remain detected by a touch panel 31 even though control-wise, conduction has been disconnected from a conduction state. As shown in the figure, even if more than one electrode 5 is detected by a touch panel 31 in each STEP, since the electrode positions newly stored in each STEP are the same as those in the case of FIG. 56(A), the time-series electrode pattern of the electrode ON sequence can be recognized to be the same as that of FIG. 56(A).

Also, as in the state of STEP 4 in FIG. 56(B), there are situations where the electrode E5 that is in conduction and the electrode E4 that is being detected by the touch panel 31 although control-wise it is not in conduction are close to each other. However, since the detection intensity of an electrode 5 detected by the touch panel 31 not in conduction is sufficiently lower than that of an electrode 5 detected in conduction, it is possible to suppress a phenomenon where the touch panel 31 detects two electrodes 5 as one electrode 5, as in the case of FIG. 56(A). As a result, there are cases in which electrode E4 is not detected in STEP 4. Thus, by targeting smartphones with which the electrode E4 is not detected, it is possible to further increase time-series electrode codes upon making electrodes in a non-detected state conductive again and to increase electrode ON sequences. Note that to ensure that a smartphone panel can recognize a change in the electrode pattern, 51 msec or more are required even for the disconnection of conduction of electrodes 5, and when there is a large load on a CPU due to other running applications, the output of a touch event may be delayed, and thus it is even better if the time is 100 msec. Note that the rationale for 51 msec is that for some smartphones the output of touch events is in accordance with 1/60 sec which corresponds to the image display frame rate of the display, and the touch event for the position in question is set to be output after the same touch position is detected twice in a row. In such a case, as shown in FIG. 57, since there is a case in which an electrode 5 is located at the position where detection is started as shown by the scanning lines on the panel (a corner of the touch panel 31) and there is a case in which at the moment when the electrode 5 is conducted (t=t₁), detection by the scanning lines happens to start from a position past the electrode position, to have the electrode 5 be detected twice (t=t₂ and t=t₃) and then the touch event be output, the output of the touch event would be after the display of a maximum of three frames. Therefore, if the electrodes 5 of the next stage are made conductive at intervals exceeding 3 frames× 1/60 sec=50 msec, or with some margin at intervals of 51 msec or more, for a smartphone to detect one or more electrodes in the same stage, the touch events need to be output in the same frame or over two consecutive frames. As a result, when one or more frames in which a touch event is not output are recognized, the interval can be recognized as being a switching point where the electrode patterns forming a time-series electrode code change. Note that some smartphones output a touch event in accordance with the image display frame rate of 1/60 sec of the display once a single touch is recognized, and some smartphones output a touch event immediately once a touch is recognized regardless of the above frame rate. In such a case, the electrode pattern for each stage may be formed at even shorter intervals. Once the coordinate values of detected electrodes are recorded, since it is possible to correctly recognize the coordinate values of newly detected electrodes 5 in the next electrode detection stage, even if electrodes 5 of which conduction has been disconnected continue to be detected in the next electrode detection stage or even if a distance to a newly detected electrode 5 is short, there is no need to provide an interval for having the apparatus to be OFF. However, if an interval is to be provided for having the apparatus be OFF, the OFF time may be as long as 51 msec which is the required time for detection. If electrodes 5 to be detected are at distances so they are not detected as fused electrodes, a plurality of electrodes 5 may be set to be read in a single predetermined step, and in such a case, the number of ways can be increased. Also, if the reading order of the electrodes 5 can be changed in a time-series, even with the same electrode pattern, it is possible to form a huge number of device IDs with a single electrode pattern. Similar to the above, this method can be applied to electrode patterns with the number of electrodes other than five. As described above, if a huge number of time-series electrode codes can be generated by forming time-series electrode patterns, they may be used as device IDs, and if information communication is necessary only to transmit device IDs, it is not necessary to provide a communication processing unit 32. Note that it is needless to say that in such a case, a conduction control unit 79 that switches between conduction and disconnection states for the electrodes 5 and necessary electronic components must be provided.

Alternatively, a fixed device ID may be stored in a memory of a communication processing unit in advance, or the device ID may be made variable and be combined with time information to make the device ID change at predetermined time intervals. In such a case, security can be enhanced by making the device ID usable only for a predetermined amount of time or a predetermined number of times, like a one-time password. Other methods of changing may be used provided that they are effective in maintaining security. Methods of changing may also be combined and used.

The methods described above may be combined. Also, provided that all code generation apparatuses 120 can be identified, device IDs may be assigned in any other way.

The size of a device ID may be 256 bits, a size common in the financial industry. Note that a corresponding device ID may be registered in advance in an application that runs in a first information processing apparatus 310 for verification and authentication, or a device ID registered in a third information processing apparatus 330 such as a server (including the cloud) may be used for verification and authentication. Authentication by a first information processing apparatus 310 in a local environment is possible for a code generation apparatus 120 even in areas in which connection to the Internet is not possible or in situations in which connecting is difficult due to large numbers of people crowded together during disasters, events, or the like. However, regarding the registration of a device ID, the registration may be made in anticipation of an increase in the number of code generation apparatuses 120. Also, if a code generation apparatus 120 is stolen, lost, or forged, it is necessary to update the registration information in a first information processing apparatus 310 by obtaining such information from a third information processing apparatus 330 when it is in a state where it can be connected to the Internet.

(Recognition of a Code Generation Apparatus in Contact with a Touch Panel 31 of the First Information Processing Apparatus 310)

As described above, when a code generation apparatus 120 is brought into contact with or substantially into contact with a touch panel 31 of a first information processing apparatus 310, the first information processing apparatus 310 reads an electrode pattern, and an electrode code based on the electrode pattern is recognized. To establish a connection with the code generation apparatus 120, the first information processing apparatus 310 needs to be connected to the code generation apparatus 120 corresponding to the electrode code, so first information processing apparatus 310 searches for a communication address corresponding to the electrode code or a part of the electrode code. If there is only one applicable communication address, it is sufficient to establish a connected state with the corresponding code generation apparatus 120. However, during the search, there is a possibility that a plurality of code generation apparatuses 120 in the vicinity that have the same electrode pattern are found in the search, or in other words, there may be a plurality of code generation apparatuses 120 equipped with a communication processing unit 32 in the vicinity having the same communication address. To be prepared for such a situation, the following methods, including an example in which the code generation apparatus 120 is equipped with a sensing unit that senses a state of being in contact or substantial being in contact with the touch panel 31, may be used to selectively recognize only the communication processing unit 32 of the code generation apparatus 120 that is in contact or substantially in contact with the touch panel 31 by combining the communication address corresponding to at least a part of the electrode code detected by the touch panel 31, and to establish a connected state. The sensing unit may be a configurational component that detects changes in a physical quantity.

(1) The first information processing unit 310 sequentially makes connections with a plurality of code generation apparatuses 120 having the same communication address retrieved by the first information processing unit 310, the time information of when the code generation apparatus 120 was pressed and the time information of when the first information processing unit 310 received a contact by the code generation apparatus 120 are perceived, respectively by each apparatus, the time information of when the code generation apparatus 120 was pressed is transmitted to the first information processing unit 310, and the code generation apparatus 120 that made contact or substantially made contact can be identified if the time information of the time of pressing received by the first information processing unit 310 and the time information of when the code generation apparatus 120 made contact or substantially made contact stored by the first information processing unit 310 are collated and found to be substantially the same. As a result, based on the unique device ID obtained from the code generation apparatus 120 that was pressed can be recognized.
(2) When a code generation apparatus 120 comes into contact with the touch panel 31 of a first information processing apparatus, a physical quantity generated on the surface of the touch panel side changes. Thus, a touch panel recognition sensor 134, which detects a physical quantity as a sensing unit, may be installed at a predetermined position of the code generation apparatus 120, and it may analyze whether a detected change in a physical quantity is due to a contact or a substantial contact by the code generation apparatus 120 with the touch panel 31. If whether or not a contact or a substantial contact has been made can be determined, the communication processing unit 32 of the code generation apparatus 120 may be put in a connection standby state, and the first information processing unit 310 may search for the communication address of the relevant communication processing unit 32, make a connection to it, and acquire a device ID. The above-mentioned physical quantity may be, for example, a resistance value of a resistive touch panel 31.
(3) As a method of recognizing a first information processing device 310 that is closest to a code generation apparatus 120, a beacon may be used. If a beacon is built in a code generation apparatus 120 and a radio wave transmitted by the beacon is detected by using the radio wave intensity detection function of a Bluetooth (including BLE) unit installed on the first information processing apparatus 310, a connection in accordance with distance is possible. In particular, since the first information processing apparatus 310 is at a very short distance of 1 m or less with respect to the code generation apparatus 120, by the radio wave intensity of the beacon, the closest first information processing apparatus 310 may be recognized with the radio wave intensity detection device, may be connected, and the device ID may be transmitted. Alternatively, GPS may be used for the mutual recognition of the position of the partner. For example, if GPS is installed in a code generation apparatus 120, together with GPS installed in the first information processing apparatus 310, the positions of partners may mutually be recognized, and the relevant code generation apparatus 120 may be identified based on the shortest interdistance. That is, as in (1), the first information processing apparatus 310 sequentially makes connections with a plurality of code generation apparatuses 120 having the same communication address, receives position information from the code generation apparatuses 120, the code generation apparatus 120, which is within a predetermined distance from the information processing apparatus 310 and is the closest in distance, may be recognized and be connected, and the device ID may be obtained.
(4) If photodetector sensors, that is, light receiving units 360 (photodiode) are installed as sensing units on the side of a code generation apparatus 120 for making contact with a touch panel, the code generation apparatus 120 comes into contact with or substantially into contact with the touch panel 31, and the first information processing apparatus 310 detects an electrode pattern, the positions of the photosensors may be recognized from the electrode pattern, an optical code notifying at least the establishment of contact may be emitted from the touch panel 31, and with the optical code the code generation apparatus 120 may recognize whether or not a contact or a substantial contact has been made. Then the communication processing unit 32 of the code generation apparatus 120 may be put in a connection standby state, and the first information processing unit 310 may search for the communication address of the relevant communication processing unit 32, make a connection to it, and acquire a device ID. An optical code refers to a code based on the enumeration of a light pattern formed by the color, intensity, or time change of light blinking, or a combination of any of these. As the time change, each time interval may be changed to form a sequence like a Morse code. That is, by changing in a time series at least one of the color of the light, the intensity of light, and the blinking time, time-series data formed by the history of these changes may be used as an optical code. When a plurality of light receiving units 360 are provided, the touch panel 31 may recognize the positions of the plurality of light receiving units 360 from the unique shape of the detected electrode 5 and the unique geometric arrangement of the electrode patterns, and light may be emitted in accordance with each light receiving unit 360. Of course, the light emission may be changed with time to obtain time-series data. Note that when only one light receiving unit 360 is provided, an optical code may be emitted upon recognizing the position from the detected electrodes 5, or an optical code may be emitted over the entire contact area of 120 of at least the code generation apparatus 120 predetermined in the touch panel 31.

This optical code may include not only information on whether or not contact or substantial contact has been made, but may also include various information transmitted from the first information processing apparatus 310. For example, it may include various information such as personal information, settlement information, reward point and coupon information, prepay balance information, various ticket information for transportation, lodging, events, and the like, various membership information, IDs, passwords, and the like. This makes it possible to transmit/receive information without establishing a connected state between the first information processing apparatus 310 and the code generation apparatus 120. Furthermore, for a code generation apparatus 120 capable of switching an electrode pattern electrically as described above, by a program that runs in the communication processing section 32, information corresponding to the received information may be transmitted as an electrode code through electrode pattern switching. In such a case, a wireless connection function of the communication processing section 32 may need not be installed, or it may be installed for transmitting/receiving information through a connection with a second information processing unit 320. The above may be combined in any way with the configuration of the code generation apparatus 120 described in this description.

The connection method is not limited to any of the above or a combination thereof, and any method may be used provided that the code generation apparatus 120 in contact with the touch panel 31 of a first information processing apparatus 310 can be recognized and the two can be connected.

In the following sections, described are transmission/reception of information to enter a connection state, transmission/reception of information after entering a connection state, and information processing based on the transmission/reception of information.

(Connection Between a Code Generation Apparatus and a First Information Processing Apparatus)

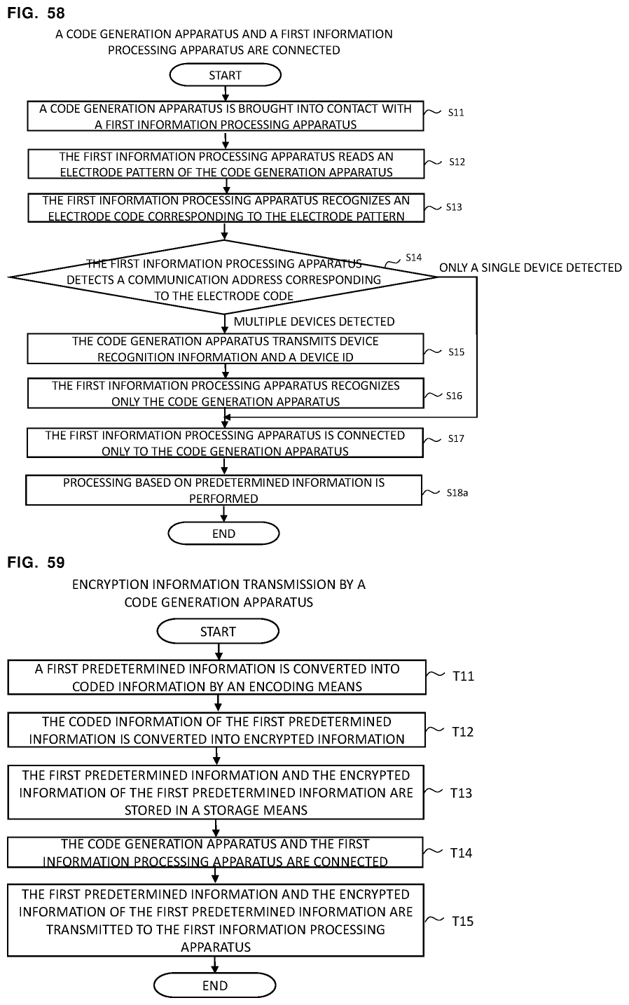

In the present invention, as described above, information processing including connecting with other information processing apparatuses may be executed by a communication connection between a code generation apparatus 120 and a first information processing apparatus 310. The connecting process is exemplified in FIG. 58 for each step.

First, a code generation apparatus 120 is brought into contact with a first information processing apparatus 310. In the case of a three-dimensional stamp, the code changeover switch 131 may be operated, the power ON/OFF switch may be operated, and in the case of a stamp-type apparatus, it may be placed on the first information processing apparatus 310 while keeping hold of the handle contact section 21 (synonymous with the human body contact conductive member 21), and in the case of a card-type apparatus, it may be made to make contact or substantially make contact with the information processing apparatus 310 by bringing the electrode arrangement region into surface contact with the information processing apparatus 310. Also, in the case of a plate-shaped card, the power ON/OFF switch may be operated and the card may be made to make contact or substantially make contact with an information processing apparatus 310 while holding the contact section 21 formed of the conductive member. (S11). The first information processing apparatus 310 may detect an electrode pattern of the code generation apparatus 120 (S12). Then, the first information processing apparatus 310 may be made to recognize an electrode code corresponding to the electrode pattern. (S13). Then, the first information processing apparatus 310 searches for the communication address corresponding to the electrode code stored in advance (S14). Note that if a communication address set based on a predetermined rule can be recognized from at least a part of the electrode code, it is not necessary to store the communication address in advance in the first information processing apparatus 310. If only one corresponding communication address is retrieved, the first information processing apparatus 310 may be connected to the code generation apparatus 120 corresponding to the communication address (S17). The connected code generation apparatus 120 transmits a unique device ID to the first information processing apparatus 310 (S15). The first information processing apparatus 310 that receives the device ID identifies the code generation apparatus 120 from the device ID and recognizes the apparatus (S16). If there is more than one code generation apparatus 120 corresponding to the corresponding communication address (there may be cases where the communication address is the same and cases where they are different), although not shown in a figure, at least one of (1) to (4) described above (recognition of the code generation apparatus 120 in contact with the touch panel 31 of a first information processing apparatus 310) may be used to identify the code generation apparatus 120, and the first information processing apparatus 310 may establish a connection only to the relevant code generation apparatus 120 (S17). Provided that the code generation apparatus 120 that has come into contact or substantially has come in contact with the first information processing apparatus 310 can be identified, other means may be resorted to. Consequently, after a connection is authenticated by the above procedures, the code generation apparatus 120 and the first information processing apparatus 310 may be connected and various information may be transmitted/received. Furthermore, various processings may be executed based on the information. The processings may include making connections with various information processing apparatuses shown below, the transmission/reception of predetermined information, processings based on information, and the disconnection of communication. (S18a).

The procedures may be in a different order from the above. That is, if a communication address includes a unique identifier that can be used to recognize an apparatus as a code generation apparatus 120, the first information processing apparatus 310 may enter a communication state with a plurality of code generation apparatuses 120 in the vicinity, and the electrode codes of the code generation apparatuses 120 may be read by the first information processing apparatus 310. If there is only a single communication address in a communication state that corresponds to the retrieved electrode code, a connected state may be established immediately. Then, the connection time is shortened, and a predetermined processing can be executed at the moment an electrode code is recognized. If there is a plurality of communication addresses corresponding to the recognized electrode code, at least one of (1) to (4) described above (recognition of the code generation apparatus 120 in contact with the touch panel 31 of a first information processing apparatus 310) may be used to identify the code generation apparatus 120, and the first information processing apparatus 310 may establish a connection only to the relevant code generation apparatus 120. Provided that the code generation apparatus 120 that is making contact or substantially making contact with a first information processing apparatus 310 can be identified, other means may be resorted to. Conversely, if there is no communication address in a communication state corresponding to the detected electrode code, the first information processing apparatus 310 notifies the code generation apparatuses 120 in the communication state that there was a misidentification, and the code generation apparatus 120 may generate an alert to prompt the code generation apparatus 120 to retry making contact with the first information processing apparatus 310. If there is still a mismatch when the code generation apparatus 120 is brought into contact with the first information processing apparatus 310 and the electrode code is read again, communication may be disconnected. Note that the number of times these processes may be executed may be predetermined.

(Determination of the Authenticity of Predetermined Information)

When information is transmitted/received between a code generation apparatus 120 and various information processing apparatuses, there is a possibility that the information may be tampered with or that information may be missing due to communication errors. Therefore, if the transmitting side transmits the original information and encrypted information at the same time, and the receiving side of the information, decrypts the encrypted information, collates it with the original information, and if they match, it can be confirmed that the data has not been tampered with. FIG. 59 exemplifies the process of generating information and encrypted information thereof transmitted from a code generation apparatus 120 to a first information processing apparatus 310 step by step.

In a situation where a code generation apparatus 120 and a first information processing apparatus 310 are in a communication connection state, first of all, the first predetermined information is converted into encoded information by an encoding method. Here, encoding includes performing irreversible transformation of data using a hash function to obtain a code sequence. And, the encoded information encoded using a hash function contains a hash value (T11). Next, the encoded information of the first predetermined information is converted into encrypted information using an encryption means (T12). The first predetermined information and the encrypted information of the first predetermined information are stored in a storage means of the code generation apparatus 120 (T13). Next, the code generation apparatus 120 establishes a connection with the first information processing apparatus 310 using the procedures shown in FIG. 58 or the like (T14). Then, the code generation apparatus 120 transmits the first predetermined information and the encrypted information of the first predetermined information to the first information processing apparatus 310 (T15).

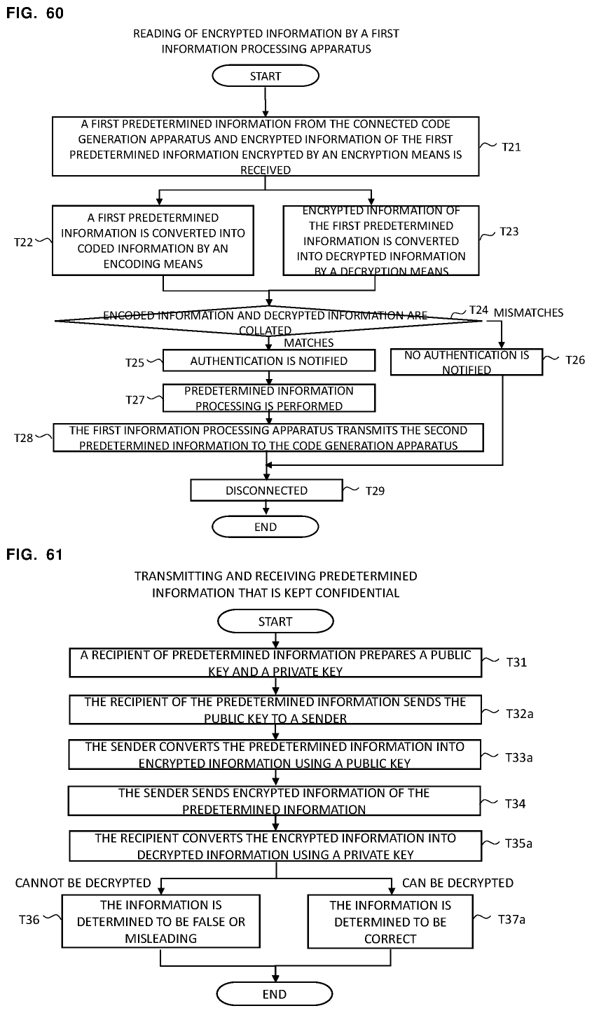

FIG. 60 exemplifies a process of the first information processing apparatus 310 reading the received first predetermined information and encrypted information thereof, and performing authenticity determination (determination of right/wrong) step by step.

The first information processing apparatus 310 receives the first predetermined information and the encrypted information of the first predetermined information transmitted from the connected code generation apparatus 120 (T21). The first predetermined information is converted into encoded information by an encoding means (T22). Furthermore, the encrypted information of the first predetermined information is converted into decrypted information by a decryption means (T23). Then, the encoded information and the decrypted information are collated. For example, if the information is converted into a hash value using a hash function as the encoding means, hash values are collated (T24). If the encoded information and the decrypted information match, the first information processing apparatus 310 transmits a notification of “authenticated” to the code generation apparatus 120 as the second predetermined information (T25). If the encoded information and the decrypted information do not match, the first information processing apparatus 310 transmits a notification of “not authenticated” to the code generation apparatus 120 as the second predetermined information. Since there is a possibility that the information may have been mismatched due to misreading by the first information processing apparatus 310, the notification may include a content prompting a re-reading. Upon receiving the notification, the code generation apparatus 120 notifies the user of the notification content as an alert, either as text or graphics on an apparatus with a display, as a vibration on an apparatus with a vibrator, or as a sound on an audio output apparatus. If the alert indicates “not authenticated,” the user may assume that there has been a misidentification and may attempt to retransmit the predetermined information, or may disconnect on his/her own. As a method of retransmission, a retransmission switch may be provided, and the user may operate the switch to retransmit the information that has already been read, or the switch may be set to automatically retransmit the information. Alternatively, assuming that there has been a misreading, the code generation apparatus 120 may be brought into contact or substantially into contact with the first information processing apparatus 310 again to have the information be read again (T26). Since it is unlikely that the reading errors continue so many times when retransmission is attempted, after a predetermined number of reading attempts resulting in mismatches, the connection may be disconnected. It may be that there is a defect in the data. However, even in such a case, it is meaningless to repeat attempts (T29). If the information is authenticated, predetermined information processing is executed (T27). The end of the processing and the result of the processing may be transmitted by the first information processing apparatus 310 to the code generation apparatus 120 as the second predetermined information (T28). The connection may be set to be automatically disconnected based on the information notifying the end of the processing. Alternatively, whether or not to disconnect may be interactively decided (T29). In addition, the disconnection of a connection may be executed in any way.

The series of procedures here are merely examples, and any method can be used provided that the authenticity of information can be evaluated in the same manner. Furthermore, in the above example, described is the first predetermined information. However, the same procedures can be applied for the second to eighth predetermined information for transmitting/receiving information, determining authenticity, and transmitting the results to the sender of the predetermined information.

As the encryption means in the above-described method, any encryption means may be used provided that it is of a high security level, and by using a public key-private key combination, it is possible to maintain a high degree of confidentiality and to guarantee a high level of integrity and authenticity.

A method of maintaining confidentiality of information is exemplified in the flowchart in FIG. 61. The recipient of a predetermined information prepares a public key and a private key as a pair (T31). The public key is transmitted to the sender of the predetermined information, and the private key is securely stored (T32a). The sender of the predetermined information uses the public key to convert the predetermined information into encrypted information (T33a). Then, the sender of the predetermined information transmits the encrypted information to the recipient of the information (T34). The receiver of the encrypted information of the predetermined information attempts to convert it into decrypted information using the private key (T35a). As a result, if the information cannot be decrypted, it is judged to be erroneous or false information, and the receiver can ask the sender to retransmit the encrypted information of the predetermined information (T36). If the information can be decrypted, it can be judged as correct information. Without the secret key of the pair, it is basically impossible to decrypt the encrypted information, so confidentiality can be maintained in transmitting/receiving information (T37a). Even if the public key sent by the recipient of the predetermined information is stolen and fake encrypted information created with it is sent, the authenticity of the information can be confirmed by making an inquiry to the sender or by making an agreement on the ID in advance.

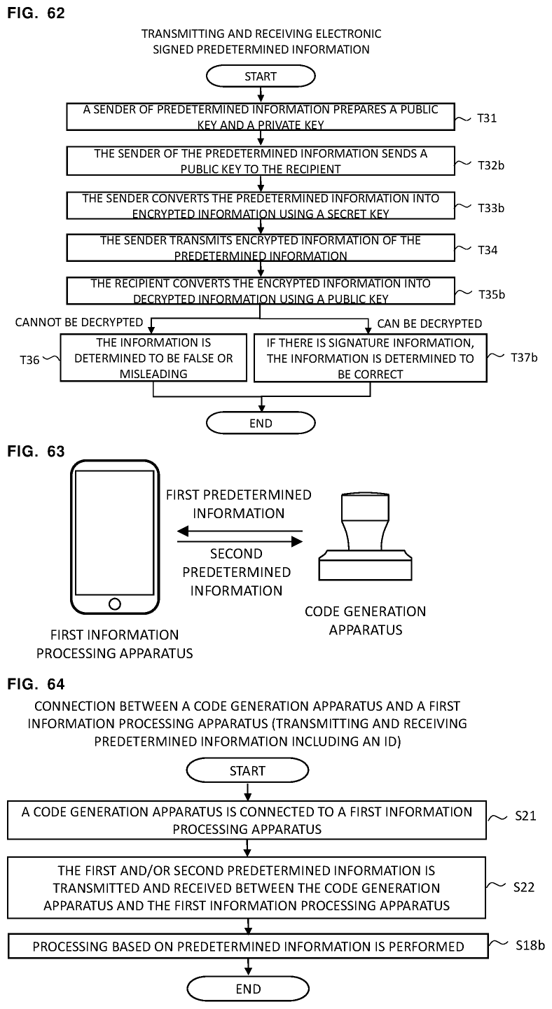

On the other hand, the transmission/reception of digitally signed predetermined information is exemplified in the flowchart of FIG. 62. The sender of the predetermined information prepares a public key and a private key as a pair (T31). The public key among them is transmitted to the recipient of the predetermined information (T32b). The sender of the predetermined information uses the private key to convert the predetermined information and the signature information into encrypted information (T33b). Then, the sender of the predetermined information transmits the encrypted information to the receiver of the information (T34). The recipient of the encrypted information of the predetermined information converts it into decrypted information using the public key (T35b). As a result, if the information cannot be decrypted, it is judged to be erroneous or false information, and the receiver can ask the sender to retransmit the encrypted information of the predetermined information (T36). If the information can be decrypted and if it is digitally signed information, it can be judged as correct information. If the predetermined information has signature information, it can be determined to be encrypted information created by the owner of the private key, since the encrypted information cannot be decrypted with the public key of the pair unless it was created with the private key of the pair (T37b). If the public key sent by the recipient of the predetermined information is stolen, there is a possibility of the information being leaked. However, since it cannot be rewritten, the authenticity and integrity of the information can be guaranteed.

Note that the method of using a public key-private key pair and the method of using a hash function may be combined.

### Tenth Embodiment

In an information communication system that includes at least one of the first to third information processing apparatuses and has two or more information processing apparatuses, including a case where there is a plurality of apparatuses of the same type, at least one of the combinations of apparatuses is generally in a state of communication connection. For example, a smartphone and a local server in a workplace or the like may always be connected via WiFi. Needless to say, the same kind of connected state is assumed in an information communication system of the present invention. However, here, the transmission/reception of predetermined information in an information processing system in which the connection between the code generation apparatus 120 and at least one of the first to third information processing apparatuses is established by a connection between the code generation apparatus 120 and the first information processing apparatus 310 as an initiator (trigger) is exemplified in FIGS. 63 to 75. Note that for systems of FIGS. 64 to 75, a connection between at least two of the first to third information processing apparatuses may be established with the establishment of a connected state between the code generation apparatus 120 and the first information processing apparatus 310.

(Information Communication System Configuration 1: Code Generation Apparatus and First Information Processing Apparatus)

FIG. 63 shows an example of the most basic system comprising a code generation apparatus 120 and a first information processing apparatus 310. In this system, after the code generation apparatus 120 establishes a connected state with the first information processing apparatus 310, either the first or second predetermined information is transmitted/received between the code generation apparatus 120 and the first information processing apparatus 310.

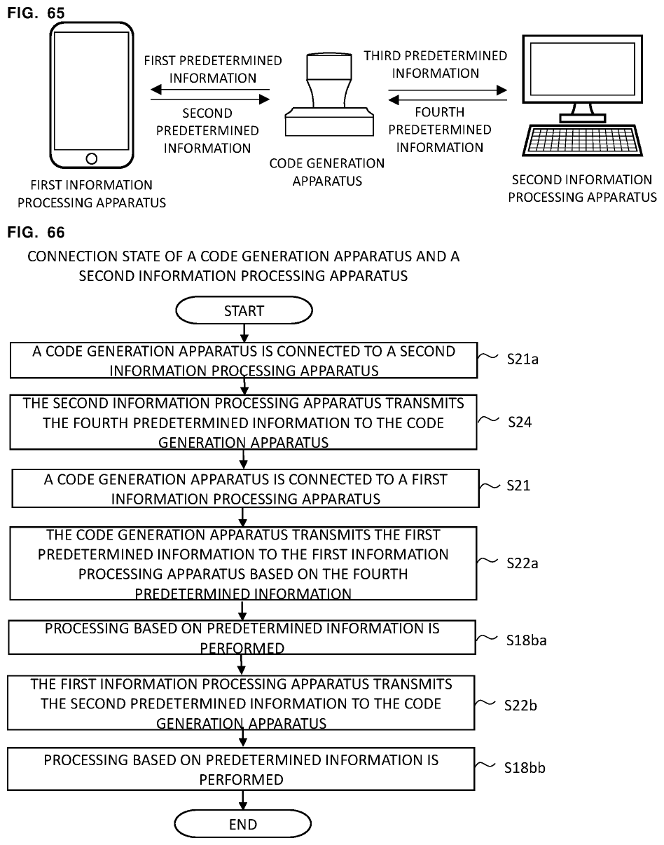

FIG. 64 exemplifies this process in a simplified flowchart. First, a first information processing apparatus 310 establishes a connection with a code generation apparatus 120 following the procedures of FIG. 58 (S21). Subsequently, at least one of the first and/or second predetermined information is transmitted/received between the code generation apparatus 120 and the first information processing apparatus 310 (S22). For example, the first predetermined information may be the device ID of the code generation apparatus 120 or the information stored in advance. Information such as tickets, services, and advertisements may be transmitted from coupons and points to this information. The first predetermined information may be, for example, the device ID of the code generation apparatus 120, or it may be information stored in advance. This information may include information from coupons and points to tickets, services, advertisements, and the like, and may be sent. The second predetermined information received from the first information processing apparatus 310 thereafter may be any kind of information, including the ID of the first information processing apparatus 310, information identifying its owner, and information associated with the first information, and the second predetermined information may be stored in a storage means of the code generation apparatus 120. Thereafter, the recorded information may then be transmitted to a second information processor 320 as in the system of FIG. 65. Note that the above order of transmission/reception may be reversed. Processing based on at least one of the first and second predetermined information is executed and the processing may include the disconnection of the connection between the code generation apparatus 120 and the first information processing apparatus 310. The disconnection may include cases where disconnection is executed by an operation by a user, processing based on received predetermined information, or automatically after a predetermined period of time from the last action (S18b).

The above are basic procedures, and information transmission/reception and information processing may be executed a plurality of times.

Note that the first predetermined information and the following predetermined information may include information of a device ID or an electrode code of the code generation apparatus 120. Furthermore, the predetermined information may include time information or information that changes with time. In addition, a communication address such as a MAC address, a BD address, an SSID, an ICCID, an IP address, or the like assigned to the communication processing apparatus 32 may be used as a code (first specific code) for identifying the first information processing apparatus 310 and the following second information processing apparatus 320 and the third information processing apparatus 330, or an ID (second specific code) may be set independently for an information processing apparatus by operating software, a WEB site, or the like. And the second predetermined information may include at least one of the first specific code and the second specific code of the information processing apparatus in addition to the device ID of the code generation apparatus 120. The predetermined processing may include making connections with various other information processing apparatuses, transmission/reception of predetermined information, other processing based on information, and communication disconnection. The predetermined information and ID shown here may be applied to other information communication system configurations, including configurations not exemplified.

In a stamp rally, the code generation apparatus 120 may transmit “granting” or “erasing” of a digital stamp to a first information processing apparatus 310 such as a smartphone as the first predetermined information, and the code generation apparatus 120 may receive specific ID information such as membership information from a smartphone as the second predetermined information and the history may be stored.

(Information Communication System Configuration 2: Code Generation Apparatus and First and Second Information Processors)

FIG. 65 shows an example of a system comprising a code generation apparatus 120, a first information processing apparatus 310, and a second information processing apparatus 320. Shown is a system in which a second information processing apparatus 320 to which the code generation apparatus 120 is connected is added to the configuration of FIG. 63, and the code generation apparatus 120 and the second information processing apparatus 320 transmit/receive the third and/or fourth predetermined information.

FIG. 66 exemplifies this process in a simplified flowchart. A second information processing apparatus 320 and a code generation apparatus 120 make a communication connection by a predetermined method (S21a), and the second information processing apparatus 320 transmits the fourth predetermined information to the code generation apparatus 120 (S24), and at least a part thereof is temporarily stored in a storage means of the code generation apparatus 120. Subsequently, following the procedures of FIG. 58 or the like, the first information processing apparatus 310 makes a communication connection with the code generation apparatus 120 (S21), and the first predetermined information which includes at least a part of the fourth predetermined information stored in a storage means is transmitted from the code generation apparatus 120 to the first information processing apparatus 310 (S22a). Thereafter, processing based on the first predetermined information from the first information processing apparatus 310 is executed (S18ba), and the second predetermined information corresponding to the processing is transmitted to the code generation apparatus 120. In this case, the processing based on the first predetermined information may include the disconnection of the connection between the code generation apparatus 120 and the first and/or second information processing apparatuses 320 (S22b). Furthermore, the third predetermined information that includes at least a part of the second predetermined information and/or is associated with the second predetermined information is transmitted to the second information processing apparatus 320 (S18bb).

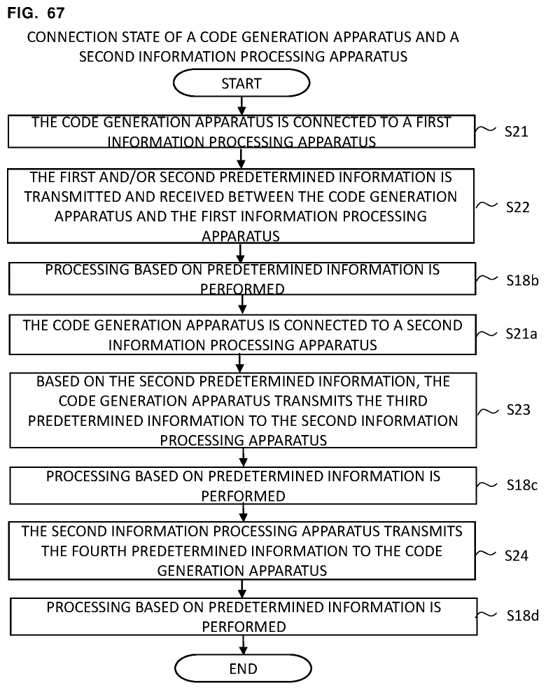

As a modified method, as exemplified in the flowchart of FIG. 67, there is also the following procedure. First, with the code generation apparatus 120 and the second information processing apparatus 320 in a connected state, and the first information processing apparatus 310 establish a connection with the code generation apparatus 120 following the procedures shown in FIG. 58 (S21). Subsequently, the first and/or second predetermined information is transmitted/received between the code generation apparatus 120 and the first information processing apparatus 310 (S22). Processing is executed based on at least one of the first and second predetermined information. This processing may include connecting and/or disconnecting the code generation apparatus 120 with the first information processing apparatus 310 and the second information processing apparatus 320. Note that these processings may be applied to other information communication system configurations. Furthermore, when the code generation apparatus 120 and the second information processing apparatus 320 are in a connected state, and the first information processing apparatus 310 requests a connection to the code generation apparatus 120, the code generation apparatus 120 may disconnect the connection with the second information processing apparatus 320 and may make a connection with the first information processing apparatus 310. (S18b). Subsequently, with the code generation apparatus 120 and the second information processing apparatus 320 in a connected state, the code generation apparatus 120 transmits the third predetermined information to the second information processing apparatus 320 based on the second predetermined information (S23). Then, processing based on at least one of the above predetermined information is executed (S18c). Then, the second information processing apparatus 320 transmits the fourth predetermined information to the code generation apparatus 120 (S24). Then, processing based on at least one of the above predetermined information is executed. This processing may include the disconnection of the connection between the code generation apparatus 120 and the second information processing apparatus 320. Note that regardless of the connection state between the first information processing apparatus 310 and the code generation apparatus 120 established following the connection method shown in FIG. 58, the code generation apparatus 120 and the second information processing apparatus 320 may always be in a connected state. Disconnection may include cases where disconnection is executed by an operation by a user or automatically after a predetermined period of time from the last action (S18d).

The first example merely describes basic procedures, and the order of the procedures may be changed, as in the modified method. And at least one of the transmissions/receptions of information and information processing may be executed a plurality of times, or at least one of the processes of transmission/reception of predetermined information and information processing may be omitted. At least one of the first or third predetermined information may include information of a device ID or an electrode code of the code generation apparatus 120. They may also be included in other predetermined information. Furthermore, the predetermined information may include time information or information that changes with time. Furthermore, at least one of the predetermined information may also include at least one of the first and second specific codes of at least one of the information processing apparatuses. The first predetermined information may include at least a part of the fourth predetermined information, and the third predetermined information may include at least a part of the second predetermined information. Including the above, the predetermined processing may include making a connection between the third information processing apparatus 330 and the first information processing apparatus 310 or the second information processing apparatus 320, or the disconnection of at least one of the connections between the code generation apparatus 120 and the first information processing apparatus 310 or the second information processing apparatus 320. The predetermined processing may include making connections with various other information processing apparatuses, transmission/reception of predetermined information, and other processings based on the information, and the disconnection of communication.

For example, in a stamp rally where the code generation apparatus 120 grants a digital stamp to the first information processing apparatus 310 such as a smartphone and manages the granting history, the code generation apparatus 120 can transmit the granting history in association with a membership ID to the second information processing apparatus 320 for data management as the third predetermined information so that information can be managed.

A similar system configuration can be used to manage the “granting” and “canceling” of reward points and coupons at stores.

Conversely, when a user uses a card-type code generation apparatus 120 as a financial settlement card such as a credit card and a prepaid card, or as a point card and the like, and brings the card into surface contact with a touch panel of a first information processing apparatus 310 of the store to perform processing such as a “settlement,” “granting” of reward points or coupons, “cancellation,” or the like, if the second information processing apparatus 320 is a smartphone of a user, the settlement details processed by the first information processing apparatus 310 and the balance of the granted coupons and reward points may be transmitted by an operation of the code generation apparatus 120, and can be confirmed on the display of the smartphone. Note that when the connection destination of the code generation apparatus 120 is switched between the first information processing apparatus 310 and the second information processing apparatus 320, connection is disconnected and then reconnected. Then, the connection may be disconnected with the connection information saved. Note that regardless of the connection state between the first information processing apparatus 310 and the code generation apparatus 120 associated with the connection method shown in FIG. 58, the code generation apparatus 120 and the second information processing apparatus 320 may always be in a connected state based on a predetermined operation. Furthermore, the same applies to the configurations of other information communication systems. Similarly, when reversing the host-guest relationship with an information processing apparatus, the connection may be disconnected temporarily with the connection information saved, and the information may be processed according to a predetermined method (with a program or the like) so that the first information processing apparatus 310 becomes the guest and the code generation apparatus 120 becomes the host.

(Information Communication System Configuration 3: Code Generation Apparatus and the First and Third Information Processors)

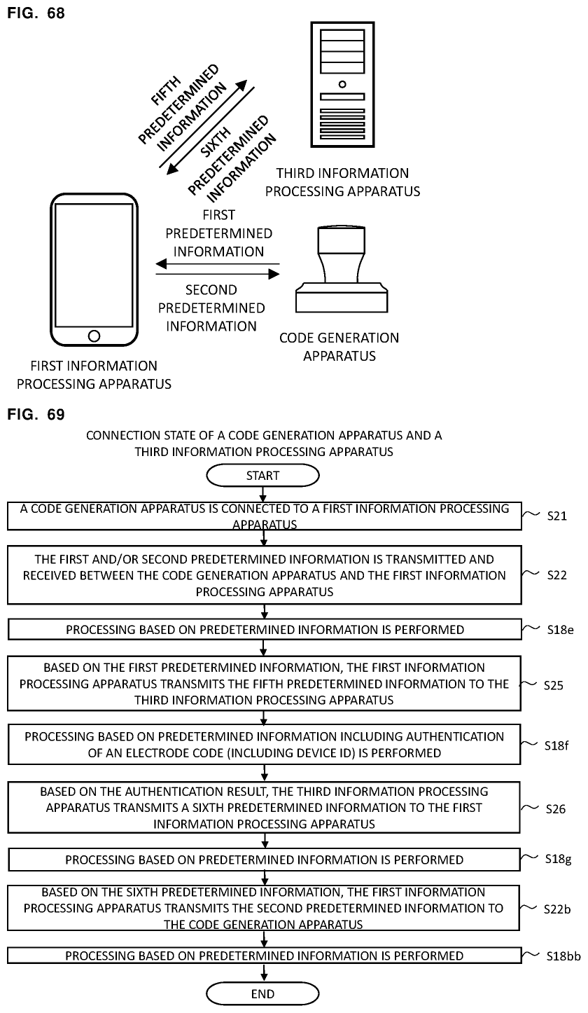

FIG. 68 shows an example of a system comprising a code generation apparatus 120, a first information processing apparatus 310, and a third information processing apparatus 330. Shown is a system in which a third information processing apparatus 330 that is in a connection state with the first information processing apparatus is added to the configuration of FIG. 63, and the first information processing apparatus 310 and the third information processing apparatus 330 transmit/receive the fourth and/or fifth predetermined information.

FIG. 69 exemplifies this process in a simplified flowchart. First, the first information processing apparatus 310 establishes a connected state with the code generation apparatus 120 following the procedures of FIG. 58 (S21). Subsequently, the first and/or second predetermined information is transmitted/received between the code generation apparatus 120 and the first information processing apparatus 310 (S22). Processing is executed based on at least one of the first and second predetermined information. In this processing, it is not necessary to disconnect the connection between the code generation apparatus 120 and the first information processing apparatus 310 (S18e). Next, based on the first predetermined information, the first information processing apparatus 310 transmits the fifth predetermined information to the third information processing apparatus 330. Note that the second information processing apparatus 320 may be used as the third information processing apparatus 330 (S25). Then, based on the predetermined information including the authentication of an electrode code (including the device ID), a processing is executed (S18f). Then, based on the authentication result, the third information processing apparatus 330 transmits the sixth predetermined information to the first information processing apparatus 310 (S26). Then, processing based on at least one of the above predetermined information is executed (S18g). Furthermore, the first information processing apparatus 310 transmits the second predetermined information to the code generation apparatus 120 based on the sixth predetermined information (S27). Then, processing based on at least one of the above predetermined information is executed. Note that this process may include the disconnection of the connection between the code generation apparatus 120 and the first information processing apparatus 310. The disconnection may include a case where the disconnection is executed by an operation by a user, processing based on received predetermined information, or automatically after a predetermined period of time from the last action (S18h).

The above are basic procedures, and the order of the procedures may be changed. And at least one of the transmissions/receptions of information and information processing may be executed a plurality of times, or at least one of the processes of transmission/reception of predetermined information and information processing may be omitted. At least one of the first or third predetermined information may include information of a device ID of the code generation apparatus 120 and an electrode code. They may also be included in other predetermined information. Furthermore, the predetermined information may include time information or information that changes with time. Also, at least one of the predetermined information may include at least one of the first and second specific codes of at least one of the information processing apparatuses. The first predetermined information may include at least a part of the fourth predetermined information, and the third predetermined information may include at least a part of the second predetermined information. Including the above, the predetermined processing may include making a connection between the third information processing apparatus 330 and the first information processing apparatus 310 or the second information processing apparatus 320, or the disconnection of at least one of the connections between the code generation apparatus 120 and the first information processing apparatus 310 or the second information processing apparatus 320. The predetermined processing may include making connections with various other information processing apparatuses, transmission/reception of predetermined information, and other processings based on the information, and the disconnection of communication.

The third information processing apparatus 330 is, for example, a server, which stores customer IDs, electrode codes, device IDs, and the like in advance, and if the fifth predetermined information based on the first predetermined information transmitted from the code generation apparatus 120 to the first information processing apparatus 310 includes a customer ID, an electrode code, a device ID, and the like, by collating with customer IDs, electrode codes, device IDs, and the like stored in the third information processing apparatus 330, at least a part of the fifth predetermined information may be authenticated.

(Information Communication System Configuration 4: Code Generation Apparatus 120 and First Through Third Information Processors)

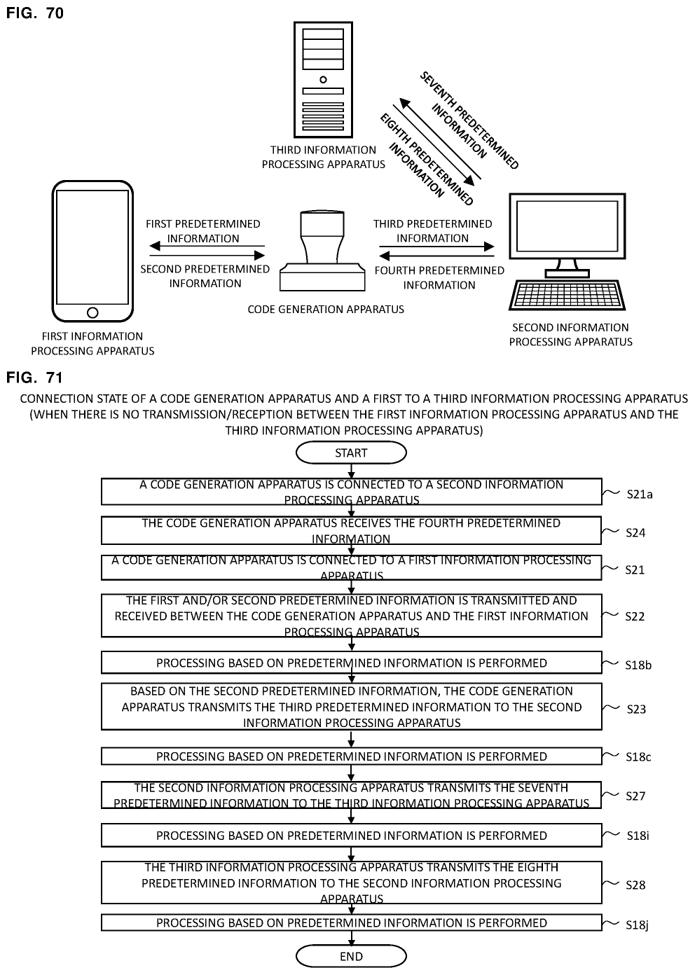

FIG. 70 is an example of a system comprising a code generation apparatus 120 and the first to third information processing apparatuses. Shown is a system in which a third information processing apparatus 330 is added to the configuration of FIG. 65, and the second information processing apparatus 320 and the third information processing apparatus 330 transmit the seventh and/or eighth predetermined information.

FIG. 71 exemplifies this process in a simplified flowchart. First, the second information processing apparatus 310 and the code generation apparatus 120 establish a connection (S21a). Subsequently, the second information processing apparatus 320 transmits the fourth predetermined information to the code generation apparatus 120 (S24). Then, the second information processing apparatus 310 and the code generation apparatus 120 are disconnected while keeping store of the predetermined information, and the first information processing apparatus 310 establishes a connection with the code generation apparatus 120 (S21). Subsequently, the first and/or second predetermined information is transmitted/received between the code generation apparatus 120 and the first information processing apparatus 310 (S22). Processing is executed based on at least one of the first and second predetermined information. This process may include disconnecting the connection between the code generation apparatus 120 and the first information processing apparatus 310 and making a connection between the code generation apparatus 120 and the second information processing apparatus 320. When the code generation apparatus 120 and the second information processing apparatus 320 are in a connected state, and the first information processing apparatus 310 requests a connection to the code generation apparatus 120, the code generation apparatus 120 may disconnect the connection with the second information processing apparatus 320 and make a connection with the first information processing apparatus 310 (S18 b). With the code generation apparatus 120 and the second information processing apparatus 320 in a connected state, the code generation apparatus 120 transmits the third predetermined information to the second information processing apparatus 320 based on the second predetermined information (S23). Then, processing based on at least one of the above predetermined information is executed (S18c). The second information processing apparatus 320 establishes a connected state with the third information processing apparatus 330, and the second information processing apparatus 320 transmits the seventh predetermined information to the third information processing apparatus 330 (S27). Then, processing based on at least one of the above predetermined information is executed (S18i). Then, the third information processing apparatus 330 transmits the eighth predetermined information to the second information processing apparatus 320 (S28). Then, processing based on at least one of the above predetermined information is executed. Note that this processing may include the disconnection of the connection between the code generation apparatus 120 and the second information processing apparatus 320. Regardless of the connection state between the first information processing apparatus 310 and the code generation apparatus 120 associated with the connection method shown in FIG. 58, at least one of the code generation apparatus 120 and the second information processing apparatus 320 and the second information processing apparatus 320 and the third information processing apparatus 330 may always be connected. The disconnection may include a case where the disconnection is executed by an operation by a user, processing based on received predetermined information, or automatically after a predetermined period of time from the last action (S18j).

The above are basic procedures, and information transmission/reception and information processing may be executed a plurality of times. The order of the steps may be changed. And at least one of the transmissions/receptions of information and information processing may be executed a plurality of times, or at least one of the processes of transmission/reception of predetermined information and information processing may be omitted. At least one of the first or third predetermined information may include information of a device ID or an electrode code of the code generation apparatus 120. Other predetermined information may also be included. Furthermore, the predetermined information may include time information or information that changes with time. Furthermore, at least one of the predetermined information may include at least one of the first and the second specific codes of at least one of the information processing apparatuses. The first predetermined information may include at least part of the fourth predetermined information, and the third predetermined information may include at least part of the second predetermined information. Including the above, the predetermined processing may include making a connection between the third information processing apparatus 330 and the first information processing apparatus 310 or the second information processing apparatus 320, or the disconnection of at least one of the connections between the code generation apparatus 120 and the first information processing apparatus 310 or the second information processing apparatus 320. The predetermined processing may include making connections with various other information processing apparatuses, transmission/reception of predetermined information, and other processings based on the information, and the disconnection of communication.

In a smart POS system, the second information processing apparatus 320 may include a smart POS cash register such as a tablet POS cash register, and detailed information of the products to be purchased (item name, item code, unit price, quantity, subtotal for each item, total, and the like) entered in the POS system may be transmitted to the code generation apparatus 120 of the store as the fourth predetermined information, and the code generation apparatus 120 may temporarily store it. After disconnecting the connection state with the second information processing apparatus 320, the purchaser may activate an associated application on his/her smartphone, which is a first information processing apparatus 310, and may display the stamp screen on the display, and the store side brings the code generation apparatus 120 into contact with the stamp screen of the smartphone of the purchaser. Then, the smartphone recognizes the electrode code of the code generation apparatus 120 of the store, searches for the communication address transmitted by the code generation apparatus 120 by BLE communication, and establishes a connected state when pairing is achieved. When a connected state is established, the code generation apparatus 120 transmits detailed information of the products to be purchased to the smartphone, and the purchaser touches a purchase approval button or a cancel button displayed on the screen of the application based on the information. When the smartphone transmits the information to the code generation apparatus 120 by BLE communication and the purchase is approved, the code generation apparatus 120 may disconnect the connected state with the smartphone and transfer a purchase approval information to the POS system. The POS system connects a membership ID management server, which is the third information processing apparatus 330, and a settlement server, and a payment is completed. The settlement server may be a local server provided that a payment can be made using the store's own prepaid card system or the like. In such a case, a WEB connection like that required for credit card payments or the like is not required. When making a credit card payment, the payment may be approved by making a WEB connection via a settlement server. After the payment is completed, the server transmits the purchase information to the POS system, payment is confirmed with the POS system, and the POS system manages product management information such as purchase information. When product management information of a plurality of stores is managed collectively, it is necessary to make a WEB connection and transmit/receive information. On-time exchange or processing by connecting to the WEB at a more convenient later time may be performed. After confirming a payment, the POS system may print a receipt with an attached printing machine or may transfer the information to a code generation apparatus 120, and after once disconnecting, the code generation apparatus 120 may be reconnected to the smartphone of the purchaser, and. receipt information, and reward point and coupon granting information may be transmitted to the smartphone. After the above processing is completed, the connected state may be disconnected. Regardless of the connection state between the first information processing apparatus 310 and the code generation apparatus 120 associated with the connection method shown in FIG. 58, at least one of the pairs of the code generation apparatus 120 and the second information processing apparatus 320, and the second information processing apparatus 320 and the third information processing apparatus 330 may always be in a connected state. Thus, since the smartphone of the purchaser is not directly connected to the server, the exchange of ID information is done indirectly. In this respect, it is useful for security because an outsider cannot directly access the server.

(Information and Communication System Configuration 5: Code Generation Apparatus and First Through Third Information Processors)

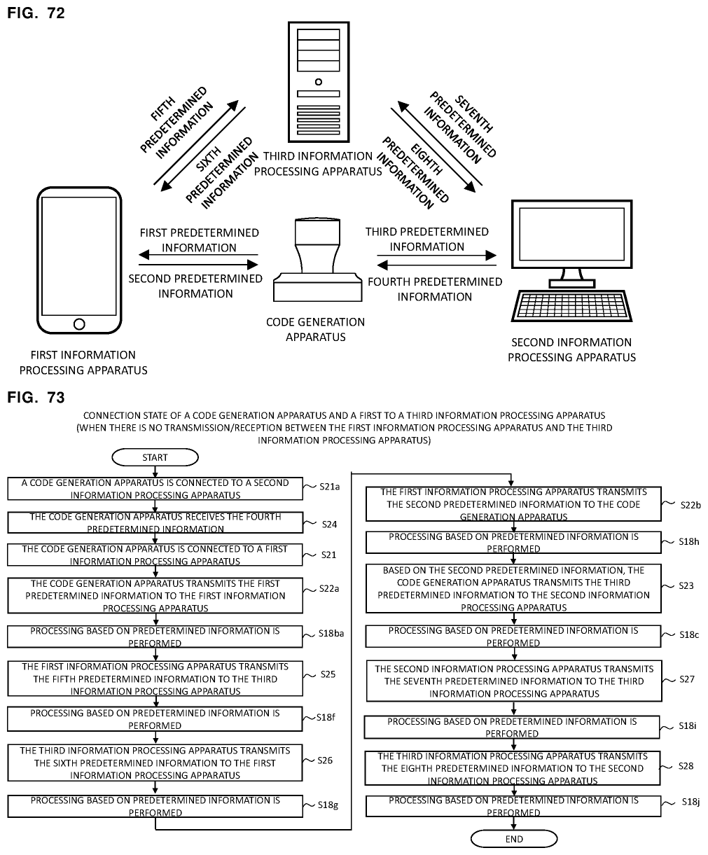

FIG. 72 is an example of a system comprising a code generation apparatus 120 and first to third information processing apparatuses. As in FIG. 70, the code generation apparatus 120 and the first to third information processing apparatuses are included, and in addition to the system in FIG. 70, the first information processing apparatus 310 and the third information processing apparatus 330 transmit/receive the fifth and/or sixth predetermined information.

FIG. 73 exemplifies this process in a simplified flowchart. This process is, so to speak, a combination of information communication systems 3 and 4. First, the second information processing apparatus 310 and the code generation apparatus 120 establish a connection (S21a). Subsequently, the second information processing apparatus 320 transmits the fourth predetermined information to the code generation apparatus 120 (S24). Then, the second information processing apparatus 310 and the code generation apparatus 120 are disconnected while keeping store of the predetermined information, and the first information processing apparatus 310 establishes a connection with the code generation apparatus 120 (S21). Subsequently, the code generation apparatus 120 transmits the first predetermined information to the first information processing apparatus 310 (S22a). Then, processing based on at least one of the above predetermined information is executed. (S18ba). Regardless of the connection state between the first information processing apparatus 310 and the code generation apparatus 120 associated with the connection method shown in FIG. 58, the first information processing apparatus 310 is in a connected state with the third information processing apparatus 330, and the first information processing apparatus 310 transmits the fifth predetermined information to the third information processing apparatus 330 based on the first predetermined information (S25). Then, based on the predetermined information including the authentication of an electrode code (including the device ID), a processing is executed (S181). Then, based on the authentication result, the third information processing apparatus 330 transmits the sixth predetermined information to the first information processing apparatus 310 (S26). Then, processing based on at least one of the above predetermined information is executed (S18g). Furthermore, based on the sixth predetermined information, the first information processing apparatus 310 transmits the second predetermined information to the code generation apparatus 120 (S22b). Then, processing based on at least one of the above predetermined information is executed. This process includes the disconnection of the connection between the code generation apparatus 120 and the first information processing apparatus 310, and the connection between the code generation apparatus 120 and the second information processing apparatus 320. Note that when the code generation apparatus 120 and the second information processing apparatus 320 are in a connected state and the first information processing apparatus 310 requests a connection to the code generation apparatus 120, the code generation apparatus 120 disconnects the connection with the second information processing apparatus 320 and makes a connection with the first information processing apparatus 310 (S18h). With the code generation apparatus 120 and the second information processing apparatus 320 in a connected state, the code generation apparatus 120 transmits the third predetermined information to the second information processing apparatus 320 based on the second predetermined information (S23). Then, processing based on at least one of the above predetermined information is executed (S18c). The second information processing apparatus 320 establishes a connected state with the third information processing apparatus 330, and the second information processing apparatus 320 transmits the seventh predetermined information to the third information processing apparatus 330 (S27). Then, processing based on at least one of the above predetermined information is executed (S18i). Then, the third information processing apparatus 330 transmits the eighth predetermined information to the second information processing apparatus 320 (S28). Then, processing based on at least one of the above predetermined information is executed. Note that this process may include the disconnection of the connection between the code generation apparatus 120 and the second information processing apparatus 320. Note that regardless of the connection state between the first information processing apparatus 310 and the code generation apparatus 120 associated with the connection method shown in FIG. 58, at least one of the pairs of the code generation apparatus 120 and the second information processing apparatus 320, the first information processing apparatus 310 and the third information processing apparatus 330, and the second information processing apparatus 320 and the third information processing apparatus 330 may always be in a connected state. Disconnection may include cases where disconnection is executed by the operation of a user or automatically after a predetermined period of time from the last action (S18j).

The above are basic procedures, and the order of the steps may be changed. And at least one of the transmissions/receptions of information and information processing may be executed a plurality of times, or at least one of the processes of transmission/reception of predetermined information and information processing may be omitted. At least one of the first or third predetermined information may include information of a device ID or an electrode code of the code generation apparatus 120. They may also be included in other predetermined information. Furthermore, the predetermined information may include time information or information that changes with time. Furthermore, at least one of the predetermined information may include at least one of the first specific code and the second specific code of at least one of the information processing apparatuses. The first predetermined information may include at least a part of the fourth predetermined information, and the third predetermined information may include at least a part of the second predetermined information. Including the above, the predetermined processing may include making a connection between the third information processing apparatus 330 and the first information processing apparatus 310 or the second information processing apparatus 320, or the disconnection of at least one of the connections between the code generation apparatus 120 and the first information processing apparatus 310 or the second information processing apparatus 320. The predetermined processing may include making connections with various other information processing apparatuses, transmission/reception of predetermined information, and other processings based on the information, and the disconnection of communication.

In this system, a direct connection between the first information processing apparatus 310 and the third information processing apparatus 330 is added to the information communication system configuration 4. Therefore, operations that require a server such as the exchange of IDs and the like can be executed more smoothly.

(Information Communication System Configuration 6: The First Information Processing Apparatus as the Information Source)

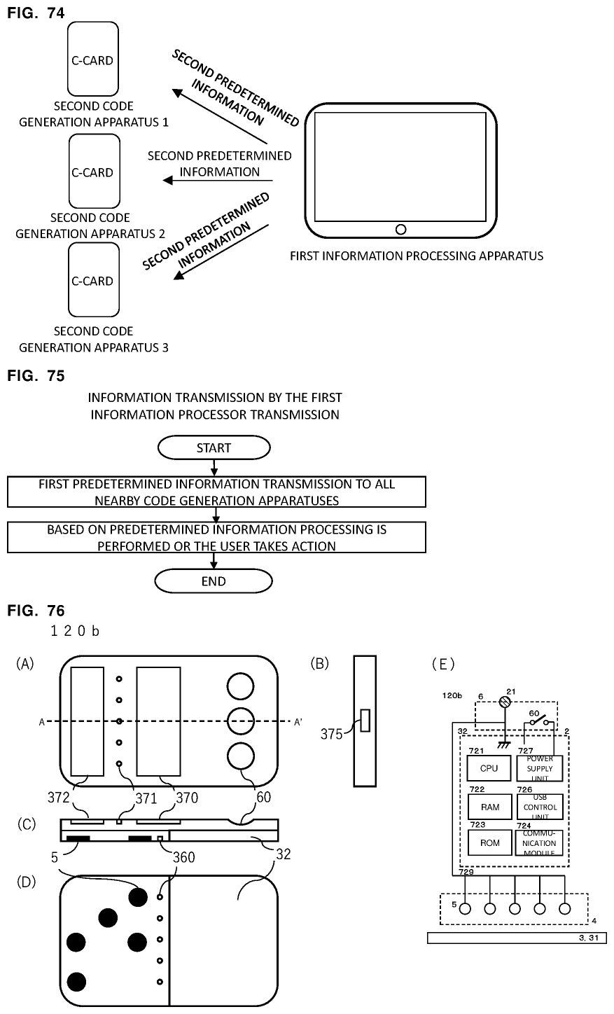

As exemplified in FIG. 74, when there is a plurality of detectable code generation apparatuses 120 in the vicinity of a first information processing apparatus 310, the first information processing apparatus 310 may be made to unilaterally provide information to these code generation apparatuses 120. FIG. 75 exemplifies this process in a simplified flowchart. For example, in a stamp rally or the like, a communication connection between a code generation apparatus 120 and a first information processing apparatus 310 is required for granting a stamp. To the plurality of code generation apparatuses 120, the first information processing apparatus 310 may provide location information of the first information processing apparatus 310 and information to encourage making contact.

Available system configurations are not limited to those described in the first to sixth embodiments, and any configuration can be used provided that a code generation apparatus 120 and a first information processor 310 are included. In addition, although only one of each apparatus is shown in FIGS. 63 to 72, at least one of them may be present in a plurality.

It is necessary to install an appropriate program to control the transmission/reception of the predetermined information above and various information processings based on the information in at least one of a code generation apparatus 120 and an information processing apparatus.

### Eleventh Embodiment

### (Example of an Embodiment of a Card-Type Code Generation Apparatus)

A card-type code generation apparatus 120b has the advantage of being easier to carry than a stamp-type code generation apparatus 120a due to its shape. Therefore, an embodiment of a card-type code generation apparatus 120b is shown, in accordance with the sixth embodiment in which a stamp-type code generation apparatus having a communication processing apparatus 32 is described.

FIG. 76 shows an example of the outer appearance of a code generation apparatus 120b. FIG. 76(A) shows a schematic top view, FIG. 76(B) shows a schematic side view, FIG. 76(C) shows a schematic sectional view dissected along the major axis direction, FIG. 76(D) shows a schematic bottom view with the removal of the housing 2, and FIG. 76(E) shows a schematic configuration diagram of the code generation apparatus 120b.

As shown in FIG. 76(A), a switch 60 having a contact unit 21 of a substantially circular conductive member is on the right side, a small display 370 is in the vicinity of the center, an LED light (alert display unit) 371 is on the left thereof, and a small solar panel 372 is arranged at the left edge. Note that a minimum configuration comprises a switch 60, and instead of a concaved switch 60 for suppressing erroneous pressing, it may be a flat conductor such that of a C-Card. The solar panel 372 is used for charging the charging unit, but other charging methods may be used instead, such as charging through a USB port. The LED lights are used to indicate the communication status, errors, the power status, or the charging status.

FIG. 76 (B), at the center shows a USB port 375. Via the USB port, information may be exchanged or the charging unit may be charged by drawing in external power.

FIG. 76(C) shows a cross-section of a switch, which can be either an interlocking switch or an independent switch. In the case of an interlocking switch, the switch is to be continuously pressed to establish a connection, whereas for an independent switch, conduction and disconnection are repeated each time the switch is pressed. As shown in the schematic top view of FIG. 76 (A), there may be a plurality of switches or just one.

In the left half of FIG. 76(D), electrodes 5 for detecting by the touch panel 31 are arranged, and in the right half, a communication processing section 32 is arranged. As shown in FIG. 76(E), the communication processing apparatus 32 comprises a CPU 721, memory means 721 and 722, a communication module 724, a USB control unit 726, a power supply 727, and the like in its basic configuration. Although not shown in the figure, the communication module 724 may comprise a Bluetooth (including BLE) unit, a beacon, and a GPS receiver, and the CPU 721 may comprise a clock function unit 133. In addition, there may also be an optical conversion processing unit, an electromagnetic conversion processing unit, a dot code reading unit, and a display control unit. Furthermore, the electrode area comprises a section that detects a contact or a substantial contact by the first information processing apparatus 310, and here, an example is shown in which a photodiode (light receiving unit) 360 is arranged. When a code generation apparatus 120b comes into surface contact with a touch panel 31, the light receiving unit of a photodiode 360 receives light from the touch panel 31 and whether or not the code generation apparatus 120b has come into contact with the touch panel 31 is determined. Furthermore, light patterns received in a time series can be used as an optical code to obtain information from a first information processing apparatus 310.

Although the electrode pattern is fixed in FIG. 76(D), a conduction control unit 79 as in the case of a stamp-type apparatus of FIG. 37 may be provided to form time-series electrode patterns and generate a large number of electrode codes. Furthermore, any one of all of the functions of a stamp-type apparatus may be installed in a card type code generation apparatus 120b. Note that although each component is shown with a specific shape (for example, a substantially circular shape for an electrode and the like), any shape will do.

The embodiment of the dot code is described in detail in the description of FIG. 24 and the description of FIGS. 90 to 97 of the International Publication WO2019/004486. And the embodiment of the optical code is described in the descriptions of FIGS. 25 to 27.

A USB memory is a convenient storage apparatus because it is small and easy to carry, has a relatively high data transfer rate, and has a simple structure and is relatively inexpensive. On the other hand, there is a possibility of loss or theft, and there is a risk of the leakage of personal information of the customer and stored confidential information. In addition, it is not easy to manage what information is stored in which USB memory or what encryption technology is used for the information. For this reason, some companies have begun to ban the use of USB memories. Therefore, there is a need for a storage medium with higher security. The card-type code generation apparatus 120b illustrated here can be used as a memory for solving these problems.

By using the card-type code generation apparatus 120b, it is possible to add a security function similar to that of a credit card, and unlike a credit card skimming is not possible. Therefore, the security level can be raised higher than that of credit cards. Since many functions can be incorporated, it may be used as a multifunctional credit card. Information transmitted to the information processing apparatus or processing based on the information may not be dealt with after a while instead of on-time on the WEB. On the other hand, various processings may be executed by connecting only to a local server and not the WEB. Furthermore, a limit may be set for the information processing apparatuses that can be connected. In addition, the system can be set to acquire the IDs of the connected information processing apparatuses and to keep a history. Since it is possible to make a connection to an information processing apparatus only by a touch operation, there is no need to worry about the shape of the port or the cords like when using a USB memory, and thus it is highly convenient.

(Overview of Control by a Program)

As described above, the bottom surface of the housing of the code generation apparatus 120 in which a plurality of electrodes 5 are arranged is brought into contact with or substantially brought into contact with a capacitance type touch panel of a first information processing apparatus 310. In such an instance, the touch panel detects an arrangement pattern of one or more electrodes 5 from the change in their capacitance. From the detected arrangement pattern, positional information of all of the electrodes 5 is recognized in accordance with the position recognition method described in FIGS. 14 and 15, and a corresponding electrode code is assigned in accordance with the method described in the [Pattern code decoding method] section of the fifth embodiment of the present description. There are cases in which the whole arrangement pattern is assigned to an electrode code, and there are cases in which a part is assigned to the electrode code and a part is assigned to a code for instructing the first information processing apparatus 310 to perform a predetermined information processing, and the first information processing apparatus 310 performs at least one of these processings. Subsequently, the first information processing apparatus 310 detects a communication address, and executes a processing such as establishing a connected state, or the like, by using the correspondence relationship exemplified in FIGS. 45 to 51, between electrode codes stored in the first information processing apparatus 310 and communication addresses. If the first information processing apparatus 310 detects a plurality of the same communication address, at least one of the methods described in the ninth embodiment is used to identify the code generation apparatus 120 making contacted or substantially making contacted, and executes a processing such as establishing a connection with a communication processing apparatus 32 installed in the housing 2 of the code generation apparatus 120, and other processings. The first information processing apparatus 310 stores the connection history and controls ON/OFF so that reconnection is easy even if the code generation apparatus 120 is disconnected once to make a connection to another information processing apparatus in the system. The first information processing apparatus 310 further transmits/receives information and executes information processing based on the information subsequently after establishing communication connection with a code generation apparatus 120 or other information processing apparatuses. It is desirable to install a program that can at least control these processes in a first information processing apparatus. In addition, if a beacon is installed in a code generation apparatus 120, an applicable program is to be installed in the first information processing apparatus 310. The program may include a function that can receive from server information associated with the beacon. The majority of current smartphones are already equipped with this function.

Also for second and third information processing apparatuses, it is desirable to install a program capable of at least controlling the transmission/reception of information with a code generation apparatus 120 or other information processing apparatuses and controlling information processing based on the information.

A code generation apparatus 120 needs to control the change in capacitance through the electrodes 5 when the code generation apparatus 120 makes contact or substantially makes contact with a first information processing apparatus 310. Then, at the request of the first information processing apparatus 310, the code generation apparatus 120 transmits to the first information processing apparatus 310 information that allows the first information processing apparatus 310 information to recognize that it is the code generation apparatus 120 that has made contact or substantially has made contact, using at least one of the methods described in the ninth embodiment and the first information processing apparatus 310 makes a recognition. After this authentication process, the code generation apparatus 120 can establish communication connection with the first information processing apparatus 310, and thus it is desirable to install a program that can control the series of processes in the code generation apparatus 120.

### Twelfth Embodiment

### (Application Example of a Code Generation Apparatus)

Applications of a code generation apparatus 120 having a communication processing unit 32 are described in “Personal authentication of an electronic stamp owner,” “Financial settlements with an electronic stamp,” “Granting/erasing of points, coupons, and stamps using an electronic stamp,” and “Use in ticketing,” and in addition to these, there are other examples as follows. Including these, they are merely examples, and any use method may is applicable as long as it is an example based on an establishment of a connected state between a code generation apparatus 120 and a first information processing apparatus 310 as a trigger. In the following examples, the bottom surface region of the housing has a circular shape or a substantially circular shape, but any shape may be used as long as a physical quantity change can be detected by the first information processing apparatus 310. Also, embodiments of a dot code are described in descriptions of FIG. 24 and FIGS. 90 to 97 of the International Publication WO2019/004486. And embodiments of an optical code are described in descriptions of FIGS. 25 to 27. (1) Electronic Stamp

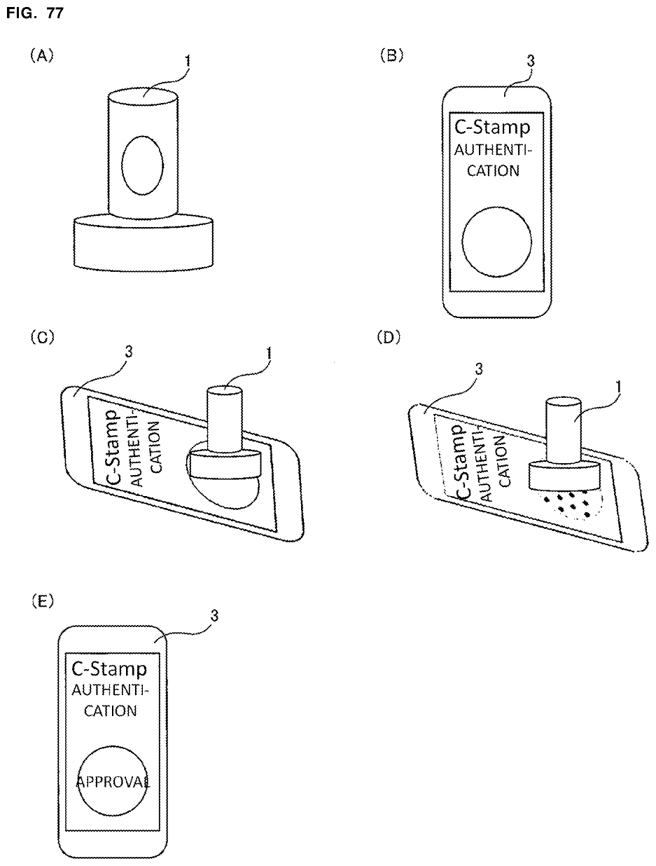

FIG. 77 is a diagram showing an embodiment of a personal authentication service using the present invention.

Hereinafter, when referred to as the present invention, it means the various inventions described in the specification mentioned above.

When paying a purchase price, making an agreement on the net, acquiring self and family private information of the principal and the like, it was necessary for the principal to present an identification card and to fill in necessary information on dedicated printed matter, and to seal it.

However, as shown in FIG. 77(A), by using a code generation apparatus 120 provided with an information communication unit as a digital seal of the person himself/herself, convenience and security can be greatly improved. Note that the code generation apparatus 120 may be equipped with a fingerprint authentication sensor to prove that the user of the code generation apparatus 120 is the person himself/herself. Further, security may be enhanced by having the user enter a password immediately before and after the stamp is applied. Also, when a code generation apparatus 120 is brought into contact with or substantially in contact with a touch panel 31, since the rotation angle of the code generation apparatus 120 with respect to the touch panel 31 can be recognized, it is possible to set a password by combining the rotation direction and angle in a predetermined order, such as “rotate the code generation apparatus 120 90 degrees to the right, rotate 45 degrees to the left and stop, and then further rotate 45 degrees to the left.” Furthermore, the code generation apparatus 120 may be moved vertically, horizontally and diagonally in a predetermined order, and a combination of the order of the directions of the movements may be set as a password. In addition, the amount of movement may be included. Of course, rotation and movement may be combined.

As shown in FIG. 77(B), in various scenes, when performing personal identification, making an approval, and entering into a contract, if a predetermined application is launched and a first information processing apparatus 310 displaying a screen for stamping is touched with a code generation apparatus 120 owned by the person, an electrode code is recognized, and the first information processing apparatus 310 and the information communication unit built into the code generation apparatus 120 get connected. Next, when a device ID that is used to specify a code generation apparatus 120 is transmitted to a first information processing apparatus 310, the first information processing apparatus 310 or an authentication server (including the cloud) connected to the first information processing apparatus 310 can authenticate the device ID and perform identity verification. For example, assuming that the electrode code is ‘1051,’ the code generation apparatus 120 whose communication address is ‘C-Stamp 1051’ which includes ‘1051’ and the first information processing apparatus 310 are connected. Note that the communication address may be a part of the electrode code ‘1051,’ for example, it may be ‘C-Stamp 51’ which includes the lower two digits, or an electrode code-communication address table may be set in advance so that a first information processing apparatus 310 can be connected to a code generation apparatus 120 having a communication address corresponding to an electrode code recognized by the first information processing apparatus 310. Furthermore, when a function F(N) capable of acquiring a communication address is set and an electrode code N is inputted as a parameter, the code generation apparatus 120 having the communication address may be connected.

As shown in FIG. 77 (C), to eliminate a forged code generation apparatus 120 or a code generation apparatus 120 having an expiration date that has passed, the code generation apparatus 120 may be equipped with a timekeeping function, and a passcode according to an absolute time or a relative time may be transmitted, and the first information processing apparatus 310 may also perform authentication of the passcode based on the stamping time and enhance security. In other words, a code generation apparatus 120 may be validated if the code generation apparatus 120 issues a one-time password and it is authenticated. Furthermore, the code generation apparatus 120 may be equipped with an information reading apparatus, a two-dimensional code such as a QR code, a dot code, or the like that has been subjected to encryption may be displayed on a display of the first information processor 310, and a code generation apparatus 120 equipped with an information reading apparatus may read it and transmit a passcode corresponding to the two-dimensional code for another high-level approval.

In regards to FIGS. 77(B) and 77(C), the electrode code output by the code generation apparatus 120 is first read by the first information processing apparatus 310. However, as shown in FIGS. 77(d) and 77(e), the code generation apparatus 120 may be equipped with a code reader, the first information processing apparatus 310 may first display a code, the code generation apparatus 120 may read the code and transmit a corresponding passcode, and the first information processing apparatus 310 may perform authentication of the code. As with FIG. 77 (C), security may be enhanced by authenticating a stamp code based on the stamping time. Furthermore, if a code corresponding to a dot code for each code generation apparatus 120 is outputted by a unique algorithm, security is further enhanced. Here, the above-mentioned code reading apparatus may read a QR code or the like or any other two-dimensional code, a bar code. Also, a code reading apparatus may be equipped with one or more light detection sensors, for example, one or more photodiodes, and a display of a first information processing apparatus 310 may emit light in a predetermined area and the code reading apparatus may read an optical code generated based on the color of a light, the intensity of a light, and the blinking intervals. Here, if an electrode code is detected from the code generation apparatus 120 first, the position of one or more photodiodes in contact or substantially in contact must be recognized from the geometric arrangement of the electrode code detected from the code generation apparatus 120, and light must be emitted in the area corresponding to the photodiodes, so that the code reading apparatus can properly recognize the light emitted from the display of the first information processing unit 310.

Authentication by a first information processing apparatus 310 described above may be performed by a PC, a server, or the cloud locally connected to the first information processing apparatus 310.

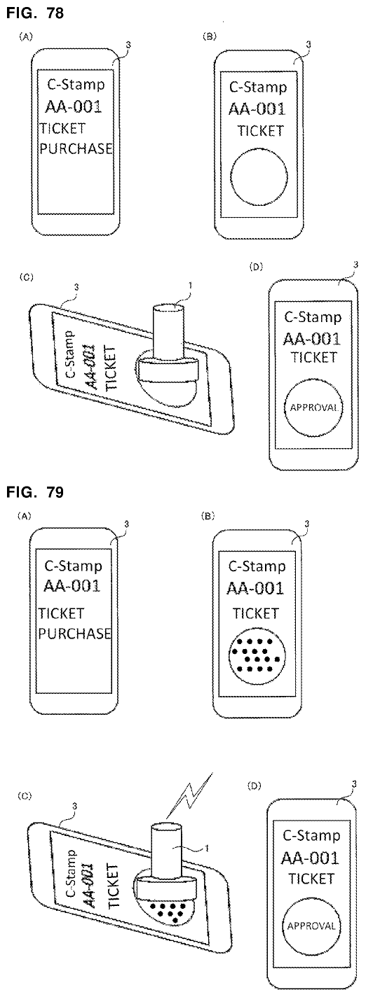

Note that in the following paragraphs, for convenience of explanation, a case where a dot code is read by a code reading apparatus will be used as an example for a description. However, as described with reference to FIG. 78, the code is not particularly limited to dot codes and may be a QR code or the like or any other two-dimensional code, a bar code, or an optical code.

### (2) Ticket Purchase and Coupon Acquisition Service

FIG. 78 is a diagram showing an example of ticket purchase and coupon acquisition service using the present invention.

As shown in FIG. 78(A), with a predetermined application, a ticket can be purchased and a coupon can be acquired. A corresponding stamp code is assigned.

As shown in FIG. 78(B), when an entry is made or a coupon is used, a predetermined application is activated and an approval screen is displayed.

As shown in FIG. 78(C), a clerk brings the code generation apparatus 120 into contact with the first information processing apparatus 310 when an entry is made or a coupon is used. The code generation apparatus 120 is set in advance so as to output a stamp code corresponding to the ticket or coupon.

As shown in FIG. 78(D), the first information processing apparatus 310 reads the stamp code output by the code generation apparatus 120, and entry and the use of coupons are approved. Upon re-entry, this screen is to be shown.

### (3) Ticket Purchase and Coupon Acquisition Service

FIG. 79 is a diagram showing a ticket purchase and coupon acquisition service (dot display) using the present invention.

As shown in FIG. 79(A), a ticket is purchased or a coupon is acquired using a predetermined application. A corresponding dot code is assigned.

As shown in FIG. 79(B), a predetermined application is activated when an entry is made or a coupon is used, and a dot code corresponding to a ticket or a coupon is displayed on the approval screen.

As shown in FIG. 79(C), a clerk brings the code generation apparatus 120 into contact with the first information processing apparatus 310 when an entry is made or a coupon is used, and the dot code is read. A dot code corresponding to a ticket or a coupon is registered in the code generation apparatus 1 in advance and it is authenticated. Note that a wireless function may be installed in the code generation apparatus 1 and the dot code may be approved by the third information processing apparatus 330.

As shown in FIG. 79(D), after the code generation apparatus 1 reads the dot code, a corresponding stamp code is output, and the first information processing apparatus 310 reads it and approves its use for entry and coupons. In a case with a wireless function installed, an approval stamp code may be transmitted from the third information processing apparatus 330 each time.

### (4) Ticket and Coupon Printout Service

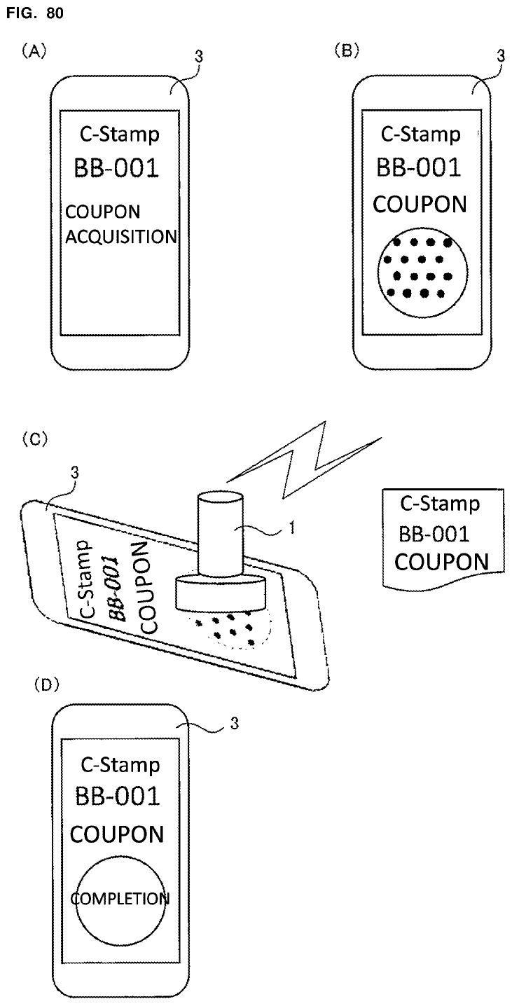

FIG. 80 is a diagram showing a ticket and coupon print output service using the present invention.

As shown in FIG. 80(A), with a predetermined application, a ticket can be purchased and a coupon can be acquired. A corresponding dot code is assigned.

As shown in FIG. 80(B), a predetermined application is activated, and a dot code corresponding to a ticket or a coupon is displayed on the print output screen.

As in FIG. 80(C), the code generation apparatus 120 equipped with the wireless function is brought into contact with the first information processing apparatus 310. The code generation apparatus 120 reads the dot code, the third information processing apparatus 330 authenticate it, and in addition, a printer that is wirelessly connected (for example, BT, Wi-Fi, and the like) outputs the ticket or the coupon. Note that a dot code corresponding to the ticket or the coupon may be registered in the code generation apparatus 120 in advance and be authenticated.

As in FIG. 80(D), after the code generation apparatus 120 reads the dot code, a corresponding stamp code is output, the first information processing apparatus 310 reads it and printing is regarded as already completed, and thereafter it becomes impossible to print.

### (5) Coupon and Point Customer Attraction Service

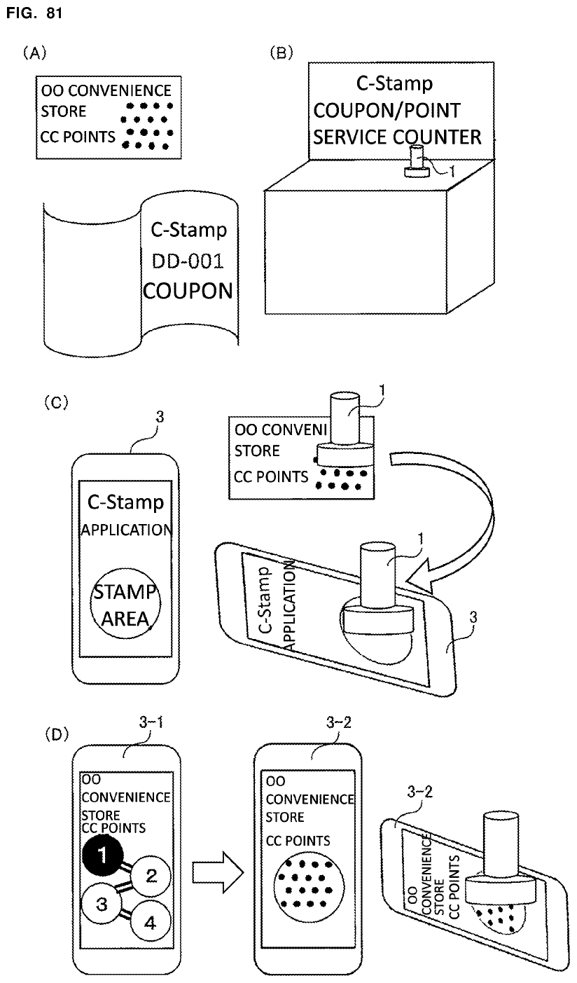

FIG. 81 is a diagram showing a coupon and point customer attraction service using the present invention.

As in FIG. 81(A), the user is given various printed materials such as flyers, DMs, newspapers, magazines, and the like which offer coupons and points services.

As in FIG. 81(B), the user goes to the service counter with the coupons and printed matter that offer points. The offering side of the coupons and the points places a service counter where attracting is necessary to attract customers.

As in FIG. 81(C), a predetermined application is activated, and after coming into contact with the bring-in coupon or dot printed matter offering points with the code generating apparatus 120, the stamp mark area of the first information processing apparatus 310 is brought into contact. A stamp code corresponding to the dot code is set in advance in the code generation apparatus 120. If a wireless function is installed in the code generation apparatus 120, it is possible to sequentially update the information of the stamp codes and the like, and to transmit information to the third information processing apparatus 330. Stamp pressing may be done either by the user or the provider. When a predetermined application is activated and upon coming into contact with the printed matter, it is brought into contact with the first information processing apparatus 310, a coupon and points corresponding to the printed matter screen are displayed.

As in FIG. 81(D), a stamp code corresponding to the dot code read by the code generation apparatus 120 is output, the first information processing apparatus 310 reads it and a coupon or points are acquired. After the first information processing apparatus 310 reads the stamp code, the code generation apparatus 1 may show a dot code in which predetermined information is defined on the display of the first information processing apparatus 310, the code generation apparatus 120 may read the dot code, and information such as information stamped in from the first information processing apparatus 310, personal information or the like may be read. The information may be transmitted using a wireless function or the like. When the seal area is brought into contact with the code generation apparatus 120, an image of a point card or a stamp rally corresponding to the printed matter is displayed on the first information processing apparatus 310, and points or a stamp are granted. Furthermore, a dot code corresponding to point or stamp acquisition information or personal information may be displayed on the screen of the first information processing apparatus 310 and be read by the code generation apparatus 120. The information may be transmitted using wireless communication or the like.

### (6) Electronic Point Card Service

FIG. 82 is a diagram showing an electronic point card service using the present invention.

Conventionally, as shown in FIG. 82(A), when making a payment at a shop, by pressing a point stamp onto a paper point card, a point is accumulated on a plastic point card. However, for the user, management is troublesome with the increase in the number of point cards, and with plastic cards, it is hard to tell how many points are accumulated and until when they are valid.

Thus, as shown in FIGS. 82(B) to 82(D), an electronic point card service using the present invention is provided. As shown in FIG. 82(B), when a predetermined application is activated and a first information processing apparatus 310 is brought into contact with a code generation apparatus 120 at the shop, a point card of the shop is displayed.

As shown in FIG. 82(C), in accordance with the amount of money and coupons used at the cashier, the shop clerk brings the code generation apparatus 120 into contact with the numerals or icons of a dot-printed paper controller, and the number of points and the date are temporarily recorded in the code generation apparatus 120. Note that points may be added and deleted without using a paper controller.

As shown in FIG. 82(C), the number of points and the date recorded in the code generation apparatus 120 are converted into a stamp code, and by coming into contact with the first information processing apparatus 310, the points specific to the shop are added in the first information processing apparatus 310. Note that the operation buttons of the code generation apparatus 120 may be pressed as many times as necessary, or the code generation apparatus 120 may be tapped or rotated to add points. With a predetermined application, the user can tell the accumulated points of each shop at any time and can use them. By activating a predetermined application and coming into contact with the seal area with the code generation apparatus 120, the point card of the specific shop is displayed.

As shown in FIG. 82(D), when using points, the first information processing apparatus 310 is touched with the code generation apparatus 120 to erase the number of points used at the cashier by identifying the dot printed numeral or corresponding icon. Note that the operation button of the code generation apparatus 120 may be pressed as many times as necessary, or the code generation apparatus 120 may be tapped or rotated to erase points. Even if the operation is mistaken, correction of points can be made using the same operation. Each shop can transmit various kinds of advertisement information of campaigns and the like to the first information processing apparatus 310 to promote the use of the shop by joining a predetermined service system for providing points and coupons.

When registering the point card of the shop, after the first information processing apparatus 310 is touched with the code generation apparatus 120, a display such as “Will you accept information distribution from the shop?” is shown on the display and the user himself/herself performs approval according to a predetermined method. As a predetermined method, displaying a dot code and having the code generation apparatus 120 read the dot code is considered to be an approval. The dot code includes the ID of the first information processing apparatus 310, personal information, and the like, and the information may be transmitted by wireless communication or the like.

Adding and erasing can be done by adding and erasing operations using the code generation apparatus 120 on the point card screen displayed by coming into contact with the code generation apparatus 120. Operations cannot be performed with the code generation apparatuses 120 of other shops.

### (7) Information Service by Print Media

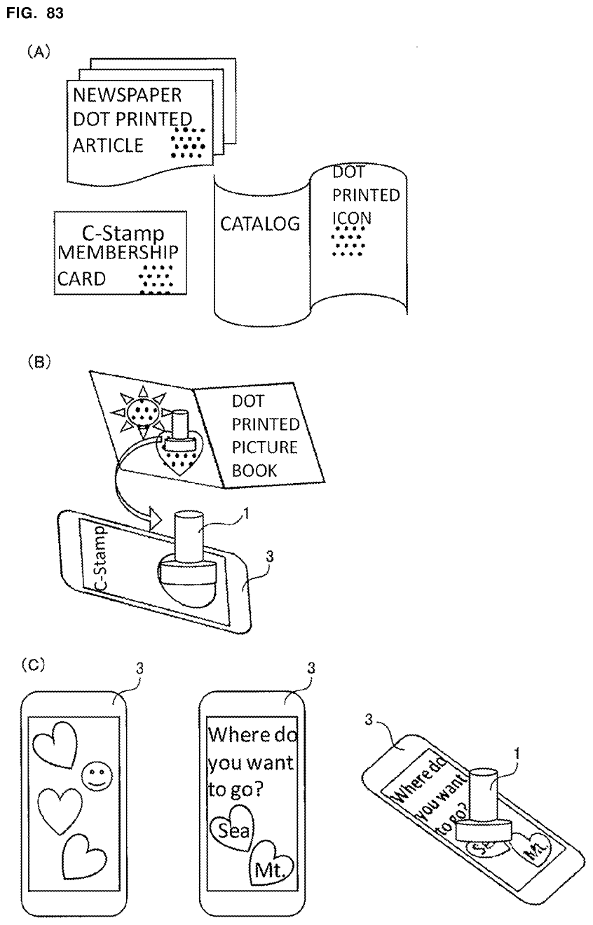

As in FIG. 83(A), a provider or the like of various printed materials such as a newspaper printed with dot codes, a member's newsletter, a magazine, a catalog, teaching material, a picture book, a sightseeing map, and the like distributes the code generation apparatus 120 as a platform. It may be sold as a set with the printed materials.

As shown in FIG. 83(B), the user has the code generation apparatus 120 touch the dot printed matter to read the dot code. Next, when the first information processing apparatus 310 is touched, a stamp code corresponding to the dot code is output, and the first information processing apparatus 310 reads the stamp code. If it is exclusive to members, the user may log in by coming into contact with the dotted membership card before coming into contact with the dot printed part. Password input may be performed by rotating the code generation apparatus 120 a predetermined number of times in a predetermined direction or by coming into contact with the first information processing apparatus 310 with a finger. A G stamp itself may issue an ID. By coming into contact with various dot printed materials with the code generation apparatus 120 and then coming into contact with the first information processing apparatus 310, it is possible to browse contents or start a game.

As shown in FIG. 83(C), when the first information processing apparatus 310 reads the stamp code, the first information processing apparatus 310 executes the browsing of contents or activation and operation instructing of the program corresponding to the stamp code (dot code). If the stamp code (dot code) is not registered in the memory of the first information processing apparatus 310, processings or contents corresponding to the stamp code (dot code) are downloaded or streamed from the third information processing apparatus 330 to the first information processing apparatus 310. Note that depending on the content, it is also possible to slide the code generation apparatus 120 on the screen of the first information processing apparatus 310 to select an operation button and decide the next action. The progressing of a game, the purchase of goods, tourist route guiding, and the like are also possible. Since the first information processing apparatus 310 can recognize the rotation angle of the code generation apparatus 120, by rotating the code generation apparatus 120, it is possible to scroll in a predetermined direction on a map or drawing and photo displayed on the first information processing apparatus 310 or to view a 360-degree panorama. When letters, icons, and graphics displayed on the first information processing apparatus 310 are selected, rotated or moved by the code generation apparatus 120, the following contents and operation instructions are displayed, and in addition, operations with the code generation apparatus 120 are possible.

### (8) Mail Order Service by Print Media

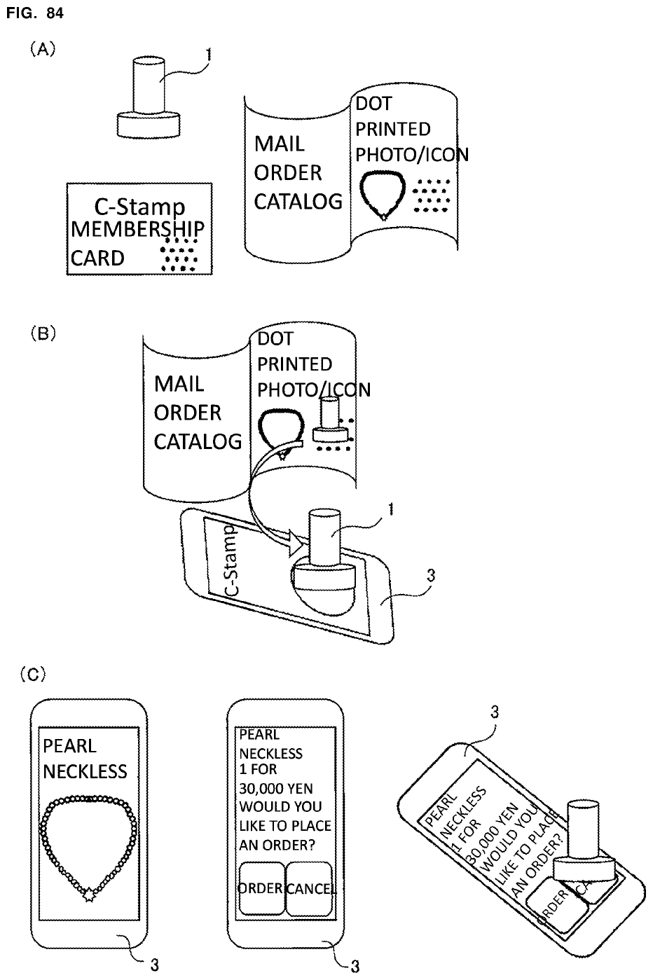

FIG. 84 is a diagram showing a mail-order service by print media using the present invention.

As shown in FIG. 84(A), a mail-order catalog on which a dot code is printed, a dotted membership card, and a code generation apparatus 120 are distributed to members. The user logs in by coming into contact with the dotted membership card. Password input may be performed by rotating the code generation apparatus 120 a predetermined number of times in a predetermined direction or by coming into contact with the first information processing apparatus 310 with a finger. The code generation apparatus 120 itself may issue an ID.

As shown in FIG. 84(B), a dot code is read by having a user touching the photograph of an item in a mail-order catalog, a “description icon,” a “cart icon,” or a “quantity icon”. Next, when the first information processing apparatus 310 is brought into contact, a stamp code corresponding to the dot code is output, and the first information processing apparatus 310 reads the stamp code.

As shown in FIG. 84(C), when a catalog is touched with the code generation apparatus 120 and then first information processing apparatus 310 is touched, a description of the item is displayed. Furthermore, when an operation button is pressed, or the code generation apparatus 120 is tapped or rotated, an order screen is displayed. When the first information processing apparatus 310 reads the stamp code, commentary on the item and order details corresponding to the stamp code (dot code) are displayed on the first information processing apparatus 310. If the stamp code (dot code) is not registered in the memory of the first information processing apparatus 310, processings or contents corresponding to the stamp code (dot code) are downloaded or streamed from the third information processing apparatus 330 to the first information processing apparatus 310. If there is no problem with the order details of the first information processing apparatus 310, the “order icon” on the display of the first information processing apparatus 310 is touched with the code generation apparatus 120 and the operation button is pressed to make an order of the item. For cancellation, the “cancel icon” is touched and the operation button is pressed to cancel the order. The code generation apparatus 120 is moved to either “Order” or “Cancel” and the operation button is pressed to select it. Selection by other methods such as tapping without pressing the operation button is also possible.

### (9) Entertainment Service

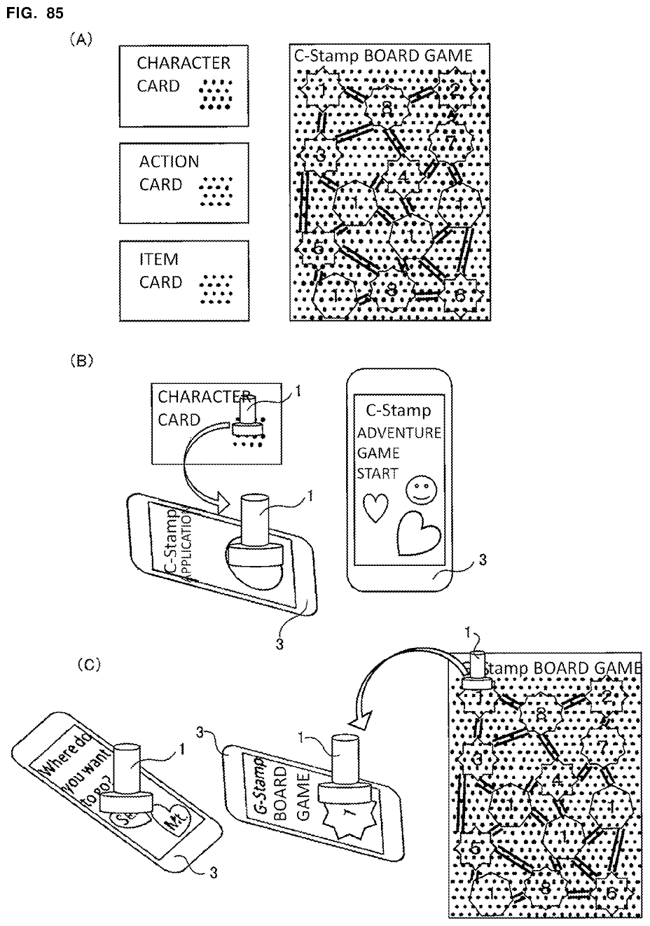

FIG. 85 is a diagram showing an entertainment service using the present invention.

As shown in FIG. 85(A), a game card, a trading card, or a game board on which a dot code is printed is developed as a game platform by a predetermined application. The dot printing may be performed on the whole surface or only a part of the card or the board.

As shown in FIG. 85(B), a predetermined application is activated by the user, a card or a board is touched with the code generation apparatus 120, and a dot code (game identification code value) is read. Next, the code generation apparatus 120 is touched with the first information processing apparatus 310 to output a stamp code corresponding to the dot code, and when the first information processing apparatus 310 reads the stamp code, the game is started. By coming into contact with the card and coming into contact with the first information processing apparatus 310, the game can be started.

As shown in FIG. 85 (C), by reading the dot code printed on collected letters, action, or item cards with the code generation apparatus 120, and by outputting a stamp code corresponding to the dot code upon coming into contact with the first information processing apparatus 310, a game progresses. With the board game, the XY coordinate values are also printed, and when the code generation apparatus 120 is placed on the board, the coordinate values of the position and the orientation of the code generation apparatus 120 can be read. Information can be input to the first information processing apparatus 310 by converting the information into a corresponding stamp code and then coming into contact with the first information processing apparatus 310 with the code generation apparatus 120. Since the first information processing apparatus 310 can recognize the rotation angle of the code generation apparatus 120, by rotating the code generation apparatus 120, it is possible to scroll in a predetermined direction on the game screen displayed on the first information processing apparatus 310 or to view a 360-degree panorama. Furthermore, by a button operation, it is also possible to select missile launches and icons displayed on the first information processing apparatus 310. Furthermore, by displaying a dot code on the first information processing apparatus 310 and reading it with the code generation apparatus 120, a new stamp code can be output and a more advanced game may be enjoyed. Letters, icons, and graphics displayed on the first information processing apparatus 310 are selected, rotated, or moved by the code generation apparatus 120 to progress the game. XY coordinate values formed on a board or a code of a predetermined area are read by the code generation apparatus 120 and the first information processing apparatus 310 is touched to advance the game.

### (10) Information Transfer Service

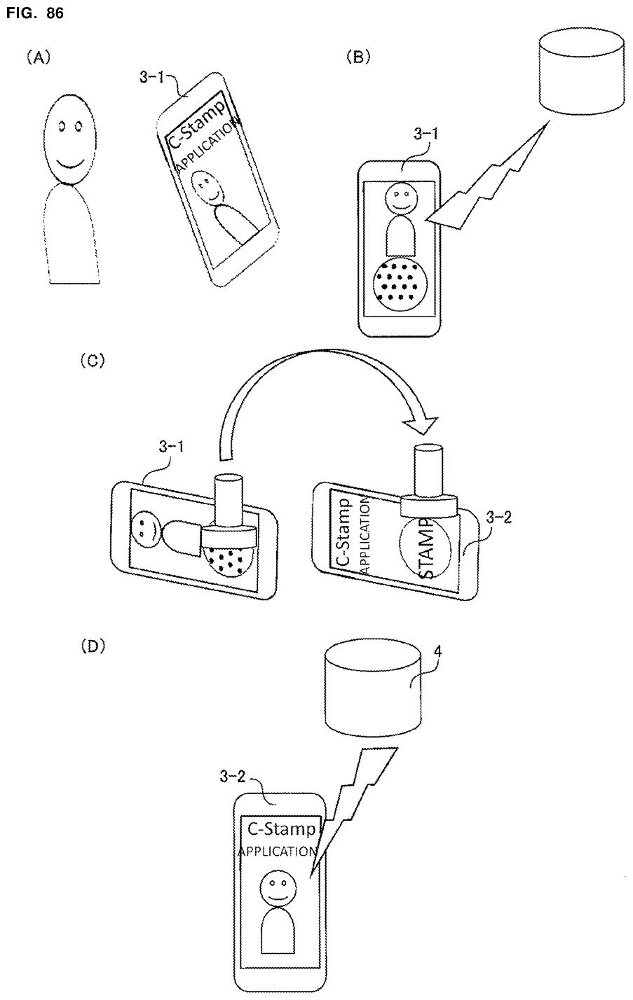

FIG. 86 is a diagram showing an information transfer service using the present invention.

As shown in FIG. 86(A), the first information processing apparatus 310 activates predetermined applications, takes photographs and videos, and displays various contents.

As shown in FIG. 86(B), when the first information processing apparatus 310 selects the information transfer mode of a predetermined application, a dot code for specifying the displayed content is displayed in part of or all of the display. The stamp code corresponding to the dot code and a linked content are uploaded to the cloud or the third information processing apparatus 330, concurrently. It may be uploaded in advance. A content corresponding to the stamp code is uploaded to the cloud.

As shown in FIG. 86(C), when the second information processing apparatus 320 that receives information activates a predetermined application and the information reception mode is selected, an imprint mark of the second information processing apparatus 320 is displayed. In the code generation apparatus 120, the dot code displayed on the first information processing apparatus 310 is read and converted into a corresponding stamp code. Next, the stamp mark area (any kind of graphic is sufficient) displayed on the second information processing apparatus 320 is touched by the code generation apparatus 120, a stamp code is outputted, and the stamp code is read by the second information processing apparatus 320.

As shown in FIG. 86(D), the stamp code read by the second information processing apparatus 320 is transmitted to the cloud or the third information processing apparatus 330, a content corresponding to the pre-registered stamp code is downloaded or streamed, and is recorded and viewable by the second information processing apparatus 320. The great advantage of this is that the content can easily be transferred without revealing your address to the other party. It is also possible to set the transferred content not to be retransmitted. A content corresponding to the stamp code is downloaded from the cloud or is streamed.

### (11) Dot Code Formation Medium Information Link

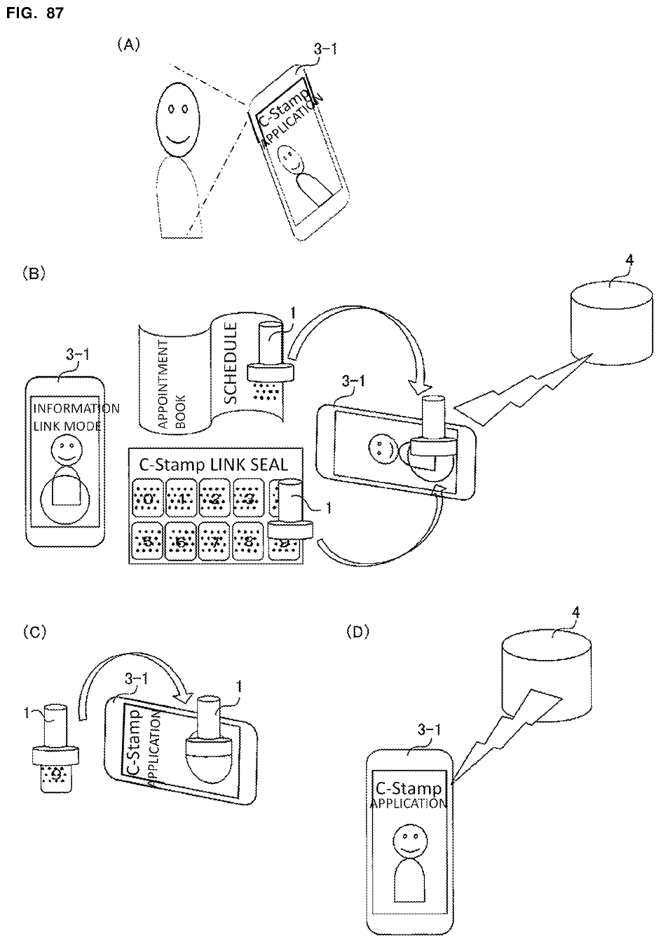

FIG. 87 is a diagram showing an information link for a dot code forming medium using the present invention.

As shown in FIG. 87(A), by activating the code generation apparatus 120 using the first information processing apparatus 310 with a predetermined application, photographs and videos can be taken, and various contents (including live video taken by the first information processing apparatus 310 and sounds) can be displayed. After reading the stamp code for linking contents, the content may be displayed.

As shown in FIG. 87(B), by setting the information link mode of a predetermined application and by coming into contact with a seal or various media on which a dot code is formed with the code generation apparatus 120, the dot code is read and is converted to a corresponding stamp code. Next, the stamp mark area (any kind of graphics is sufficient) displayed on the first information processing apparatus 310 is touched by the code generation apparatus 120, the stamp code is output, and the stamp code is read by the first information processing apparatus 310. Note that the information link mode may be set after the code generation apparatus 120 reads the dot code and the stamp code is output. The information link mode may be set by a setting on the side of the first information processing apparatus 310, by reading a dot code instructing an exclusive information link mode with the code generation apparatus 120 or by operating a button of the code generation apparatus 120. In addition, the dot code formed on a seal or various media also includes an instruction for setting the information link mode, and just by reading the dot code with the code generation apparatus 120, and just by reading the stamp code by coming into contact with the first information processing apparatus 310, the information link mode is set, and the stamp code and a corresponding content are linked. The stamp code corresponding to the dot code and the content displayed in FIG. 87(A) are linked, and the content is uploaded to the cloud or the third information processing apparatus 330. Contents may be upgraded in advance. A content corresponding to the stamp code is uploaded to the cloud. A stamp code-content name table may also be registered.

As shown in FIG. 87(C), thereafter, by having the dot code formed on a seal or various media and linked with the content of FIG. 87(B) be touch with the code generation apparatus 120, by having the dot code be read, and by having the dot code be converted to a corresponding stamp code upon coming into contact with the first information processing apparatus 310, the corresponding content can be browsed and executed. Thereafter, even if the predetermined application is re-activated, the content can be browsed and executed in the same way. Furthermore, the content can also be browsed and executed with the second information processing apparatus 320. The stamp code may be output by coming into contact with the medium where the dot code is formed and is linked to some content, and by coming into contact with the second information processing apparatus 320.

As shown in FIG. 87(D), as another method, by activating a predetermined application, the first dot code corresponding to the stamp code linked to the displayed content is displayed and the code is read by the code generation apparatus 120, and by coming into contact with the medium on which the second dot code is formed, the second dot code and the stamp code are linked, and then by coming into contact with the medium, coming into contact with the second information processing apparatus 320, and outputting the stamp code, the corresponding content can be browsed and executed. The content corresponding to the stamp code is downloaded from the cloud or is streamed.

### Thirteenth Embodiment

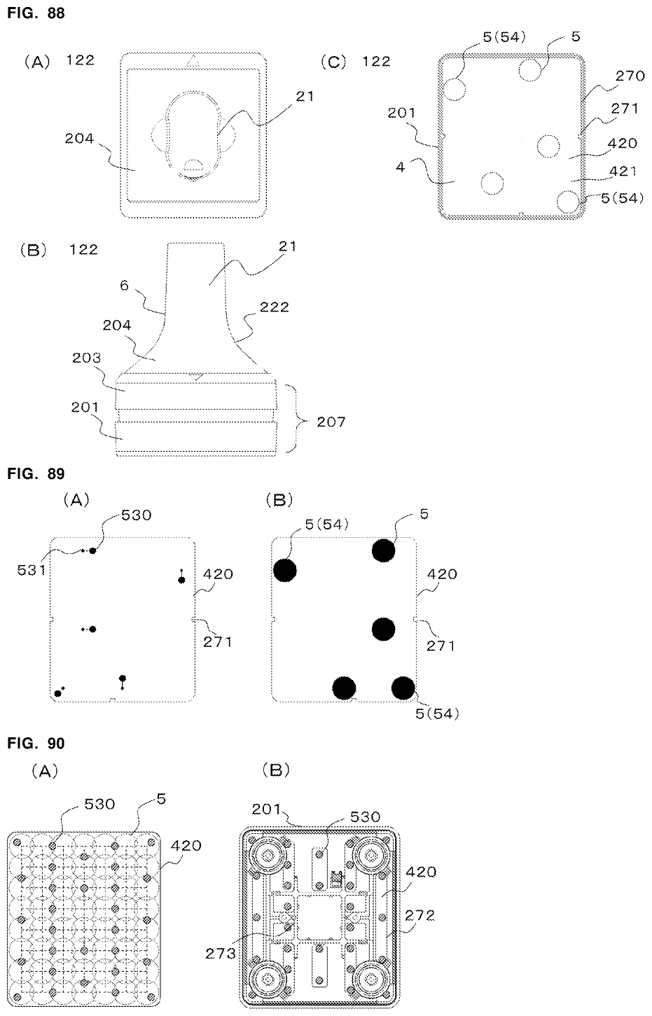

FIG. 88 is a schematic view showing the external shape of a code generation apparatus 122 of the thirteenth (27th?) embodiment. FIG. 88(A) shows a top view, FIG. 88(B) shows a side view, and FIG. 88(C) is a bottom view.

As shown in FIGS. 88(A) to 88(C), the code generation apparatus 122 has a shape similar to a stamp with a substantially rectangular bottom, in the structure the holding section 204 of the housing 2 and the upper side housing 203 are integrated, and the push button of the push button switch of the operation unit 6 is accommodated. Therefore, by holding the holding section 204 in the hand, bringing code generation apparatus 122 into face contact and pressing it against the touch panel 31, the holding section 204 and the upper side housing 203 slide along the side of the lower side housing 201, and by the internal switching structure described below, the two types of pattern codes, the first conductive pattern 81 and the second conductive pattern 82, can be generated sequentially. The handle section 222 is formed of a conductor and is made a human body contact conductive member 21 so that it can be touched naturally when it is held in the hand. Note that just the holding section 204 may be made a human body contact conductive member 21, and the handle section 222 excluding the holding section 204 may be made of a non-conductive material. In this case, it is desirable to make the holding section 204 easily identifiable by its color or shape. Needless to say that the descriptions related to the handle section 222, the holding section 204, and the human body contact conductive member 21 may apply to embodiments hereafter.

As shown in FIGS. 88 to 91, the thirteenth embodiment differs from the eleventh embodiment in regards to the electrodes 5 that are provided on the bottom surface 4 of the code generation apparatus 122 and generate the two types of pattern codes, the first conductive pattern 81 and the second conductive pattern 82, and differ in the conductive pattern formation method, the connection structure of the electrodes 5, and the code pattern changing method.

Descriptions of parts other than these that are not significantly different from the code generation apparatus of the eleventh embodiment are omitted hereafter.

As shown in FIG. 88(C), on the bottom face 4 of the lower side housing 201 of the code generation apparatus 122, a first circuit board 420, on which the electrodes 5 are patterned by etching a copper thin-film layer of the two-layer printed circuit board, is fitted inside the bottom frame portion 270 of the lower side housing 201 so that the position of the circuit board does not shift, and is fixed by a double-coated adhesive film with a thickness of 50 μm. For the first circuit board 420, a two-layer circuit board with copper thin-film layers on both sides is used, and electrodes 5 with a diameter of substantially 8 mm are provided at five predetermined positions on the bottom face 4 side as shown with dashed lines in the figure to form a unique code pattern.

The number of electrodes 5 may be 3 or more, or within a range that can appropriately generate a code pattern.

The electrodes 5 are actually covered with an electrode visual recognition prevention sheet 421 so that they cannot be seen from the outside to prevent the code pattern from being duplicated or forged. Of course, it is not necessary to cover the electrodes with the electrode visual recognition prevention sheet 421. In such a case, it is necessary to cover the electrodes with a protective material such as plating to prevent corrosion.

The material of the first circuit board 420 must have a dielectric constant that does not increase the coupling capacitance between two adjacent electrodes 5 at a distance of about 10 mm when a plurality of electrodes 5 are placed to create the first and second conductive patterns 81 and 82, and it is possible to use glass epoxy resin (FR-4, with a dielectric constant of about 4.5), which is a material generally used for printed circuit boards. Also, by using a circuit board material with a lower relative dielectric constant, the coupling capacitance between electrodes 5 can be reduced and the spacing between adjacent electrodes 5 can be shortened, enabling a further increase in the number of pattern codes that can be created.

The thickness of the circuit board must be such that sufficient flatness can be ensured in an area of substantially 5 cm×5 cm of the external dimensions of the bottom surface of the code generation apparatus 122, assuming that the mainly used code recognition apparatus 3 is a smartphone. Furthermore, to suppress the coupling capacitance between the above-mentioned electrodes 5 in terms of electrical characteristics, a thinner circuit board is preferable, and thus the thickness is about 1.6 mm. If priority is given to ensuring flatness, the thickness may be more than 1.6 mm, and even if the thickness is 2.4 mm, the performance in a practical range can be ensured.

The method of fixing the lower side housing 201 and the first circuit board 420 is not limited to using double-sided adhesive tape, but also a method of using an adhesive agent, a method of screwing the lower side housing 201 and the first circuit board 420 together, and a method of providing a hook on the molded portion of 201 and fitting the parts together may be used.

Furthermore, the bottom frame portion 270 and the first circuit board 420 are provided with circuit board positioning sites 271 at positions corresponding to each of three different sides, and the convex portion of the bottom frame portion 270 and the concave portion of the first circuit board 420 are mated. It is fitted. As a result, it is possible to prevent the first circuit board 420 from being fitted in the wrong direction and to prevent the fitting sites to be out of position.

On the bottom surface 4 side of the first circuit board 420, which is the bottom surface 4 of the code generation apparatus 122, an electrode visual recognition prevention sheet 421 is attached with double-sided adhesive tape to cover the entire area of the bottom surface 4 of the first circuit board 420 and to adhere to the first circuit board 420, to prevent the shape and arrangement of the electrodes 5 from being visible from outside the code generation apparatus 122. The method of attachment is not limited to the use of double-sided adhesive tape, and any method such as applying an adhesive agent to the entire adhesive surface or the like may be used.

In the sheet outline of the electrode visual recognition prevention sheet 421, concave portions are provided at positions corresponding to convex portions of the bottom frame portion 270 as in the case of the circuit board positioning sites 271 provided on three sides of the first circuit board 420, and by mating the concave portions of the first circuit board 420 and the concave portions of the electrode visual recognition prevention sheet 421 when attaching the sheet to the first circuit board 420, it is possible to prevent the sheet attachment sites to be out of position.

In addition, the material and thickness of the electrode visual recognition prevention sheet 421 must be such that the electrodes 5 on the first circuit board 420 cannot be seen through, and the surface of the sheet must be flat and hard after it is attached so that a level difference between the electrode 5 edges and the base member caused by the thickness of the copper thin film layer is not reflected on the surface of the sheet disabling the determination of the electrode arrangement positions. Furthermore, to enable the code recognition apparatus 3 to detect the electrodes 5, it is desirable to have the capacitance generated between an electrode 5 and the touch panel 31 be large only in the area directly under the electrodes 5. Thus, the sheet must be thin and have a high relative dielectric constant.

To achieve both of these conditions, it is preferable to use a sheet of polycarbonate resin (PC), polyethylene terephthalate resin (PET) glass epoxy resin (FR4), polyethylene terephthalate resin (PET), or the like in sheet form with a thickness of 0.2 mm or less, including the double-sided adhesive tape. Otherwise, provided that the level of performance is as an electrode visual recognition prevention sheet 421, any other material, thickness, or attaching method may be used as long as the same performance can be secured as the electrode visibility prevention sheet 421.

Graphics such as a product logo or a management code may be printed on the surface of the electrode visual recognition prevention sheet 421 on the surface of the bottom 4 side, which is to be brought into contact with a touch panel 31, to improve the design and to facilitate product management at the time of mass production. In addition, when printing, a protective sheet such as a thin silicon sheet or PET sheet of about 20 μm may be attached to protect the printed surface and to prevent slippage when it is in contact with a touch panel 31, or the surface may be coated with varnish, which is a common method for protecting printed surfaces of printed matters. In such a case, the thickness of the entire electrode visual recognition prevention sheet 421 must be kept at a level that does not interfere with the detection of the electrodes by a touch panel 31.

FIGS. 89(A) and (B) show examples of circuit board patterns of the first circuit board 420. FIG. 89(A) shows a top view and FIG. 89(B) shows a pattern diagram of the bottom face 4 side.

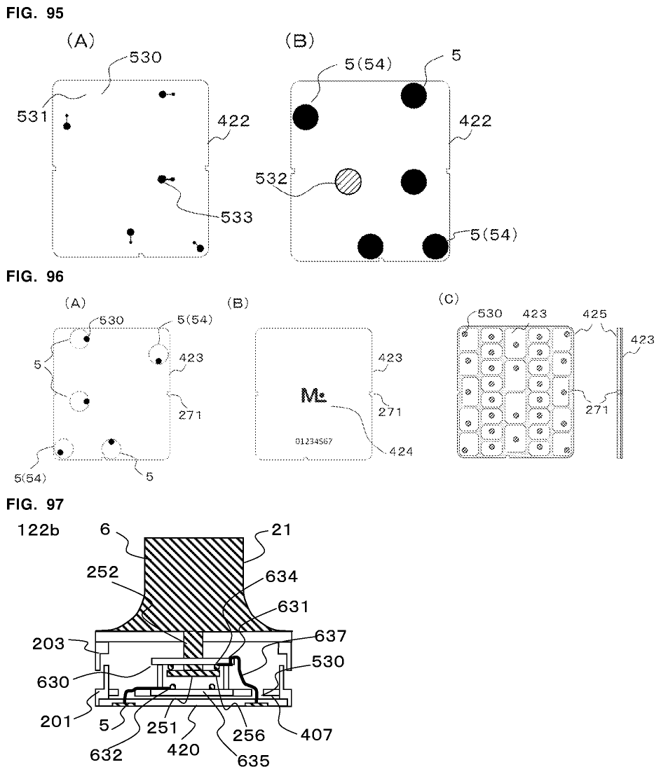

As shown in FIGS. 89 (A) and 89 (B), the first circuit board 420 uses a two-layer circuit board with copper thin film layers on both sides, and electrodes 5 with a diameter of substantially 8 mm are arranged at five predetermined positions on the bottom 4 side so as to form a unique code pattern. Each electrode 5 is connected to a conductor connection terminal 530 provided on the top side of the circuit board via a through-hole 531. The electrode diameter may be reduced to about 6 mm diameter depending on the performance of the touch panel to be targeted. As a result, the number of positions at which electrodes can be placed increase and in turn, the number of code patterns increase. Electrodes with a diameter of more than 8 mm are also possible, but since predetermined distances must be secured between adjacent electrode edges, with electrodes of larger diameter, the number of positions at which electrodes can be placed decreases and in turn, the number of code patterns decreases. Among the electrodes 5 on the bottom surface 4 in FIG. 89(B), the two electrodes 5 (54) at the lower right and upper left in the figure are reference electrodes, and the distance between the centers of these two reference electrodes is the longest among all the electrodes 5 arranged. Based on this distance, the electrode pattern is decoded as a pattern code according to the method shown in [Pattern code decoding method] of the fifth embodiment. The same applies to electrode patterns shown in FIG. 95(B) and FIG. 96(A). Note that in the electrode placement grid coordinate system in FIG. 15 of the [Pattern code decoding method], the electrode placement grid is 7×7 with scale markings up to 6 in the X direction and 6 in the Y direction. However, in the thirteenth embodiment, the electrode placement grid is elongated in the vertical direction to 7×8 with scale markings up to 6 in the X direction and 7 in the Y direction. This is to increase the placement positions of the electrodes 5 other than the reference electrode 5 (54) and arrange more code patterns. The [Pattern code decoding method] is implemented similarly.

FIGS. 90(A) and 90(B) are diagrams showing a state in which the first circuit board 420 is mated to the lower side housing 201 and are explanatory diagrams of the wiring connection method of the electrodes 5. FIG. 90(A) shows placeable positions for the electrodes 5 and the conductor connection terminals 530 of the first circuit board 420, and FIG. 90(B) shows a view from above of the mated state of the first circuit board 420 with the lower side housing 201.

In FIG. 90(A), the circles indicated by the short broken lines are placeable positions for electrodes 5, and in the case of this practical example, all of the placeable positions are 56. The grid shown by the long broken line indicates grid coordinates for generating a code pattern, and 5 electrodes are placed among all of the grid intersections at five positions to create a unique code pattern and which are far enough apart from each other so that they can be recognized as different touch positions by a smartphone, which is a code recognition apparatus 3. Due to the restriction in the distance between electrodes, no other electrodes are placed at grid intersections adjacent to the position of an electrode. The circles hatched with shaded lines are the placeable positions for the conductor connection terminals 530, and due to the restriction in the distance between electrodes, one position is set in common for two adjacent electrode positions excluding the four corners, making the total 30 positions.

As shown in FIG. 90(B), the bottom of the lower side housing 201 has a wiring passage hole 272 so that all of the conductor connection terminals 530 can be seen when the first circuit board 420 is mated. By sharing the placement position of the conductive wire connection terminal 530 with respect to the arrangement positions of two electrodes 5, the bottom opening area of the wiring passage hole 272 of the lower side housing 201 is reduced, the flatness of the bottom 4 of the lower side housing 201 is not impaired and the strength is not reduced.

In the center of the lower side housing 201, a fixed pedestal 273 is provided for fixing the second circuit board 630 described below, and since according to the structure, a movable electrode slides inside the fixed pedestal 273, the conductor connection terminals 530 of the first circuit board 420 are placed so as to avoid this area and no wiring passage holes 272 are provided.

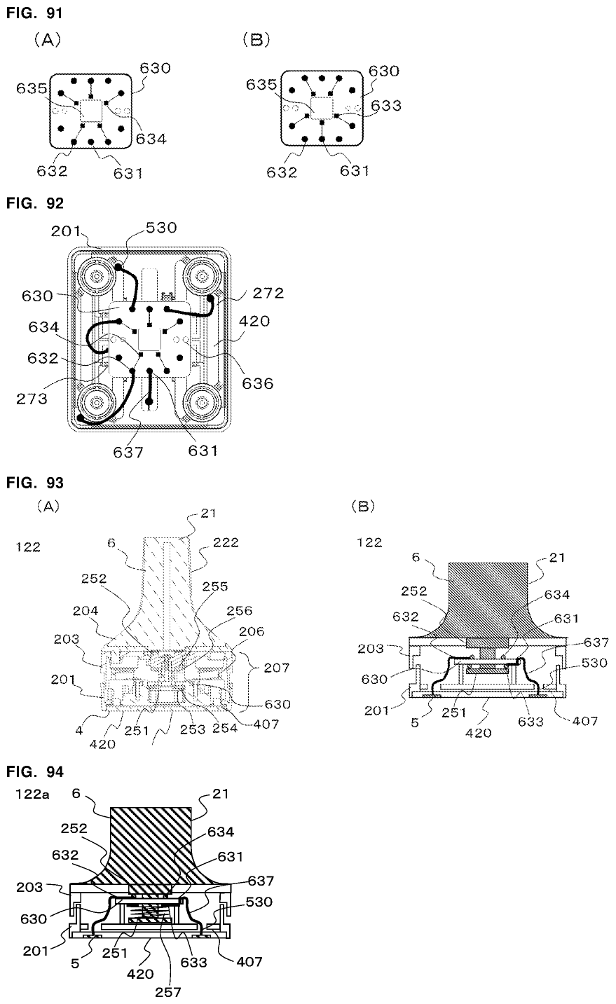

FIGS. 91(A) and (B) show circuit board pattern diagrams of the second circuit board 630. FIG. 91(A) shows a top view and FIG. 91(B) shows a pattern diagram of a bottom view.

As shown in FIG. 91, the second circuit board 630 is made of a two-layer printed wiring board, with five first-stage electrode connection terminals 631 and five second-stage electrode connection terminals 632 alternately arranged at substantially even intervals around the periphery of the circuit board, and through holes connect the copper thin-film layers on the upper and lower surfaces. The first-stage electrode connection terminals 631 are wired and connected in a copper thin film layer to the first-stage contact units 633 which are arranged at substantially even intervals around the movable electrode sliding hole 635 in the center of the circuit board on the lower surface side. The second-stage electrode connection terminals 632 are wired and connected in a copper thin film layer to the second-stage contact units 634 which are arranged at substantially equal intervals around the movable electrode sliding holes 635 in the center of the circuit board on the upper surface side. Furthermore, the first-stage electrode connection terminal 633 and the second-stage electrode connection terminal 634 are arranged so that their positions do not overlap in the vertical direction even when viewed transparently so as to reduce coupling capacitance as much as possible.

Contact terminal parts are surface-implemented for each of the five upper and lower positions of the first-stage contact units 633 and second-stage contact units 634. If the plurality of electrodes is other than five, corresponding first-stage electrode connection terminals 631 and second-stage electrode connection terminals 632 may be provided, and corresponding contact terminal components may be surface-implemented.

FIG. 92 shows a diagram of a state in which the first circuit board 420 is mated to the lower side housing 201 and the second circuit board 630 is fixed to the lower side housing 201, and is an explanatory diagram of a wiring connection method for the electrodes 5.

The second circuit board 630 is fixed to the fixed pedestal 273 in the center of the lower side housing 201 by fitting screws into the screw holes 638 on the left and right edges of the second circuit board 630. The circuit board fixed surface of the fixed pedestal 273 is located at the upper edge of the lower side housing 201, about 10 mm higher than the first circuit board 420, to separate the terminals and wiring on the second circuit board 630 from the touch panel 31, to reduce parasitic coupling capacitance, and to secure area for connecting wiring between the conductor connection terminals 530 of the first circuit board 420, and the first and second electrode connection terminals 631 and 632 of the second circuit board 630. Note that depending on the performance of a targeted touch panel, the position of the circuit board fixed surface of the fixed pedestal 273 may be less than about 10 mm or more than about 10 mm from the first circuit board 420 at the upper edge of the lower side housing 201.

For the code generation apparatus 122, the electrodes 5 to be detected by a touch panel 31 of a code recognition apparatus 3 for the first conductive pattern 81 to be generated before pressing down the holding section 204 are soldered with conducting wiring 636 from the conductor connection terminals 530 corresponding to the electrodes 5 on the first circuit board 420 to the first stage electrode connection terminals 631 of the second circuit board 630 through wiring passage holes 272 of the lower side housing 201. Since the first-stage electrode connection terminals 631 located at five positions on the second circuit board 630 are all terminals having the same function, it is desirable to select terminals in positions where the length of the conducting wire 636 that is wired between the conductor connection terminals 530 are as short as possible and where crossings or parallel placements with respect to other wires are avoided as much as possible.

Next, the electrodes 5 to be detected by the touch panel 31 of the code recognition apparatus 3 for the second conductive pattern 82 to be generated after pressing down the holding section 204 are soldered with conducting wiring 636 from the conductor connection terminals 530 corresponding to the electrodes 5 on the first circuit board 420 to the second stage electrode connection terminals 632 of the second circuit board 630 through wiring passage holes 272 of the lower side housing 201. Since the second-stage electrode connection terminals 632 located at five positions on the second circuit board 630 are also all terminals having the same function, it is desirable to select terminals in positions where the length of the conducting wire 636 that is wired between the conductor connection terminals 530 are as short as possible and where crossings or parallel placements with respect to other wires are avoided as much as possible.

In this way, for the code generation apparatus 122, the electrodes 5 to be detected by the touch panel 31 for the first conductive pattern 81 and the electrodes 5 to be detected by the touch panel 31 for the second conductive pattern 82 from the five electrodes of the first circuit board 420 to form a unique electrode arrangement pattern as a code pattern can be selected base on the wiring. Therefore, by changing the chronological order of the electrodes 5 detected in the first and second stages, a large number of time-series patterns and thus a large number of unique codes can be generated from a single unique electrode arrangement pattern.

For example, if the number of electrodes to be detected in the first stage is set to one, five types of time series patterns can be generated. Similarly, if the first stage is set to have two electrodes, there will be 10 different patterns, if the first stage is set to have three electrodes, there will be 10 different patterns, and if the first stage is set to have four electrodes, there will be 5 different patterns, making a total of 30 time-series patterns. Therefore, if all of the time-series patterns are created, 30 pattern codes can be generated from one unique electrode arrangement pattern. Note that if the total number of electrodes to be selected for the first and second stages is set to four, with five electrodes placed in five positions, the two reference electrodes with the longest distance between electrodes must be selected in either the first or second stage, and thus there are three different patterns for the electrode arrangement patterns of four electrodes. On the other hand, for the electrode arrangement patterns of four electrodes, there are four different patterns when the first stage is set to have one electrode, six different patterns when the first stage is set to have two electrodes, and four different patterns when the first stage is set to have three electrodes, making a total of 14 different patterns, and thus resulting in 14×3=42 pattern codes. If the total number of electrodes to be selected for the first and second stages is set to three, similarly, there are three different patterns for arranging three electrodes. There are three different patterns when the first stage is set to have one electrode, and three different patterns when the first stage is set to have two electrodes, making a total of six different patterns, and thus resulting in 6×3=12 pattern codes, for a grand total of 54 patterns. Furthermore, if six or more electrodes are arranged and up to five electrodes are to be detected, even more pattern codes can be generated. Of course, the number of electrodes detected in the first and second stages combined can be any number, provided that the number of electrodes to be detected is three or more and less than the number of electrodes actually placed. Needless to say that the above descriptions may apply to all subsequent descriptions related to pattern codes.

Here, the code generation apparatus 122 that can generate 30 different types of codes can be created using all common components, with the only difference being the wiring specifications from the conductor connection terminals 530 of the first circuit board 420 to the first and second stage electrode connection terminals 631 and 632 of the second circuit board 630. Furthermore, in the case of another different code with a different electrode arrangement pattern, it is possible to create code generation apparatuses 122 of another 30 different codes simply by changing the first circuit board 420 and the wiring specifications.

FIG. 93 shows a sectional view of the bottom 4 of the code generation apparatus 122, dissected vertically at the center along the long length side. FIG. 93(A) shows the actual structure, and FIG. 93(B) shows a schematic diagram describing the electrical connection state. As shown in FIG. 93(A), the first circuit board 420 is mated and fixed to the bottom 4 of the lower side housing 201. A gap 407 with a height of about 1 mm is provided between the bottom of the lower side housing 201 and the first circuit board 420, so that the parasitic coupling capacitance generated in conductors such as the electrodes 5 of the first circuit board 420 is not greatly affected by the structure of the lower side housing 201. In addition, the lower side housing 201 has substantially cylindrical supporting columns 206 protruding from the lower side housing 201 from positions near the four vertices of the bottom surface 4 to the interior of the upper side housing 203.

Furthermore, the second circuit board 630, which is mated and fixed to the fixed pedestal 273 with screws in the center of the lower side housing 201, has a movable electrode sliding hole 635 opened in the center of the circuit board, and a lower side movable contact unit 251 that can freely slide from the back side to the front side is inserted, and is fixed sandwiched between the upper side movable contact unit 252 provided in the upper part of the surface of the second circuit board 630 and the second circuit board 630.

The lower side movable contact unit 251 has a structure in which a brim-shaped portion 253 is provided at the bottom of a columnar body with a substantially rectangular shape in a plan view, and the entire lower side movable contact unit 251 is conductive. A movable contact 254 made of conductive rubber and is elastic is provided at a position opposite to the first stage contact unit 633 provided nearby the movable electrode sliding hole 635 of the second circuit board 630 with a brim-shaped portion 253, to absorb the variations in the contact intervals between the first stage contact unit 633 on the second circuit board 630 side and a part of the lower side movable contact unit 251 making contact, and to make all of the contacts conductive to each other. Also, the movable contact 254 is not limited to conductive rubber, and can be a plate spring contact, or the like, provided that it has elasticity and can absorb the variations in the contact intervals and make all of the contacts conductive to each other.

The upper side movable contact unit 252 has a structure in which a step portion 255 is provided on the upper part of a columnar body having a substantially rectangular shape in a plan view, and a concave part is provided in the center of the columnar structure to insert and fit the lower side movable contact unit 251, and the entire upper side movable contact unit 252 is conductive. A movable contact 256 made of conductive rubber and is elastic is provided at a position opposite to the second stage contact part 634 provided nearby the movable electrode sliding hole 635 of the second circuit board 630 of a step portion 255, to absorb the variations in the contact intervals between the second stage contact unit 634 on the second circuit board 630 side and a part of the upper side movable contact unit 252 making contact, and to make all of the contacts conductive to each other. Also, the movable contact 256 is not limited to conductive rubber, as is the case with the lower side movable contact unit 251.

The upper side movable contact unit 252 is provided with a latch structure in the upper part and is mated and fixed to the upper side housing 203. The upper side housing 203 has a cylindrical opening at a position corresponding to the supporting column 206 protruding from the lower side housing 201. At the bottom of the cylindrical opening, there is a step that reduces the diameter of the opening so that the supporting column 206 that can slide is inserted. At the bottom of the cylindrical opening, there is a step where the opening diameter is reduced, and with a spring inserted for the supporting column 206, a screw with a brim is fixed to the supporting column 206 inserted from the opening at the top of the upper side housing 203 with the supporting column 206 sandwiched between the lower side housing 201 and the upper side housing 203. As a result, the upper side housing 203 and the lower side housing 201 are fixed with the ability to slide, and a contact drive mechanism for the push button switch for switching the conductive pattern of the code recognition apparatus 122 is formed. The first stage contact unit 633 and the movable contact 254, and the second stage contact unit 634 and the movable contact 256 are appropriately spaced from each other so that both contacts do not contact at the same time during a switching operation, and the switching method is of non-shorting type. This is to avert limitations in the number of multi-touches that can be detected simultaneously set on the touch panel 31 of a smartphone such as an iPhone (registered trademark). The structure from the lower side housing 201 to the upper side housing 203 is the main body 207.

A holding section 204 is attached to the upper side housing 203 with a removable structure. The holding section 204 is comprised of a non-conductive lid section that covers the upper side housing 203 with high design quality and a conductive handle section 222 that corresponds to the handle of the stamp. The handle section 222 is in contact with and is conductive with the upper movable contact unit 252.

The parts filled with shaded lines and the parts indicated with bold lines in FIG. 93(B) are conductive. In a state before the push button switch of the operation unit 6 is pressed, for the code generation apparatus 122, by having a person hold a human body contact conductive member 21 of a handle section 222, there is conduction from the human body to the electrodes 5 from the first electrodes 5 of the first circuit board 420 through the conductive wire connection terminals 530, wiring 637, the first stage electrode connection terminals 631 of the second circuit board 630, the movable contact 254, the lower movable contact unit 251, and the upper movable contact unit 252.

Furthermore, in a state in which the push button switch of the operation unit 6 is being pressed, by having a person hold a human body contact conductive member 21 of a handle section 222, there is conduction from the human body to the electrodes 5 from the first electrodes 5 of the first circuit board 420 through the conductive wire connection terminals 530, wiring 637, the second stage electrode connection terminals 632 of the second circuit board 630, the movable contact 256, and the upper movable contact unit 252.

### Modification Example 1 of the Thirteenth Embodiment

FIG. 94 is a diagram showing a code generation apparatus 122a of the modification example 1 of the thirteenth embodiment. For the code generation apparatus 122a of the modification example 1, an electrically conductive spring 257 is sandwiched between the first stage electrode connection terminal 631 of the second circuit board 630 and the lower side movable contact unit 251 instead of the movable contact 256 made of conductive rubber, and according to specifications here, the first-stage electrode connection terminal 631 and the lower side movable contact unit 251 always remain conducted regardless of whether the push button switch of the operation unit 6 is pressed or not. As a result, the conductive pattern 81 before pressing can be stably generated even if the sliding structure of a push button switch of the operation unit 6 of the code generation apparatus 122a is loose or rattling.

For the code generation apparatus 122a, the number of detected electrodes of the second-stage conductive pattern 82 after pressing does not decrease with respect to the number of detected electrodes of the first-stage conductive pattern 81 before the push button switch is pressed.

### Modification Example 2 of the Thirteenth Embodiment

FIG. 95 is a diagram showing modification example 2 of the thirteenth embodiment. In modification example 2, instead of the first circuit board 420, as shown in the circuit board pattern example of the first circuit board 422, in addition to the five unique electrodes 5 on the bottom surface 4 side, another electrode 532 is provided.

Electrode 532 is connected to the additional conductor connection terminal 534 on the upper side in the same way as electrodes 5. According to specifications here, for code decoding, two of the five electrodes 5 are designated as reference electrodes 54 and are placed at the fixed positions of the upper left and the lower right so that the distance between the two electrodes is the longest compared with the distances between other electrodes. The remaining three electrodes 5 are placed at grid intersections of the grid coordinates so that including the two reference electrodes 54, the distance between any two electrodes is far enough apart so that the touch panel 31 of a code recognition apparatus 3 can detect the two at the two different touch positions, and so that decoding gives a code unique with respect to codes of other electrode placement patterns. Similarly, the electrodes 532 are placed at the grid intersections of the grid coordinates with the distance between any two electrodes far enough apart so that the touch panel 31 of a code recognition apparatus 3 can detect the two at the two different touch positions and so that decoding gives a unique code with an arrangement pattern including the reference electrodes 54 and any two electrodes 5 out of the other three electrodes 5.

As a result, when the first circuit board 422 is used, by selecting a total of five electrodes, two reference electrodes 54 and three of the four electrodes of the group of electrodes 5 other than the reference electrode 54 and the additional electrode 533, and connecting them to the wiring 637, it is possible to create four types of unique conductive patterns from one type of first circuit board 422, and it is possible to reduce the designing and manufacturing cost of the first circuit board 422.

Furthermore, the additional electrodes 533 are not limited to one, and a plurality of electrodes may be placed on the first circuit board at grid intersections of the grid coordinates under the condition that the distance between any two electrodes is far enough apart so that the touch panel 31 of a code recognition apparatus 3 can detect the two at the two different touch positions and so that decoding gives a code unique with respect to codes of other electrode placement patterns.

### Modification Example 3 of the Thirteenth Embodiment

FIG. 96 is a diagram showing modification example 3 of the thirteenth embodiment. In the specifications of modification example 3, a first circuit board 423 made of a one-layer printed wiring circuit board having a thin base member of about 0.2 mm is used instead of the first circuit board 420 made of a two-layer printed wiring circuit board. FIG. 96(A) shows a pattern example of the upper surface side of the first circuit board 423, FIG. 96(B) shows a pattern example of the bottom surface 4 side, and FIG. 96(C) shows an example in which a spacer 425 is used in combination when the lower side housing 201 of the code generation apparatus 122 is shared with the first circuit board 420.

As shown in FIG. 96 (A), the first circuit board 423 is provided with a copper thin film layer on the upper side of the base member of about 0.2 mm in thickness having the same external shape as the first circuit board 420, and electrodes 5 with a diameter of substantially 8 mm are formed according to the electrode arrangement specifications for code patterns. Since the electrodes are placed on the upper side, to create the same code pattern as the first circuit board 420, it is necessary to place the electrodes 5 in mirror symmetry with respect to the electrodes of the first circuit board 420, and thus care is required. Also, with the first circuit board 423, a resist layer is applied to the upper layer of the electrodes 5 with openings at the positions corresponding to the conductive wire connection terminals 530 of the first circuit board 420, to form conductive wire connection terminals 530.

A resist layer is applied to the entire surface of the bottom surface 4 side of the first circuit board 423. The resist layer is to be opaque black or white so that electrodes 5 cannot be seen through the layer. Also, the resist layer is applied to both sides to prevent warping of the base member. On the resist layer, graphics 424 such as logos and management numbers are printed on a silk layer of the printed wiring circuit board. The graphics 424 can also be printed separately by a Tampo printing method after assembly is completed. As a result, the electrode visual recognition prevention sheet 421 is unnecessary

As shown in FIG. 96(C), the lower side housing 201 of the code generation apparatus 122 can be shared with the first circuit board 420 by forming a spacer 425 with a resin plate with a low dielectric constant that fills the difference between the thickness of the first circuit board 423 and the thickness of the first circuit board 420, and attaching it to the upper side of the first circuit board 423 with an adhesive agent or the like. When the first circuit board 420 is 1.6 mm thick, the first circuit board 423 is 0.2 mm thick, and the adhesive layer is 0.05 mm thick, the spacer 425 needs to be about 1.35 mm thick. In addition, it is preferable to make the spacer 425 into a frame-shaped structure with holes opened at each conductive connection terminal 530 position to reduce the parasitic coupling capacitance of the electrodes 5, as well as to allow the conductive wires 637 to be soldered at all of the conductive connection terminal 530 positions so that they can be shared by all first circuit boards 423. Similarly, forming the spacer 425 with a resin plate with a low dielectric constant is also effective in reducing the parasitic coupling capacitance of the electrode 5.

### Modification Example 4 of the Thirteenth Embodiment

FIG. 97 is a diagram showing a code generation apparatus 122b according to modification example 4 of the thirteenth embodiment. According to specifications here of the code generation apparatus 122b of the modification example 4, the third circuit board 63 is provided on the lower surface side of a lower side movable contact unit 251, and a movable contact of conductive rubber is provided on the lower surface side of the second stage electrode connection terminal 632 and the lower side movable contact unit 251, and by pressing the push button switch of the operation unit 6, the second-stage electrode connection terminal 632 and the lower side movable contact unit 251 are made conductive on the upper surface side of the third circuit board 63. The structures of the first-stage electrode connection terminal 631 and the lower side movable contact unit 251 before pressing is the same as those of the code generation apparatus 122.

As a result, for the code generation apparatus 122b, there is a clear distinction that the electrodes 5 connected by wiring 637 to the second circuit board 630 is the first-stage conductive pattern 81, and the electrodes 5 connected by wiring 637 to the third circuit board 63 is the second-stage conductive pattern 82. Therefore, it is possible to reduce time-series pattern errors in the assembly process.

### Fourteenth Embodiment

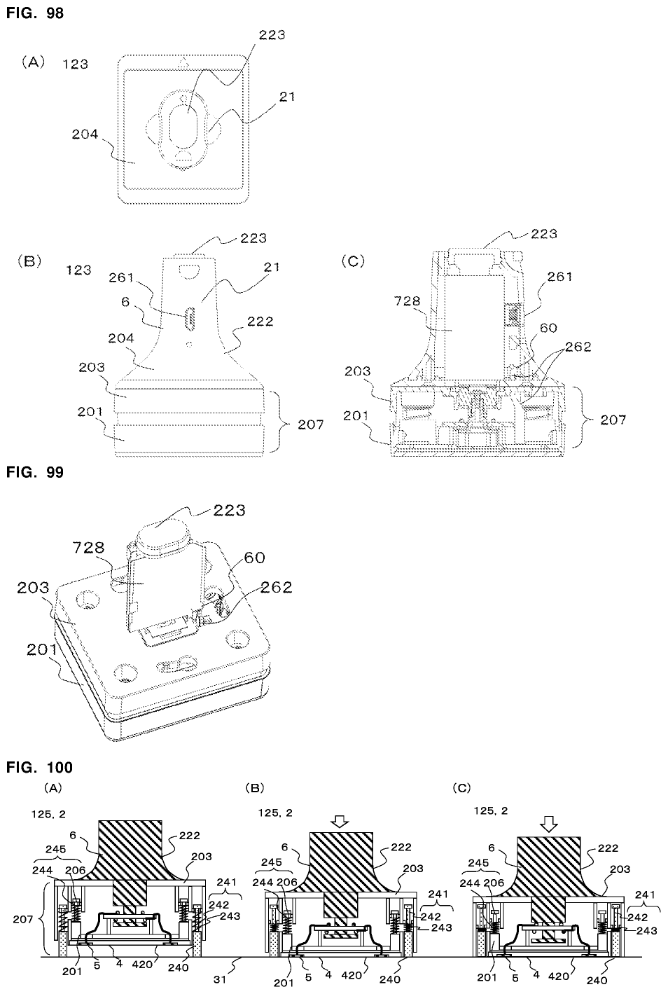

The code generation apparatus 123 shown in FIG. 98 is a practical example in which the specifications of the code generation apparatus 117 of the sixth embodiment are incorporated into the housing of the code generation apparatus 122 as a specific structure. FIG. 98 is a schematic view showing the external shape of the code generation apparatus 123. FIG. 98(A) shows a top view, FIG. 98(B) shows a side view, and FIG. 98(C) shows a sectional view obtained by dissecting the center of the bottom surface 4 in the vertical direction along the short length side.

As shown in FIGS. 98 (A) to 98 (C), the code generation apparatus 123 makes the touch panel 31 of a smartphone, which is a code recognition apparatus 3, detect the electrodes 5 with an operation of the push button switch, and this detection triggers the connection of the smartphone and the generation apparatus 123 by one-to-one communication to transmit and receive a code pattern or a lot of other types of information. A communication unit and a power supply are installed in the holding section 204 for such purpose. The communication apparatus may use Bluetooth, WIFI, NFC, RF, or any other means as a communication means.

A power switch 223 is provided at the top of the handle section 222. In addition, an LED lamp may be provided to indicate clearly that the power is ON. Furthermore, an LED lamp may be provided to indicate the communication status clearly. In addition, a USB connector 261 for charging and installing programs is provided on a side of the handle section 222. Also, a reset pin insertion hole may be provided to function as a reset switch for the communication unit board, which cannot be visually recognized from the exterior.

Inside the handle section 222, there is a PCB board 728 on which the apparatus shown in FIG. 76 is installed, which is provided with the communication function of the code generation apparatus 117 of the sixth embodiment in a direction parallel to the long length side direction of the bottom surface 4, and there is a lithium ion rechargeable battery built-in as a power supply unit 727. All of the structures other than that of the handle section 222 can be used without changing parts of the code generation apparatus 122. Note that the bottom surface 4 may be square or circular.

FIG. 99 shows a diagram for describing a structure in which the handle section 222 has been removed so that the inside can be seen. As shown in FIGS. 98(C) and 99, a push button switch 60 is installed in the lower right edge of the PCB board 728. Furthermore, a switch push bar 262 penetrating the upper side housing 203 from the lower side housing 201 is provided at an under position corresponding to the button position of the push button switch 60 for triggering communication. When the handle section 222 is held and the operation unit 6 is pressed, the holding section 204 and the entire upper side housing 203 slide downward, the conductive pattern is switched, and a two-stage code pattern for the code generation apparatus 123 is generated. In addition, the switch push bar 262 protruding from the lower side housing 201 extends relatively upward, and the button of the push button switch 60 for the communication trigger enters a pressed state, causing the communication unit on the PCB board 728 to turn ON, the communication unit of the code recognition apparatus 3 to interconnect, and the transmission/reception of data to start. Note that in regards to the transmission/reception of data (including cases of either transmission or reception), methods and applications described in the sixth and eighth embodiments, and later described in the fifteenth embodiment may be used. Of course, needless to say, that the communication unit performs connections and the transmission/reception of data (including cases of either transmission or reception) in an optimum manner Note that the code generation apparatus 123 may be manufactured by combining specifications in this embodiment with those of other embodiments, or a system including the code generation apparatus 123 may be constructed.

### Fifteenth Embodiment

FIG. 100 is a diagram showing an outline of a drive mechanism of the code generation apparatus 125 of the fifteenth embodiment. The code generation apparatus 125 is provided with a two-stage drive mechanism so that the electrodes 5 do not come into contact with the touch panel 31 of the code recognition apparatus 3 at the point when the code generation apparatus 125 comes into contact with the touch panel 31. As a result, when the code generation apparatus 125 is placed on the touch panel surface, the code generation apparatus 125 can be pressed in a state where the frame-shaped housing 240 is completely in face contact with the touch panel surface, so that the first stage conductive pattern 81 can be more reliably detected by the touch panel 31.

As shown in FIG. 100(A), the code generation apparatus 125 is provided with a lower side housing 201 on the innermost side of the main body 207, and the lower side housing 201 is provided with a first sliding mechanism 245 involving a first supporting column 206 and a first spring 244 having structures similar to those of the lower side housing 201 of the code generation apparatus 122 of the thirteenth embodiment, and push button switch mechanism to changeover the connections of the electrodes 5. Furthermore, since the electrodes 5 are arranged on the bottom surface 4 side of the first stage circuit board 420 fitted to the lower side housing 201, they have structures that enable them move in the vertical direction together with the lower side housing 201.

At the outermost part of the main body 207 is the upper side housing 203, and the upper side housing 203 likewise has a receiving side structure with a first sliding mechanism 245 (a tube through which the first supporting column 206 is inserted and a stopper for the first spring 244) which is of the same structure as the upper side housing 203 of the code generation apparatus 122 of the thirteenth embodiment and has a push button switch mechanism.

In addition, the housing 207 of the code generation apparatus 125 has a frame-shaped housing 240 and a sliding mechanism 241 thereof so as to be sandwiched between the lower side housing 201 and the upper side housing 203.

The frame-shaped housing 240 is provided in a frame shape between the lower side housing 201 and the upper side housing 203 so as to surround the outer periphery of the bottom surface 4, and a second sliding mechanism 241 comprising second supporting columns 242 and second springs 243 are provided above the four corners. Furthermore, the receiving side structure of the second sliding mechanism 241 (a tube through which the second supporting column 242 is inserted and a stopper for the first spring 243) is located further outside of the receiving side structure of the first sliding mechanism 245 in the upper side housing 203 and at a position corresponding to the second sliding mechanism 241.

As shown in FIG. 100(A), when the housing 2 of the code generation apparatus 125 is in contact with a touch panel 31 and no external force is applied, the first spring 244 of the first sliding mechanism and the second spring 243 of the second sliding mechanism 241 cause the frame-shaped housing 240 to be positioned at the bottom of the body 207 of the housing 2, and only the bottom edge of the frame-shaped housing 240 makes contact with the touch panel 31. Therefore, when the code generation apparatus 125 is only in contact with the touch panel 31, the electrodes 5 do not come into contact with the touch panel 31 and are not detected by the code recognition apparatus 3.

As shown in FIG. 100(A), when holding the handle section 222 and pressing the operation unit 6, immediately after pressing is started, since the bottom surface 4 of the lower side housing 201 (bottom surface 4 side of the first circuit board 420) is away from the touch panel 31, no force is applied and the first spring 244 of the first sliding mechanism 245 does not contract. On the other hand, since the frame housing 240 is in contact with the touch panel 31, a force is applied to the second spring 243 of the second sliding mechanism 241, causing the spring 243 to contract, and the entire operation unit 6 moves down so that the frame-shaped housing 240 fits into the upper side housing 203.

When the entire operation unit 6 is lowered to the state shown in FIG. 100(B), the bottom surface 4 comes into contact with the touch panel 31, the electrodes 5 are detected by the touch panel 31, and a conductive pattern 81 of the first stage is detected by the code recognition apparatus 3. In addition, since a force is also applied to the first spring 244 of the first sliding mechanism 245, the lower side housing 203 also begins to move down according to the pressing.

When the operation unit 6 is lowered to the state shown in FIG. 100 (C), the push-button switch mechanism is activated, the first-stage conductive pattern 81 switches to the second-stage conductive pattern 82, and both the first- and second-stage conductive patterns 81 and 82 are detected by the code recognition apparatus 3, enabling decoding to a pattern code.

Generally, when pressing a stamp-shaped code generation apparatus with a bottom surface 4 of about 4 to 5 cm×5 to 6 cm onto a touch panel 31, in some cases, the bottom surface 4 of may not be pressed in the vertical direction with the bottom surface 4 parallel to the surface of the touch panel 31. In such a case, for example, for the code generation apparatus 122 of the thirteenth embodiment, only one of the four vertices of the bottom surface 4 may come into contact with the touch panel first, causing the conductive pattern 81 of the first stage not to be pressed properly parallel to the touch panel 31. As a result, sufficient time for the first-stage conductive pattern 81 to be properly detected by the touch panel 31 cannot be secured, a state occurs in which the first-stage conductive pattern 81 and the second-stage conductive pattern 82 cannot be distinguished, and a pattern code may not be properly decoded.

However, in the case of the code generation apparatus 125 of this practical example, the structure is such that the electrodes 5 do not come into face contact with the touch panel 31 in the initial stage of making face contact immediately after pressing is started, and the electrodes 5 come into face contact with the touch panel 31 only after the pressing progresses and all four vertices of the bottom surface 4 come into face contact with the surface of the touch panel 31. Therefore, after the first conductive pattern 81 is detected by the touch panel 31, the second conductive pattern 82 can be detected reliably regardless of how the pressing was performed. Note that specifications of the code generation apparatus 125 of this practical example may be applied to the code generation apparatuses of other practical examples.

### Sixteenth Embodiment

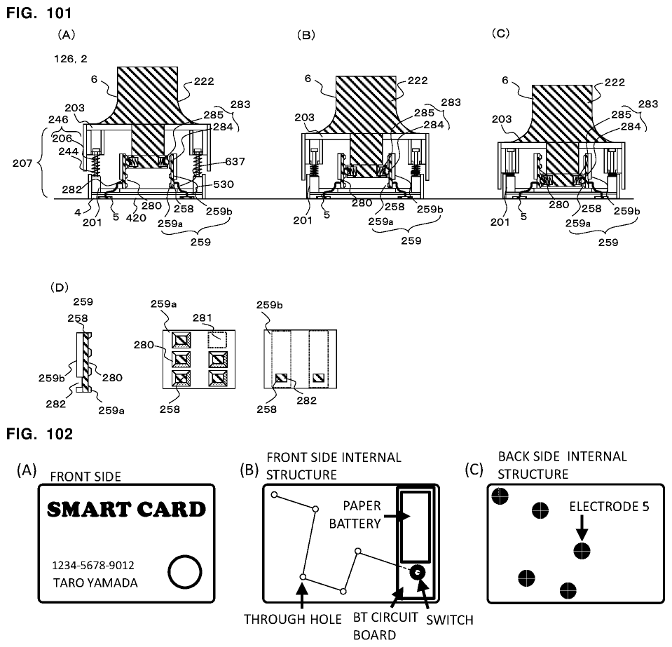

FIG. 101 is a diagram showing an outline of a drive mechanism of the code generation apparatus 126 of the sixteenth embodiment. The code generation apparatus 126 is provided with a drive mechanism similar to the internal structure of a slide switch in the vertical direction, so that it is possible to sequentially generate three types of conductive patterns in three stages. For example, compared with the code generation apparatus 122, which generates two types of conductive patterns in two stages, more time-series patterns can be generated, and according to this specification, many more pattern codes can be generated with a single arrangement pattern of electrodes 5 and a single first circuit board 420 pattern.

As shown in FIG. 101(A), the code generation apparatus 126 has inside the main body 207, a lower side housing 201, an upper side housing 203, and a sliding mechanism 246 of a structure similar to that of the code generation apparatus 122 comprising a supporting column 206 and a first spring 244 that helps the upper side housing 203 to slide in the vertical direction when the handle section 222 of the control unit 6 is pressed. Furthermore, on the bottom surface 4 of the lower side housing 201, a first circuit board 420 is mated and fixed to the lower side housing 201 with the same structure as that of the code generation apparatus 125, electrodes 5 are arranged on the bottom surface 4 side of the first circuit board 420, and they are connected to conductive wire connection terminals 530 on the upper surface side of the first circuit board 420 via through holes.

In the center of the lower side housing 201, contact shielding tubes 259 with fixed contact plates 258 for selecting time-series patterns built-in are provided in the vertical direction in the form of a cylinder or a polygonal column such as a square column, in the place of the second circuit board 630 and the lower side and upper side movable contact units 251 and 252 of the code generation apparatus 122.

FIG. 101(D) shows a schematic diagram of a contact shielding tube 259, with the tube part cut open to describe the function of the tube. The contact shielding tube 259 has a double-layered tube structure, and between the inner tube 259a and the outer tube 259b, a number of fixed contact plates 258 corresponding to the electrodes 5 arranged on the first circuit board 420 are disposed at equal intervals in the case of tubes of cylindrical structure, and one plate on each side or at equal intervals in the case of tubes of polygonal structure. The inner tube 259a is provided with either an opening 280 or a non-opened section 281 at positions corresponding to the fixed contact plates 258 and are divided into three stages in the vertical direction. The structure is such that a fixed contact plate 258 is exposed by an opening 280. Furthermore, the sides of the opening 280 have a gentle taper angle so that the openings are wider with respect to the surface of the inner tubes 259a. The inner tubes 259a are mated and fixed with claws or the like so that inner tubes 259a can be easily removed from the lower side housing 201. As a result, it is possible to easily change time-series patterns by changing the positions of the openings 280 and non-opened sections 281 by preparing a plurality of inner tubes 259a corresponding to different time-series patterns, exchanging them, and assembling.

The outer tube 259b has openings at positions corresponding to the fixed contact plate 258 at the end of the lower side housing 201, and serves as tube side conductive wire connection terminals 282. The fixed contact plates 258 are exposed from the openings of the tube side conductive wire contact terminals 282. Furthermore, the outer tube 259b has a structure that is fixed or formed in one with the lower side housing 201 so that it cannot be easily removed.

By connecting the conductive wire connection terminals 530 of the first circuit board 420 of the lower side housing 201 and the conductive wire connection terminals 282 of the outer tube 259b with the wiring 637, there is conduction from the electrodes 5 to the openings 280 of the corresponding fixed contact plates 258.

A movable electrode 25 that can slide is inserted inside the contact shielding tube 259. At the lower end of the movable electrode 25, laterally movable contacts 283 are provided at positions corresponding to the fixed contact plates 258 of the contact shielding tube 259. A conductive spherical contact 284 and a conductive spring 285 are embedded inside the movable electrode 25, with a hemispherical portion of the spherical contact 284 exposed from the movable electrode 25, and the lateral movable contact 283 made to be slidable in the lateral direction are embedded at this position. When the movable electrode 25 slides up and down on the inner surface of the contact shielding tube 259, the spherical contact 284 takes on a structure that goes in and out of the inner side of the movable electrode 25 in the horizontal direction, absorbs the level differences of the openings 280 in the inner tube 259a of the contact shielding tube 259, and with the fixed contact plates 258 exposed in the openings 280 and the spherical contacts 284 making contact, there is conduction through the movable electrode 25 to the handle section 222. As a result, there is conduction from electrodes 5 to handle section 222 only at the positions where openings 280 of the contact shielding tube 259 are located.

FIGS. 101(A), 101(B), and 101(C) show explanatory diagrams of a state in which the handle section 222 is held and the operation unit 6 is pressed. FIG. 101(A) shows a state before pressing, in which a movable electrode 25 is located at the uppermost part of a contact shield tube 259, the openings 280 at the top stage of the inner tube 259a and the spherical contacts 284 are conductive, the corresponding electrodes 5 are in a state of being detected by the touch panel 31, and a first stage conductive pattern 81 is being generated. FIG. 101 (B) shows a diagram of a state in which pressing is to an intermediate state, and the movable electrode 25 is positioned at the center of the contact shielding tube 259 in the vertical direction, the openings 280 of the central stage of the inner tube 259a and the spherical contacts 284 are conductive, the corresponding electrodes 5 are in a state of being detected by the touch panel 31, and a second-stage conductive pattern 82 is being generated. FIG. 101(C) shows a diagram of a state in which the movable electrode 25 is pressed to the bottom, and the movable electrode 25 is positioned at the lowermost end of the contact shielding tube 259, the openings 280 of the lowest stage of the inner tube 259a and the spherical contacts 284 are conductive, the corresponding electrodes 5 are in a state of being detected by the touch panel 31, and a third-stage conductive pattern 83 is being generated.

With these structures, the code generation apparatus 126 can generate conductive patterns in three stages, making it possible to create a large number of time-series patterns with a single arrangement pattern of electrodes 5 and a single first circuit board 420 pattern. Furthermore, it is possible to set four or more stages, and the method of detecting electrode patterns in such multiple stages is not limited to the method of this practical example, and any other method may be used.

Dividing the pressed state into multiple stages to increase the time-series patterns according to present specifications is also applicable to code generation apparatuses shown in other embodiments.

### Seventeenth Embodiment

### (Configuration Example of a Bluetooth-Equipped Code Generation Apparatus)

For a Bluetooth (BT) equipped code generation apparatus, it is possible to prepare a large number of distinguishable code generation apparatuses having different BD addresses for electrode codes corresponding to respective electrode patterns, and the code generation apparatus may be the form of a card. Note that the configuration of the card-type code generation apparatus described in the eleventh embodiment may also be used. FIG. 102 shows an example of a schematic diagram of the structure of a Bluetooth (BT) unit equipped card-type code generation apparatus 124 implemented with through-holes. FIG. 102(A) shows the front side of a code generation apparatus 124, FIG. 102(B) shows an internal structure of the front side of a code generation apparatus 124, and FIG. 102(C) shows a schematic diagram of the internal structure of the back side of a code generation apparatus 124. As shown in FIG. 102(A), the surface of the code generation apparatus 124 has a holding area for pinching with the fingers, in addition to a design or information in a text such as that on a normal financial card or ID card. By pinching the holding area, the fingers and an electric circuit in the card are made conductive, and when the code generation apparatus 124 is brought into contact or substantially brought into contact with a touch panel 31, via the connected electrodes 5, there is conduction from the touch panel 31 to the fingers thus causing a change in capacitance. Furthermore, the holding area may also function as a power button for the BT circuit board. In such a case, if the mechanism is such that the BT circuit board is conductive only while the power button is being pinched, electric power is not consumed while the button is not being pinched, and thus power saving can be achieved and the code generation apparatus 124 can continuously be used for a long period of time even if a consumable battery such as a paper battery (a sheet-type lithium-ion battery or the like) is used.

The mechanism of the power button can be such that once it is pressed, conduction continues until it is pressed again. Other mechanisms may also be applied. Also, the holding area for conduction and the power button may be separated. As the power source, a rechargeable type may also be used.

The size of the code generation apparatus 124 is preferably the same as that of a normal credit card with a thickness of 1 mm or less, in consideration of storability in a wallet or the like. If storing in a wallet is not intended, the thickness may be arbitrary.

As shown in FIG. 102(B), the front-side internal structure of a code generation apparatus 124 has through-holes made of conductive material placed over the positions of the corresponding electrodes shown in FIG. 102(C), and these through-holes are connected by conductive wiring. In addition, the conductive wiring is connected to a switch as shown by the dotted line in the area overlapping the BT circuit board. In this example, the switch acts as both an indicator electrode and a power button, and thus the switch has a double donut structure. There may be a paper battery on the BT circuit board. In addition to the above-mentioned power, the BT circuit board may have a Bluetooth (a beacon function may be included), a CPU, a storage media (ROM and RAM), and a clock function. There may also be other components. The BT circuit board may be a printed circuit board assembly (PCBA).

As shown in FIG. 102(C), a plurality of electrodes 5 are arranged in the back-side internal structure of a code generation apparatus 124, which are connected with through holes of the back-side internal structure via wiring by having a structure in which through-holes of the back-side internal structure are in contact, respectively. One electrode pattern is formed by the combination of electrodes 5, each of which has a different placement position, and a different electrode pattern is formed with one or more electrodes 5 with different arrangement positions with respect to the one electrode pattern.

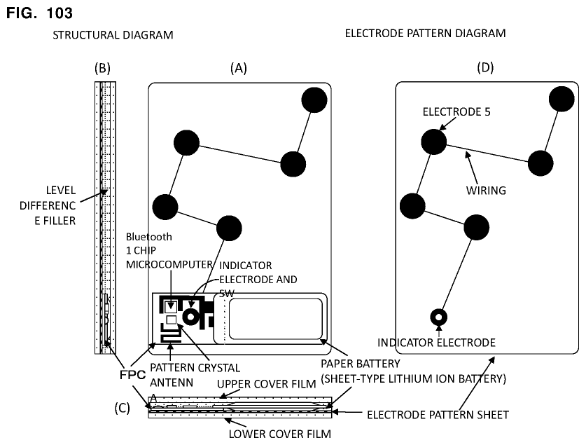

FIG. 103 shows a detailed structural diagram and electrode pattern diagram of a card-type code generation apparatus 124 equipped with a Bluetooth (BT) unit and a PCBA having a surface mount device (SMD) using surface mount technology (SMT). FIG. 103(A) is a structural diagram showing an internal structure of a code generation apparatus 124 in wired form, FIG. 103(B) is an internal side view of the long-length side of the code generation apparatus 124, FIG. 103(C) is an internal side view of the short-length side of the code generation apparatus 124, and FIG. 103(D) shows an example of an electrode pattern in wired form.

As shown in FIG. 103(A), in a surface mount type apparatus, the electrodes 5 and wires are connected in the same plane, unlike a through-hole implemented apparatus. As in the through-hole implemented apparatus, there may be a BT, a CPU, storage media (ROM and RAM), a power supply, a clock function, and a beacon function. In the figure, a pattern antenna and crystal are shown in the BT unit. The circuit board may be a flexible printed circuit board (FPC) among PCBs.

FIGS. 103(B) and 103(C) show a stacked structure including a stepped filler, an FPC, and an electrode pattern sheet, with cover films applied to each the front and back surfaces.

The through-hole implemented apparatus and surface mount type apparatus shown here are mere examples, and the code generation apparatus 124 can be of any other shape, size, and configuration. The number of electrodes may be other than five, and each may be of any shape and size. Also, there may be electrodes not included in an electrode pattern. There may also be a plurality of holding sections. When a plurality of holding sections is arranged, each of the plurality of holding sections may correspond to a different electrode pattern formed depending on electrodes 5 that become conductive when a section is held.

When providing a power switch in a holding section of the code generation apparatus 124, it is necessary to prevent the power switch from being pressed and the power from being turned ON when placed in a wallet or a cardholder, and even if the power turns ON, the power may be forcibly turned OFF when pairing with a Bluetooth is not achieved within a predetermined time.

Coupling with installed electronic components and patterned circuits may occur and result in the misrecognition of electrodes. However, misrecognition may be prevented by providing the electrodes and electronic components in different areas, and also by placing the patterned circuits in close proximity with a predetermined distance away.

When a smartphone is placed in a case and used as an information processing apparatus, the case frame may protrude from the touch panel surface plane of the smartphone, and cause a level difference to form. In such a case, when the code generation apparatus 124 is held and brought into contact with the touch panel 31, a gap may form due to the level difference, and the electrodes cannot be detected. Furthermore, when a tablet is used as an information processing apparatus, there are cases in which the electrode pattern arrangement area may not fit in well in the electrode pattern detection area due to the wide width of the outer frame of the touch panel surface. To have the code generation apparatus 124 be applicable for both a smartphone placed in a case with a level difference and a tablet with a wide width outer frame for the touch panel surface, the whole card may be made to be usable when it is placed on a touch panel surface and pressing the holding section down. In such a case, it is desirable to adopt a mechanism and material for the circuit board of which the dielectric constant is reduced as low as possible so that the electronic components near the holding section are not detected as electrodes 5. In addition, a base material that is easy to bend and easily returns back in place may be used, so that when a holding section is held with the fingers and the code generation apparatus 124 is pressed against the touch panel, only the electrode pattern arrangement area comes into contact with the touch panel surface of the smartphone or tablet.

### (Information Processing of a Bluetooth-Equipped Code Generation Apparatus and an Information Processing Apparatus)

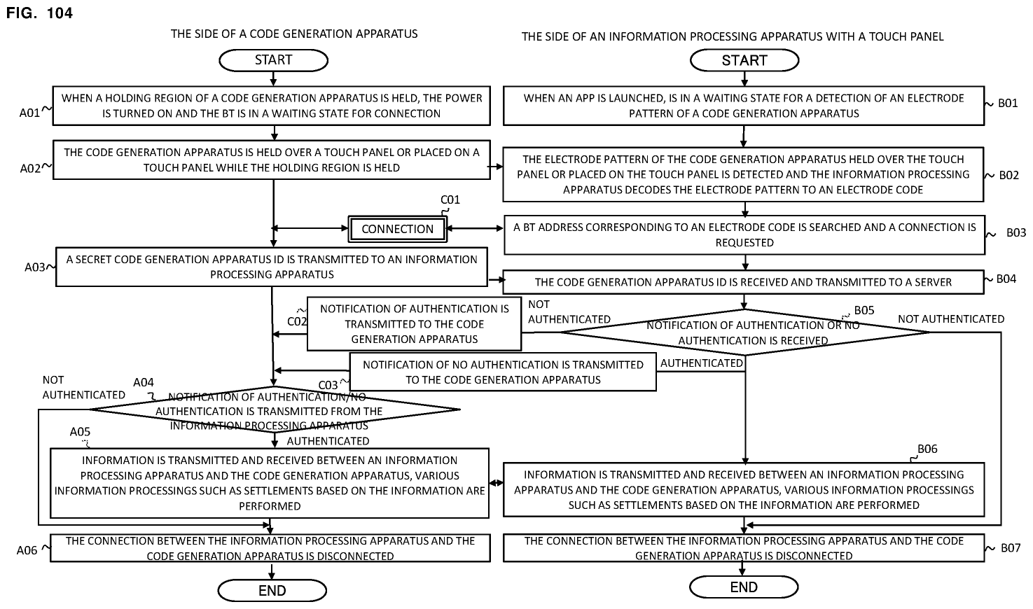

FIG. 104 shows a flowchart of an overall image of the connection between a Bluetooth-equipped code generation apparatus 124 and an information processing apparatus such as a smartphone, tablet, or the like, or a touch panel 31 connected to an information processing apparatus.

On the side of the code generation apparatus, when a holding area of a code generation apparatus 124 is pinched with the fingers, the BT control system turns ON and the BT enters in a connection standby state (A1). When the code generation apparatus 124 is brought into contact or substantially brought into contact with a touch panel 31 while holding a holding area, a change in capacitance occurs, and the side of the touch panel detects an electrode pattern based on the change (A2). When the code generation apparatus 124 in contact or substantially contact with the touch panel 31 is identified by the touch panel 31, the touch panel 31 and the code generation apparatus 124 are connected (C1). When a connection state is established, the code generation apparatus 124 sends a confidential code generation apparatus ID to the touch panel 31 (A3). If the ID cannot be authenticated on the touch panel side, a notification of “not authenticated” is sent to the code generation apparatus 124 (C2, A4), and the connection between the touch panel 31 and the code generation apparatus 124 is disconnected. If the connection is disconnected, the user may attempt to establish a connection again by bringing the code generation apparatus 124 into contact or substantially into contact with the touch panel 31. Also, a limit may be set on the number of reconnection attempts (A6). If the ID is authenticated on the touch panel side, an “authenticated” notice is sent to the code generation apparatus 124 (C3, A4), information is transmitted and received between the touch panel 31 and the code generation apparatus 124, and various information processings such as completing a settlement is performed based on the information (A5). After the predetermined information processing is completed, the connection between the touch panel 31 and the code generation apparatus 124 is disconnected (A6).

On the side of the touch panel of the information processing apparatus, when an application is launched, the touch panel enters a standby state for the detection of an electrode pattern of the code generation apparatus 124 (B1). When the code generation apparatus 124 makes contact or substantially makes contact with the touch panel 31, the touch panel 31 detects the electrode pattern of the code generation apparatus 124, and the information processing apparatus decodes the electrode pattern into an electrode code (B2). When the information processing apparatus searches for the BD address corresponding to the electrode code and identifies the code generation apparatus 124 that has made contact or has substantially made contact with the touch panel 31, the information processing apparatus requests to make a connection (B3), and the information processing apparatus and the code generation apparatus 124 make a connection (C1). The information processing apparatus sends the device ID sent from the code generation apparatus 124 to a server (B4). ID authentication is performed on the server, and the result is sent to the touch panel 31 as the notification of “authenticated” or “not authenticated” (B5). When not authenticated, a notification of “not authenticated” is transmitted from the touch panel 31 to the code generation apparatus 124 (C2), and the connection between the touch panel 31 and the code generation apparatus 124 is disconnected (A6). When authenticated, a notification of “authenticated” is transmitted from the touch panel 31 to the code generation apparatus 124 (C3), information is transmitted and received between the touch panel 31 and the code generation apparatus 124, and various information processings such as a settlement is completed based on the notification (B6). After the predetermined information processing is completed, the connection between the touch panel 31 and the code generation apparatus 124 is disconnected (B7).

In summary, the four following processes are included. (1) electrode code acquisition (A2, B2), (2) BT connection (B3, C1), (3) card authentication (A3-A4, B4-B5, C2-C3), (4) various information processings (A5, B6).

As described above, a series of information processings based on the connection between a Bluetooth-equipped code generation apparatus 124 and an information processing apparatus is exemplified. However, the order of processings may differ, other processes may be present, and a part of the processes may be omitted. Furthermore, for code generation apparatuses of other shapes and sizes, such a series of information processes may be applied.

### (Connection Between a Bluetooth-Equipped Code Generation Apparatus and an Information Processing Apparatus)

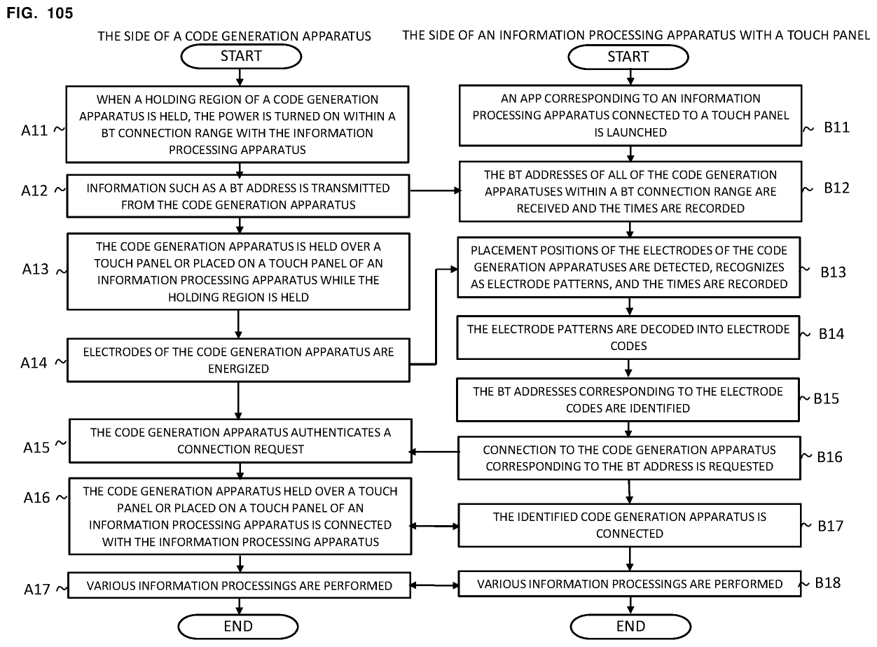

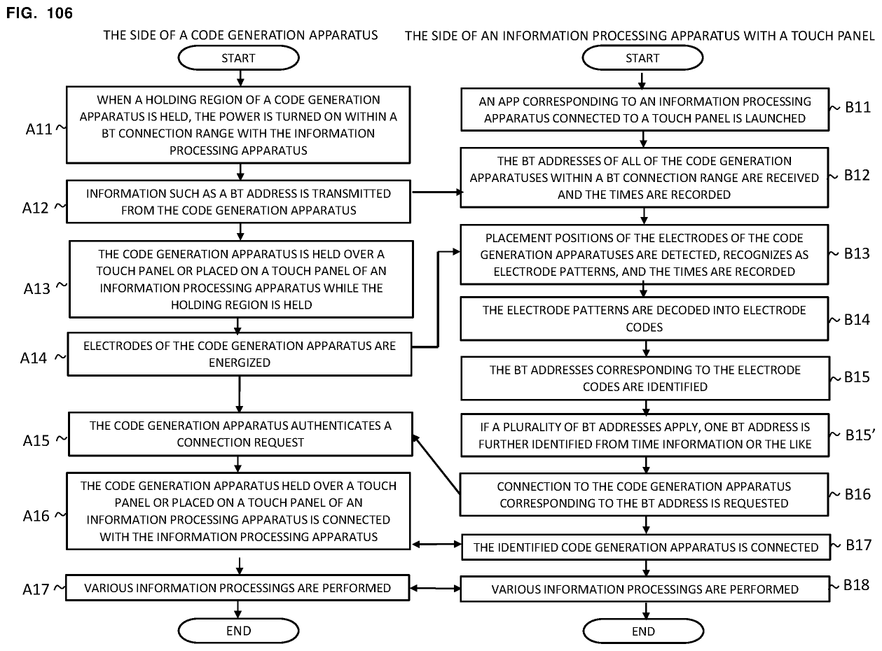

Among the above-described series of processings, detailed examples of the connection between a Bluetooth-equipped code generation apparatus 124 and an information processing apparatus are shown in FIGS. 105 and 106. FIG. 105 corresponds to a normal case, and FIG. 106 corresponds to a special case.

Connection procedures for a normal case are shown in FIG. 105.

On the side of the code generation apparatus, the power turns ON when the holding area of a code generation apparatus is held within the connection range for the BT unit and the information processing equipment (A11). Then, the code generation apparatus transmits information such as the BD address, and the information processing apparatus receives it (A12). While holding the holding area, the code generation apparatus is brought into contact or substantially brought into contact with the touch panel 31 of the information processing apparatus (A13). Then, the electrodes 5 of the code generation apparatus are energized (A14). When the information processing apparatus identifies the code generation apparatus that has made contact or has substantially make contact, since a request to make a connection is transmitted, and the code generation apparatus authenticates the request to make a connection (A15). Then the code generation apparatus that has made contact or has substantially made contact and the information processing apparatus equipped with the touch panel 31 is connected (A16). Various information processings are performed based on the transmission and reception of information with the information processing apparatus (A17). The process here conforms to the section (Connection between a code generation apparatus and a first information processing apparatus) of the ninth embodiment.

On the side of the information processing apparatus equipped with the touch panel 31, the corresponding application is launched (B11). the BD addresses of all of the code generation apparatuses whose power turns ON within the BT connection range are received, and the times are recorded (B12). The information processing apparatus detects the arrangement position of the 5 electrodes of the code generation apparatus via the touch panel 31 and recognizes it as an electrode pattern, and the time is recorded (B13). The information processing apparatus decodes the electrode pattern into an electrode code (B14). The information processing apparatus identifies the BD address corresponding to the electrode code based on the correspondence table in the next section of electrode codes, BD addresses, and device IDs stored in the information processor. The correspondence table may be stored in a server or the like and read (B15). Then, the information processor requests to make a connection to the code generation apparatus corresponding to the BD address (B16). The information processing apparatus is connected to the identified code generation apparatus (B17). Various information processings are performed based on the transmission and reception of information with the code generation apparatus (B18).

FIG. 106 shows a special case in which a plurality of smart cards turns ON within a BT connection range when electronic coupons are distributed or payments are made in a POS system in a crowded place. This corresponds to a case where a plurality of BD addresses corresponding to the same electrode code by decoding by an information processing apparatus happen to be detected. In this case, a connection is made only with the smart card that is at the shortest distance, or a connection is made based on time information recorded in the information processing apparatus (B15′). If more than one apparatus may still apply, the system may determine that there is an error and may prompt the user to make another attempt. Alternatively, a photosensor may be installed in the card and optical signals from the touch panel 31 may be used for collation.

### (Electrode Code and BD Address Mapping and Code Generation Apparatus ID)

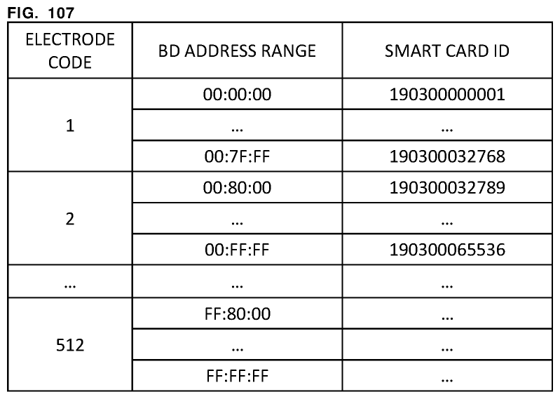

As described in the section (Recognition of a code generation apparatus in contact with a touch panel 31 of the first information processing apparatus 310) of the ninth embodiment and in the description of FIG. 106, even if a plurality of BD addresses is assigned per one electrode code, it is possible to distinguish them, and it is possible to assign code generation apparatus IDs corresponding to respective BD addresses. FIG. 107 exemplifies a case where hexadecimal Bluetooth device (BD) addresses used to distinguish BT terminals connected to a network are mapped with smartphone IDs and the total number of electrode codes is set to 512. Since the upper 24 bits of the 48 bits of the BD address are assigned to a corporate ID, in this example, the lower 24 bits are assigned to the BT device.

24 of the 48 bits of the BD address are assigned to the corporate ID, so in this example, the lower In addition, here, the code generation apparatus ID is a serial code that uniquely identifies each code generation apparatus, and the upper four digits may be used for the date of manufacture.

(Software Overview)

The software installed in a code generation apparatus 124 is BT control and data transmission/reception firmware, which controls BT connections and the transmissions/receptions of predetermined data to information processing apparatuses. That is, when a holding area of a code generation apparatus 124 is held, the power turns ON and the BT unit enters a standby state for pairing. After the code generation apparatus 124 is brought into contact or substantially brought into contact with a touch panel 31, pairing is performed at the request of the information processing apparatus having the touch panel 31. Then, the concealed device ID of the code generation apparatus 124 is transmitted to the information processing apparatus. When the device ID is authenticated by the information processing apparatus via an authentication server or the like, an approval notification is transmitted, and the information recorded in the storage medium of the code generation apparatus 124 is transmitted to the information processing apparatus or information is received from the information processing apparatus. In addition, a data security program may be installed to decode electronically signed data and encode into electronically signed data in data transmission/reception and to encrypt and decrypt data. Furthermore, various information processings are performed according to various installed applications.

The software installed in an information processing apparatus having a touch panel 31 is a capacitance code recognition application, a data transmission/reception application, and the like. The capacitance code recognition application detects an electrode pattern when the code generation apparatus 124 is brought into contact or substantially brought into contact with the touch panel 31, and the electrode pattern is decoded into an electrode code. That is, when the indicating electrode of a holding area is held with the fingers, the touch panel 31 detects the plurality of electrodes 5 provided inside the contact section of the card made conductive, and the electrode pattern formed from the coordinate values of each detected electrode 5 is decoded into an electrode code. The data transmission/reception application detects the BD addresses of the BT devices that exist in the vicinity of the information processing apparatus, identifies the code generation apparatus 124 with the BD address corresponding to the electrode code among them, and pairs the information processing apparatus with the corresponding code generation apparatus 124. It then performs transmission and reception of data, and transmits the concealed device ID sent from the code generation apparatus 124 to an authentication server. The result of authentication or non-authentication from the server is sent to the code generation apparatus 124, and information processing is performed according to the result. The software may be equipped with a function that can identify the Bluetooth with the closest distance from its Bluetooth radio wave strength (beacon function).

As an example of an authentication method, after pairing is established, one-time passwords from the cloud may be used upon transmission and reception of information between the first information processing apparatus and the code generation apparatus 124. Based on the received one-time password, the code generation apparatus 124 generates a one-time ID and sends it to the first information processing apparatus by BT, which in turn sends it to the cloud, and the cloud identifies and authenticates the code generation apparatus 124. Other authentication methods may also be used.

### (Application Example of a Bluetooth-Equipped Code Generation Apparatus)

Specifically, the code generation apparatus 124 can be used as a smart card. That is, as an industrial touch panel authentication card, it can be used as authentication for allowing the operation of industrial equipment such as manufacturing equipment, medical equipment, inspection equipment, control equipment, information displaying equipment, and the like, or as a personal identification card for admission and exit of authorized personnel to important facilities. Also, as a touch panel authentication card for business use, it can provide information (products and services) that visitors want to know by making contact or substantially making contact with a touch panel for a signage placed in stores. For example, using a touch panel installed in a hotel, information on sightseeing and events can be provided. And it can also be applied as an e-commerce settlement card. In these cases, there is no need for a special card reader, which is necessary for magnetic cards and IC cards. Of course, a special card reader may also be used. Depending on the method of use, it is also possible to form offline systems, that is, systems requiring only local communication.

It can also be used as a game card that can be used by moving and rotating the card. Furthermore, it can also be used as a storage medium that does not require a port such as that of a USB.

Examples of applications of the system, including procedures, are shown below.

### (1) Smart POS System

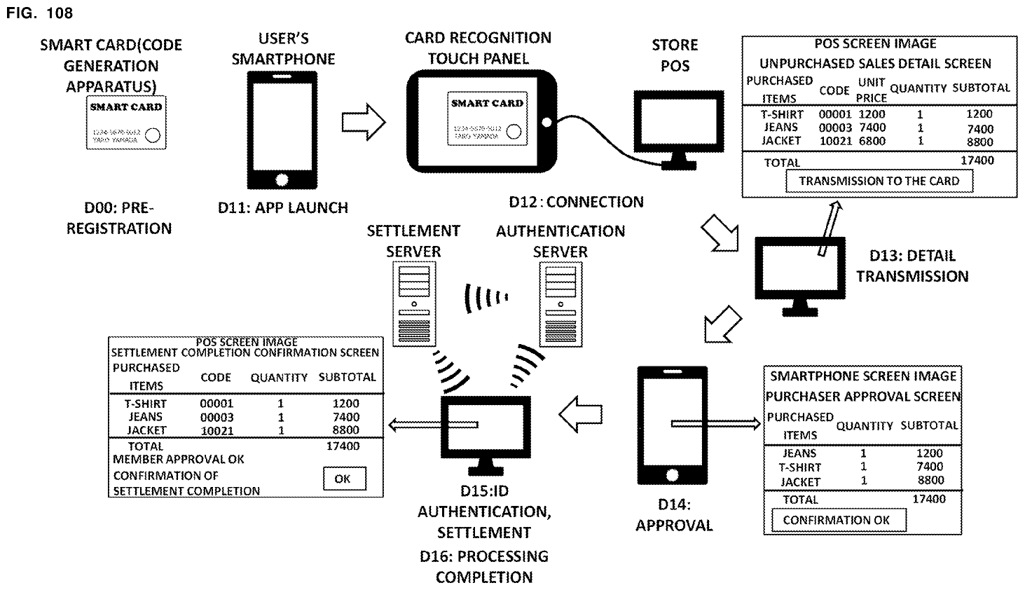

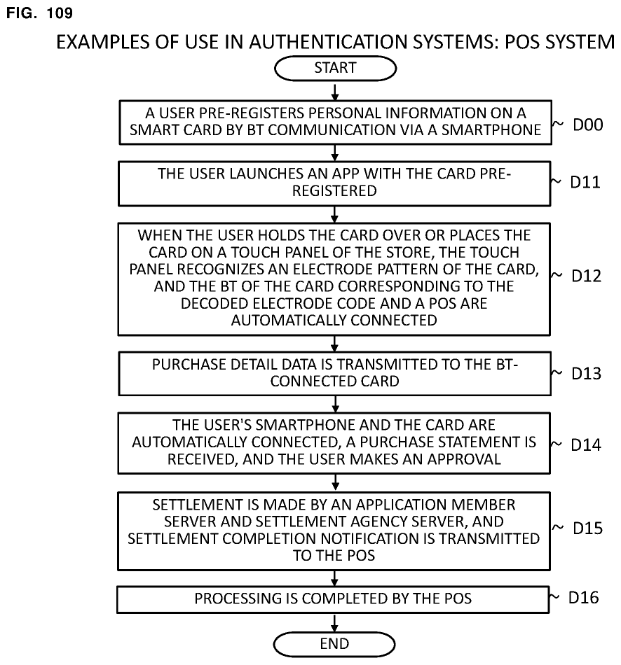

FIG. 108 and the flowchart in FIG. 109 exemplify the use of a code generation apparatus in a smart POS system. In this example, the user uses both his/her own code generation apparatus 124 and an information processing apparatus.

The user registers personal information in the smart card in advance (D00) through BT communication via a code generation apparatus 124 (smart card). To use the card, the user first launches an application in which the card has already been registered (D11). Next, when the user brings the card into contact or substantially brings the card into contact with a card recognition touch panel (which may be a touch panel of a tablet POS) connected to an information processing apparatus (which may include a tablet POS) of the store, the touch panel 31 detects the electrode positions of the card, and the information processing apparatus decodes the electrode pattern into an electrode code. The POS is then automatically connected to the BT of the card corresponding to the electrode code (D12). Purchase detail data is transmitted to the BT-connected card (D13). When the card is automatically connected to the information processing apparatus (smartphone), the smartphone receives a purchase detail statement and the user approves it (D14). Once the user is authenticated by the authentication server (application member server), a settlement is processed by a settlement agency server, and after completion, a settlement completion notification is sent to the POS system (D15). Lastly, the POS system records and analyzes the data, and the process is completed (D16). If a pre-charge function is implemented in a member application, the settlement process can be done using only local communication without having to perform communication through the WEB.

### (2) Admission and Exit Authentication

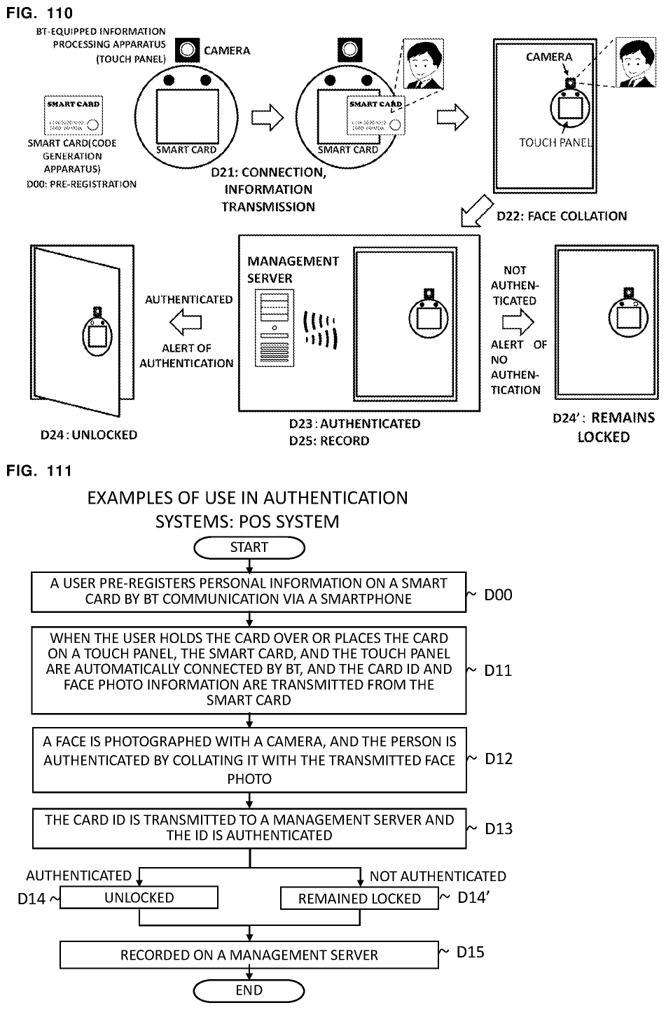

FIG. 110 and the flowchart in FIG. 111 exemplify the use for admission/exit authentication. This is an example in which a user uses a smart card alone.

The user registers personal information in a smart card in advance by BT communication via a code generation apparatus 124 (smart card) (D00). When in use, if the user brings the smart card into contact or substantially into contact with a touch panel 31 connected to an information processing apparatus, the smart card and the information processing apparatus are automatically connected by BT, and a card ID and face photo information are transmitted to the information processing apparatus (D21). Then, the face of the user is photographed by a camera connected to the information processing apparatus, and the personal authentication is performed by collating the transmitted face photo with the photographed face photo (D22). Furthermore, the card ID is transmitted to the management server, and ID authentication is performed (D23). Once authentication is complete, a notification of “authenticated” is transmitted to the information processing apparatus, the notification is shown on the display, and the entrance is unlocked (D24). If not authenticated, a notification of “not authenticated” is transmitted to the information processor and the notification is shown on the display, and the entrance remains locked (D24′). Regardless of whether the entrance is unlocked or remains locked, the action is recorded in the management server (D25). It is also possible to embed a smartphone in the touch panel 31 of the information processing apparatus. Furthermore, a special card reader is not required. It can be used for personal authentication for admission to and exit from controlled areas and for personal authentication at the reception desk of hotels and membership clubs. Note that this system can be implemented without registering personal information such as a face photo in a management server, and thus leakage of personal information can be prevented.

(3) e-Commerce

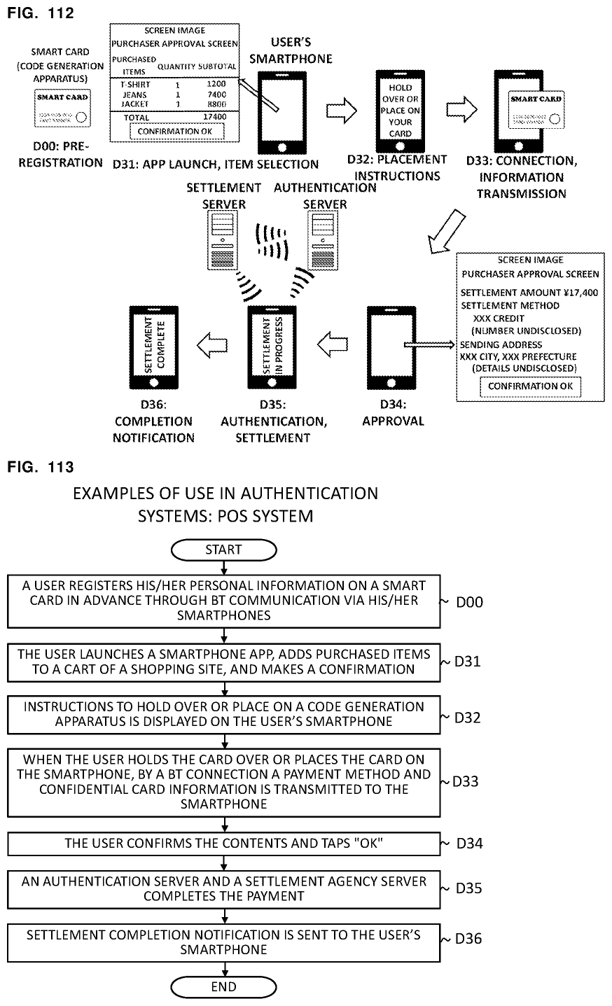

FIG. 112 and the flowchart in FIG. 113 exemplify use for admission/exit authentication. This is an example in which a user uses both his/her own code generation apparatus 124 and his/her own information processing apparatus, and unlike the examples (1) and (2), this is an example in which a user brings his/her own code generation apparatus 124 into contact or substantially brings his/her own code generation apparatus 124 into contact with his/her own information processing apparatus.

The user registers his/her personal information in a smart card in advance through BT communication via the code generation apparatus 124 (smart card) (D00). When using the smart card, the user launches a smart card application, puts items to be purchased in a cart at a shopping site, and confirms the purchase (D31). Then, the information processing apparatus will display instructions to bring the smart card into contact or substantially into contact with the information processing apparatus (D32). Next, when the user brings the smart card into contact or substantially into contact with the information processing apparatus, the settlement method and concealed card information are transmitted from the smart card to the information processing apparatus via BT connection (D33). The user confirms the contents and taps “OK” (D34). Once the user is authenticated, the settlement is processed by a settlement agency server and the settlement is completed (D35). Lastly, a settlement completion notification is transmitted to the information processing apparatus (D36).

Simple payment can be made by simply bringing the card into contact or substantially bringing the card into contact with the information processing apparatus and making an approving, without having to enter the card information directly into the site. It is possible to make specifications so that personal information is not stored in the settlement server.

It is possible to freely set and change a smart card so that it can be used with an information processing apparatus (a smartphone or the like) of only the user or so that it can be used with other information processing apparatuses. It is also possible to use an application to control the card so that it can be disabled when it is lost or so that the disabled state can be dissolved.

Here, only three examples have been described with reference to the drawings, but the code generation apparatus 124 may be used for other purposes.

In this example, we have described a card-type code generation apparatus 124 with Bluetooth (BT) as a communication apparatus, but any other communication apparatus may be used in the place of Bluetooth, such as WiFi, NFC, RF, or any other means of communication. Needless to say, the connection and data transmission/reception (including when only either transmission or reception is performed) is to be performed in a manner optimal to the communication apparatus. Furthermore, the structure, the communication means, the method of connection and data transmission/reception (including a case where only either transmission or reception is performed), applications, and the system of a code generation apparatus equipped with the communication apparatus described in the sixth and eighth embodiments or other examples may be combined and used in any way. Note that it is needless to say that among the embodiments for a code generation apparatus having a three-dimensional shape (stamp or the like), those applicable to a card-type code generation apparatus may be applied to a card-type code generation apparatus.

### EXPLANATION OF SIGNS

1, 111, 112, 112A, 115, 117, 117A, 117B, 120, 120A, 120B, 121, 122, 122A, 122B, 123, 125 . . . CODE GENERATION APPARATUS
1 [symbol] 111 [symbol] 112 [symbol] 112A [symbol] 115 [symbol] 117 [symbol] 117A [symbol] 117B [symbol] 120 [symbol] 120 A [symbol] 120B [symbol] 121 [symbol] 122 [symbol] 122A [symbol] 122B [symbol] 123, 124
131 . . . CODE CHANGEOVER SWITCH
132 . . . CODE GENERATION RECOGNITION SWITCH
133 . . . CLOCK FUNCTION
134 . . . TOUCH PANEL RECOGNITION SENSOR
2 . . . HOUSING
201 . . . LOWER SIDE HOUSING
203 . . . UPPER SIDE HOUSING
204 . . . HOLDING UNIT
206 . . . SUPPORTING COLUMN
207 . . . MAIN BODY
209 . . . FITTING PROTRUSION
21 . . . CONTACT SECTION, HUMAN BODY CONTACT CONDUCTIVE MEMBER, HUMAN BODY CONTACT ELECTRODE
210 . . . FITTING GROOVE
211 . . . CONDUCTIVE SHEET
222 . . . HANDLE UNIT
223 . . . POWER SUPPLY SWITCH
25 . . . MOVABLE ELECTRODE
251 . . . LOWER SIDE MOVABLE CONTACT UNIT
252 . . . UPPER SIDE MOVABLE CONTACT UNIT
253 . . . BRIM-SHAPED PORTION
254, 256 . . . MOVABLE CONTACT
255 . . . STEP PORTION
261 . . . USB CONNECTOR
262 . . . SWITCH PUSH BAR
270 . . . BOTTOM SURFACE FRAME PORTION
271 . . . CIRCUIT BOARD POSITIONING PORTION
272 . . . WIRING PASSAGE HOLE
273 . . . FIXED PEDESTAL
3 . . . CODE RECOGNITION APPARATUS
31 . . . TOUCH PANEL
310 . . . FIRST INFORMATION PROCESSING APPARATUS
32 . . . COMMUNICATION PROCESSING UNIT
320 . . . SECOND INFORMATION PROCESSING APPARATUS
330 . . . THIRD INFORMATION PROCESSING APPARATUS
360 . . . LIGHT RECEIVING UNIT
370 . . . DISPLAY
371 . . . ALERT DISPLAYING UNIT
372 . . . SOLAR PANEL
375 . . . USB PORT
4 . . . BOTTOM SURFACE
400 . . . CONDUCTIVE PATTERN PRINTED SHEET
404 . . . CONNECTION TERMINAL
407 . . . GAP
420, 422, 423 . . . FIRST CIRCUIT BOARD
421 . . . ELECTRODE VISUAL RECOGNITION PREVENTION SHEET
424 . . . GRAPHICS
425 . . . SPACER
5, 532 . . . ELECTRODE
530, 534 . . . CONDUCTIVE WIRE CONNECTION TERMINAL
531 . . . THROUGH HOLE
533 . . . ADDITIONAL ELECTRODE
54 . . . STANDARD ELECTRODE
6 . . . OPERATION UNIT, SECOND OPERATION UNIT
60 . . . PUSH BUTTON SWITCH
612 . . . CIRCUIT BOARD CONNECTION TERMINAL
630 . . . SECOND CIRCUIT BOARD
63 . . . THIRD CIRCUIT BOARD
631 . . . FIRST STAGE ELECTRODE CONNECTION TERMINAL
632 . . . SECOND STAGE ELECTRODE CONNECTION TERMINAL
633 . . . FIRST STAGE CONTACT UNIT
634 . . . SECOND STAGE CONTACT UNIT
635 . . . MOVABLE ELECTRODE SLIDING HOLE
636 . . . CONDUCTING WIRE
637 . . . WIRING
638 . . . SCREW HOLE
724 . . . WIRELESS COMMUNICATION UNIT, COMMUNICATION MODULE
727 . . . POWER SUPPLY UNIT
728 . . . PCB BOARD
78 . . . FIRST OPERATION UNIT
79 . . . CONDUCTION CONTROL UNIT
81 . . . FIRST CONDUCTIVE PATTERN
82 . . . SECOND CONDUCTIVE PATTERN, SECOND ELECTRODE PATTERN
95 . . . SLIDE SWITCH

1. An apparatus, wherein a plurality of electrodes detected by a change in a physical quantity detected by a touch panel by bringing it into contact with or by substantially into contact with the touch panel connected to a first information processing apparatus is arranged on a bottom surface of a housing comprising: a communication processing unit that is equipped with a housing formed of a conductive material connected to the said plurality of electrodes and that enters a connected state based on at least a part of an electrode code with the said first information processing apparatus that recognizes the electrode code formed based on electrodes detected by the said touch panel among the said plurality of electrodes.

2. The apparatus according to claim 1, wherein the said communication processing unit includes a storage means, and at least a unique device ID or a unique ID formed by combining a device ID with an electrode code is stored.

3. The apparatus according to claim 1, wherein the said electrode code is formed based on at least one of shapes, sizes, and geometric arrangements of the detected electrodes, magnitudes of detected physical quantities, and combinations thereof.

4. (canceled)

5. The apparatus according to claim 1, wherein the said first information processing apparatus enters a connected state with the said communication processing unit by recognizing a communication address including at least a part of the said electrode code or a communication address corresponding to at least a part of the said electrode code.

6. The apparatus according to claim 1, comprising a first operation unit configured to control the said communication processing unit, wherein the said first information processing apparatus enters a connected state with the said communication processing unit by recognizing a communication address including at least a part of the said electrode code or a communication address corresponding to at least a part of the said electrode code and by operating the said first operation unit.

7. The apparatus according to claim 1, comprising a sensing unit for sensing a state wherein the said first information processing apparatus is in contact with or substantially in contact with the said touch panel, wherein the said first information processing apparatus enters a connected state with the said communication processing unit by recognizing a communication address including at least a part of the said electrode code or a communication address corresponding to at least a part of the said electrode code and by having the said sensing unit sensing a state wherein the said first information processing apparatus is in contact with or substantially in contact with the said touch panel.

8. The apparatus according to claim 7, wherein the said sensing unit detects a change in a physical quantity detected from the said touch panel.

9. The apparatus according to claim 8, wherein the said sensing unit comprises one or more light detection sensors on a surface that is in contact with or substantially in contact with the said touch panel, and detects light displayed on the touch panel.

10. The apparatus according to claim 9, wherein positions of the said one or more light detection sensors are recognized by at least one of shapes, sizes, and geometric arrangements of the electrodes, magnitudes of detected physical quantities, and combinations thereof serving as a basis for forming the said electrode code and an optical code formed upon a history thereof is acquired by changing at least one of light colors, light intensities, and blinking times in time series in a region of the said touch panel corresponding to the said position.

11. The apparatus according to claim 1, wherein the said first information processing apparatus enters a connected state with the said communication processing unit located at a distance closest from the said first information processing apparatus when a plurality of communication addresses including at least a part of the said electrode codes or a plurality of communication addresses corresponding to at least a part of the said electrode codes are recognized.

12. The apparatus according to claim 11, wherein the said communication processing unit comprises a GPS and causes the first information processing apparatus to recognize a position acquired by the said GPS.

13. The apparatus according to claim 1, wherein the said communication processing unit has a clock function and transmits time information or information that changes with time.

14. The apparatus according to claim 1, wherein the said housing has either a plate shape or a three-dimensional shape, and a film formed of a non-conductive material is provided on the surface of the bottom surface section of the housing.

15. The apparatus according to claim 1, wherein the said conductive material is connected to a contact region formed in a region of a surface of the said housing, and an electrode code formed based on electrodes detected by the said touch panel is recognized by conduction of the conductive material to the said electrodes caused upon making contact with or holding the said contact region.

16. The apparatus according to claim 1, wherein the said conductive material is connected to a contact region formed in a region on the surface of the said housing, the contact region is formed in a plurality of regions on the surface of the housing, and by causing conduction between each conductive material in the said regions and the said electrodes connected to respective conductive material by making contact with or holding at least one of the said plurality of areas, a switchable electrode code formed based on electrodes detected by the said touch panel is recognized.

17. The apparatus according to claim 15, wherein a film formed of a non-conductive material is provided on a surface of the contact region.

18. The apparatus according to claim 1, further comprising: one or more second operation units capable of switching electrode codes formed based on electrodes detected by the said touch panel by conduction or disconnection of at least a part of conduction paths between the said electrodes and the said conductive material when a predetermined operation is received.

19. The apparatus according to claim 1, further comprising: a conduction control unit capable of switching electrode codes formed based on electrodes detected by the said touch panel by electrically connecting or disconnecting at least a part of conduction paths between the said electrodes and the said conductive material.

20. The apparatus according to claim 19, wherein an electrode code is formed based on a history of electrodes detected by the said touch panel by electrically changing the said connection or disconnection in time series.

21. The apparatus according to claim 1, wherein at least a part of the said electrode code includes a code for instructing the said first information processing apparatus to perform a predetermined information processing.

22. An information communication method, wherein a communication processing unit provided in a housing of the apparatus according to claim 1 with a plurality of electrodes arranged on the housing bottom surface, and a first information processing apparatus connected to a touch panel that detects one or more positions by detecting changes in physical quantities are caused to enter a connected state based on at least a part of the said electrode codes by causing the said first information processing apparatus to recognize an electrode code formed based on a plurality of electrodes detected by changes in physical quantities detected by the said touch panel by bringing the housing bottom surface into contact with or substantially into contact with the touch panel.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. An information communication system comprising: the apparatus according to any claim 1 and a first information processing apparatus connected to a touch panel that detects one or more positions by detecting changes in physical quantities, and wherein a plurality of electrodes arranged at the bottom surface of the housing of the apparatus is brought into contact with or substantially into contact with the said touch panel, the said first information processing apparatus recognizes an electrode code formed based on electrodes detected by the said touch panel among the said plurality of electrodes, and the communication processing unit provided in a housing of the said apparatus and the said first information processing apparatus enter a connected state based on at least a part of the said electrode code.

41. (canceled)

42. (canceled)

43. (canceled)

44. A program wherein a plurality of electrodes arranged on a bottom surface of a housing of the apparatus according claim 1 is brought into contact with or substantially into contact with a touch panel that detects one or more positions by detecting changes in physical quantities and is connected to the first information processing apparatus, the said first information processing apparatus recognizes an electrode code formed based on electrodes detected by the said touch panel among the said plurality of electrodes, and by using the information communication method according to any one of claims 22 to 25, the said first information processing apparatus and a communication processing unit provided in the housing of the said apparatus are caused to enter a connected state based on at least a part of the said electrode code.

45. (canceled)
